(19) United States
(12) Patent Application Publication
(10) Pub. No.: US 2026/0140350 A1
(43) Pub. Date: May 21, 2026

(54) Optical Lens Assembly and Electronic Device

(71) Applicant: NINGBO SUNNY AUTOMOTIVE OPTECH CO., LTD., Ningbo (CN)

(72) Inventors: Wenwei QIU, Ningbo (CN); Yifeng WANG, Ningbo (CN); Bo YAO, Ningbo (CN); Wentao WANG, Ningbo (CN)

(21) Appl. No.: 19/445,422

(22) Filed: Jan. 9, 2026

Related U.S. Application Data
(63) Continuation of application No. PCT/CN2024/112964, filed on Aug. 19, 2024.

(30) Foreign Application Priority Data
Jul. 13, 2023 (CN) 202310861678.8
Aug. 17, 2023 (CN) 202311044426.2
Dec. 19, 2023 (CN) 202311757471.2

(51) Int. Cl. G02B 13/00; G02B 7/02; G02B 9/62; G02B 9/64; H04N 23/55

(52) U.S. Cl. CPC G02B 13/0045; G02B 7/025; G02B 9/62; G02B 9/64; G02B 13/006; H04N 23/55

(57) ABSTRACT

Provided in the disclosure are an optical lens assembly and an electronic device. The optical lens assembly includes, in sequence from a first side to a second side: a first lens with a positive refractive power, wherein a first-side face of the first lens is a convex face; a second lens with a negative refractive power, wherein a first-side face of the second lens is a concave face, and a second-side face of the second lens is a concave face; a third lens with a positive refractive power, wherein a second-side face of the third lens is a convex face; a fourth lens with a refractive power, wherein a first-side face of the fourth lens is a convex face; a fifth lens with a refractive power; and a sixth lens with a negative refractive power.

### CROSS-REFERENCE TO RELATED APPLICATION(S)

The disclosure claims priority to Chinese Patent Application No. 202310861678.8 filed to the China National Intellectual Property Administration on Jul. 13, 2023 and entitled “Optical lens assembly and Electronic Device”, simultaneously further claims priority to Chinese Patent Application No. 202311044426.2 filed to the China National Intellectual Property Administration on Aug. 17, 2023 and entitled “Optical lens assembly and Electronic Device”, and simultaneously further claims priority to Chinese Patent Application No. 202311757471.2 filed to the China National Intellectual Property Administration on Dec. 19, 2023 and entitled “Optical lens assembly and Electronic Device”, and simultaneously further claims priority to PCT Application No. PCT/CN2024/112964 filed to the China National Intellectual Property Administration on Aug. 19, 2024 and entitled “Optical lenses and Electronic Devices”.

### FIELD

The disclosure relates to the technical field of optical imaging devices, and particularly, to an optical lens assembly and an electronic device.

### BACKGROUND

With the development of science and technology, there are more and more demands for optical lens assembly in daily life, and the optical lens assembly are applied to more and more scenarios. For example, the automobile driving industry, for driving safety, a driving environment needs to be detected more accurately, and the optical lens assembly has become key devices for detecting information around a car. As an automobile driving system increasingly develops, especially in recent years the innovation of automatic driving technology brought by the development of big data and artificial intelligence, market requirements for vehicle foresight optical lens assembly have become more and more stringent, such as a contradiction between low-cost, low sensitivity and high resolution, a contradiction between small diameter and miniaturization and high light flux and high pixel, requirements of fields of view for different use conditions, etc. Meanwhile, considering the high requirement for safety in automobile driving, proportions of the thermal stability and vibration stability of the optical lens assembly are also increasing.

However, there are a number of problems with the current optical lens assembly, for example, if a vehicle lens needs better resolution performance, an aspheric lens needs to be configured to improve a resolution force, but this increases costs and make it difficult to realize low cost. Meanwhile, the vehicle foresight optical lens assembly needs to be good in imaging performance at medium and long distances, but an existing lens architecture that only uses 6 spherical lenses have problems of combining high resolution, high light flux, and low sensitivity. In addition, an existing vehicle lens is difficult to realize long back focal lengths, miniaturization, and small CRAs at the same time, and thus may not well match an assembled vehicle chip. An existing optical lens assembly generally needs high light flux, and thus a large clear diameter needs to be disposed, which is difficult to achieve a balance with the need for miniaturization.

That is to say, optical lens assembly in the related art have the problem that it is difficult to take high resolution, miniaturization, long back focal lengths, small CRAs, low sensitivity, and high light flux into consideration at the same time.

### SUMMARY

Some embodiments of the disclosure is to provide an optical lens assembly and an electronic device, to solve the problem that an optical lens assembly in the related art is difficult to take high resolution, miniaturization, long back focal lengths, small CRAs, low sensitivity, and high light flux into consideration at the same time.

In an embodiment of the disclosure, an optical lens assembly is provided, sequentially includes from a first side to a second side: a first lens having a positive refractive power; a second lens having a negative refractive power; a third lens having a positive refractive power; a fourth lens having a refractive power; a fifth lens having a refractive power; and a sixth lens having a negative refractive power.

In an implementation, a first-side surface of the first lens is a convex surface, and a second-side surface of the first lens is a concave surface.

In an implementation, the first-side surface of the first lens is the convex surface, and the second-side surface of the first lens is a convex surface.

In an implementation, a first-side surface of the second lens is a concave surface, and a second-side surface of the first lens is a concave surface.

In an implementation, a first-side surface of the third lens is a convex surface, and a second-side surface of the third lens is a convex surface.

In an implementation, the first-side surface of the third lens is a concave surface, and the second-side surface of the third lens is the convex surface.

In an implementation, the fourth lens has a positive refractive power; and a first-side surface c is a convex surface, and a second-side surface of the fourth lens is a convex surface.

In an implementation, the fourth lens has a negative refractive power; and the first-side surface of the fourth lens is the convex surface, and the second-side surface of the fourth lens is a concave surface.

In an implementation, the fifth lens has a negative refractive power; and a first-side surface of the fifth lens is a concave surface, and a second-side surface of the fifth lens is a convex surface.

In an implementation, the fifth lens has the negative refractive power; and the first-side surface of the fifth lens is the concave surface, and the second-side surface of the fifth lens is a concave surface.

In an implementation, the fifth lens has a positive refractive power; and the first-side surface of the fifth lens is the convex surface, and the second-side surface of the fifth lens is a concave surface.

In an implementation, a first-side surface of the sixth lens is a concave surface, and a second-side surface of the sixth lens is a convex surface.

In an implementation, the first-side surface of the sixth lens is the concave surface, and the second-side surface of the sixth lens is a concave surface.

In an implementation, the first-side surface of the sixth lens is a convex surface, and the second-side surface of the sixth lens is the concave surface.

In an implementation, the fourth lens and the fifth lens are cemented to form a double cemented lens.

In an implementation, the optical lens assembly further includes a diaphragm, where the diaphragm is disposed between the second lens and the third lens.

In an implementation, a total optical length of the optical lens assembly, which is a distance TTL from a center of a first side of the first lens to a center of an imaging surface of the optical lens assembly, and an entire set focal length value F of the optical lens assembly meet: TTL/F≤4.

In an implementation, the entire set focal length value F of the optical lens assembly, a radian value θ of a maximum field of view of the optical lens assembly, and a maximum clear diameter D of the first-side surface of the first lens meet: (F*θ)/D≥0.2.

In an implementation, the maximum clear diameter D of the first-side surface of the first lens, an image height H corresponding to the maximum field of view of the optical lens assembly, and the maximum field of view of the optical lens assembly meet: D/H/FOV≤0.08.

In an implementation, the maximum clear diameter D of the first-side surface of the first lens, the image height H corresponding to the maximum field of view of the optical lens assembly, and the entire set focal length value F of the optical lens assembly meet: D/H/F≤0.2.

In an implementation, the entire set focal length value F of the optical lens assembly and the radian value θ of the maximum field of view of the optical lens assembly meet: F/θ≤30.

In an implementation, the image height H corresponding to the maximum field of view of the optical lens assembly, the entire set focal length value F of the optical lens assembly, and the radian value θ of the maximum field of view of the optical lens assembly meet: |(H−F*θ)/(F*θ)|≤0.06.

In an implementation, the entire set focal length value F of the optical lens assembly and an Entrance Pupil Diameter ENPD of the optical lens assembly meet: F/ENPD≤3.

In an implementation, the image height H corresponding to the maximum field of view of the optical lens assembly, the entire set focal length value F of the optical lens assembly, and the radian value θ of the maximum field of view of the optical lens assembly meet: 0.4≤(H/2)/(F*tan(θ/2))≤2.

In an implementation, a curvature radius R4 of a second-side surface of the second lens and a curvature radius R5 of the first-side surface of the third lens meet: |R4/R5|≤20.

In an implementation, a focal length F6 of the sixth lens and the entire set focal length value F of the optical lens assembly meet: F6/F≥−7.

In an implementation, a focal length F2 of the second lens and a focal length F3 of the third lens meet: −5≤F2/F3≤−0.02.

In an implementation, the entire set focal length value F of the optical lens assembly, a curvature radius R3 of a first-side surface of the second lens, and the curvature radius R4 of the second-side surface of the second lens meet: |F/R3|+|F/R4|≤8.

In an implementation, an air gap d7 between the third lens and the fourth lens and an optical back focal length of the optical lens assembly, which is a distance BFL from a center of a second-side of the last lens of the optical lens assembly to a center of the imaging surface, meet: (d7*BFL)/(d7+BFL)≤1.

In an implementation, a curvature radius R6 of a second-side surface of the third lens and the entire set focal length value F of the optical lens assembly meet: |R6/F|≤10.

In an implementation, a curvature radius R7 of a first-side surface of the fourth lens and the entire set focal length value F of the optical lens assembly meet: R7/F≤7.

In an implementation, the curvature radius R10 of the second-side surface of the fifth lens and the entire set focal length value F of the optical lens assembly meet: |R10/F|≥1.2.

In an implementation, the curvature radius R11 of the first-side surface of the sixth lens and the entire set focal length value F of the optical lens assembly meet: |R11/F|≤5.

In an implementation, the curvature radius R10 of the second-side surface of the fifth lens and the total optical length of the optical lens assembly, which is the distance TTL from the center of a first side of the first lens to the center of the imaging surface of the optical lens assembly, meet: |R10/TTL|≥0.8.

In an implementation, a center thickness d6 of the third lens and the total optical length of the optical lens assembly, which is the distance TTL from the center of the first side of the first lens to the center of the imaging surface of the optical lens assembly, meet: d6/TTL≥0.02.

In an implementation, the total optical length of the optical lens assembly, which is the distance TTL from the center of the first side of the first lens to the center of the imaging surface of the optical lens assembly, and a center thickness d11 of the sixth lens meet: TTL/d11≥6.

In an implementation, a center thickness d8 of the fourth lens, a center thickness d9 of the fifth lens, and the total optical length of the optical lens assembly, which is the distance TTL from the center of the first side of the first lens to the center of the imaging surface of the optical lens assembly, meet: (d8+d9)/TTL≥0.05.

In an implementation, a distance d26 between the first lens and the third lens, the center thickness d6 of the third lens, and the total optical length of the optical lens assembly, which is the distance TTL from the center of the first side of the first lens to the center of the imaging surface of the optical lens assembly, meet: |(d26−d6)/TTL|≤0.15.

In an implementation, a center thickness d3 of the second lens and the center thickness d6 of the third lens meet: 0.2≤d3/d6.

In an implementation, the distance d26 between the first lens and the third lens, the center thickness d6 of the third lens, and the curvature radius R5 of the first-side surface of the third lens meet: |(d26−d6)/R5|≤0.4.

In an implementation, the maximum clear diameter D of the first-side surface of the first lens and a curvature radius R1 of the first-side surface of the first lens meet: D/R1≥0.05.

In an implementation, a maximum effective clear diameter D7 of the first-side surface of the fourth lens corresponding to the maximum field of view of the optical lens assembly, the curvature radius R7 of a first-side surface of the fourth lens, and a sagittal height SAG7 of the first-side surface of the fourth lens meet: arctan(D7/(R7−SAG7))≥0.2.

In an implementation, the curvature radius R10 of the second-side surface of the fifth lens, the center thickness d8 of the fourth lens, and the center thickness d9 of the fifth lens meet: |R10/(d8+d9)|≥2.5.

In an implementation, the curvature radius R10 of the second-side surface of the fifth lens and the center thickness d9 of the fifth lens meet: |R10/d91≥5.2.

In an implementation, a curvature radius R12 of a second-side surface of the sixth lens and the center thickness d11 of the sixth lens meet: |R12/d11|≤55.

In an implementation, the curvature radius R11 of the first-side surface of the sixth lens and the curvature radius R12 of a second-side surface of the sixth lens meet: |R11/R12|≥0.1.

A curvature radius R10 of a second-side surface of the fifth lens and a curvature radius R11 of a first-side surface of the sixth lens meet: |R10/R11|≥4.3.

In another embodiment of the disclosure, an electronic device is provided, includes the optical lens assembly and an imaging element for converting an optical image formed by the optical lens assembly into an electrical signal.

Through the application of the technical solutions of the disclosure, the optical lens assembly sequentially includes from the first side to the second side: the first lens having the positive refractive power, the second lens having the negative refractive power, the third lens having the positive refractive power, the fourth lens having the refractive power, the fifth lens having the refractive power, and the sixth lens having the negative refractive power.

The first lens has the positive refractive power, the first-side surface of the first lens is the convex surface, such that an incidence angle of light may be small, and the corresponding image height decreases under the same FOV, facilitating the receiving of light with a larger angle, and increasing light flux at the same time; and the second-side surface of the first lens may be the concave surface or the convex surface. In an embodiment, the second-side surface of the first lens is the concave surface, a light trend is smooth, resolution is improved, and system sensitivity is reduced. When the second-side surface of the first lens is the convex surface, the light may be further compressed, such that follow-up lens diameters are reduced, and miniaturization is realized.

The second lens has the negative refractive power, the first-side surface of the second lens is the concave surface, such that the light trend in the front is effectively smoothed, the light is diverged, and the system sensitivity is reduced, thereby facilitating the increasing of the image surface and the correction of an aberration; and the second-side surface of the second lens is the concave surface to further diverge the light, and under the same FOV, a follow-up optical system may have a larger light receiving surface, such that the image surface is expanded, a physical diameter of the diaphragm may be enlarged, and an aperture is enlarged, thereby achieving a larger light entering amount, and increasing the brightness of the image surface.

The third lens has the positive refractive power, and the first-side surface of the third lens is the convex surface or the concave surface; in an embodiment, the first-side surface of the third lens is the convex surface, the light may be effectively collected, the light trend is smoothed, the system sensitivity is reduced, and a diameter of a rear end is simultaneously reduced, thereby realizing miniaturization; in another embodiment, the first-side surface of the third lens is the concave surface, the follow-up optical system may have a larger light receiving surface, so as to balance the aberration and improve resolution; and the second-side surface of the third lens is the convex surface and has a significant shape difference from the first-side surface of the fourth lens, such that the light trend is further changed, and follow-up diameters are compressed, thereby realizing miniaturization.

The fourth lens has the positive refractive power or the negative refractive power, and the first-side surface of the fourth lens is the convex surface, such that the light trend is effectively changed, lights are converged, and a diameter of a rear end is compressed; and the second-side surface of the fourth lens is the convex surface or the concave surface. In an embodiment, the second-side surface of the fourth lens is the convex surface, the fourth lens is conductive to matching the fifth lens to realize double cementing, such that the aberration may also be effectively improved under the premise of rational allocation of refractive indexes of the fourth lens and the fifth lens, thereby improving resolution. In another embodiment, the second-side surface of the fourth lens is the concave surface, the fourth lens is conductive to matching the fifth lens to realize double cementing, such that the aberration may also be effectively improved under the premise of rational allocation of the refractive indexes of the fourth lens and the fifth lens, thereby improving resolution.

The refractive power of the fifth lens is positive or negative, and in an embodiment, the refractive power of the fifth lens is negative, the lights are diverged. In another embodiment, the fifth lens has the positive refractive power, a diameter of a rear end is reduced, and miniaturization is realized.

The sixth lens has the negative refractive power, facilitating the smooth transition of the lights to an imaging surface, such that imaging stability is guaranteed.

In the disclosure, six lenses are used, and by optimizing and designing the refractive powers, surface types, and the like of the lenses, the optical lens assembly of the disclosure has at least one beneficial effect of having high resolution, miniaturization, long back focal lengths, small CRAs, low sensitivity, high light flux, and the like.

The disclosure is mainly intended to provide an optical lens assembly and an electronic device, so as to solve at least one of the problems that an optical lens assembly in the related art may not take small light flux, high resolution, and a small diameter into consideration at the same time, and the design of lenses is limited due to miniaturization, causing high sensitivity, aberration and the like to not be well balanced.

In an embodiment of the disclosure, an optical lens assembly is provided, includes: a first lens, having a positive refractive power; a second lens, having a refractive power; a third lens, having a positive refractive power; a fourth lens, having a negative refractive power; a fifth lens, having a positive refractive power; a sixth lens, having a refractive power; a seventh lens, having a refractive power; and an eighth lens, having a negative refractive power.

In an implementation, a first-side surface of the first lens is a convex surface, and a second-side surface of the first lens is a concave surface.

In an implementation, the first-side surface of the first lens is the convex surface, and the second-side surface of the first lens is a convex surface.

In an implementation, the second lens has a negative refractive power, and the first-side surface of the second lens is a convex surface, and a second-side surface of the second lens is a concave surface.

In an implementation, the second lens has a negative refractive power, and the first-side surface of the second lens is a concave surface, and a second-side surface of the second lens is a convex surface.

In an implementation, the second lens has a positive refractive power, and the first-side surface of the second lens is a concave surface, and a second-side surface of the second lens is a convex surface.

In an implementation, the first-side surface of the third lens is the concave surface, and the second-side surface of the third lens is a convex surface.

In an implementation, the first-side surface of the fourth lens is the concave surface, and the second-side surface of the fourth lens is a convex surface.

In an implementation, the first-side surface of the fifth lens is the convex surface, and the second-side surface of the fifth lens is a convex surface.

In an implementation, the first-side surface of the fifth lens is the concave surface, and the second-side surface of the fifth lens is a convex surface.

In an implementation, the sixth lens has a negative refractive power, and the first-side surface of the sixth lens is a convex surface, and a second-side surface of the sixth lens is a concave surface.

In an implementation, the sixth lens has a positive refractive power, and the first-side surface of the sixth lens is a convex surface, and a second-side surface of the sixth lens is a convex surface.

In an implementation, the sixth lens has a positive refractive power, and the first-side surface of the sixth lens is a convex surface, and a second-side surface of the sixth lens is a concave surface.

In an implementation, the seventh lens has a positive refractive power, and the first-side surface of the seventh lens is a convex surface, and a second-side surface of the seventh lens is a convex surface.

In an implementation, the seventh lens has a negative refractive power, and the first-side surface of the seventh lens is a concave surface, and a second-side surface of the seventh lens is a convex surface.

In an implementation, the seventh lens has a negative refractive power, and the first-side surface of the seventh lens is a concave surface, and a second-side surface of the seventh lens is a concave surface.

In an implementation, the seventh lens has a negative refractive power, and the first-side surface of the seventh lens is a convex surface, and a second-side surface of the seventh lens is a concave surface.

In an implementation, the first-side surface of the eighth lens is the concave surface, and the second-side surface of the eighth lens is a concave surface.

In an implementation, the first-side surface of the eighth lens is the convex surface, and the second-side surface of the eighth lens is a concave surface.

In an implementation, the optical lens assembly further includes a diaphragm, where the diaphragm is disposed between the second lens and the third lens.

In an implementation, the third lens and the fourth lens are cemented to form a double cemented lens, and the sixth lens and the seventh lens are cemented to form a double cemented lens.

In an implementation, a sum d67 of a center thickness of the sixth lens and a center thickness of the seventh lens and a total optical length TTL of the optical lens assembly meet: d67/TTL≤0.3.

In an implementation, an entire set focal length value F of the optical lens assembly, a radian value θ of a maximum field of view of the optical lens assembly, and a maximum clear diameter D of the first-side surface of the first lens corresponding to the optical lens assembly at the maximum field of view meet: (F*θ)/D≥0.3.

In an implementation, an entire set focal length value F of the optical lens assembly, a maximum field of view FOV of the optical lens assembly, and an image height H corresponding to the maximum field of view of the optical lens assembly meet: (FOV×F)/H≥45.

In an implementation, a total optical length TTL of the optical lens assembly and an entire set focal length value F of the optical lens assembly meet: TTL/F≤3.

In an implementation, an entire set focal length value F of the optical lens assembly, a maximum field of view FOV of the optical lens assembly, and an image height H corresponding to the maximum field of view of the optical lens assembly meet: TTL/H/FOV≤0.5

In an implementation, an entire set focal length value F of the optical lens assembly and an image height H corresponding to a maximum field of view of the optical lens assembly meet: 0.5≤F/H≤3.

In an implementation, a curvature radius R1 of the first-side surface of the first lens, a curvature radius R2 of the second-side surface of the first lens, a maximum effective clear diameter D of the first-side surface of the first lens corresponding to a maximum field of view FOV, and a maximum effective clear diameter D2 of the second-side surface of the first lens corresponding to the maximum field of view FOV meet: −1≤(R1/D)/(R2/D2)≤1

In an implementation, a curvature radius R9 of the first-side surface of the fifth lens and a curvature radius R10 of the second-side surface of the fifth lens meet: −6.5≤R9/R10≤7

In an implementation, an image height H corresponding to a maximum field of view FOV of the optical lens assembly, an entire set focal length value F of the optical lens assembly, and a radian value θ of the maximum field of view of the optical lens assembly meet: |(H−F*θ)/(F*θ)|≤0.05

In an implementation, the focal length value F of the entire set of optical lens assembly assemblies and an ENPD of the optical lens assembly meet: F/ENPD≤2.

In an implementation, a maximum clear diameter D of the first-side surface of the first lens corresponding to the optical lens assembly at a maximum field of view, an entire set focal length value F of the optical lens assembly, and an image height H corresponding to a maximum field of view of the optical lens assembly meet: D/H/F≤0.2.

In an implementation, a curvature radius R10 of the second-side surface of the fifth lens and a maximum effective clear diameter D9 of the first-side surface of the fifth lens corresponding to a maximum field of view meet: R10/D9≥−7.

In an implementation, a curvature radius R10 of the second-side surface of the fifth lens and an entire set focal length value F of the optical lens assembly meet: R10/F≥−3.5.

In an implementation, a curvature radius R15 of the second-side surface of the eighth lens and a TTL of the optical lens assembly meet: R15/TTL≥0.001.

In an implementation, an optical BFL of the optical lens assembly and an entire set focal length value F of the optical lens assembly meet: BFL/F≤0.54.

In an implementation, a curvature radius R15 of the second-side surface of the eighth lens and an optical BFL of the optical lens assembly meet: R15/BFL≥0.5.

In an implementation, a curvature radius R15 of the second-side surface of the eighth lens and an entire set focal length value F of the optical lens assembly meet: R15/F≥0.3.

In an implementation, a curvature radius R1 of a first-side surface of a first lens, a center thickness d1 of the first lens, and a curvature radius R2 of a second-side surface of the first lens meet: 0.175≤(R1+d1)/|R2|≤0.8.

In an implementation, a curvature radius R31 of a first-side surface of a third lens and a curvature radius R42 of a second-side surface of a fourth lens meet: 0.5≤R31/R42≤1.5.

In an implementation, a sum d67 of a center thickness of a sixth lens and a center thickness of a seventh lens and the entire set focal length value F of the optical lens assembly meet: 0.25 d67/F≤0.62.

In an implementation, a curvature radius R61 of a first-side surface of a sixth lens and a curvature radius R72 of a second-side surface of the seventh lens meet: 0.25≤|R61/R72|≤1.4.

In an implementation, a curvature radius R1 of the first-side surface of the first lens and the entire set focal length value F of the optical lens assembly meet: 0.5≤R1/F≤1.85.

In an implementation, a curvature radius R21 of a first-side surface of a second lens, a curvature radius R22 of a second-side surface of the second lens, and a center thickness d2 of the second lens meet: 0.35≤|R21|/((R22)+d2)≤1.4.

In an implementation, the center thickness d2 of the second lens and an edge thickness ET2 of the second lens meet: 0.95≤d2/ET2≤1.5.

In an implementation, a combined focal length F34 of the third lens and the fourth lens, and the entire set focal length value F of the optical lens assembly meet: 0<|F34/F|≤0.75.

In an implementation, a focal length F5 of a fifth lens and the entire set focal length value F of the optical lens assembly meet: 0.7≤F5/F≤2.

In an implementation, a combined focal length F67 of the sixth lens and the seventh lens, and the entire set focal length value F of the optical lens assembly meet: 0.55≤|F67/F|≤4.5.

In an implementation, a focal length F3 of the third lens and the entire set focal length value F of the optical lens assembly meet: 0.35≤F3/F≤1.8.

In an implementation, a focal length F4 of the fourth lens and the entire set focal length value F of the optical lens assembly meet: −2.4≤F4/F≤−0.2.

In an implementation, a focal length F8 of an eighth lens and the entire set focal length value F of the optical lens assembly meet: −3.2≤F8/F≤−0.5.

In an implementation, a focal length F1 of the first lens and the entire set focal length value F of the optical lens assembly meet: 1.05≤F1/F≤2.8.

In an implementation, each of lenses of the optical lens assembly meets the followings.

When a first-side surface of one of the lenses is a convex surface or a second-side surface of the one of the lenses is a concave surface, a sagittal height Sag(D/2)/n of the lens at one-nth of an optical axis and a sagittal height Sag(D/2)/(n+1) of the one of the lenses at one-(n+1)th of the optical axis meet: Sag(D/2)/n>Sag(D/2)/(n+1), where n≥1.

When the first-side surface of the one of the lenses is the concave surface or the second-side surface is the convex surface, a sagittal height Sag(D/2)/n of the one of the lenses at one-nth of an optical axis and a sagittal height Sag(D/2)/(n+1) of the one of the lenses at one-(n+1)th of the optical axis meet: Sag(D/2)/n>Sag(D/2)/(n+1), where n≥1.

In another embodiment of the disclosure, an electronic device is provided, includes the optical lens assembly and an imaging element for converting an optical image formed by the optical lens assembly into an electrical signal.

By using the technical solutions of the disclosure, the optical lens assembly includes the first lens, the second lens, the third lens, the fourth lens, the fifth lens, the sixth lens, the seventh lens, and the eighth lens. The first lens has the positive refractive power, a first-side surface of the first lens is a convex surface; the second lens has the refractive power, a first-side surface of the second lens has a surface shape opposite to that of a second-side surface of the second lens; the third lens has the positive refractive power, a first-side surface of the third lens is a concave surface, and a second-side surface of the third lens is a convex surface; the fourth lens has the negative refractive power, a first-side surface of the fourth lens is a concave surface, and a second-side surface of the fourth lens is a convex surface; the fifth lens has the positive refractive power, a second-side surface of the fifth lens is a convex surface; the sixth lens has the refractive power, a first-side surface of the sixth lens is a convex surface; the seventh lens has the refractive power; and the eighth lens has the negative refractive power, and a second-side surface of the eighth lens is a concave surface.

The first lens has the positive refractive power, and has a convergence effect on lights. Meanwhile, by designing the first-side surface of the first lens as the convex surface, the lights are collected over a large range, such that a large number of the lights enter the optical lens assembly, thereby increasing light flux and illuminance of the optical lens assembly. By designing the second-side surface of the first lens as the concave surface, a size of the first lens is decreased to meet a processing requirement, and at the same time, costs are reduced. Furthermore, the control of the lights by the concave surface causes the lights transitioning to a rear part to not be too sensitive, thereby facilitating improvement of resolution. The first lens uses a high refractive index material, which facilitates the gathering of front end lights, so as to decrease a front end diameter.

The first lens has the positive refractive power, and the first-side surface of the first lens and the second-side surface of the first lens both are convex surfaces, such that the lights passing through the first lens are more convergent when being emitted from the second-side surface of the first lens, to limit heights of the lights, so as to compress a diameter of the optical lens assembly, thereby realizing small-diameter and miniaturization design. Moreover, the first lens uses spherical glass, such that processing costs are reduced while a waterproofing membrane may be additionally plated.

The second lens has a negative refractive power; and a first-side surface of the second lens is a convex surface, and a second-side surface of the second lens is a concave surface. By setting the second lens to the negative refractive power and designing the first-side surface of the second lens as the convex surface, the front end lights are stably transitioned. The second-side surface of the second lens is the concave surface, such that the lights are filled in the pupil as much as possible after the lights converged on the first-side surface are released, thereby improving target surface illuminance.

The second lens has the negative refractive power; and a first-side surface of the second lens is a concave surface, and a second-side surface of the second lens is a convex surface. By setting the second lens to the negative refractive power and designing the first-side surface of the second lens as the concave surface to match the second-side surface of the convex first lens, a light trend is stabilized, and at the same time, by designing the second-side surface of the second lens as the convex surface to receive the lights perfectly, the sensibility of the optical lens assembly is reduced.

The second lens has a positive refractive power; and the first-side surface of the second lens is the convex surface, and the second-side surface of the second lens is the concave surface. The second lens has the positive refractive power and is a curved moon shaped convex to the first-side, such that the lights are compressed by the second lens to decrease a rear end diameter, thereby realizing miniaturization.

The third lens has the positive refractive power; and a first-side surface of the third lens is the concave surface, and a second-side surface of the third lens is the convex surface. The third lens is designed as the positive refractive power. The concave surface design of the first-side surface of the third lens is to better receive the lights passing through a diaphragm, so as to reserve an enough space for aberration adjustment of the lights of a rear optical system. By designing the second-side surface of the third lens as the convex surface, it ensures that the third lens and the fourth lens are able to have a close light trend, such that an optical energy loss caused by reflection between the lenses is reduced, relative illuminance is improved, and field curvature may be reduced to correct an off-axis aberration.

The fourth lens has the negative refractive power, the first-side surface of the fourth lens is the concave surface, and the second-side surface of the fourth lens is the convex surface. The fourth lens uses the negative refractive power. The first-side surface of the fourth lens being the concave surface is to better receive the lights incident through the third lens. The second-side surface of the fourth lens is designed as the convex surface to change the light trend. Moreover, the fourth lens is used as a cemented negative film, such that its material attributes also play a crucial role in correcting aberrations such as chromatic aberrations.

The fifth lens has the positive refractive power; and the first-side surface of the fifth lens is the convex surface, and the second-side surface of the fifth lens is the convex surface. The fifth lens uses the positive refractive power, and the first-side surface uses the convex surface, such that the lights of a front optical system may be gathered, and the rear end diameter is limited. The fifth lens serves as an important lens that bears a front lens group and a rear lens group, and the decreasing of the diameter may reduce a large aberration impact caused by edge FOV lights, such that the sensitivity and optical performance of the optical lens assembly are improved. By designing the second-side surface of the fifth lens as the convex surface, a size of the rear end diameter is optimized, and the convex surface design also maintains the sensitivity of the lights transmitted from the first-side surface, thereby facilitating reduction in the sensitivity.

The fifth lens has the positive refractive power; and the first-side surface of the fifth lens is the concave surface, and the second-side surface of the fifth lens is the convex surface. The fifth lens uses the positive refractive power, and by designing the first-side surface of the fifth lens as the concave surface to receive upward lights emitted, changes in a light trend of the fifth lens are not significant, such that the sensitivity of the fifth lens is optimized. The second-side surface of the fifth lens being the convex surface changes the light trend, causing the lights to be smoothly transitioned to the rear part.

The sixth lens has the negative refractive power; and the first-side surface of the sixth lens is the convex surface, and the second-side surface of the sixth lens is the concave surface. By setting the sixth lens to the negative refractive power, the first-side surface of the sixth lens being the convex surface is to converge the front end lights, the second-side surface of the sixth lens is designed as the concave surface, and the lights are diverged, such that light flux is increased, thereby an imaging effect in a dark environment is improved.

The sixth lens has the positive refractive power; and the first-side surface of the sixth lens is the convex surface, and the second-side surface of the sixth lens is the convex surface. The sixth lens is set to the positive refractive power. The first-side surface of the sixth lens is designed as the convex surface to be symmetrical with the convex surface of the second-side surface of the fourth lens, such that an effect of balancing an aberration is achieved. By designing the second-side surface of the sixth lens as the convex surface, the lights may be further converged to the center to decrease the rear end diameter.

The sixth lens has the positive refractive power; and the first-side surface of the sixth lens is the convex surface, and the second-side surface of the sixth lens is the concave surface. The sixth lens is set to the positive refractive power to converge the lights. The first-side surface of the sixth lens is designed as the convex surface to receive the front end lights. The second-side surface of the sixth lens is designed as the concave surface to achieve a transition effect, such that the trend of the lights entering the seventh lens is smooth, thereby improving the resolution of the optical lens assembly.

The seventh lens has the positive refractive power; and the first-side surface of the seventh lens is the convex surface, and the second-side surface of the seventh lens is the convex surface. By designing the seventh lens as the positive refractive power, and by simultaneously using double convex structure design, the front end lights are In an implementation converged, such that the lights smoothly enter the rear optical system, thereby realizing a small diameter.

The seventh lens has the negative refractive power; and the first-side surface of the seventh lens is the concave surface, and the second-side surface of the seventh lens is the convex surface. By designing the seventh lens as the negative refractive power, and designing the seventh lens as a curved moon shaped structure convex to the second-side, the seventh lens may receive the lights emitted from the sixth lens, and the lights are diffused outwards, so as to expand an imaging range.

The seventh lens has the negative refractive power; and the first-side surface of the seventh lens is the concave surface, and the second-side surface of the seventh lens is the concave surface. By designing the seventh lens as the negative refractive power, and designing the seventh lens as a double concave structure to match the double concave sixth lens, the lights are transitioned without a loss, and through the cooperation of the positive and negative refractive powers, an aberration between an edge light and a center light is corrected, thereby realizing high resolution.

The seventh lens has the negative refractive power; and the first-side surface of the seventh lens is the convex surface, and the second-side surface of the seventh lens is the concave surface. By designing the seventh lens as the negative refractive power, designing the first-side surface of the seventh lens as the convex surface to gather the lights, and designing the second-side surface of the seventh lens as the concave surface to diverge the lights, the heights of the lights are rapidly accumulated subsequently on an image surface, thereby expanding the imaging range.

The eighth lens has the negative refractive power; and the first-side surface of the eighth lens is the concave surface, and the second-side surface of the eighth lens is the concave surface. By designing the eighth lens as the negative refractive power, and designing the first-side surface as the concave surface, the lights entering through the seventh lens are collected, and by designing the second-side surface as the concave surface, a peripheral light aberration may be controlled and regulated to a certain extent, thereby improving the resolution of the optical lens assembly.

The eighth lens has the negative refractive power; and the first-side surface of the eighth lens is the convex surface, and the second-side surface of the eighth lens is the concave surface. By designing the eighth lens as the negative refractive power, the lights may be further diverged. The designing of the first-side surface as the convex surface facilitates the receiving of the incident lights of the seventh lens. The designing of the second-side surface as the concave surface facilitates the increasing of the light flux, thereby improving the imaging quality of the optical lens assembly in a dark environment.

The disclosure provides an optical lens assembly. The optical lens assembly may sequentially include from a first-side to a second-side along an optical axis: a first lens having a positive refractive power; a second lens having a refractive power; a third lens having a refractive power; a fourth lens having a refractive power; a fifth lens having a refractive power; a sixth lens having a refractive power; a seventh lens having a refractive power; and an eighth lens having a negative refractive power.

In an implementation, a first-side surface of the first lens is a convex surface, and a second-side surface of the first lens is a concave or convex surface.

In an implementation, the second lens has a negative refractive power, and the first-side surface of the second lens is a concave surface, and a second-side surface of the second lens is a concave surface.

In an implementation, the third lens has a positive refractive power, and the first-side surface of the third lens is a convex surface, and a second-side surface of the third lens is a convex surface; or the third lens has a negative refractive power, and the first-side surface of the third lens is a convex surface, and a second-side surface of the third lens is a concave surface

In an implementation, the fourth lens has a positive refractive power, and the first-side surface of the fourth lens is a convex surface, and a second-side surface of the fourth lens is a convex surface; or the fourth lens has a negative refractive power, and the first-side surface of the fourth lens is a concave surface, and the second-side surface of the fourth lens is a concave surface; or the fourth lens has a negative refractive power, and the first-side surface of the fourth lens is a convex surface, and a second-side surface of the fourth lens is a concave surface.

In an implementation, the fifth lens has a positive refractive power, and the first-side surface of the fifth lens is a convex surface, and a second-side surface of the fifth lens is a convex surface; or the fifth lens has a negative refractive power, and the first-side surface of the fifth lens is a concave surface, and a second-side surface of the fifth lens is a convex surface

In an implementation, the sixth lens has a negative refractive power, and the first-side surface of the sixth lens is a convex surface, and a second-side surface of the sixth lens is a concave surface; or the sixth lens has a positive refractive power, and the first-side surface of the sixth lens is a convex surface, and a second-side surface of the sixth lens is a convex surface

In an implementation, the seventh lens has a positive refractive power, and the first-side surface of the seventh lens is a convex surface, and a second-side surface of the seventh lens is a convex surface; or the seventh lens has a negative refractive power, and the first-side surface of the seventh lens is a concave surface, and a second-side surface of the seventh lens is a concave surface; or the seventh lens has a negative refractive power, and the first-side surface of the seventh lens is a concave surface, and a second-side surface of the seventh lens is a convex surface

In an implementation, a first-side surface of the eighth lens is a concave surface, and a second-side surface of the eighth lens is a concave or convex surface.

In an implementation, the optical lens assembly further includes a diaphragm, where the diaphragm is disposed between the second lens and the third lens.

In an implementation, the third lens and the fourth lens are cemented to form a double cemented lens.

In an implementation, the fourth lens and the fifth lens are cemented to form a double cemented lens.

In an implementation, the sixth lens and the seventh lens are cemented to form a double cemented lens.

In an implementation, the optical lens assembly of the disclosure meets: TTL/F≤3.5, where TTL refers to a distance from the center of the first-side surface of the first lens to the imaging surface of the optical lens assembly on the optical axis, and F refers to a total effective focal length of the optical lens assembly.

In an implementation, the optical lens assembly of the disclosure meets: F/ENPD≤2, where F refers to the total effective focal length of the optical lens assembly, and ENPD refers to an entrance pupil diameter of the optical lens assembly.

In an implementation, the optical lens assembly of the disclosure meets: 0≤R31/F≤20, where R31 refers to a curvature radius of the first-side surface of the third lens, and F refers to the total effective focal length of the optical lens assembly.

In an implementation, the optical lens assembly of the disclosure meets: 0.4≤R31/F≤10, where R31 refers to a curvature radius of the first-side surface of the third lens, and F refers to the total effective focal length of the optical lens assembly.

In an implementation, the optical lens assembly of the disclosure meets: −20≤R52/F≤0, where R52 refers to a curvature radius of the second-side surface of the fifth lens, and F refers to the total effective focal length of the optical lens assembly.

In an implementation, the optical lens assembly of the disclosure meets: 0≤R61/F≤20, where R61 refers to a curvature radius of the first-side surface of the sixth lens, and F refers to the total effective focal length of the optical lens assembly.

In an implementation, the optical lens assembly of the disclosure meets: −12≤R21/R22<0, where R21 refers to a curvature radius of the first-side surface of the second lens, and R22 refers to a curvature radius of the second-side surface of the second lens.

In an implementation, the optical lens assembly of the disclosure meets: −8≤R21/F≤−0.35, where R21 refers to the curvature radius of the first-side surface of the second lens, and F refers to the total effective focal length of the optical lens assembly.

In an implementation, the optical lens assembly of the disclosure meets: 0.02≤d23/TTL≤0.4, where d23 refers to an air gap between the second lens and the third lens on the optical axis, that is, a distance from the center of the second-side surface of the second lens to the center of the first-side surface of the third lens; and the TTL refers to the distance from the center of the first side of the first lens to the imaging surface of the optical lens assembly on the optical axis.

In an implementation, the optical lens assembly of the disclosure meets: 0.035≤d23/TTL≤0.25, where d23 refers to an air gap between the second lens and the third lens on the optical axis, that is, a distance from the center of the second-side surface of the second lens to the center of the first-side surface of the third lens; and the TTL refers to the distance from the center of the first side of the first lens to the imaging surface of the optical lens assembly on the optical axis.

In an implementation, the optical lens assembly of the disclosure meets: −4≤F2/F. F2 is an effective focal length of the second lens; and F refers to the total effective focal length of the optical lens assembly.

In an implementation, the optical lens assembly of the disclosure meets: −2.5≤F2/F≤−0.3. F2 is an effective focal length of the second lens; and F refers to the total effective focal length of the optical lens assembly.

In an implementation, the optical lens assembly of the disclosure meets: 0≤R22/F≤5, where R22 refers to the curvature radius of the second-side surface of the second lens, and F refers to the total effective focal length of the optical lens assembly.

In an implementation, the optical lens assembly of the disclosure meets: −8≤F8/F, where F8 refers to an effective focal length of the eighth lens, and F refers to the total effective focal length of the optical lens assembly.

In an implementation, the optical lens assembly of the disclosure meets: −5≤F8/F≤−0.25 where F8 refers to an effective focal length of the eighth lens, and F refers to the total effective focal length of the optical lens assembly.

In an implementation, the optical lens assembly of the disclosure meets: F1/F≤8, where F1 refers to an effective focal length of the first lens, and F refers to the total effective focal length of the optical lens assembly.

In an implementation, the optical lens assembly of the disclosure meets: d67/TTL≤0.05, where d67 refers to an air gap between the sixth lens and the seventh lens on the optical axis, and the TTL refers to the distance from the center of the first-side surface of the first lens to the imaging surface of the optical lens assembly on the optical axis.

In an implementation, the optical lens assembly of the disclosure meets: 0.6≤|F67/F|, where F67 refers to a combined focal length of the sixth lens and the seventh lens, and F refers to the total effective focal length of the optical lens assembly.

In an implementation, the optical lens assembly of the disclosure meets: 45°≤(FOV×F)/H, FOV refers to a maximum field of view of the optical lens assembly, F refers to the total effective focal length of the optical lens assembly, and H refers to an image height corresponding to the maximum field of view of the optical lens assembly.

In an implementation, the optical lens assembly of the disclosure meets: 50°≤(FOV×F)/H≤90°, FOV refers to a maximum field of view of the optical lens assembly, F refers to the total effective focal length of the optical lens assembly, and H refers to an image height corresponding to the maximum field of view of the optical lens assembly.

In an implementation, the optical lens assembly of the disclosure meets: 1.0≤F/H≤2.5, where F refers to the total effective focal length of the optical lens assembly, and H refers to the image height corresponding to the maximum field of view FOV of the optical lens assembly.

In an implementation, the optical lens assembly of the disclosure meets: |(R11/D1)/(R12/D2)|≤1, where R11 refers to a curvature radius of the first-side surface of the first lens, D1 refers to a maximum clear diameter of the first-side surface of the first lens corresponding to the maximum field of view of the optical lens assembly, R12 refers to a curvature radius of the second-side surface of the first lens, and D2 refers to a maximum effective clear diameter of the second-side surface of the first lens corresponding to the maximum field of view of the optical lens assembly.

In an implementation, the optical lens assembly of the disclosure meets: D1/H/FOV≤0.1, FOV refers to the maximum field of view of the optical lens assembly, D1 refers to the maximum effective clear diameter of the first-side surface of the first lens corresponding to a maximum field of view of the optical lens assembly, and H refers to the image height corresponding to the maximum field of view of the optical lens assembly.

In an implementation, the optical lens assembly of the disclosure meets: TTL/H/FOV≤0.2, where FOV refers to the maximum field of view of the optical lens assembly, H refers to the image height corresponding to the maximum field of view of the optical lens assembly, and TTL refers to the distance from the center of the first-side surface of the first lens to the imaging surface of the optical lens assembly on the optical axis.

In an implementation, the optical lens assembly of the disclosure meets: 0.5≤(H/2)/(F×tan(θ/2))≤1.5, H refers to the image height corresponding to the maximum field of view of the optical lens assembly, F refers to the total effective focal length of the optical lens assembly, and θ refers to a radian value corresponding to the maximum field of view FOV of the optical lens assembly.

In an implementation, the optical lens assembly of the disclosure meets: 0<F45/F≤3, where F45 refers to a combined focal length of the fourth lens and the fifth lens, and F refers to the total effective focal length of the optical lens assembly.

In an implementation, the optical lens assembly of the disclosure meets: −10≤R42/R51≤4, where R42 refers to a curvature radius of the second-side surface of the fourth lens, and R51 refers to a curvature radius of the first-side surface of the fifth lens.

In an implementation, the optical lens assembly of the disclosure meets: d45/TTL≤0.04 where d45 refers to an air gap between the fourth lens and the fifth lens on the optical axis, and the TTL refers to the distance from the center of the first-side surface of the first lens to the imaging surface of the optical lens assembly on the optical axis.

In an implementation, the optical lens assembly of the disclosure meets: |F34/F|≤8.5, where F34 refers to a combined focal length of the third lens and the fourth lens, and F refers to the total effective focal length of the optical lens assembly.

In an implementation, the optical lens assembly of the disclosure meets: −6≤R32/R41≤2, where R32 refers to a curvature radius of the second-side surface of the third lens, and R41 refers to a curvature radius of the first-side surface of the fourth lens.

In an implementation, the optical lens assembly of the disclosure meets: d34/TTL≤0.04, where d34 refers to an air gap between the third lens and the fourth lens on the optical axis, and the TTL refers to the distance from the center of the first-side surface of the first lens to the imaging surface of the optical lens assembly on the optical axis.

In an implementation, the optical lens assembly of the disclosure meets: −12≤R21/F≤0, where R21 refers to the curvature radius of the first-side surface of the second lens, and F refers to the total effective focal length of the optical lens assembly.

In an implementation, the optical lens assembly of the disclosure meets: 0.7≤R62/R71≤1.3, where R62 refers to a curvature radius of the second-side surface of the sixth lens, and R71 refers to a curvature radius of the first-side surface of the seventh lens.

In an implementation, the optical lens assembly of the disclosure meets: −0.75≤R21/(R22+d2)≤−0.1, where R21 refers to the curvature radius of the first-side surface of the second lens, R22 refers to the curvature radius of the second-side surface of the second lens, and d2 refers to a center thickness of the second lens.

In an implementation, the optical lens assembly of the disclosure meets: 0.28≤d2/ET2≤0.65, where d2 refers to the center thickness of the second lens, and ET2 refers to an edge thickness of the second lens.

In an implementation, the optical lens assembly of the disclosure meets: 0.5≤R11/F≤2.8, where R11 refers to the curvature radius of the first-side surface of the first lens, and the F refers to the total effective focal length of the optical lens assembly.

In an implementation, the optical lens assembly of the disclosure meets: 0.35≤R31/F≤1.5, where R31 refers to the curvature radius of the first-side surface of the third lens, and the F refers to the total effective focal length of the optical lens assembly.

In an implementation, the optical lens assembly of the disclosure meets: −3.5≤R52/R61≤−0.35, where R52 refers to the curvature radius of the second-side surface of the fifth lens, and R61 refers to the curvature radius of the first-side surface of the sixth lens.

In an implementation, the optical lens assembly of the disclosure meets: −2≤(R52*F)/(R61*TTL)≤−0.16, where the R52 refers to the curvature radius of the second-side surface of the fifth lens, the F refers to the total effective focal length of the optical lens assembly, the R61 refers to the curvature radius of the first-side surface of the sixth lens, and the TTL refers to the distance from the center of the first-side surface of the first lens to the imaging surface of the optical lens assembly on the optical axis.

In an implementation, the optical lens assembly of the disclosure meets: −1.25≤R81/F≤−0.2, where R81 refers to the curvature radius of the first-side surface of the eighth lens, the F refers to the total effective focal length of the optical lens assembly.

In an implementation, the optical lens assembly of the disclosure meets: −4.5≤F1/F8≤−1, where the F1 refers to the effective focal length of the first lens, and F8 refers to an effective focal length of the eighth lens.

In an implementation, the optical lens assembly of the disclosure meets: 0.35≤(d6+d7)/F≤0.68, where d6 refers to the center thickness of the sixth lens, d7 refers to the center thickness of the seventh lens, and the F refers to the total effective focal length of the optical lens assembly.

In an implementation, the optical lens assembly of the disclosure meets: −3.8≤F6/F7≤−0.4, where F6 refers to an effective focal length of the sixth lens, and F7 refers to an effective focal length of the seventh lens.

In an implementation, each of lenses of the optical lens assembly meets the followings.

When a first-side surface of one of the lenses is a convex surface or a second-side surface of the one of the lenses is a concave surface, the optical lens assembly of the disclosure meets: Sag(D/2)/n>Sag(D/2)/(n+1), where Sag(D/2)/n refers to a sagittal height of the lens at one-nth of an optical axis, and Sag(D/2)/(n+1) refers to a sagittal height of the one of the lenses at one-(n+1)th of the optical axis, where n≥1.

When the first-side surface of the one of the lenses is the concave surface or the second-side surface is the convex surface, the optical lens assembly of the disclosure meets: Sag(D/2)/n>Sag(D/2)/(n+1), where the Sag(D/2)/n refers to a sagittal height of the lens at one-nth of an optical axis, and the Sag(D/2)/(n+1) refers to a sagittal height of the one of the lenses at one-(n+1)th of the optical axis, where n≥1.

In another embodiment of the disclosure, an electronic device is provided, includes the optical lens assembly and an imaging element for converting an optical image formed by the optical lens assembly into an electrical signal.

This solution uses eight lenses. By optimizing and designing the shapes, refractive powers, etc. of the lenses, the optical lens assembly has at least one beneficial effects of high resolution, miniaturization, a small diameter, low sensitivity, high light flux, a long focal length, small distortion, or high performance, such that the optical lens assembly is able to better meet application requirements of vehicle front-view lenses.

### BRIEF DESCRIPTION OF DRAWINGS

The drawings, which form a part of the disclosure, are configured to provide a further understanding of the disclosure. The exemplary embodiments of the disclosure and the description thereof are configured to explain the disclosure, but do not constitute improper limitations to the disclosure. In the drawings:

FIG. 1 is a schematic structural diagram of an optical lens assembly according to Example 1 of the disclosure.

FIG. 2 is a schematic structural diagram of an optical lens assembly according to Example 2 of the disclosure.

FIG. 3 is a schematic structural diagram of an optical lens assembly according to Example 3 of the disclosure.

FIG. 4 is a schematic structural diagram of an optical lens assembly according to Example 4 of the disclosure.

FIG. 5 is a schematic structural diagram of an optical lens assembly according to Example 5 of the disclosure.

FIG. 6 is a schematic structural diagram of an optical lens assembly according to Example 6 of the disclosure.

FIG. 7 is a schematic structural diagram of an optical lens assembly according to Example 7 of the disclosure.

FIG. 8 is a schematic structural diagram of an optical lens assembly according to Example 8 of the disclosure.

FIG. 9 is a schematic structural diagram of an optical lens assembly according to Example 9 of the disclosure.

FIG. 10 is a schematic structural diagram of an optical lens assembly according to Example 10 of the disclosure.

FIG. 11 is a schematic structural diagram of an optical lens assembly according to Example 11 of the disclosure.

FIG. 12 is a schematic structural diagram of an optical lens assembly according to Example 12 of the disclosure.

FIG. 13 is a schematic structural diagram of an optical lens assembly according to Example 13 of the disclosure.

FIG. 14 is a schematic structural diagram of an optical lens assembly according to Example 14 of the disclosure.

FIG. 15 is a schematic structural diagram of an optical lens assembly according to Example 15 of the disclosure.

FIG. 16 is a schematic structural diagram of an optical lens assembly according to Example 16 of the disclosure.

FIG. 17 is a schematic structural diagram of an optical lens assembly according to Example 17 of the disclosure.

FIG. 18 is a schematic structural diagram of an optical lens assembly according to Example 18 of the disclosure.

FIG. 19 is a schematic structural diagram of an optical lens assembly according to Example 19 of the disclosure.

FIG. 20 is a schematic structural diagram of an optical lens assembly according to Example 20 of the disclosure.

FIG. 21 is a schematic structural diagram of an optical lens assembly according to Example 21 of the disclosure.

FIG. 22 is a schematic structural diagram of an optical lens assembly according to Example 22 of the disclosure.

FIG. 23 is a schematic structural diagram of an optical lens assembly according to Example 23 of the disclosure.

FIG. 24 is a schematic structural diagram of an optical lens assembly according to Example 24 of the disclosure.

FIG. 25 is a schematic structural diagram of an optical lens assembly according to Example 25 of the disclosure.

FIG. 26 is a schematic structural diagram of an optical lens assembly according to Example 26 of the disclosure.

FIG. 27 is a schematic structural diagram of an optical lens assembly according to Example 27 of the disclosure.

FIG. 28 is a schematic structural diagram of an optical lens assembly according to Example 28 of the disclosure.

FIG. 29 is a schematic structural diagram of an optical lens assembly according to Example 29 of the disclosure.

FIG. 30 is a schematic structural diagram of an optical lens assembly according to Example 30 of the disclosure.

FIG. 31 is a schematic structural diagram of an optical lens assembly according to Example 31 of the disclosure.

FIG. 32 is a schematic structural diagram of an optical lens assembly according to Example 32 of the disclosure.

FIG. 33 is a schematic structural diagram of an optical lens assembly according to Example 33 of the disclosure.

FIG. 34 is a schematic structural diagram of an optical lens assembly according to Example 34 of the disclosure.

FIG. 35 is a schematic structural diagram of an optical lens assembly according to Example 35 of the disclosure.

FIG. 36 is a schematic structural diagram of an optical lens assembly according to Example 36 of the disclosure.

FIG. 37 is a schematic structural diagram of an optical lens assembly according to Example 37 of the disclosure.

FIG. 38 is a schematic structural diagram of an optical lens assembly according to Example 38 of the disclosure.

FIG. 39 is a schematic structural diagram of an optical lens assembly according to Example 39 of the disclosure.

FIG. 40 is a schematic structural diagram of an optical lens assembly according to Example 40 of the disclosure.

FIG. 41 is a schematic structural diagram of an optical lens assembly according to Example 41 of the disclosure.

FIG. 42 is a schematic structural diagram of an optical lens assembly according to Example 42 of the disclosure.

FIG. 43 is a schematic structural diagram of an optical lens assembly according to Embodiment III, Embodiment IV and Embodiment V of the disclosure.

### DESCRIPTION OF EMBODIMENTS

It is to be noted that the embodiments in the disclosure and the features in the embodiments may be combined with one another without conflict. The disclosure will be described below in detail with reference to the drawings and the embodiments.

It is to be noted that, unless otherwise defined, all technical and scientific terms used herein have the same meaning as commonly understood by those of ordinary skill in the art to which the disclosure belongs.

In the disclosure, in the absence of any indication to the contrary, terms such as “on, under, top, and bottom” are used generally with respect to the orientation shown in the drawings, or with respect to the parts themselves in the vertical, perpendicular, or gravitational direction; and similarly, for ease of comprehension and description, “inside or outside” refers to the inside and the outside of the contours of the respective parts themselves, provided, however, that the above terms are not intended to be used in a manner that restricts the disclosure.

It is to be noted that, in the specification, expressions such as first, second, third, etc. are used only to distinguish one feature from another and do not indicate any limitation of the features. Accordingly, without departing from the teachings of the disclosure, the first lens discussed below may also be referred to as a second lens or a third lens.

In the drawings, the thickness, size and shape of the lens have been slightly exaggerated for ease of illustration. Specifically, a spherical shape or aspheric shape shown in the drawings is shown by some embodiments. That is, the spherical shape or the aspheric shape is not limited to the spherical shape or aspheric shape shown in the drawings. The drawings are for illustrative purposes only and are not strictly to scale.

Herein, a paraxial region refers to a region nearby an optical axis. If the surface of a lens is convex and a position of the convex surface is not defined, it indicates that the lens surface is a convex surface at least in the paraxial region; and if the surface of the lens is a concave surface and a position of the concave surface is not defined, it indicates that the lens surface is a concave surface at least in the paraxial region. The surface of each lens that is close to a first-side becomes a first-side surface of the lens, and the surface of each lens that is close to a second-side becomes a second-side surface of the lens. Determination of the shape of the surface in the paraxial region may be based on the determination of those who are generally knowledgeable in the art, a convex surface and a concave surface are determined by a positive R-value or a negative R-value (R refers to a curvature radius of the paraxial region, and generally refers to an R value on a lens data base in optical software). For the first-side surface, when the R value is positive, the first-side surface is determined as a convex surface; and when the R value is negative, the first-side surface is determined as a concave surface. For the second-side surface, when the R value is positive, the second-side surface is determined as a concave surface; and when the R value is negative, the second-side surface is determined as a convex surface.

It is to be noted that, a left side of an optical lens assembly is the first-side, and a right side of the optical lens assembly is the second-side.

In an exemplary implementation, an optical lens assembly provided in the disclosure may be used as a vehicle lens. For the vehicle lens, a left side is an object side, and a right side is an image side; and a first-side is the object side, and a second-side is the image side. Light from the object side may be imaged on the image side.

When the optical lens assembly of the disclosure is applied to a projection lens or a radar emission lens, the left side is an imaging side, and the right side is an image source side. In an exemplary implementation, the optical lens assembly provided in the disclosure may be used as, for example, a projection lens or a laser radar emission end lens. In this case, the image side of the optical lens assembly may be the image source side, and the object side may be the imaging side. Light from the image source side may be imaged on the imaging side, and the imaging surface of the optical lens assembly is an image source surface.

In order to solve the problem that optical lens assembly in the related art are difficult to take high resolution, miniaturization, long back focal lengths, small CRAs, low sensitivity, and high light flux into consideration at the same time, the disclosure provides an optical lens assembly and an electronic device.

### Technical Solution I

### Embodiment I

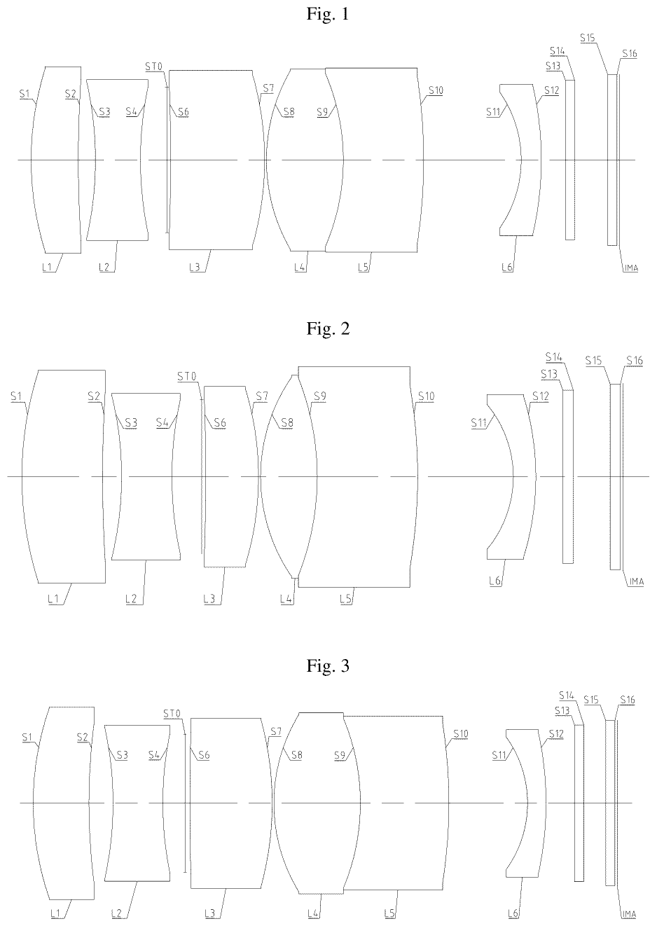

As shown in FIG. 1 to FIG. 12, an optical lens assembly sequentially includes from a first-side to a second-side: a first lens having a positive refractive power, a second lens having a negative refractive power, a third lens having a positive refractive power, a fourth lens having a refractive power, a fifth lens having a refractive power, and a sixth lens having a negative refractive power. A first-side surface of the first lens is a convex surface; a first-side surface of the second lens is a concave surface; a second-side surface of the second lens is a concave surface; a second-side surface of the third lens is a convex surface; and a first-side surface of the fourth lens is a convex surface.

The first lens has the positive refractive power, the first-side surface of the first lens is the convex surface, such that an incidence angle of light may be small, and the corresponding image height decreases under the same FOV, facilitating the receiving of light with a larger angle, and increasing light flux at the same time; and a second-side surface of the first lens may be a concave surface or a convex surface. When the second-side surface of the first lens is the concave surface, a light trend is smooth, resolution is improved, and system sensitivity is reduced. When the second-side surface of the first lens is the convex surface, the light may be further compressed, such that follow-up lens diameters are reduced, and miniaturization is realized.

The second lens has the negative refractive power, the first-side surface of the second lens is the concave surface, such that the light trend in the front is effectively smoothed, the light is diverged, and the system sensitivity is reduced, thereby facilitating the increasing of follow-up image surfaces and the correction of an aberration; and the second-side surface is the concave surface to further diverge the light, and under the same FOV, a follow-up optical system may have a larger light receiving surface, such that the image surface is expanded, a physical diameter of the diaphragm may be enlarged, and an aperture is enlarged, thereby achieving a larger light entering amount, and increasing the brightness of the image surface.

The third lens has the positive refractive power, and a first-side surface of the third lens may be a convex surface or a concave surface; when the first-side surface of the third lens is the convex surface, the light may be effectively collected, the light trend is smoothed, the system sensitivity is reduced, and a diameter of a rear end is simultaneously reduced, thereby realizing miniaturization; when the first-side surface of the third lens is the concave surface, the follow-up optical system may have a larger light receiving surface, so as to balance the aberration and improve resolution; and the second-side surface of the third lens is the convex surface and has a significant shape difference from the first-side surface of the fourth lens, such that the light trend is further changed, and follow-up diameters are compressed, thereby realizing miniaturization.

The fourth lens has the positive refractive power or the negative refractive power, and the first-side surface of the fourth lens is the convex surface, such that the light trend is effectively changed, lights are converged, and a diameter of a rear end is compressed; and a second-side surface of the fourth lens is a convex surface or a concave surface. When the second-side surface of the fourth lens is the convex surface, the fourth lens is conductive to matching the fifth lens to realize double cementing, such that the aberration is able to also be effectively improved under the premise of rational allocation of refractive indexes of the fourth lens and the fifth lens, thereby improving resolution. When the second-side surface of the fourth lens is the concave surface, the fourth lens is conductive to matching the fifth lens to realize double cementing, such that the aberration is able to also be effectively improved under the premise of rational allocation of the refractive indexes of the fourth lens and the fifth lens, thereby improving resolution.

The refractive power of the fifth lens may be positive or negative, and in an embodiment, the refractive power of the fifth lens is negative, the lights are diverged. In another embodiment, the fifth lens has the positive refractive power, a diameter of a rear end is reduced, and miniaturization is realized.

The sixth lens has the negative refractive power, facilitating the smooth transition of the lights to an imaging surface, such that imaging stability is guaranteed.

In the disclosure, six lenses are used, and by optimizing and designing the refractive powers, surface types, and the like of the lenses, the optical lens assembly of the disclosure has at least one beneficial effect of having high resolution, miniaturization, long back focal lengths, small CRAs, low sensitivity, high light flux, and the like.

In this embodiment, the second-side surface of the first lens is the concave surface. A light trend is smoothed, resolution is improved, and system sensitivity is reduced.

In this embodiment, the second-side surface of the first lens is the convex surface. Light may be further compressed, follow-up lens diameters are reduced, and miniaturization is realized.

In this embodiment, the first-side surface of the third lens is the convex surface. The light may be effectively collected, the light trend is smoothed, the system sensitivity is reduced, and a diameter of a rear end is simultaneously reduced, thereby realizing miniaturization.

In this embodiment, the first-side surface of the third lens is the concave surface. When the first-side surface of the third lens is the concave surface, the follow-up optical system may have a larger light receiving surface, so as to balance the aberration and improve resolution.

In this embodiment, the fourth lens has the positive refractive power, and the second-side surface of the fourth lens is the convex surface. When the second-side surface of the fourth lens is the convex surface, the fourth lens is conductive to matching the fifth lens to realize double cementing, such that the aberration is able to also be effectively improved under the premise of rational allocation of refractive indexes of the fourth lens and the fifth lens, thereby improving resolution.

In this embodiment, the fourth lens has the negative refractive power, and the second-side surface of the fourth lens is the concave surface. When the second-side surface of the fourth lens is the concave surface, the fourth lens is conductive to matching the fifth lens to realize double cementing, such that the aberration is able to also be effectively improved under the premise of rational allocation of refractive indexes of the fourth lens and the fifth lens, thereby improving resolution.

In this embodiment, the fifth lens has a negative refractive power; and a first-side surface of the fifth lens is a concave surface, and a second-side surface of the fifth lens is a convex surface. When the second-side surface of the fifth lens is the convex surface, a diameter of a rear end is reduced, miniaturization is realized, and a ratio of a curvature radius of the second-side surface of the fifth lens to a curvature radius of a first-side surface of the sixth lens is large, such that while high resolution is guaranteed, the system sensitivity is effectively reduced, and a ghost image at the place is weakened.

In this embodiment, the fifth lens has the negative refractive power; and the first-side surface of the fifth lens is the concave surface, and the second-side surface of the fifth lens is a concave surface. When the second-side surface of the fifth lens is the concave surface, a back focal length is increased, a CRA is reduced, and the ratio of the curvature radius of the second-side surface of the fifth lens to the curvature radius of the first-side surface of the sixth lens is large, such that while high resolution is guaranteed, the system sensitivity is effectively reduced, and a ghost image at the place is weakened.

In this embodiment, the fifth lens has a positive refractive power; and the first-side surface of the fifth lens is the convex surface, and the second-side surface of the fifth lens is the concave surface. The first-side surface of the fifth lens is the convex surface, double cementing is realized by matching the fourth lens, such that an aberration may be effectively improved under the premise of rational allocation of refractive indexes of the fourth lens and the fifth lens, thereby improving resolution; and the fifth lens has the positive refractive power, facilitating the reduction of the diameter of the rear end, and thus realizing miniaturization.

In this embodiment, the first-side surface of the sixth lens is the concave surface, and a second-side surface of the sixth lens is a convex surface. The first-side surface of the sixth lens is the concave surface, and front light is diverged, facilitating the increase of a back focal length and the assembly of a module; at the same time, an image surface is expanded, and a CRA is reduced; and the second-side surface is the convex surface, facilitating the reduction of the diameter of the rear end, and thus realizing miniaturization.

In this embodiment, the first-side surface of the sixth lens is the concave surface, and the second-side surface of the sixth lens is a concave surface. The second-side surface of the sixth lens is the concave surface, facilitating the increase of a back focal length and the assembly of the module; and at the same time, the image surface is expanded, and the CRA is reduced.

In this embodiment, the first-side surface of the sixth lens is the convex surface, and the second-side surface of the sixth lens is the concave surface. The first-side surface of the sixth lens is the convex surface, facilitating the balance of an aberration, and at the same time, a diameter of a rear end is reduced, thereby realizing miniaturization.

In this embodiment, the fourth lens and the fifth lens are cemented to form a double cemented lens. The fourth lens and the fifth lens are cemented, such that light passing through the third lens is smoothly transitioned to the imaging surface, thereby reducing a total length. Various aberrations of the optical system are fully corrected, such that a resolution ratio may be increased with a compact structure, and optical performance such as distortions, CRAs, and the like is optimized. By arranging the double cemented lens, an air gap between two lenses may be reduced, thereby reducing a total length of the system; assembling components between the fourth lens and the fifth lens are reduced at the same time, thereby simplifying processes and reducing costs; tolerance sensitivity problems such as tilt/core shift of a lens unit caused in an assembling process are resolved simultaneously; light losses caused by the reflection among the lenses may also be reduced, thereby improving illuminance; and a field curvature may further be reduced, and an off-axis point aberration of the system may be corrected.

In this embodiment, the optical lens assembly further includes a diaphragm, where the diaphragm is disposed between the second lens and the third lens. By arranging the diaphragm between the second lens and the third lens, light entering the optical system is effectively collected, a lens diameter on a rear end of the optical system is reduced, and the assembling sensitivity of the system is reduced.

In this embodiment, a total optical length of the optical lens assembly, which is a distance TTL from the center of a first side of the first lens to the center of an imaging surface of the optical lens assembly, and a focal length value F of an entire set of optical lens assemblymeet: TTL/F≤4. The miniaturization of the system may be realized by controlling the total optical length of the optical lens assembly and the focal length value of the entire set within the range. Preferably, TTL/F≤3.

In this embodiment, the entire set focal length value F of the optical lens assembly, a radian value θ of a maximum field of view of the optical lens assembly, and a maximum clear diameter D of the first-side surface of the first lens meet: (F*θ)/D≥0.2. A front end diameter of the optical lens assembly may be small, thereby reducing an imaging system size of the optical lens assembly. Preferably, (F*θ)/D≥0.4.

In this embodiment, the maximum clear diameter D of the first-side surface of the first lens, an image height H corresponding to the maximum field of view of the optical lens assembly, and the maximum field of view of the optical lens assembly meet: D/H/FOV≤0.08. By meeting this conditional expression, a small front end diameter is guaranteed, such that miniaturization may be realized. Preferably, D/H/FOV≤0.05.

In this embodiment, the maximum clear diameter D of the first-side surface of the first lens, the image height H corresponding to the maximum field of view of the optical lens assembly, and the entire set focal length value F of the optical lens assembly meet: D/H/F≤0.2. By meeting this conditional expression, at a fixed focal length, characteristics of a large target surface and a small diameter may be provided for the optical lens assembly. Preferably, D/H/F≤0.1.

In this embodiment, the entire set focal length value F of the optical lens assembly and the radian value θ of the maximum field of view of the optical lens assembly meet: F/θ≤30. Through an appropriate design of a ratio of the focal length to the FOV, while low system sensitivity is guaranteed, a small CRA, a long back focal length, and high resolution are realized. Preferably, 25≤F/θ≤29.5.

In this embodiment, the image height H corresponding to the maximum field of view of the optical lens assembly, the entire set focal length value F of the optical lens assembly, and the radian value θ of the maximum field of view of the optical lens assembly meet: |(H−F*θ)/(F*θ)|≤0.06. By meeting this conditional expression, it ensures that the focal length of the optical lens assembly is increased while the FOV and imaging surface of the optical lens assembly remain unchanged, such that an imaging effect at a center area of the imaging surface of the optical lens assembly is highlighted. Preferably, |(H−F*θ)/(F*θ)|≤0.04.

In this embodiment, the entire set focal length value F of the optical lens assembly and an ENPD of the optical lens assembly meet: F/ENPD≤3. By meeting this conditional expression, a small FNO is guaranteed, and light flux is increased. Preferably, F/ENPD≤2.5.

In this embodiment, the image height H corresponding to the maximum field of view of the optical lens assembly, the entire set focal length value F of the optical lens assembly, and the radian value θ of the maximum field of view of the optical lens assembly meet: 0.4≤(H/2)/(F*tan(θ/2))≤2. This condition reflects a ratio of an actual image height to an ideal image height, such that a large angular resolution is able to be realized. Preferably, 0.8≤(H/2)/(F*tan(θ/2))≤1.5.

In this embodiment, a curvature radius R4 of a second-side surface of the second lens and a curvature radius R5 of the first-side surface of the third lens meet: |R4/R5|≤20. The curvature of the neighboring lenses of the second lens and third lens is similar, such that the aberration of the optical system may be corrected, and smooth light passing through the first lens is guaranteed, thereby reducing the tolerance sensitivity of the optical system. Preferably, |R4/R5|≤10.

In this embodiment, a curvature radius R10 of a second-side surface of the fifth lens and a curvature radius R11 of the first-side surface of the sixth lens meet: |R10/R11|≥4.3. By meeting this conditional expression, a ratio of the curvature radii of the neighboring surfaces is large, such that while high resolution is guaranteed, the system sensitivity is effectively reduced, and a place where the energy of the ghost image is concentrated is far away from the imaging surface, thereby effectively weakening the ghost image at the place. Preferably, |R10/R11|≥4.45.

In this embodiment, a focal length F6 of the sixth lens and the entire set focal length value F of the optical lens assembly meet: F6/F≥−7. The sixth lens has the negative refractive power, the light may be smoothly transitioned to the imaging surface while the back focal length is increased by controlling a ratio of the focal length of the sixth lens to the focal length value of the entire set of optical lens assembly, thereby facilitating overall assembly. Preferably, −5≤F6/F≤−0.2.

In this embodiment, a focal length F2 of the second lens and a focal length F3 of the third lens meet: −5≤F2/F3≤−0.02. The light is smoothly transitioned and the aberration is balanced by controlling the focal lengths of the second lens and the third lens, which are adjacent to each other, with opposite signs and similar values. Preferably, −3≤F2/F3≤−0.05.

In this embodiment, the entire set focal length value F of the optical lens assembly, a curvature radius R3 of a first-side surface of the second lens, and the curvature radius R4 of the second-side surface of the second lens meet: |F/R3|+|F/R4|≤8. By meeting this conditional expression, a surface curvature of the second lens is controlled, and by properly diverging the light, the follow-up optical system has a larger light receiving surface, such that the aberration is balanced, and a light entering amount is increased. Preferably, |F/R3|+|F/R4|≤6.

In this embodiment, an air gap d7 between the third lens and the fourth lens and an optical back focal length of the optical lens assembly, which is a distance BFL from the center of a second-side of the last lens of the optical lens assembly to the center of the imaging surface, meet: (d7*BFL)/(d7+BFL)≤1. By meeting this conditional expression, the ratio of the optical back focal length to the gap between the third lens and the fourth lens is balanced, assembly yield is able to be increased, and the optical system has an enough back focal length to place other optical elements, so as to increase design flexibility. Preferably, (d7*BFL)/(d7+BFL)≤0.5.

In this embodiment, a curvature radius R6 of a second-side surface of the third lens and the entire set focal length value F of the optical lens assembly meet: |R6/F|≤10. By controlling the curvature radius of the second-side surface of the third lens, the light is smoothly transitioned to the rear, the aberration is reduced, and resolution is improved. Preferably, |R6/F|≤6.

In this embodiment, a curvature radius R7 of a first-side surface of the fourth lens and the entire set focal length value F of the optical lens assembly meet: R7/F≤7. By controlling the curvature radius of the first-side surface of the fourth lens, the light is converged and lowered to enter a position of the follow-up optical system, thereby reducing a diameter of a rear end. Preferably, R7/F≤5.

In this embodiment, the curvature radius R10 of the second-side surface of the fifth lens and the entire set focal length value F of the optical lens assembly meet: |R10/F|≥1.2. By controlling the curvature radius of the second-side surface of the fifth lens to be larger, the transition of the light is smooth, such that the system sensitivity is effectively reduced, and a ghost image at the place is weakened. Preferably, |R10/F|≥1.5.

In this embodiment, the curvature radius R11 of the first-side surface of the sixth lens and the entire set focal length value F of the optical lens assembly meet: |R11/F|≤5. By meeting this conditional expression, a back focal length is increased, and modules are assembled; and at the same time, an image surface is expanded, and a CRA is reduced. Preferably, |R11/F|≤3.

In this embodiment, the curvature radius R10 of the second-side surface of the fifth lens and the total optical length of the optical lens assembly, which is the distance TTL from the center of the first side of the first lens to the center of the imaging surface of the optical lens assembly, meet: |R10/TTL|≥0.8. By meeting this conditional expression, miniaturization is realized while the system sensitivity is reduced. Preferably, |R10/TTL|≥0.85.

In this embodiment, a center thickness d6 of the third lens and the total optical length of the optical lens assembly, which is the distance TTL from the center of the first side of the first lens to the center of the imaging surface of the optical lens assembly, meet: d6/TTL≥0.02. The center thickness of the third lens is large, facilitating the processing of the lens, and by matching the second lens with the negative focal length, the trend of the light is able to be stabilized. Preferably, d6/TTL≥0.04.

In this embodiment, the total optical length of the optical lens assembly, which is the distance TTL from the center of the first side of the first lens to the center of the imaging surface of the optical lens assembly, and a center thickness d11 of the sixth lens meet: TTL/d11≥6. This conditional expression is met, and through the rational matching of the center thickness of the sixth lens and the total optical length, a small CRA is achieved while miniaturization is realized. Preferably, TTL/d11≥9.

In this embodiment, a center thickness d8 of the fourth lens, a center thickness d9 of the fifth lens, and the total optical length of the optical lens assembly, which is the distance TTL from the center of the first side of the first lens to the center of the imaging surface of the optical lens assembly, meet: (d8+d9)/TTL≥0.05. The center thickness of the double cemented lens of the fourth lens and the fifth lens is large, facilitating the processing of the lens, and the trend of the light is stabilized. Preferably, (d8+d9)/TTL≥0.1.

In this embodiment, a distance d26 between the first lens and the third lens, the center thickness d6 of the third lens, and the total optical length of the optical lens assembly, which is the distance TTL from the center of the first side of the first lens to the center of the imaging surface of the optical lens assembly, meet: |(d26-d6)/TTL|≤0.15. By designing and controlling a difference between the distance between the first lens and the third lens and the center thickness of the third lens, a ratio of the difference to the total length is small, such that the system sensitivity may be effectively reduced and ghost images reflected by the surfaces at the place are weakened. Preferably, |(d26−d6)/TTL|≤0.05. More preferably, |(d26−d6)/TTL|≤0.01.

In this embodiment, a center thickness d3 of the second lens and the center thickness d6 of the third lens meet: 0.2≤d3/d6. By rationally controlling a ratio of the center thickness of the second lens to the center thickness of the third lens, the system sensitivity may be effectively reduced, and the assembly yield is increased. Preferably, 0.3≤d3/d6≤1.8. More preferably, 0.38≤|d3/d6|≤1.2.

In this embodiment, the distance d26 between the first lens and the third lens, the center thickness d6 of the third lens, and the curvature radius R5 of the first-side surface of the third lens meet: |(d26−d6)/R5|≤0.4. By designing and controlling a difference between the distance between the first lens and the third lens and the center thickness of the third lens, a ratio of the difference to the curvature radius of the first-side surface of the third lens is small, such that the system sensitivity may be effectively reduced and ghost images reflected by the surfaces at the place are weakened. Preferably, |(d26−d6)/R5|≤0.05. More preferably, (d26−d6)/R5|≤0.03.

In this embodiment, the maximum clear diameter D of the first-side surface of the first lens and a curvature radius R1 of the first-side surface of the first lens meet: D/R1≥0.05. By controlling the maximum clear diameter of the first-side surface of the first lens and the curvature radius of the first-side surface, a small front end diameter and high light flux is able to be realized at the same time. Preferably, D/R1≥0.2.

In this embodiment, a maximum effective clear diameter D7 of the first-side surface of the fourth lens corresponding to the maximum field of view of the optical lens assembly, the curvature radius R7 of a first-side surface of the fourth lens, and a sagittal height SAG7 of the first-side surface of the fourth lens meet: arctan(D7/(R7−SAG7))≥0.2. By rationally controlling a field angle of the first-side surface of the fourth lens, ghost images are weakened. Preferably, arctan(D7/(R7−SAG7))≥0.4.

In this embodiment, the curvature radius R10 of the second-side surface of the fifth lens, the center thickness d8 of the fourth lens, and the center thickness d9 of the fifth lens meet: |R10/(d8+d9)|≥2.5. By rationally controlling a ratio of a curvature radius of a second-side surface of the double cemented lens to a center thickness of the double cemented lens, a ghost image produced by the double cemented lens is able to be effectively weakened, and the light trend at the place is smoothed, thereby reducing the system sensitivity. Preferably, |R10/(d8+d9)|≥2.95. More preferably, |R10/(d8+d9)|≥3.2.

In this embodiment, the curvature radius R10 of the second-side surface of the fifth lens and the center thickness d9 of the fifth lens meet: |R10/d9|≥5.2. By rationally controlling the curvature radius of the second-side surface of the fifth lens to the center thickness of the fifth lens, light emitted by the double cemented lens may be more smoothed, a CRA is effectively reduced, and the system sensitivity is reduced. Preferably, |R10/d9|≥5.3. More preferably, |R10/d9|≥16.

In this embodiment, a curvature radius R12 of a second-side surface of the sixth lens and the center thickness d11 of the sixth lens meet: |R12/d11|≤55. By controlling a ratio of the curvature radius of the second-side surface of the last lens to the center thickness to be not too large, corresponding ghosts may be weakened at a small CRA, and the machinability of the lens is improved. Preferably, |R12/d11|≤22. More preferably, |R12/d11|≤18.5.

In this embodiment, the curvature radius R11 of the first-side surface of the sixth lens and the curvature radius R12 of a second-side surface of the sixth lens meet: |R11/R12|≥0.1. By controlling a ratio of the curvature radii of the first-side surface and the second-side surface of the last lens to be not too small, a ghost image at the place is weakened while a small CRA is guaranteed. Preferably, |R11/R12|≥0.25. More preferably, |R11/R12|≥0.32.

### Embodiment II

As shown in FIG. 1 to FIG. 12, an optical lens assembly sequentially includes from a first-side to a second-side: a first lens having a positive refractive power; a second lens having a negative refractive power; a third lens having a positive refractive power; a fourth lens having a refractive power; a fifth lens having a refractive power; and a sixth lens having a negative refractive power. A curvature radius R10 of a second-side surface of the fifth lens and a curvature radius R11 of a first-side surface of the sixth lens meet: |R10/R11|≥4.3. By meeting this conditional expression, a ratio of the curvature radii of the neighboring surfaces is large, such that while high resolution is guaranteed, the system sensitivity is effectively reduced, and a place where the energy of the ghost image is concentrated is far away from the imaging surface, thereby effectively weakening the ghost image at the place. Preferably, |R10/R11|≥4.45.

In this embodiment, a first-side surface of the first lens is a convex surface, such that an incidence angle of light may be small, and the corresponding image height decreases under the same FOV, facilitating the receiving of light with a larger angle, and increasing light flux at the same time; and a second-side surface is a concave surface, a light trend is smooth, the resolution is improved, and the system sensitivity is reduced.

In this embodiment, the first-side surface of the first lens is the convex surface, such that an incidence angle of light may be small, and the corresponding image height decreases under the same FOV, facilitating the receiving of light with a larger angle, and increasing light flux at the same time; and the second-side surface of the first lens is a convex surface, light may be further compressed, such that follow-up lens diameters are reduced, and miniaturization is realized.

In this embodiment, a first-side surface of the second lens is a concave surface, such that the light trend in the front is effectively smoothed, the light is diverged, and the system sensitivity is reduced, thereby facilitating the increasing of follow-up image surfaces and the correction of an aberration; and a second-side surface is a concave surface to further diverge the light, and under the same FOV, a follow-up optical system may have a larger light receiving surface, such that the image surface is expanded, a physical diameter of the diaphragm may be enlarged, and an aperture is enlarged, thereby achieving a larger light entering amount, and increasing the brightness of the image surface.

In this embodiment, when a first-side surface of the third lens is a convex surface, the light may be effectively collected, the light trend is smoothed, the system sensitivity is reduced, and a diameter of a rear end is simultaneously reduced, thereby realizing miniaturization; and a second-side surface is a convex surface and has a significant shape difference from the first-side surface of the fourth lens, such that the light trend is further changed, and follow-up diameters are compressed, thereby realizing miniaturization.

In this embodiment, the first-side surface of the third lens is the concave surface, the follow-up optical system may have a larger light receiving surface, so as to balance the aberration and improve resolution; and the second-side surface is the convex surface and has a significant shape difference from the first-side surface of the fourth lens, such that the light trend is further changed, and follow-up diameters are compressed, thereby realizing miniaturization.

In this embodiment, the fourth lens has a positive refractive power, and a first-side surface of the fourth lens is a convex surface, such that the light trend is effectively changed, lights are converged, and a diameter of a rear end is compressed; and a second-side surface is a convex surface, the fourth lens is conductive to matching the fifth lens to realize double cementing, such that the aberration may also be effectively improved under the premise of rational allocation of refractive indexes of the fourth lens and the fifth lens, thereby improving resolution.

In this embodiment, the fourth lens has a negative refractive power, and the first-side surface of the fourth lens is a concave surface, such that the light trend is effectively changed, lights are converged, and the diameter of the rear end is compressed; and the second-side surface is the convex surface, the fourth lens is conductive to matching the fifth lens to realize double cementing, such that the aberration may also be effectively improved under the premise of rational allocation of refractive indexes of the fourth lens and the fifth lens, thereby improving resolution.

In this embodiment, the fifth lens has a negative refractive power; and a first-side surface of the fifth lens is a concave surface, and a second-side surface of the fifth lens is a convex surface. When the second-side surface of the fifth lens is the convex surface, a diameter of a rear end is reduced, miniaturization is realized, and a ratio of a curvature radius of the second-side surface of the fifth lens to a curvature radius of a first-side surface of the sixth lens is large, such that while high resolution is guaranteed, the system sensitivity is effectively reduced, and a ghost image at the place is weakened.

In this embodiment, the fifth lens has the negative refractive power; and the first-side surface of the fifth lens is the concave surface, and the second-side surface of the fifth lens is a concave surface. When the second-side surface of the fifth lens is the concave surface, a back focal length is increased, a CRA is reduced, and the ratio of the curvature radius of the second-side surface of the fifth lens to the curvature radius of the first-side surface of the sixth lens is large, such that while high resolution is guaranteed, the system sensitivity is effectively reduced, and a ghost image at the place is weakened.

In this embodiment, the fifth lens has a positive refractive power; and the first-side surface of the fifth lens is the convex surface, and the second-side surface of the fifth lens is the concave surface. The first-side surface of the fifth lens is the convex surface, double cementing is realized by matching the fourth lens, such that an aberration may be effectively improved under the premise of rational allocation of refractive indexes of the fourth lens and the fifth lens, thereby improving resolution; and the fifth lens has the positive refractive power, facilitating the reduction of the diameter of the rear end, and thus realizing miniaturization.

In this embodiment, the first-side surface of the sixth lens is the concave surface, and a second-side surface of the sixth lens is a convex surface. The first-side surface of the sixth lens is the concave surface, and front light is diverged, facilitating the increase of a back focal length and the assembly of a module; at the same time, an image surface is expanded, and a CRA is reduced; and the second-side surface is the convex surface, facilitating the reduction of the diameter of the rear end, and thus realizing miniaturization.

In this embodiment, the first-side surface of the sixth lens is the concave surface, and the second-side surface of the sixth lens is a concave surface. The second-side surface of the sixth lens is the concave surface, facilitating the increase of a back focal length and the assembly of the module; and at the same time, the image surface is expanded, and the CRA is reduced.

In this embodiment, the first-side surface of the sixth lens is the convex surface, and the second-side surface of the sixth lens is the concave surface. The first-side surface of the sixth lens is the convex surface, facilitating the balance of an aberration, and at the same time, a diameter of a rear end is reduced, thereby realizing miniaturization.

In this embodiment, the fourth lens and the fifth lens are cemented to form a double cemented lens. The fourth lens and the fifth lens are cemented, such that light passing through the third lens is smoothly transitioned to the imaging surface, thereby reducing a total length. Various aberrations of the optical system are fully corrected, such that a resolution ratio may be increased with a compact structure, and optical performance such as distortions, CRAs, and the like is optimized. By arranging the double cemented lens, an air gap between two lenses is able to be reduced, thereby reducing a total length of the system; assembling components between the fourth lens and the fifth lens are reduced at the same time, thereby simplifying processes and reducing costs; tolerance sensitivity problems such as tilt/core shift of a lens unit caused in an assembling process are resolved simultaneously; light losses caused by the reflection among the lenses may also be reduced, thereby improving illuminance; and a field curvature may further be reduced, and an off-axis point aberration of the system may be corrected.

In this embodiment, the optical lens assembly further includes a diaphragm, where the diaphragm is disposed between the second lens and the third lens. By arranging the diaphragm between the second lens and the third lens, light entering the optical system is effectively collected, a lens diameter on a rear end of the optical system is reduced, and the assembling sensitivity of the system is reduced.

In this embodiment, a total optical length of the optical lens assembly, which is a distance TTL from the center of a first side of the first lens to the center of an imaging surface of the optical lens assembly, and a focal length value F of an entire set of optical lens assembly meet: TTL/F≤4. The miniaturization of the system may be realized by controlling the total optical length of the optical lens assembly and the focal length value of the entire set within the range. Preferably, TTL/F≤3.

In this embodiment, the entire set focal length value F of the optical lens assembly, a radian value θ of a maximum field of view of the optical lens assembly, and a maximum clear diameter D of the first-side surface of the first lens meet: (F*θ)/D≥0.2. A front end diameter of the optical lens assembly may be small, thereby reducing an imaging system size of the optical lens assembly. Preferably, (F*θ)/D≥0.4.

In this embodiment, the maximum clear diameter D of the first-side surface of the first lens, an image height H corresponding to the maximum field of view of the optical lens assembly, and the maximum field of view of the optical lens assembly meet: D/H/FOV≤0.08. By meeting this conditional expression, a small front end diameter is guaranteed, such that miniaturization may be realized. Preferably, D/H/FOV≤0.05.

In this embodiment, the maximum clear diameter D of the first-side surface of the first lens, the image height H corresponding to the maximum field of view of the optical lens assembly, and the entire set focal length value F of the optical lens assembly meet: D/H/F≤0.2. By meeting this conditional expression, at a fixed focal length, characteristics of a large target surface and a small diameter may be provided for the optical lens assembly. Preferably, D/H/F≤0.1.

In this embodiment, the entire set focal length value F of the optical lens assembly and the radian value θ of the maximum field of view of the optical lens assembly meet: F/θ≤30. Through an appropriate design of a ratio of the focal length to the FOV, while low system sensitivity is guaranteed, a small CRA, a long back focal length, and high resolution are realized. Preferably, 25≤F/θ≤29.5.

In this embodiment, the image height H corresponding to the maximum field of view of the optical lens assembly, the entire set focal length value F of the optical lens assembly, and the radian value θ of the maximum field of view of the optical lens assembly meet: |(H−F*θ)/(F*θ)|≤0.06. By meeting this conditional expression, it ensures that the focal length of the optical lens assembly is increased while the FOV and imaging surface of the optical lens assembly remain unchanged, such that an imaging effect at a center area of the imaging surface of the optical lens assembly is highlighted. Preferably, |(H−F*θ)/(F*θ)|≤0.04.

In this embodiment, the entire set focal length value F of the optical lens assembly and an ENPD of the optical lens assembly meet: F/ENPD≤3. By meeting this conditional expression, a small FNO is guaranteed, and light flux is increased. Preferably, F/ENPD≤2.5.

In this embodiment, the image height H corresponding to the maximum field of view of the optical lens assembly, the entire set focal length value F of the optical lens assembly, and the radian value θ of the maximum field of view of the optical lens assembly meet: 0.4≤(H/2)/(F*tan(θ/2))≤2. This condition reflects a ratio of an actual image height to an ideal image height, such that a large angular resolution may be realized. Preferably, 0.8≤(H/2)/(F*tan(θ/2))≤1.5.

In this embodiment, a curvature radius R4 of a second-side surface of the second lens and a curvature radius R5 of the first-side surface of the third lens meet: |R4/R5|≤20. The curvature of the neighboring lenses of the second lens and third lens is similar, such that the aberration of the optical system may be corrected, and smooth light passing through the first lens is guaranteed, thereby reducing the tolerance sensitivity of the optical system. Preferably, |R4/R5|≤10.

In this embodiment, a focal length F6 of the sixth lens and the entire set focal length value F of the optical lens assembly meet: F6/F≥−7. The sixth lens has the negative refractive power, the light is able to be smoothly transitioned to the imaging surface while the back focal length is increased by controlling a ratio of the focal length of the sixth lens to the focal length value of the entire set of optical lens assembly, thereby facilitating overall assembly. Preferably, −5≤F6/F≤−0.2.

In this embodiment, a focal length F2 of the second lens and a focal length F3 of the third lens meet: −5≤F2/F3≤−0.02. The light is smoothly transitioned and the aberration is balanced by controlling the focal lengths of the second lens and the third lens, which are adjacent to each other, with opposite signs and similar values. Preferably, −3≤F2/F3≤−0.05.

In this embodiment, the entire set focal length value F of the optical lens assembly, a curvature radius R3 of a first-side surface of the second lens, and the curvature radius R4 of the second-side surface of the second lens meet: |F/R3|+|F/R4|≤8. By meeting this conditional expression, a surface curvature of the second lens is controlled, and by properly diverging the light, the follow-up optical system has a larger light receiving surface, such that the aberration is balanced, and a light entering amount is increased. Preferably, |F/R3|+|F/R4|≤6.

In this embodiment, an air gap d7 between the third lens and the fourth lens and an optical back focal length of the optical lens assembly, which is a distance BFL from the center of a second-side of the last lens of the optical lens assembly to the center of the imaging surface, meet: (d7*BFL)/(d7+BFL)≤1. By meeting this conditional expression, the ratio of the optical back focal length to the gap between the third lens and the fourth lens is balanced, assembly yield is able to be increased, and the optical system has an enough back focal length to place other optical elements, so as to increase design flexibility. Preferably, (d7*BFL)/(d7+BFL)≤0.5.

In this embodiment, a curvature radius R6 of a second-side surface of the third lens and the entire set focal length value F of the optical lens assembly meet: |R6/F|≤10. By controlling the curvature radius of the second-side surface of the third lens, the light is smoothly transitioned to the rear, the aberration is reduced, and resolution is improved. Preferably, |R6/F|≤6.

In this embodiment, a curvature radius R7 of a first-side surface of the fourth lens and the entire set focal length value F of the optical lens assembly meet: R7/F≤7. By controlling the curvature radius of the first-side surface of the fourth lens, the light is converged and lowered to enter a position of the follow-up optical system, thereby reducing a diameter of a rear end. Preferably, R7/F≤5.

In this embodiment, the curvature radius R10 of the second-side surface of the fifth lens and the entire set focal length value F of the optical lens assembly meet: |R10/F|≥1.2. By controlling the curvature radius of the second-side surface of the fifth lens to be larger, the transition of the light is smooth, such that the system sensitivity is effectively reduced, and a ghost image at the place is weakened. Preferably, |R10/F1≥1.5.

In this embodiment, the curvature radius R11 of the first-side surface of the sixth lens and the entire set focal length value F of the optical lens assembly meet: |R11/F|≤5. By meeting this conditional expression, a back focal length is increased, and modules are assembled; and at the same time, an image surface is expanded, and a CRA is reduced. Preferably, |R11/F|≤3.

In this embodiment, the curvature radius R10 of the second-side surface of the fifth lens and the total optical length of the optical lens assembly, which is the distance TTL from the center of the first side of the first lens to the center of the imaging surface of the optical lens assembly, meet: |R10/TTL|≥0.8. By meeting this conditional expression, miniaturization is realized while the system sensitivity is reduced. Preferably, |R10/TTL|≥0.85.

In this embodiment, a center thickness d6 of the third lens and the total optical length of the optical lens assembly, which is the distance TTL from the center of the first side of the first lens to the center of the imaging surface of the optical lens assembly, meet: d6/TTL≥0.02. The center thickness of the third lens is large, facilitating the processing of the lens, and by matching the second lens with the negative focal length, the trend of the light is able to be stabilized. Preferably, d6/TTL≥0.04.

In this embodiment, the total optical length of the optical lens assembly, which is the distance TTL from the center of the first side of the first lens to the center of the imaging surface of the optical lens assembly, and a center thickness d11 of the sixth lens meet: TTL/d11≥6. This conditional expression is met, and through the rational matching of the center thickness of the sixth lens and the total optical length, a small CRA is achieved while miniaturization is realized. Preferably, TTL/d11≥9.

In this embodiment, a center thickness d8 of the fourth lens, a center thickness d9 of the fifth lens, and the total optical length of the optical lens assembly, which is the distance TTL from the center of the first side of the first lens to the center of the imaging surface of the optical lens assembly, meet: (d8+d9)/TTL≥0.05. The center thickness of the double cemented lens of the fourth lens and the fifth lens is large, facilitating the processing of the lens, and the trend of the light is stabilized. Preferably, (d8+d9)/TTL≥0.1.

In this embodiment, a distance d26 between the first lens and the third lens, the center thickness d6 of the third lens, and the total optical length of the optical lens assembly, which is the distance TTL from the center of the first side of the first lens to the center of the imaging surface of the optical lens assembly, meet: |(d26−d6)/TTL|≤0.15. By designing and controlling a difference between the distance between the first lens and the third lens and the center thickness of the third lens, a ratio of the difference to the total length is small, such that the system sensitivity may be effectively reduced and ghost images reflected by the surfaces at the place are weakened. Preferably, |(d26−d6)/TTL|≤0.05.

In this embodiment, a center thickness d3 of the second lens and the center thickness d6 of the third lens meet: 0.2≤d3/d6. By rationally controlling a ratio of the center thickness of the second lens to the center thickness of the third lens, the system sensitivity may be effectively reduced, and the assembly yield is increased. Preferably, 0.3≤d3/d6≤1.8.

In this embodiment, the distance d26 between the first lens and the third lens, the center thickness d6 of the third lens, and the curvature radius R5 of the first-side surface of the third lens meet: |(d26−d6)/R5|≤0.4. By designing and controlling a difference between the distance between the first lens and the third lens and the center thickness of the third lens, a ratio of the difference to the curvature radius of the first-side surface of the third lens is small, such that the system sensitivity may be effectively reduced and ghost images reflected by the surfaces at the place are weakened. Preferably, |(d26−d6)/R5|≤0.05.

In this embodiment, the maximum clear diameter D of the first-side surface of the first lens and a curvature radius R1 of the first-side surface of the first lens meet: D/R1≥0.05. By controlling the maximum clear diameter of the first-side surface of the first lens and the curvature radius of the first-side surface, a small front end diameter and high light flux is able to be realized at the same time. Preferably, D/R1≥0.2.

In this embodiment, a maximum effective clear diameter D7 of the first-side surface of the fourth lens corresponding to the maximum field of view of the optical lens assembly, the curvature radius R7 of a first-side surface of the fourth lens, and a sagittal height SAG7 of the first-side surface of the fourth lens meet: arctan(D7/(R7−SAG7))≥0.2. By rationally controlling a field angle of the first-side surface of the fourth lens, ghost images are weakened. Preferably, arctan(D7/(R7−SAG7))≥0.4.

In this embodiment, the curvature radius R10 of the second-side surface of the fifth lens, the center thickness d8 of the fourth lens, and the center thickness d9 of the fifth lens meet: |R10/(d8+d9)|≥2.5. By rationally controlling a ratio of a curvature radius of a second-side surface of the double cemented lens to a center thickness of the double cemented lens, a ghost image produced by the double cemented lens is able to be effectively weakened, and the light trend at the place is smoothed, thereby reducing the system sensitivity. Preferably, |R10/(d8+d9)|≥2.95. More preferably, |R10/(d8+d9)|≥3.2.

In this embodiment, the curvature radius R10 of the second-side surface of the fifth lens and the center thickness d9 of the fifth lens meet: |R10/d9|≥5.2. By rationally controlling the curvature radius of the second-side surface of the fifth lens to the center thickness of the fifth lens, light emitted by the double cemented lens is able to be more smoothed, a CRA is effectively reduced, and the system sensitivity is reduced. Preferably, |R10/d9|≥5.3. More preferably, |R10/d9|≥6.

In this embodiment, a curvature radius R12 of a second-side surface of the sixth lens and the center thickness d11 of the sixth lens meet: |R12/d11|≤55. By controlling a ratio of the curvature radius of the second-side surface of the last lens to the center thickness to be not too large, corresponding ghosts may be weakened at a small CRA, and the machinability of the lens is improved. Preferably, |R12/d11|≤22. More preferably, |R12/d11|≤18.5.

In this embodiment, the curvature radius R11 of the first-side surface of the sixth lens and the curvature radius R12 of a second-side surface of the sixth lens meet: |R11/R12|≥0.1. By controlling a ratio of the curvature radii of the first-side surface and the second-side surface of the last lens to be not too small, a ghost image at the place is weakened while a small CRA is guaranteed. Preferably, |R11/R12|≥0.25. More preferably, |R11/R12|≥0.32.

Optionally, the optical lens assembly may further include a color filter for correcting color deviation and protective glass for protecting a photosensitive element on an imaging surface.

The optical lens assembly in the disclosure may use a plurality of lenses, for example, the above six lenses. The disclosure does not specifically limit the specific number of spherical lenses and aspheric lenses, and the number of the aspheric lenses may be increased when the focus is on imaging quality. An aspheric lens has a characteristic that a curvature keeps changing from the center of the lens to the periphery of the lens. Unlike a spherical lens with a constant curvature from the center of the lens to the periphery of the lens, the aspheric lens has the characteristic of a better curvature radius and the advantages of improving distortions and improving astigmatic aberrations. By using the aspheric lens, aberrations during imaging may be eliminated as much as possible, thereby improving the imaging quality.

In an exemplary implementation, in this solution, whether the lens is made of plastic or glass is not limited, and if the focus is on temperature performance, the first lens, the second lens, the third lens, the fourth lens, the fifth lens, and the sixth lens may all be glass lenses. The optical lens assembly made of glass may inhibit a back focal length of the optical lens assembly from shifting with temperature changes, thereby improving the stability of the system. Meanwhile, the use of a glass material may avoid the image blurring of the lens caused by high and low temperature changes in an environment used, affecting the normal use of the optical lens assembly. For example, the all-glass design of the optical lens assembly has a wide temperature range and may maintain stable optical performance within a range of −40° C.-105° C. Specifically, when the focus is on resolution quality and reliability, the first lens to the sixth lens may all be glass aspheric lenses. Definitely, in an application scenario with a low requirement for temperature stability, the first lens to the sixth lens in the optical lens assembly may also be made of plastic. Manufacturing costs may be effectively reduced by using plastic to manufacture the optical lens assembly. Definitely, the first lens to the sixth lens in the optical lens assembly may also be made by a combination of plastic and glass.

The disclosure further provides an electronic device, including the optical lens assembly and an imaging element for converting an optical image formed by the optical lens assembly into an electrical signal. The imaging element may be a Charge-Coupled Device (CCD) or a Complementary Metal Oxide Semiconductor (CMOS). The electronic device may be an independent imaging device such as a digital camera, and may also be an imaging module which is integrated on a mobile electronic device such as a mobile phone. The electronic device is provided with the optical lens assembly described above.

However, a person skilled in the art should know that the number of the lenses forming the optical lens assembly may be changed without departing from the technical solutions claimed in the disclosure to achieve each result and advantage described in the specification. For example, although descriptions are made in the implementation with six lenses as an example, the optical lens assembly is not limited to six lenses. If necessary, the optical lens assembly may further include another number of lenses.

Examples of specific surface types and parameters of the optical lens assembly applicable to the above-mentioned implementation mode will further be described below with reference to the drawings.

It is to be noted that, any one of Example 1 to Example 12 is applicable to all embodiments of the disclosure.

### Example 1

FIG. 1 is a schematic diagram of an optical lens assembly structure of Example 1.

As shown in FIG. 1, an optical lens assembly sequentially includes from a first side to a second side: a first lens L1, a second lens L2, a diaphragm STO, a third lens L3, a fourth lens L4, a fifth lens L5, a sixth lens L6, a first-side surface S13 of an optical filter, a second-side surface S14 of the optical filter, a first-side surface S15 of protective glass, a second-side surface S16 of the protective glass, and an imaging surface IMA.

The first lens L1 has a positive refractive power; and a first-side surface S1 of the first lens is a convex surface, and a second-side surface S2 of the first lens is a concave surface. The second lens L2 has a negative refractive power; and a first-side surface S3 of the second lens is a concave surface, and a second-side surface S4 of the second lens is a concave surface. The third lens L3 has a positive refractive power; and a first-side surface S6 of the third lens is a concave surface, and a second-side surface S7 of the third lens is a convex surface. The fourth lens L4 has a positive refractive power; and a first-side surface S8 of the fourth lens is a convex surface, and a second-side surface S9 of the fourth lens is a convex surface. The fifth lens L5 has a negative refractive power; and a first-side surface S9 of the fifth lens is a concave surface, and a second-side surface S10 of the fifth lens is a convex surface. The sixth lens L6 has a negative refractive power; and a first-side surface S11 of the sixth lens is a concave surface, and a second-side surface S12 of the sixth lens is a convex surface. Light from the first-side passes through the surfaces S1 to S16 in sequence, and is finally imaged on the imaging surface IMA. Since the fourth lens L4 and the fifth lens L5 are cemented to form a double cemented lens, the second-side surface S9 of the fourth lens and the first-side surface S9 of the fifth lens are the same surface.

In this example, an entire set focal length value F of the optical lens assembly is 16.429 mm, a maximum field of view of the optical lens assembly is 32.080°, and a total optical length TTL of the optical lens assembly is 31.677 mm.

Table 1 shows a basic structure parameter table of the optical lens assembly in Example 1, where curvature radius, and thickness/distance are all in millimeters (mm).

TABLE 1

| Surface | Curvature | Thickness/ | Refractive | Abbe |
|---|---|---|---|---|
| number | radius R | distance | index N | number Vd |
| S1 | 16.520 | 2.540 | 1.83 | 42.73 |
| S2 | 67.090 | 0.920 | | |
| S3 | −19.246 | 2.426 | 1.75 | 34.99 |
| S4 | 19.246 | 1.432 | | |
| STO | Infinity | 0.194 | | |
| S6 | −109.500 | 5.060 | 1.69 | 54.54 |
| S7 | −16.750 | 0.100 | | |
| S8 | 9.660 | 4.140 | 1.62 | 63.39 |
| S9 | −11.750 | 4.330 | 1.75 | 34.99 |
| S10 | −29.810 | 5.250 | | |
| S11 | −6.400 | 1.085 | 1.73 | 28.32 |
| S12 | −17.790 | 1.300 | | |
| S13 | Infinity | 0.500 | 1.52 | 64.20 |
| S14 | Infinity | 1.775 | | |
| S15 | Infinity | 0.500 | 1.52 | 64.20 |
| S16 | Infinity | 0.125 | | |
| IMA | / | / | | |

### Example 2

FIG. 2 is a schematic diagram of an optical lens assembly structure of Example 2.

As shown in FIG. 2, an optical lens assembly sequentially includes from a first-side to a second-side: a first lens L1, a second lens L2, a diaphragm STO, a third lens L3, a fourth lens L4, a fifth lens L5, a sixth lens L6, a first-side surface S13 of an optical filter, a second-side surface S14 of the optical filter, a first-side surface S15 of protective glass, a second-side surface S16 of the protective glass, and an imaging surface IMA.

The first lens L1 has a positive refractive power; and a first-side surface S1 of the first lens is a convex surface, and a second-side surface S2 of the first lens is a concave surface. The second lens L2 has a negative refractive power; and a first-side surface S3 of the second lens is a concave surface, and a second-side surface S4 of the second lens is a concave surface. The third lens L3 has a positive refractive power; and a first-side surface S6 of the third lens is a concave surface, and a second-side surface S7 of the third lens is a convex surface. The fourth lens L4 has a positive refractive power; and a first-side surface S8 of the fourth lens is a convex surface, and a second-side surface S9 of the fourth lens is a convex surface. The fifth lens L5 has a negative refractive power; and a first-side surface S9 of the fifth lens is a concave surface, and a second-side surface S10 of the fifth lens is a convex surface. The sixth lens L6 has a negative refractive power; and a first-side surface S11 of the sixth lens is a concave surface, and a second-side surface S12 of the sixth lens is a convex surface. Light from the first-side passes through the surfaces S1 to S16 in sequence, and is finally imaged on the imaging surface IMA. Since the fourth lens L4 and the fifth lens L5 are cemented to form a double cemented lens, the second-side surface S9 of the fourth lens and the first-side surface S9 of the fifth lens are the same surface.

In this example, an entire set focal length value F of the optical lens assembly is 15.906 mm, a maximum field of view of the optical lens assembly is 32.080°, and a total optical length TTL of the optical lens assembly is 28.947 mm.

Table 2 shows a basic structure parameter table of the optical lens assembly in Example 2, where curvature radius, and thickness/distance are all in millimeters (mm).

TABLE 2

| Surface | Curvature | Thickness/ | Refractive | Abbe |
|---|---|---|---|---|
| number | radius R | distance | index N | number Vd |
| S1 | 16.760 | 3.885 | 1.83 | 42.73 |
| S2 | 67.120 | 0.912 | | |
| S3 | −16.459 | 2.426 | 1.75 | 34.99 |
| S4 | 17.625 | 1.432 | | |
| STO | Infinity | 0.194 | | |
| S6 | −105.850 | 2.542 | 1.69 | 54.54 |
| S7 | −14.626 | 0.100 | | |
| S8 | 8.483 | 2.727 | 1.62 | 63.39 |
| S9 | −13.008 | 4.839 | 1.75 | 34.99 |
| S10 | −25.949 | 4.606 | | |
| S11 | −5.447 | 1.085 | 1.73 | 28.32 |
| S12 | −12.985 | 1.300 | | |
| S13 | Infinity | 0.500 | 1.52 | 64.20 |
| S14 | Infinity | 1.775 | | |
| S15 | Infinity | 0.500 | 1.52 | 64.20 |
| S16 | Infinity | 0.125 | | |
| IMA | / | / | | |

### Example 3

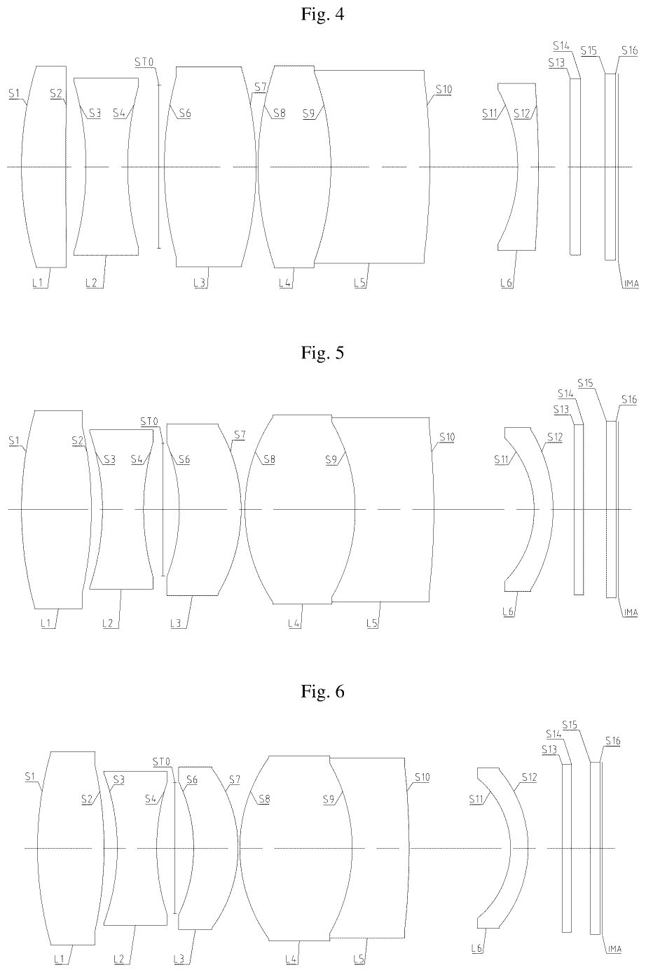

FIG. 3 is a schematic diagram of an optical lens assembly structure of Example 3.

As shown in FIG. 3, an optical lens assembly sequentially includes from a first-side to a second-side: a first lens L1, a second lens L2, a diaphragm STO, a third lens L3, a fourth lens L4, a fifth lens L5, a sixth lens L6, a first-side surface S13 of an optical filter, a second-side surface S14 of the optical filter, a first-side surface S15 of protective glass, a second-side surface S16 of the protective glass, and an imaging surface IMA.

The first lens L1 has a positive refractive power; and a first-side surface S1 of the first lens is a convex surface, and a second-side surface S2 of the first lens is a concave surface. The second lens L2 has a negative refractive power; and a first-side surface S3 of the second lens is a concave surface, and a second-side surface S4 of the second lens is a concave surface. The third lens L3 has a positive refractive power; and a first-side surface S6 of the third lens is a convex surface, and a second-side surface S7 of the third lens is a convex surface. The fourth lens L4 has a positive refractive power; and a first-side surface S8 of the fourth lens is a convex surface, and a second-side surface S9 of the fourth lens is a convex surface. The fifth lens L5 has a negative refractive power; and a first-side surface S9 of the fifth lens is a concave surface, and a second-side surface S10 of the fifth lens is a convex surface. The sixth lens L6 has a negative refractive power; and a first-side surface S11 of the sixth lens is a concave surface, and a second-side surface S12 of the sixth lens is a convex surface. Light from the first-side passes through the surfaces S1 to S16 in sequence, and is finally imaged on the imaging surface IMA. Since the fourth lens L4 and the fifth lens L5 are cemented to form a double cemented lens, the second-side surface S9 of the fourth lens and the first-side surface S9 of the fifth lens are the same surface.

In this example, an entire set focal length value F of the optical lens assembly is 15.907 mm, a maximum field of view of the optical lens assembly is 32.080°, and a total optical length TTL of the optical lens assembly is 31.595 mm.

Table 3 shows a basic structure parameter table of the optical lens assembly in Example 3, where curvature radius, and thickness/distance are all in millimeters (mm).

TABLE 3

| Surface | Curvature | Thickness/ | Refractive | Abbe |
|---|---|---|---|---|
| number | radius R | distance | index N | number Vd |
| S1 | 15.592 | 3.017 | 1.83 | 42.73 |
| S2 | 34.222 | 1.304 | | |
| S3 | −18.999 | 2.696 | 1.75 | 34.99 |
| S4 | 18.999 | 1.201 | | |
| STO | Infinity | 0.262 | | |
| S6 | 147.858 | 4.448 | 1.69 | 54.54 |
| S7 | −17.036 | 0.094 | | |
| S8 | 9.235 | 4.678 | 1.62 | 63.39 |
| S9 | −11.910 | 4.785 | 1.75 | 34.99 |
| S10 | −27.694 | 4.254 | | |
| S11 | −6.154 | 0.997 | 1.73 | 28.32 |
| S12 | −18.010 | 1.545 | | |
| S13 | Infinity | 0.500 | 1.52 | 64.20 |
| S14 | Infinity | 1.189 | | |
| S15 | Infinity | 0.500 | 1.52 | 64.20 |
| S16 | Infinity | 0.125 | | |
| IMA | / | / | | |

### Example 4

FIG. 4 is a schematic diagram of an optical lens assembly structure of Example 4.

As shown in FIG. 4, an optical lens assembly sequentially includes from a first-side to a second-side: a first lens L1, a second lens L2, a diaphragm STO, a third lens L3, a fourth lens L4, a fifth lens L5, a sixth lens L6, a first-side surface S13 of an optical filter, a second-side surface S14 of the optical filter, a first-side surface S15 of protective glass, a second-side surface S16 of the protective glass, and an imaging surface IMA.

The first lens L1 has a positive refractive power; and a first-side surface S1 of the first lens is a convex surface, and a second-side surface S2 of the first lens is a concave surface. The second lens L2 has a negative refractive power; and a first-side surface S3 of the second lens is a concave surface, and a second-side surface S4 of the second lens is a concave surface. The third lens L3 has a positive refractive power; and a first-side surface S6 of the third lens is a convex surface, and a second-side surface S7 of the third lens is a convex surface. The fourth lens L4 has a positive refractive power; and a first-side surface S8 of the fourth lens is a convex surface, and a second-side surface S9 of the fourth lens is a convex surface. The fifth lens L5 has a negative refractive power; and a first-side surface S9 of the fifth lens is a concave surface, and a second-side surface S10 of the fifth lens is a convex surface. The sixth lens L6 has a negative refractive power; and a first-side surface S11 of the sixth lens is a concave surface, and a second-side surface S12 of the sixth lens is a convex surface. Light from the first-side passes through the surfaces S1 to S16 in sequence, and is finally imaged on the imaging surface IMA. Since the fourth lens L4 and the fifth lens L5 are cemented to form a double cemented lens, the second-side surface S9 of the fourth lens and the first-side surface S9 of the fifth lens are the same surface.

In this example, an entire set focal length value F of the optical lens assembly is 16.047 mm, a maximum field of view of the optical lens assembly is 32.080°, and a total optical length TTL of the optical lens assembly is 28.863 mm.

Table 4 shows a basic structure parameter table of the optical lens assembly in Example 4, where curvature radius, and thickness/distance are all in millimeters (mm).

TABLE 4

| Surface | Curvature | Thickness/ | Refractive | Abbe |
|---|---|---|---|---|
| number | radius R | distance | index N | number Vd |
| S1 | 16.761 | 2.142 | 1.83 | 42.73 |
| S2 | 295.851 | 0.976 | | |
| S3 | −15.002 | 2.018 | 1.75 | 34.99 |
| S4 | 15.002 | 1.511 | | |
| STO | Infinity | 0.262 | | |
| S6 | 16.825 | 4.440 | 1.69 | 54.54 |
| S7 | −16.497 | 0.094 | | |
| S8 | 15.226 | 3.525 | 1.62 | 63.39 |
| S9 | −13.498 | 4.785 | 1.75 | 34.99 |
| S10 | −35.180 | 4.254 | | |
| S11 | −7.818 | 0.997 | 1.73 | 28.32 |
| S12 | −51.999 | 1.545 | | |
| S13 | Infinity | 0.500 | 1.52 | 64.20 |
| S14 | Infinity | 1.189 | | |
| S15 | Infinity | 0.500 | 1.52 | 64.20 |
| S16 | Infinity | 0.125 | | |
| IMA | / | / | | |

### Example 5

FIG. 5 is a schematic diagram of an optical lens assembly structure of Example 5.

As shown in FIG. 5, an optical lens assembly sequentially includes from a first-side to a second-side: a first lens L1, a second lens L2, a diaphragm STO, a third lens L3, a fourth lens L4, a fifth lens L5, a sixth lens L6, a first-side surface S13 of an optical filter, a second-side surface S14 of the optical filter, a first-side surface S15 of protective glass, a second-side surface S16 of the protective glass, and an imaging surface IMA.

The first lens L1 has a positive refractive power; and a first-side surface S1 of the first lens is a convex surface, and a second-side surface S2 of the first lens is a convex surface. The second lens L2 has a negative refractive power; and a first-side surface S3 of the second lens is a concave surface, and a second-side surface S4 of the second lens is a concave surface. The third lens L3 has a positive refractive power; and a first-side surface S6 of the third lens is a concave surface, and a second-side surface S7 of the third lens is a convex surface. The fourth lens L4 has a positive refractive power; and a first-side surface S8 of the fourth lens is a convex surface, and a second-side surface S9 of the fourth lens is a convex surface. The fifth lens L5 has a negative refractive power; and a first-side surface S9 of the fifth lens is a concave surface, and a second-side surface S10 of the fifth lens is a convex surface. The sixth lens L6 has a negative refractive power; and a first-side surface S11 of the sixth lens is a concave surface, and a second-side surface S12 of the sixth lens is a convex surface. Light from the first-side passes through the surfaces S1 to S16 in sequence, and is finally imaged on the imaging surface IMA. Since the fourth lens L4 and the fifth lens L5 are cemented to form a double cemented lens, the second-side surface S9 of the fourth lens and the first-side surface S9 of the fifth lens are the same surface.

In this example, an entire set focal length value F of the optical lens assembly is 15.982 mm, a maximum field of view of the optical lens assembly is 32.080°, and a total optical length TTL of the optical lens assembly is 30.965 mm.

Table 5 shows a basic structure parameter table of the optical lens assembly in Example 5, where curvature radius, and thickness/distance are all in millimeters (mm).

TABLE 5

| Surface | Curvature | Thickness/ | Refractive | Abbe |
|---|---|---|---|---|
| number | radius R | distance | index N | number Vd |
| S1 | 19.159 | 3.620 | 1.83 | 42.73 |
| S2 | −20.096 | 0.578 | | |
| S3 | −12.585 | 2.132 | 1.75 | 34.99 |
| S4 | 12.585 | 1.008 | | |
| STO | Infinity | 0.850 | | |
| S6 | −9.643 | 3.205 | 1.69 | 54.54 |
| S7 | −8.478 | 0.200 | | |
| S8 | 8.716 | 5.716 | 1.62 | 63.39 |
| S9 | −9.117 | 4.081 | 1.75 | 34.99 |
| S10 | −38.099 | 5.201 | | |
| S11 | −5.297 | 0.984 | 1.73 | 28.32 |
| S12 | −8.005 | 1.084 | | |
| S13 | Infinity | 0.500 | 1.52 | 64.20 |
| S14 | Infinity | 1.181 | | |
| S15 | Infinity | 0.500 | 1.52 | 64.20 |
| S16 | Infinity | 0.125 | | |
| IMA | / | / | | |

### Example 6

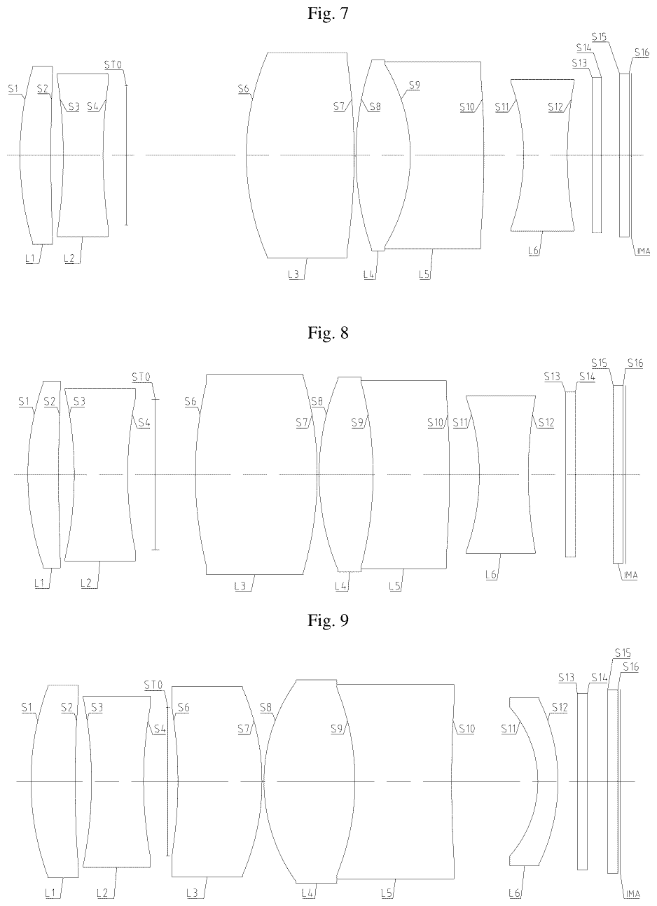

FIG. 6 is a schematic diagram of an optical lens assembly structure of Example 6.

As shown in FIG. 6, an optical lens assembly sequentially includes from a first-side to a second-side: a first lens L1, a second lens L2, a diaphragm STO, a third lens L3, a fourth lens L4, a fifth lens L5, a sixth lens L6, a first-side surface S13 of an optical filter, a second-side surface S14 of the optical filter, a first-side surface S15 of protective glass, a second-side surface S16 of the protective glass, and an imaging surface IMA.

The first lens L1 has a positive refractive power; and a first-side surface S1 of the first lens is a convex surface, and a second-side surface S2 of the first lens is a convex surface. The second lens L2 has a negative refractive power; and a first-side surface S3 of the second lens is a concave surface, and a second-side surface S4 of the second lens is a concave surface. The third lens L3 has a positive refractive power; and a first-side surface S6 of the third lens is a concave surface, and a second-side surface S7 of the third lens is a convex surface. The fourth lens L4 has a positive refractive power; and a first-side surface S8 of the fourth lens is a convex surface, and a second-side surface S9 of the fourth lens is a convex surface. The fifth lens L5 has a negative refractive power; and a first-side surface S9 of the fifth lens is a concave surface, and a second-side surface S10 of the fifth lens is a convex surface. The sixth lens L6 has a negative refractive power; and a first-side surface S11 of the sixth lens is a concave surface, and a second-side surface S12 of the sixth lens is a convex surface. Light from the first-side passes through the surfaces S1 to S16 in sequence, and is finally imaged on the imaging surface IMA. Since the fourth lens L4 and the fifth lens L5 are cemented to form a double cemented lens, the second-side surface S9 of the fourth lens and the first-side surface S9 of the fifth lens are the same surface.

In this example, an entire set focal length value F of the optical lens assembly is 15.967 mm, a maximum field of view of the optical lens assembly is 32.080°, and a total optical length TTL of the optical lens assembly is 29.767 mm.

Table 6 shows a basic structure parameter table of the optical lens assembly in Example 6, where curvature radius, and thickness/distance are all in millimeters (mm).

TABLE 6

| Surface | Curvature | Thickness/ | Refractive | Abbe |
|---|---|---|---|---|
| number | radius R | distance | index N | number Vd |
| S1 | 18.667 | 3.509 | 1.83 | 42.73 |
| S2 | −20.214 | 0.699 | | |
| S3 | −11.424 | 2.075 | 1.75 | 34.99 |
| S4 | 11.424 | 0.965 | | |
| STO | Infinity | 0.982 | | |
| S6 | −8.264 | 2.341 | 1.69 | 54.54 |
| S7 | −7.165 | 0.093 | | |
| S8 | 8.314 | 5.922 | 1.62 | 63.39 |
| S9 | −9.182 | 3.000 | 1.75 | 34.99 |
| S10 | −39.589 | 5.346 | | |
| S11 | −4.816 | 0.924 | 1.73 | 28.32 |
| S12 | −6.432 | 1.788 | | |
| S13 | Infinity | 0.500 | 1.52 | 64.20 |
| S14 | Infinity | 0.999 | | |
| S15 | Infinity | 0.500 | 1.52 | 64.20 |
| S16 | Infinity | 0.125 | | |
| IMA | / | / | | |

### Example 7

FIG. 7 is a schematic diagram of an optical lens assembly structure of Example 7.

As shown in FIG. 7, an optical lens assembly sequentially includes from a first-side to a second-side: a first lens L1, a second lens L2, a diaphragm STO, a third lens L3, a fourth lens L4, a fifth lens L5, a sixth lens L6, a first-side surface S13 of an optical filter, a second-side surface S14 of the optical filter, a first-side surface S15 of protective glass, a second-side surface S16 of the protective glass, and an imaging surface IMA.

The first lens L11 has a positive refractive power; and a first-side surface S1 of the first lens is a convex surface, and a second-side surface S2 of the first lens is a concave surface. The second lens L2 has a negative refractive power; and a first-side surface S3 of the second lens is a concave surface, and a second-side surface S4 of the second lens is a concave surface. The third lens L3 has a positive refractive power; and a first-side surface S6 of the third lens is a convex surface, and a second-side surface S7 of the third lens is a convex surface. The fourth lens L4 has a positive refractive power; and a first-side surface S8 of the fourth lens is a convex surface, and a second-side surface S9 of the fourth lens is a convex surface. The fifth lens L5 has a negative refractive power; and a first-side surface S9 of the fifth lens is a concave surface, and a second-side surface S10 of the fifth lens is a convex surface. The sixth lens L6 has a negative refractive power; and a first-side surface S11 of the sixth lens is a concave surface, and a second-side surface S12 of the sixth lens is a concave surface. Light from the first-side passes through the surfaces S1 to S16 in sequence, and is finally imaged on the imaging surface IMA. Since the fourth lens L4 and the fifth lens L5 are cemented to form a double cemented lens, the second-side surface S9 of the fourth lens and the first-side surface S9 of the fifth lens are the same surface.

In this example, an entire set focal length value F of the optical lens assembly is 15.982 mm, a maximum field of view of the optical lens assembly is 32.080°, and a total optical length TTL of the optical lens assembly is 32.642 mm.

Table 7 shows a basic structure parameter table of the optical lens assembly in Example 7, where curvature radius, and thickness/distance are all in millimeters (mm).

TABLE 7

| Surface | Curvature | Thickness/ | Refractive | Abbe |
|---|---|---|---|---|
| number | radius R | distance | index N | number Vd |
| S1 | 16.585 | 1.652 | 1.83 | 42.73 |
| S2 | 108.762 | 0.659 | | |
| S3 | −27.267 | 2.123 | 1.75 | 34.99 |
| S4 | 27.267 | 1.245 | | |
| STO | Infinity | 6.408 | | |
| S6 | 13.820 | 5.754 | 1.69 | 54.54 |
| S7 | −34.955 | 0.094 | | |
| S8 | 15.453 | 2.904 | 1.62 | 63.39 |
| S9 | −9.454 | 3.935 | 1.75 | 34.99 |
| S10 | −52.363 | 2.116 | | |
| S11 | −11.595 | 2.333 | 1.73 | 28.32 |
| S12 | 21.302 | 1.321 | | |
| S13 | Infinity | 0.500 | 1.52 | 64.20 |
| S14 | Infinity | 0.974 | | |
| S15 | Infinity | 0.500 | 1.52 | 64.20 |
| S16 | Infinity | 0.125 | | |
| IMA | / | / | | |

### Example 8

FIG. 8 is a schematic diagram of an optical lens assembly structure of Example 8.

As shown in FIG. 8, an optical lens assembly sequentially includes from a first-side to a second-side: a first lens L1, a second lens L2, a diaphragm STO, a third lens L3, a fourth lens L4, a fifth lens L5, a sixth lens L6, a first-side surface S13 of an optical filter, a second-side surface S14 of the optical filter, a first-side surface S15 of protective glass, a second-side surface S16 of the protective glass, and an imaging surface IMA.

The first lens L1 has a positive refractive power; and a first-side surface S1 of the first lens is a convex surface, and a second-side surface S2 of the first lens is a concave surface. The second lens L2 has a negative refractive power; and a first-side surface S3 of the second lens is a concave surface, and a second-side surface S4 of the second lens is a concave surface. The third lens L3 has a positive refractive power; and a first-side surface S6 of the third lens is a convex surface, and a second-side surface S7 of the third lens is a convex surface. The fourth lens L4 has a positive refractive power; and a first-side surface S8 of the fourth lens is a convex surface, and a second-side surface S9 of the fourth lens is a convex surface. The fifth lens L5 has a negative refractive power; and a first-side surface S9 of the fifth lens is a concave surface, and a second-side surface S10 of the fifth lens is a convex surface. The sixth lens L6 has a negative refractive power; and a first-side surface S11 of the sixth lens is a concave surface, and a second-side surface S12 of the sixth lens is a concave surface. Light from the first-side passes through the surfaces S1 to S16 in sequence, and is finally imaged on the imaging surface IMA. Since the fourth lens L4 and the fifth lens L5 are cemented to form a double cemented lens, the second-side surface S9 of the fourth lens and the first-side surface S9 of the fifth lens are the same surface.

In this example, an entire set focal length value F of the optical lens assembly is 15.980 mm, a maximum field of view of the optical lens assembly is 32.080°, and a total optical length TTL of the optical lens assembly is 29.876 mm.

Table 8 shows a basic structure parameter table of the optical lens assembly in Example 8, where curvature radius, and thickness/distance are all in millimeters (mm).

TABLE 8

| Surface | Curvature | Thickness/ | Refractive | Abbe |
|---|---|---|---|---|
| number | radius R | distance | index N | number Vd |
| S1 | 14.113 | 1.538 | 1.83 | 42.73 |
| S2 | 108.762 | 0.781 | | |
| S3 | −19.344 | 2.672 | 1.75 | 34.99 |
| S4 | 19.344 | 1.378 | | |
| STO | Infinity | 2.004 | | |
| S6 | 19.271 | 6.088 | 1.69 | 54.54 |
| S7 | −17.584 | 0.097 | | |
| S8 | 12.660 | 2.691 | 1.62 | 63.39 |
| S9 | −18.289 | 3.821 | 1.75 | 34.99 |
| S10 | −52.363 | 1.493 | | |
| S11 | −11.611 | 2.444 | 1.73 | 28.32 |
| S12 | 21.252 | 1.853 | | |
| S13 | Infinity | 0.500 | 1.52 | 64.20 |
| S14 | Infinity | 1.891 | | |
| S15 | Infinity | 0.500 | 1.52 | 64.20 |
| S16 | Infinity | 0.125 | | |
| IMA | / | / | | |

### Example 9

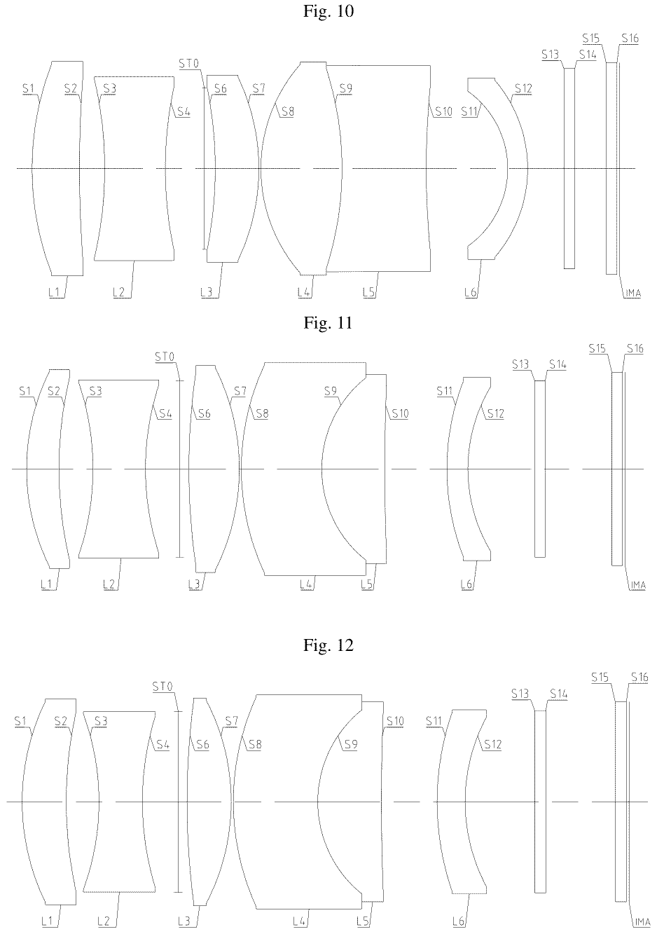

FIG. 9 is a schematic diagram of an optical lens assembly structure of Example 9.

As shown in FIG. 9, an optical lens assembly sequentially includes from a first-side to a second-side: a first lens L1, a second lens L2, a diaphragm STO, a third lens L3, a fourth lens L4, a fifth lens L5, a sixth lens L6, a first-side surface S13 of an optical filter, a second-side surface S14 of the optical filter, a first-side surface S15 of protective glass, a second-side surface S16 of the protective glass, and an imaging surface IMA.

The first lens L1 has a positive refractive power; and a first-side surface S1 of the first lens is a convex surface, and a second-side surface S2 of the first lens is a concave surface. The second lens L2 has a negative refractive power; and a first-side surface S3 of the second lens is a concave surface, and a second-side surface S4 of the second lens is a concave surface. The third lens L3 has a positive refractive power; and a first-side surface S6 of the third lens is a concave surface, and a second-side surface S7 of the third lens is a convex surface. The fourth lens L4 has a positive refractive power; and a first-side surface S8 of the fourth lens is a convex surface, and a second-side surface S9 of the fourth lens is a convex surface. The fifth lens L5 has a negative refractive power; and a first-side surface S9 of the fifth lens is a concave surface, and a second-side surface S10 of the fifth lens is a concave surface. The sixth lens L6 has a negative refractive power; and a first-side surface S11 of the sixth lens is a concave surface, and a second-side surface S12 of the sixth lens is a convex surface. Light from the first-side passes through the surfaces S1 to S16 in sequence, and is finally imaged on the imaging surface IMA. Since the fourth lens L4 and the fifth lens L5 are cemented to form a double cemented lens, the second-side surface S9 of the fourth lens and the first-side surface S9 of the fifth lens are the same surface.

In this example, an entire set focal length value F of the optical lens assembly is 15.999 mm, a maximum field of view of the optical lens assembly is 32.080°, and a total optical length TTL of the optical lens assembly is 29.094 mm.

Table 9 shows a basic structure parameter table of the optical lens assembly in Example 9, where curvature radius, and thickness/distance are all in millimeters (mm).

TABLE 9

| Surface | Curvature | Thickness/ | Refractive | Abbe |
|---|---|---|---|---|
| number | radius R | distance | index N | number Vd |
| S1 | 13.557 | 2.177 | 1.83 | 42.73 |
| S2 | 54.181 | 0.815 | | |
| S3 | −20.863 | 2.567 | 1.75 | 34.99 |
| S4 | 20.863 | 1.198 | | |
| STO | Infinity | 0.495 | | |
| S6 | −22.900 | 4.152 | 1.69 | 54.54 |
| S7 | −11.540 | 0.098 | | |
| S8 | 8.490 | 4.495 | 1.62 | 63.39 |
| S9 | −12.316 | 4.767 | 1.75 | 34.99 |
| S10 | 63.338 | 4.257 | | |
| S11 | −5.564 | 0.992 | 1.73 | 28.32 |
| S12 | −9.335 | 0.956 | | |
| S13 | Infinity | 0.500 | 1.52 | 64.20 |
| S14 | Infinity | 1.001 | | |
| S15 | Infinity | 0.500 | 1.52 | 64.20 |
| S16 | Infinity | 0.125 | | |
| IMA | / | / | | |

### Example 10

FIG. 10 is a schematic diagram of an optical lens assembly structure of Example 10.

As shown in FIG. 10, an optical lens assembly sequentially includes from a first-side to a second-side: a first lens L1, a second lens L2, a diaphragm STO, a third lens L3, a fourth lens L4, a fifth lens L5, a sixth lens L6, a first-side surface S13 of an optical filter, a second-side surface S14 of the optical filter, a first-side surface S15 of protective glass, a second-side surface S16 of the protective glass, and an imaging surface IMA.

The first lens L1 has a positive refractive power; and a first-side surface S1 of the first lens is a convex surface, and a second-side surface S2 of the first lens is a concave surface. The second lens L2 has a negative refractive power; and a first-side surface S3 of the second lens is a concave surface, and a second-side surface S4 of the second lens is a concave surface. The third lens L3 has a positive refractive power; and a first-side surface S6 of the third lens is a concave surface, and a second-side surface S7 of the third lens is a convex surface. The fourth lens L4 has a positive refractive power; and a first-side surface S8 of the fourth lens is a convex surface, and a second-side surface S9 of the fourth lens is a convex surface. The fifth lens L5 has a negative refractive power; and a first-side surface S9 of the fifth lens is a concave surface, and a second-side surface S10 of the fifth lens is a concave surface. The sixth lens L6 has a negative refractive power; and a first-side surface S11 of the sixth lens is a concave surface, and a second-side surface S12 of the sixth lens is a convex surface. Light from the first-side passes through the surfaces S1 to S16 in sequence, and is finally imaged on the imaging surface IMA. Since the fourth lens L4 and the fifth lens L5 are cemented to form a double cemented lens, the second-side surface S9 of the fourth lens and the first-side surface S9 of the fifth lens are the same surface.

In this example, an entire set focal length value F of the optical lens assembly is 15.999 mm, a maximum field of view of the optical lens assembly is 32.080°, and a total optical length TTL of the optical lens assembly is 26.951 mm.

Table 10 shows a basic structure parameter table of the optical lens assembly in Example 10, where curvature radius, and thickness/distance are all in millimeters (mm).

TABLE 10

| Surface | Curvature | Thickness/ | Refractive | Abbe |
|---|---|---|---|---|
| number | radius R | distance | index N | number Vd |
| S1 | 13.356 | 2.172 | 1.83 | 42.73 |
| S2 | 56.010 | 1.157 | | |
| S3 | −17.898 | 2.779 | 1.75 | 34.99 |
| S4 | 17.898 | 1.790 | | |
| STO | Infinity | 0.499 | | |
| S6 | −18.924 | 2.000 | 1.69 | 54.54 |
| S7 | −9.750 | 0.095 | | |
| S8 | 7.258 | 3.721 | 1.62 | 63.39 |
| S9 | −14.947 | 3.867 | 1.75 | 34.99 |
| S10 | 38.745 | 3.736 | | |
| S11 | −4.381 | 0.913 | 1.73 | 28.32 |
| S12 | −6.242 | 1.663 | | |
| S13 | Infinity | 0.500 | 1.52 | 64.20 |
| S14 | Infinity | 1.434 | | |
| S15 | Infinity | 0.500 | 1.52 | 64.20 |
| S16 | Infinity | 0.125 | | |
| IMA | / | / | | |

### Example 11

FIG. 11 is a schematic diagram of an optical lens assembly structure of Example 11.

As shown in FIG. 11, an optical lens assembly sequentially includes from a first-side to a second-side: a first lens L1, a second lens L2, a diaphragm STO, a third lens L3, a fourth lens L4, a fifth lens L5, a sixth lens L6, a first-side surface S13 of an optical filter, a second-side surface S14 of the optical filter, a first-side surface S15 of protective glass, a second-side surface S16 of the protective glass, and an imaging surface IMA.

The first lens L1 has a positive refractive power; and a first-side surface S1 of the first lens is a convex surface, and a second-side surface S2 of the first lens is a concave surface. The second lens L2 has a negative refractive power; and a first-side surface S3 of the second lens is a concave surface, and a second-side surface S4 of the second lens is a concave surface. The third lens L3 has a positive refractive power; and a first-side surface S6 of the third lens is a convex surface, and a second-side surface S7 of the third lens is a convex surface. The fourth lens L4 has a negative refractive power; and a first-side surface S8 of the fourth lens is a convex surface, and a second-side surface S9 of the fourth lens is a concave surface. The fifth lens L5 has a positive refractive power; and a first-side surface S9 of the fifth lens is a convex surface, and a second-side surface S10 of the fifth lens is a concave surface. The sixth lens L6 has a negative refractive power; and a first-side surface S11 of the sixth lens is a convex surface, and a second-side surface S12 of the sixth lens is a concave surface. Light from the first-side passes through the surfaces S1 to S16 in sequence, and is finally imaged on the imaging surface IMA. Since the fourth lens L4 and the fifth lens L5 are cemented to form a double cemented lens, the second-side surface S9 of the fourth lens and the first-side surface S9 of the fifth lens are the same surface.

In this example, an entire set focal length value F of the optical lens assembly is 15.999 mm, a maximum field of view of the optical lens assembly is 32.080°, and a total optical length TTL of the optical lens assembly is 28.240 mm.

Table 11 shows a basic structure parameter table of the optical lens assembly in Example 11, where curvature radius, and thickness/distance are all in millimeters (mm).

TABLE 11

| Surface | Curvature | Thickness/ | Refractive | Abbe |
|---|---|---|---|---|
| number | radius R | distance | index N | number Vd |
| S1 | 10.376 | 1.525 | 1.83 | 42.73 |
| S2 | 18.705 | 1.603 | | |
| S3 | −12.660 | 2.480 | 1.75 | 34.99 |
| S4 | 12.832 | 1.617 | | |
| STO | Infinity | 0.430 | | |
| S6 | 31.743 | 2.376 | 1.69 | 54.54 |
| S7 | −10.605 | 0.099 | | |
| S8 | 11.538 | 3.795 | 1.75 | 34.99 |
| S9 | 5.469 | 2.976 | 1.62 | 63.39 |
| S10 | 110.134 | 2.930 | | |
| S11 | 11.431 | 0.989 | 1.73 | 28.32 |
| S12 | 7.543 | 3.147 | | |
| S13 | Infinity | 0.500 | 1.52 | 64.20 |
| S14 | Infinity | 3.147 | | |
| S15 | Infinity | 0.500 | 1.52 | 64.20 |
| S16 | Infinity | 0.125 | | |
| IMA | / | / | | |

### Example 12

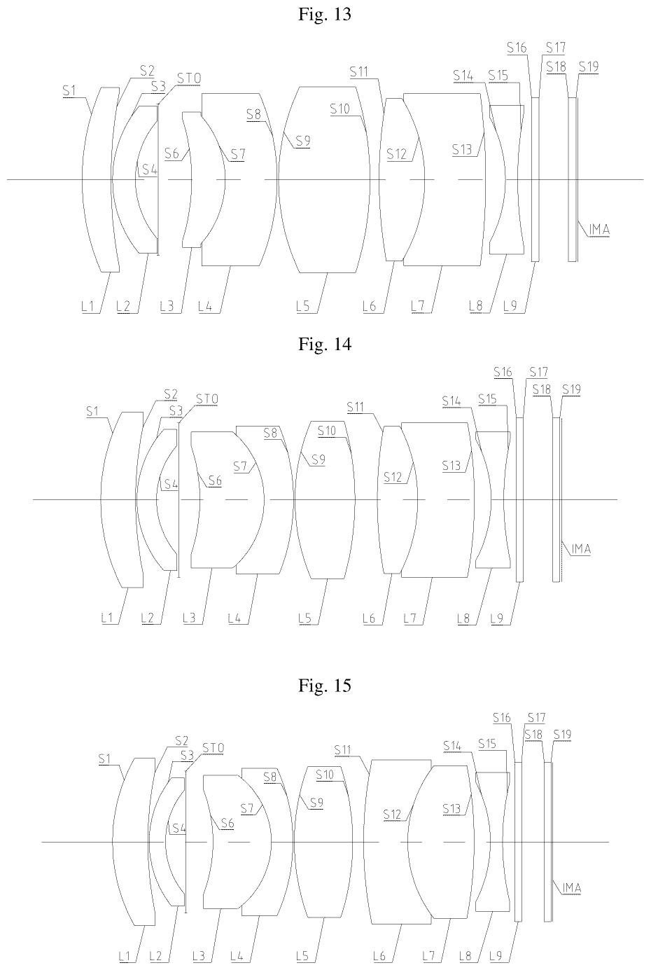

FIG. 12 is a schematic diagram of an optical lens assembly structure of Example 12.

As shown in FIG. 12, an optical lens assembly sequentially includes from a first-side to a second-side: a first lens L1, a second lens L2, a diaphragm STO, a third lens L3, a fourth lens L4, a fifth lens L5, a sixth lens L6, a first-side surface S13 of an optical filter, a second-side surface S14 of the optical filter, a first-side surface S15 of protective glass, a second-side surface S16 of the protective glass, and an imaging surface IMA.

The first lens L1 has a positive refractive power; and a first-side surface S1 of the first lens is a convex surface, and a second-side surface S2 of the first lens is a concave surface. The second lens L2 has a negative refractive power; and a first-side surface S3 of the second lens is a concave surface, and a second-side surface S4 of the second lens is a concave surface. The third lens L3 has a positive refractive power; and a first-side surface S6 of the third lens is a convex surface, and a second-side surface S7 of the third lens is a convex surface. The fourth lens L4 has a negative refractive power; and a first-side surface S8 of the fourth lens is a convex surface, and a second-side surface S9 of the fourth lens is a concave surface. The fifth lens L5 has a positive refractive power; and a first-side surface S9 of the fifth lens is a convex surface, and a second-side surface S10 of the fifth lens is a concave surface. The sixth lens L6 has a negative refractive power; and a first-side surface S11 of the sixth lens is a convex surface, and a second-side surface S12 of the sixth lens is a concave surface. Light from the first-side passes through the surfaces S1 to S16 in sequence, and is finally imaged on the imaging surface IMA. Since the fourth lens L4 and the fifth lens L5 are cemented to form a double cemented lens, the second-side surface S9 of the fourth lens and the first-side surface S9 of the fifth lens are the same surface.

In this example, an entire set focal length value F of the optical lens assembly is 15.999 mm, a maximum field of view of the optical lens assembly is 32.080°, and a total optical length TTL of the optical lens assembly is 27.532 mm.

Table 12 shows a basic structure parameter table of the optical lens assembly in Example 12, where curvature radius, and thickness/distance are all in millimeters (mm).

TABLE 12

| Surface | Curvature | Thickness/ | Refractive | Abbe |
|---|---|---|---|---|
| number | radius R | distance | index N | number Vd |
| S1 | 10.438 | 2.000 | 1.83 | 42.73 |
| S2 | 18.928 | 1.483 | | |
| S3 | −11.617 | 1.971 | 1.75 | 34.99 |
| S4 | 13.272 | 1.628 | | |
| STO | Infinity | 0.401 | | |
| S6 | 35.817 | 2.000 | 1.69 | 54.54 |
| S7 | −9.976 | 0.099 | | |
| S8 | 11.494 | 3.830 | 1.75 | 34.99 |
| S9 | 5.391 | 2.886 | 1.62 | 63.39 |
| S10 | 101.100 | 2.528 | | |
| S11 | 12.546 | 1.271 | 1.73 | 28.32 |
| S12 | 8.211 | 3.156 | | |
| S13 | Infinity | 0.500 | 1.52 | 64.20 |
| S14 | Infinity | 3.154 | | |
| S15 | Infinity | 0.500 | 1.52 | 64.20 |
| S16 | Infinity | 0.125 | | |
| IMA | / | / | | |

To sum up, Example 1 to Example 12 respectively meet relationships shown in Table 13.

TABLE 13

| Conditional | Example | | | | | | | | | | | |
|---|---|---|---|---|---|---|---|---|---|---|---|---|
| expression | 1 | 2 | 3 | 4 | 5 | 6 | 7 | 8 | 9 | 10 | 11 | 12 |
| TTL/F | 1.928 | 1.820 | 1.986 | 1.799 | 1.937 | 1.864 | 2.042 | 1.870 | 1.819 | 1.685 | 1.765 | 1.721 |
| (F*θ)/D | 0.932 | 0.884 | 0.871 | 0.940 | 0.887 | 0.890 | 0.956 | 0.974 | 0.961 | 0.928 | 0.978 | 0.978 |
| D/H/FOV | 0.033 | 0.035 | 0.036 | 0.033 | 0.034 | 0.034 | 0.033 | 0.032 | 0.032 | 0.033 | 0.031 | 0.032 |
| D/H/F | 0.065 | 0.070 | 0.072 | 0.066 | 0.069 | 0.069 | 0.067 | 0.065 | 0.065 | 0.067 | 0.063 | 0.063 |
| F/θ | 29.342 | 28.408 | 28.411 | 28.661 | 28.545 | 28.517 | 28.544 | 28.540 | 28.574 | 28.575 | 28.575 | 28.575 |
| \|(H − F*θ)/(F*θ)\| | 0.005 | 0.011 | 0.004 | 0.007 | 0.022 | 0.018 | 0.025 | 0.005 | 0.007 | 0.006 | 0.012 | 0.010 |
| F/ENPD | 2.000 | 2.000 | 2.000 | 2.000 | 2.000 | 2.000 | 2.000 | 2.000 | 2.000 | 2.000 | 2.000 | 2.000 |
| (H/2)/(F*tan(θ/2)) | 0.979 | 0.984 | 0.978 | 0.981 | 0.995 | 0.991 | 0.949 | 0.969 | 0.981 | 0.980 | 0.985 | 0.984 |
| \|R4/R5\| | 0.176 | 0.167 | 0.128 | 0.892 | 1.305 | 1.383 | 1.973 | 1.004 | 0.911 | 0.946 | 0.404 | 0.371 |
| \|R10/R11\| | 4.658 | 4.764 | 4.500 | 4.500 | 7.192 | 8.220 | 4.516 | 4.510 | 11.383 | 8.843 | 9.635 | 8.058 |
| F6/F | −0.864 | −0.856 | −0.831 | −0.789 | −1.578 | −2.159 | −0.622 | −0.621 | −1.321 | −1.580 | −2.117 | −2.311 |
| F2/F3 | −0.446 | −0.454 | −0.550 | −0.762 | −0.170 | −0.176 | −1.187 | −0.878 | −0.463 | −0.432 | −0.693 | −0.695 |
| \|F/R3\| + \|F/R4\| | 1.707 | 1.869 | 1.675 | 2.139 | 2.540 | 2.795 | 1.172 | 1.652 | 1.534 | 1.788 | 2.510 | 2.583 |
| (d7*BFL)/(d7 + BFL) | 0.098 | 0.098 | 0.091 | 0.091 | 0.189 | 0.090 | 0.091 | 0.095 | 0.095 | 0.093 | 0.098 | 0.098 |
| \|R6/F\| | 1.020 | 0.920 | 1.071 | 1.028 | 0.530 | 0.449 | 2.187 | 1.100 | 0.721 | 0.609 | 0.663 | 0.624 |
| R7/F | 0.588 | 0.533 | 0.581 | 0.949 | 0.545 | 0.521 | 0.967 | 0.792 | 0.531 | 0.454 | 0.721 | 0.718 |
| \|R10/F\| | 1.815 | 1.631 | 1.741 | 2.192 | 2.384 | 2.479 | 3.276 | 3.277 | 3.959 | 2.422 | 6.884 | 6.319 |
| \|R11/F\| | 0.390 | 0.342 | 0.387 | 0.487 | 0.331 | 0.302 | 0.726 | 0.727 | 0.348 | 0.274 | 0.714 | 0.784 |
| \|R10/TTL\| | 0.941 | 0.896 | 0.877 | 1.219 | 1.230 | 1.330 | 1.604 | 1.753 | 2.177 | 1.438 | 3.900 | 3.672 |
| d6/TTL | 0.160 | 0.088 | 0.141 | 0.154 | 0.104 | 0.079 | 0.176 | 0.204 | 0.143 | 0.074 | 0.084 | 0.073 |
| TTL/d11 | 29.196 | 26.680 | 31.681 | 28.941 | 31.462 | 32.208 | 13.991 | 12.224 | 29.323 | 29.528 | 28.549 | 21.657 |
| (d8 + d9)/TTL | 0.267 | 0.261 | 0.300 | 0.288 | 0.316 | 0.300 | 0.210 | 0.218 | 0.318 | 0.282 | 0.240 | 0.244 |
| \|(d26 − d6)/TTL\| | 0.003 | 0.084 | 0.032 | 0.011 | 0.044 | 0.080 | 0.143 | 0.025 | 0.032 | 0.157 | 0.133 | 0.126 |
| d3/d6 | 0.479 | 0.954 | 0.606 | 0.455 | 0.665 | 0.886 | 0.369 | 0.439 | 0.618 | 1.390 | 1.044 | 0.985 |
| \|(d26 − d6)/R5\| | 0.001 | 0.023 | 0.007 | 0.019 | 0.141 | 0.288 | 0.339 | 0.039 | 0.040 | 0.223 | 0.118 | 0.097 |
| arctan(D7/(R7 − | 0.853 | 0.941 | 0.883 | 0.586 | 0.923 | 0.956 | 0.602 | 0.685 | 0.960 | 1.055 | 0.756 | 0.740 |
| SAG7)) | | | | | | | | | | | | |
| D/R1 | 0.597 | 0.601 | 0.656 | 0.570 | 0.527 | 0.538 | 0.565 | 0.651 | 0.688 | 0.723 | 0.883 | 0.878 |
| \|R10/(d8 + d9)\| | 3.519 | 3.430 | 2.927 | 4.233 | 3.889 | 4.437 | 7.657 | 8.041 | 6.839 | 5.107 | 16.266 | 15.054 |
| \|R10/d9\| | 6.885 | 5.363 | 5.787 | 7.352 | 9.337 | 13.199 | 13.308 | 13.703 | 13.287 | 10.021 | 37.004 | 35.030 |
| \|R12/d11\| | 16.396 | 11.968 | 18.059 | 52.140 | 8.134 | 6.960 | 9.130 | 8.695 | 9.408 | 6.839 | 7.625 | 6.459 |
| \|R11/R12\| | 0.360 | 0.419 | 0.342 | 0.150 | 0.662 | 0.749 | 0.544 | 0.546 | 0.596 | 0.702 | 1.515 | 1.528 |

Table 14 shows an effective focal length F of the optical lens assembly in Example 1 to Example 12, and effective focal lengths F1 to F6 of the lenses (in millimeter).

TABLE 14

| | Example | | | | | | | | | | | |
|---|---|---|---|---|---|---|---|---|---|---|---|---|
| Parameter | 1 | 2 | 3 | 4 | 5 | 6 | 7 | 8 | 9 | 10 | 11 | 12 |
| F | 16.429 | 15.906 | 15.907 | 16.047 | 15.982 | 15.967 | 15.982 | 15.980 | 15.999 | 15.999 | 15.999 | 15.999 |
| ENPD | 8.214 | 7.953 | 7.954 | 8.024 | 7.991 | 7.983 | 7.991 | 7.990 | 7.999 | 8.000 | 8.000 | 7.999 |
| TTL | 31.677 | 28.947 | 31.595 | 28.863 | 30.965 | 29.767 | 32.642 | 29.876 | 29.094 | 26.951 | 28.240 | 27.532 |
| FOV | 32.080 | 32.080 | 32.080 | 32.080 | 32.080 | 32.080 | 32.080 | 32.080 | 32.080 | 32.080 | 32.080 | 32.080 |
| θ | 0.560 | 0.560 | 0.560 | 0.560 | 0.560 | 0.560 | 0.560 | 0.560 | 0.560 | 0.560 | 0.560 | 0.560 |
| H | 9.246 | 9.003 | 8.945 | 9.048 | 9.144 | 9.099 | 8.723 | 8.901 | 9.022 | 9.015 | 9.064 | 9.049 |
| D | 9.869 | 10.076 | 10.225 | 9.561 | 10.089 | 10.042 | 9.364 | 9.184 | 9.326 | 9.651 | 9.158 | 9.161 |
| BFL | 4.200 | 4.200 | 3.859 | 3.859 | 3.391 | 3.912 | 3.420 | 4.869 | 3.082 | 4.223 | 7.420 | 7.435 |
| F1 | 25.538 | 25.720 | 31.791 | 21.104 | 12.204 | 12.064 | 23.137 | 19.188 | 21.038 | 20.430 | 25.634 | 25.046 |
| F2 | −12.425 | −10.952 | −12.225 | −9.668 | −8.052 | −7.291 | −17.783 | −12.457 | −13.478 | −11.485 | −8.112 | −7.945 |
| F3 | 27.838 | 24.148 | 22.231 | 12.681 | 47.457 | 41.413 | 14.979 | 14.194 | 29.117 | 26.569 | 11.710 | 11.435 |
| F4 | 9.233 | 8.703 | 9.164 | 12.107 | 8.191 | 8.084 | 9.901 | 12.481 | 8.836 | 8.419 | −18.859 | −18.441 |
| F5 | −28.677 | −41.215 | −31.864 | −32.088 | −16.918 | −16.556 | −15.927 | −39.162 | −13.314 | −13.875 | 9.181 | 9.079 |
| F6 | −14.197 | −13.616 | −13.213 | −12.662 | −25.224 | −34.475 | −9.936 | −9.922 | −21.130 | −25.278 | −33.872 | −36.979 |
| R1 | 16.520 | 16.760 | 15.592 | 16.761 | 19.159 | 18.667 | 16.585 | 14.113 | 13.557 | 13.356 | 10.376 | 10.438 |
| R3 | −19.246 | −16.459 | −18.999 | −15.002 | −12.585 | −11.424 | −27.267 | −19.344 | −20.863 | −17.898 | −12.660 | −11.617 |
| R4 | 19.246 | 17.625 | 18.999 | 15.002 | 12.585 | 11.424 | 27.267 | 19.344 | 20.863 | 17.898 | 12.832 | 13.272 |
| R5 | −109.500 | −105.850 | 147.858 | 16.825 | −9.643 | −8.264 | 13.820 | 19.271 | −22.900 | −18.924 | 31.743 | 35.817 |
| R6 | −16.750 | −14.626 | −17.036 | −16.497 | −8.478 | −7.165 | −34.955 | −17.584 | −11.540 | −9.750 | −10.605 | −9.976 |
| R7 | 9.660 | 8.483 | 9.235 | 15.226 | 8.716 | 8.314 | 15.453 | 12.660 | 8.490 | 7.258 | 11.538 | 11.494 |
| R10 | −29.810 | −25.949 | −27.694 | −35.180 | −38.099 | −39.589 | −52.363 | −52.363 | 63.338 | 38.745 | 110.134 | 101.100 |
| R11 | −6.400 | −5.447 | −6.154 | −7.818 | −5.297 | −4.816 | −11.595 | −11.611 | −5.564 | −4.381 | 11.431 | 12.546 |
| R12 | −17.790 | −12.985 | −18.010 | −51.999 | −8.005 | −6.432 | 21.302 | 21.252 | −9.335 | −6.242 | 7.543 | 8.211 |
| d3 | 2.426 | 2.426 | 2.696 | 2.018 | 2.132 | 2.075 | 2.123 | 2.672 | 2.567 | 2.779 | 2.480 | 1.971 |
| d26 | 4.972 | 4.964 | 5.463 | 4.767 | 4.567 | 4.721 | 10.435 | 6.835 | 5.075 | 6.225 | 6.130 | 5.482 |
| d6 | 5.060 | 2.542 | 4.448 | 4.440 | 3.205 | 2.341 | 5.754 | 6.088 | 4.152 | 2.000 | 2.376 | 2.000 |
| d7 | 0.100 | 0.100 | 0.094 | 0.094 | 0.200 | 0.093 | 0.094 | 0.097 | 0.098 | 0.095 | 0.099 | 0.099 |
| d8 | 4.140 | 2.727 | 4.678 | 3.525 | 5.716 | 5.922 | 2.904 | 2.691 | 4.495 | 3.721 | 3.795 | 3.830 |
| d9 | 4.330 | 4.839 | 4.785 | 4.785 | 4.081 | 3.000 | 3.935 | 3.821 | 4.767 | 3.867 | 2.976 | 2.886 |
| d11 | 1.085 | 1.085 | 0.997 | 0.997 | 0.984 | 0.924 | 2.333 | 2.444 | 0.992 | 0.913 | 0.989 | 1.271 |
| D7 | 9.604 | 9.592 | 9.605 | 9.601 | 9.609 | 9.612 | 10.035 | 9.574 | 9.873 | 9.603 | 9.834 | 9.542 |
| SAG7 | 1.278 | 1.486 | 1.347 | 0.777 | 1.444 | 1.530 | 0.837 | 0.940 | 1.583 | 1.815 | 1.100 | 1.037 |

### Technical Solution II

In order to solve at least one of the problems that an optical lens assembly in the related art may not take small light flux, high resolution, and a small diameter into consideration at the same time, and the design of lenses is limited due to miniaturization, causing high sensitivity, aberration and the like to not be well balanced, the disclosure provides an optical lens assembly and an electronic device.

### Embodiment III

As shown in FIG. 13 to FIG. 24, an optical lens assembly includes a first lens, a second lens, a third lens, a fourth lens, a fifth lens, a sixth lens, a seventh lens, and an eighth lens. The first lens has a negative refractive power, and a first-side surface of the first lens is a convex surface; the second lens has a refractive power, and a first-side surface of the second lens has a surface shape opposite to that of a second-side surface of the second lens; the third lens has a positive refractive power, a first-side surface of the third lens is a concave surface, and a second-side surface of the third lens is a convex surface; the fourth lens has a negative refractive power, a first-side surface of the fourth lens is a concave surface, and a second-side surface of the fourth lens is a convex surface; the fifth lens has a positive refractive power, and a first-side surface of the fifth lens is a convex surface; the sixth lens has a refractive power, and a first-side surface of the sixth lens is a convex surface; the seventh lens has a refractive power; and the eighth lens has a negative refractive power, and a second-side surface of the eighth lens is a concave surface.

In an embodiment, the first lens has the positive refractive power, and has a convergence effect on lights. Meanwhile, by designing the first-side surface of the first lens as the convex surface, the lights are collected over a large range, such that a large number of the lights enter the optical lens assembly, thereby increasing light flux and illuminance of the optical lens assembly. By designing the second-side surface of the first lens as the concave surface, a size of the first lens is decreased to meet a processing requirement, and at the same time, costs are reduced. Furthermore, the control of the lights by the concave surface causes the lights transitioning to a rear part to not be too sensitive, thereby facilitating improvement of resolution. The first lens uses a high refractive index material, which facilitates the gathering of front end lights, so as to decrease a front end diameter.

In an embodiment, the first lens has the positive refractive power, and the first-side surface and the second-side surface of the first lens both are convex surfaces, such that the lights passing through the first lens are more convergent when being emitted from the second-side surface of the first lens, to limit heights of the lights, so as to compress a diameter of the optical lens assembly, thereby realizing small-diameter and miniaturization design. Moreover, the first lens uses spherical glass, such that processing costs are reduced while a waterproofing membrane may be additionally plated.

In an embodiment, the second lens has the negative refractive power; and the first-side surface of the second lens is the convex surface, and the second-side surface of the second lens is the concave surface. By setting the second lens to the negative refractive power and designing the first-side surface of the second lens as the convex surface, the front end lights are stably transitioned. The second-side surface of the second lens uses the design of the concave surface, such that the lights are filled in the pupil as much as possible after the lights converged on the first-side surface are released, thereby improving target surface illuminance.

In an embodiment, the second lens has the negative refractive power; and the first-side surface of the second lens is the concave surface, and the second-side surface of the second lens is the convex surface. By setting the second lens to the negative refractive power and designing the first-side surface of the second lens as the concave surface to match the second-side surface of the convex first lens, a light trend is stabilized, and at the same time, by designing the second-side surface of the second lens as the convex surface to receive the lights perfectly, the sensibility of the optical lens assembly is reduced.

In an embodiment, the second lens has the positive refractive power; and the first-side surface of the second lens is the convex surface, and the second-side surface of the second lens is the concave surface. The second lens has the positive refractive power and is a curved moon shaped convex to the first-side, such that the lights are compressed by the second lens to decrease a rear end diameter, thereby realizing miniaturization.

In an embodiment, the third lens has the positive refractive power; and the first-side surface of the third lens is the concave surface, and the second-side surface of the third lens is the convex surface. The third lens is designed as the positive refractive power. The concave surface design of the first-side surface of the third lens is to better receive the lights passing through a diaphragm, so as to reserve an enough space for aberration adjustment of the lights of a rear optical system. By designing the second-side surface of the third lens as the convex surface, it ensures that the third lens and the fourth lens may have a close light trend, such that an optical energy loss caused by reflection between the lenses is reduced, relative illuminance is improved, and field curvature may be reduced to correct an off-axis aberration.

In an embodiment, the fourth lens has the negative refractive power, the first-side surface of the fourth lens is the concave surface, and the second-side surface of the fourth lens is the convex surface. The fourth lens uses the negative refractive power. The first-side surface of the fourth lens being the concave surface is to better receive the lights incident through the third lens. The second-side surface of the fourth lens is designed as the convex surface to change the light trend. Moreover, the fourth lens is used as a cemented negative film, such that its material attributes also play a crucial role in correcting aberrations such as chromatic aberrations.

In an embodiment, the fifth lens has the positive refractive power; and the first-side surface of the fifth lens is the convex surface, and the second-side surface of the fifth lens is the convex surface. The fifth lens uses the positive refractive power, and the first-side surface uses the convex surface, such that the lights of a front optical system may be gathered, and the rear end diameter is limited. The fifth lens serves as an important lens that bears a front lens group and a rear lens group, and the decreasing of the diameter may reduce a large aberration impact caused by edge FOV lights, such that the sensitivity and optical performance of the optical lens assembly are improved. By designing the second-side surface of the fifth lens as the convex surface, a size of the rear end diameter is optimized, and the convex surface design also maintains the sensitivity of the lights transmitted from the first-side surface, thereby facilitating reduction in the sensitivity.

In an embodiment, the fifth lens has the positive refractive power; and the first-side surface of the fifth lens is the concave surface, and the second-side surface of the fifth lens is the convex surface. The fifth lens uses the positive refractive power, and by designing the first-side surface of the fifth lens as the concave surface to receive upward lights emitted, changes in a light trend of the fifth lens are not significant, such that the sensitivity of the fifth lens is optimized. The second-side surface of the fifth lens being the convex surface changes the light trend, causing the lights to be smoothly transitioned to the rear part.

In an embodiment, the sixth lens has the negative refractive power; and the first-side surface of the sixth lens is the convex surface, and the second-side surface of the sixth lens is the concave surface. By setting the sixth lens to the negative refractive power, the first-side surface of the sixth lens being the convex surface is to converge the front end lights, the second-side surface of the sixth lens is designed as the concave surface, and the lights are diverged, such that light flux is increased, thereby an imaging effect in a dark environment is improved.

In an embodiment, the sixth lens has the positive refractive power; and the first-side surface of the sixth lens is the convex surface, and the second-side surface of the sixth lens is the convex surface. The sixth lens is set to the positive refractive power. The first-side surface of the sixth lens is designed as the convex surface to be symmetrical with the convex surface of the second-side surface of the fourth lens, such that an effect of balancing an aberration is achieved. By designing the second-side surface of the sixth lens as the convex surface, the lights may be further converged to the center to decrease the rear end diameter.

In an embodiment, the sixth lens has the positive refractive power; and the first-side surface of the sixth lens is the convex surface, and the second-side surface of the sixth lens is the concave surface. The sixth lens is set to the positive refractive power to converge the lights. The first-side surface of the sixth lens is designed as the convex surface to receive the front end lights. The second-side surface of the sixth lens is designed as the concave surface to achieve a transition effect, such that the trend of the lights entering the seventh lens is smooth, thereby improving the resolution of the optical lens assembly.

In an embodiment, the seventh lens has the positive refractive power; and the first-side surface of the seventh lens is the convex surface, and the second-side surface of the seventh lens is the convex surface. By designing the seventh lens as the positive refractive power, and by simultaneously using double convex structure design, the front end lights are further converged, such that the lights smoothly enter the rear optical system, thereby realizing a small diameter.

In an embodiment, the seventh lens has the negative refractive power; and the first-side surface of the seventh lens is the concave surface, and the second-side surface of the seventh lens is the convex surface. By designing the seventh lens as the negative refractive power, and designing the seventh lens as a curved moon shaped structure convex to the second-side, the seventh lens may receive the lights emitted from the sixth lens, and the lights are diffused outwards, so as to expand an imaging range.

In an embodiment, the seventh lens has the negative refractive power; and the first-side surface of the seventh lens is the concave surface, and the second-side surface of the seventh lens is the concave surface. By designing the seventh lens as the negative refractive power, and designing the seventh lens as a double concave structure to match the double concave sixth lens, the lights are transitioned without a loss, and through the cooperation of the positive and negative refractive powers, an aberration between an edge light and a center light is corrected, thereby realizing high resolution.

In an embodiment, the seventh lens has the negative refractive power; and the first-side surface of the seventh lens is the convex surface, and the second-side surface of the seventh lens is the concave surface. By designing the seventh lens as the negative refractive power, designing the first-side surface of the seventh lens as the convex surface to gather the lights, and designing the second-side surface of the seventh lens as the concave surface to diverge the lights, the heights of the lights are rapidly accumulated subsequently on an image surface, thereby expanding the imaging range.

In an embodiment, the eighth lens has the negative refractive power; and the first-side surface of the eighth lens is the concave surface, and the second-side surface of the eighth lens is the concave surface. By designing the eighth lens as the negative refractive power, and designing the first-side surface as the concave surface, the lights entering through the seventh lens are collected, and by designing the second-side surface as the concave surface, a peripheral light aberration is able to be controlled and regulated to a certain extent, thereby improving the resolution of the optical lens assembly.

In an embodiment, the eighth lens has the negative refractive power; and the first-side surface of the eighth lens is the convex surface, and the second-side surface of the eighth lens is the concave surface. By designing the eighth lens as the negative refractive power, the lights may be further diverged. The designing of the first-side surface as the convex surface facilitates the receiving of the incident lights of the seventh lens. The designing of the second-side surface as the concave surface facilitates the increasing of the light flux, thereby improving the imaging quality of the optical lens assembly in a dark environment.

In this embodiment, the optical lens assembly further includes a diaphragm, and the diaphragm is located between the second lens and the third lens. By arranging the diaphragm between the second lens and the third lens, alight entering the optical lens assembly is collected to decrease a diameter of a rear optical system of the optical lens assembly, so as to reducing the assembly sensitivity of the optical lens assembly.

In this embodiment, the third lens and the fourth lens are cemented lenses, and the sixth lens and the seventh lens are cemented lenses. By designing the third lens and the fourth lens, which have opposite refractive powers, as the cemented lenses, the stable transition of the light to the rear optical system is facilitated. The sixth lens and the seventh lens are cemented lenses, such that the light passing through the front lens may be gently transitioned to the rear optical system, a total optical length of the optical lens assembly is shortened to cause various aberrations of the optical lens assembly to be fully corrected, and with a compact structure, a resolution ratio of the optical lens assembly is increased, and optical performance such as distortions, CRAs, and the like is optimized.

By designing the third lens and the fourth lens, as well as the sixth lens and the seventh lens, as the cemented lenses, an air gap between the two lenses may be reduced, and the total length of the optical lens assembly is shortened, such that the miniaturization of the optical lens assembly is facilitated, assembly components of the two lens members may also be reduced, processes are reduced, costs are reduced, and chromatic dispersion complementarity of the two lenses facilitates reduction in chromatic aberration, and may further reduce field curvature and correct an off-axis point aberration of the optical lens assembly, thereby improving imaging quality. By rationally distributing the focal length, thermal compensation is realized, thereby achieving good temperature performance.

In this embodiment, a curvature radius R15 of the second-side surface of the eighth lens and an entire set focal length value F of the optical lens assembly meet: R15/F≥0.3. When the focal length value F of the entire set of optical lens assembly assemblies is fixed, it ensures that the curvature radius of the second-side surface of the eighth lens is positive, such that rear lights may be effectively adjusted, an aberration is balanced, and the resolution of the optical lens assembly is improved. Preferably, R15/F≥0.5.

In this embodiment, a sum d67 of a center thickness of the sixth lens and a center thickness of the seventh lens and a total optical length TTL of the optical lens assembly meet: d67/TTL≤0.3. When the TTL is similar, if the sum of the center thicknesses of the sixth lens and the seventh lens is smaller, limitation to the diameter of the rear optical system is larger, such that the diameter of the rear optical system is decreased, a small diameter effect is achieved, and at the same time, limitation to the center thickness of the cemented lens also plays an important role in controlling low cost. Preferably, d67/TTL≤0.26.

In this embodiment, an entire set focal length value F of the optical lens assembly, a radian value θ of a maximum field of view of the optical lens assembly, and a maximum clear diameter D of the first-side surface of the first lens corresponding to the optical lens assembly at the maximum field of view meet: (F*θ)/D≥0.3. When the FOV is constant, if the maximum clear diameter of the first-side surface of the first lens is smaller, it is more conductive to reducing a front end diameter of the optical lens assembly, thereby decreasing the size of the optical lens assembly. Preferably, (F*θ)/D≥0.5.

In this embodiment, an entire set focal length value F of the optical lens assembly, a maximum field of view FOV of the optical lens assembly, and an image height H corresponding to the maximum field of view of the optical lens assembly meet: (FOV×F)/H≥45. Through such arrangement, when the image height is the same, long focal length and large angle resolution are realized. Preferably, (FOV×F)/H≥50.

In this embodiment, a total optical length TTL of the optical lens assembly and an entire set focal length value F of the optical lens assembly meet: TTL/F≤3. When the focal length is close, a smaller TTL means that the optical lens assembly has a smaller size, such that the miniaturization of the optical lens assembly is realized. Preferably, TTL/F≤2.5.

In this embodiment, an entire set focal length value F of the optical lens assembly, a maximum field of view FOV of the optical lens assembly, and an image height H corresponding to the maximum field of view of the optical lens assembly meet: TTL/H/FOV≤0.5. With the same imaging surface and same image height, the length of the optical lens assembly may be effectively limited, and the miniaturization of the optical lens assembly is realized. TTL/H/FOV≤0.3.

In this embodiment, an entire set focal length value F of the optical lens assembly and an image height H corresponding to a maximum field of view of the optical lens assembly meet: 0.5≤F/H≤3. By controlling a ratio of the focal length value F of the entire set of optical lens assembly assemblies to the image height within a rational range, the resolution capability of the optical lens assembly is improved. Preferably, 1≤F/H≤2.5.

In this embodiment, a curvature radius R1 of the first-side surface of the first lens, a curvature radius R2 of the second-side surface of the first lens, a maximum effective clear diameter D of the first-side surface of the first lens corresponding to a maximum field of view, and a maximum effective clear diameter D2 of the second-side surface of the first lens corresponding to the maximum field of view meet: −1≤(R1/D)/(R2/D2)≤1. By limiting the curvature and maximum effective clear diameter of the first lens, and ensuring the above relationship within a certain range, a height of an edge light entering the optical lens assembly may be effectively limited, thereby further achieving a small diameter. Preferably, −0.5≤(R1/D)/(R2/D2)≤0.7.

In this embodiment, a curvature radius R9 of the first-side surface of the fifth lens and a curvature radius R10 of the second-side surface of the fifth lens meet: −6.5≤R9/R10≤7. By controlling the curvature radius of the fifth lens within a rational range, the deviation of incident angles of lights from different FOVs may be reduced, such that the smooth transition of the lights is facilitated, thereby reducing the sensitivity of the optical lens assembly. Preferably, −4≤R9/R10≤6.5.

In this embodiment, an image height H corresponding to a maximum field of view of the optical lens assembly, an entire set focal length value F of the optical lens assembly, and a radian value θ of the maximum field of view of the optical lens assembly meet: |(H−F*θ)/(F*θ)|≤0.05. When it ensures that the focal length of the optical lens assembly is increased while the FOV and imaging surface of the optical lens assembly remain unchanged, such that an imaging effect at a center region of the imaging surface of the optical lens assembly is highlighted, thereby reducing an impact of target surface distortion. Preferably, |(H−F*θ)/(F*θ)|≤0.04.

In this embodiment, the focal length value F of the entire set of optical lens assembly assemblies and an ENPD of the optical lens assembly meet: F/ENPD≤2. Through such arrangement, the ENPD is increased, and light flux is increased, such that relative illuminance is improved, thereby improving the imaging capability in a dark environment. Preferably, F/ENPD≤1.8.

In this embodiment, a maximum clear diameter D of the first-side surface of the first lens corresponding to the optical lens assembly at a maximum field of view, an entire set focal length value F of the optical lens assembly, and an image height H corresponding to a maximum field of view of the optical lens assembly meet: D/H/F≤0.2. When the focal length value of the entire set of optical lens assembly assemblies is fixed, the optical lens assembly has the characteristics of a large target surface and a small diameter. Preferably, D/H/F≤0.15.

In this embodiment, a curvature radius R10 of the second-side surface of the fifth lens and a maximum effective clear diameter D9 of the first-side surface of the fifth lens corresponding to a maximum field of view meet: R10/D9≥−7. By rationally setting a ratio of the curvature radius of the fifth lens to the maximum effective clear diameter, the height of the light entering the fifth lens is decreased, such that a small diameter is realized while the processability of the lens is taken into consideration at the same time. Preferably, R10/D9≥−4.

In this embodiment, a curvature radius R10 of the second-side surface of the fifth lens and an entire set focal length value F of the optical lens assembly meet: R10/F≥−3.5. When the focal length is fixed, the curvature radius of the second-side surface of the fifth lens is controlled, such that the height of the light is able to be effectively decreased, so as to reduce the diameter of the rear optical system. Preferably, R10/F≥−2.5.

In this embodiment, a curvature radius R15 of the second-side surface of the eighth lens and a total optical length TTL of the optical lens assembly meet: R15/TTL≥0.001. With the total optical length unchanged, the curvature radius of the second-side surface of the eighth lens is controlled, such that a reflection ghost image generated among the eighth lens, an optical filter, and protective glass may be reduced, thereby improving imaging quality. Preferably, R15/TTL≥0.2.

In this embodiment, an optical BFL of the optical lens assembly and an entire set focal length value F of the optical lens assembly meet: BFL/F≤0.54. By limiting a ratio of the BFL to the F, on the basis of realizing miniaturization, an optical path difference between the edge light and a center light is reduced by limiting the BFL, such that an aberration is reduced, thereby improving resolution. Preferably, BFL/F≤0.41.

In this embodiment, a curvature radius R15 of the second-side surface of the eighth lens and an optical BFL of the optical lens assembly meet: R15/BFL≥0.5. The reflection ghost image easily generated among the second-side surface of the eighth lens, the optical filter, and the protective glass. The ghost image may be weakened or even avoided by controlling the second-side surface of the eighth lens to be the concave surface, and by controlling the optical BFL, the resolution capability of the optical lens assembly may be improved significantly. Preferably, R15/BFL≥2.

In this embodiment, the curvature radius R1 of the first-side surface of the first lens, the center thickness d1 of the first lens, and the curvature radius R2 of the second-side surface of the first lens meet: 0.175≤(R1+d1)/|R2|≤0.8. By controlling the curvature radii and center thicknesses of the two side surfaces of the first lens, the first lens has a smooth shape, facilitating collection of front light rays, thereby improving illuminance. Preferably, 0.2≤(R1+d1)/|R2|≤0.7.

In this embodiment, the curvature radius R31 of the first-side surface of the third lens and the curvature radius R42 of the second-side surface of the fourth lens meet: 0.5≤R31/R42≤1.5. By controlling a ratio of the curvature radius of the first-side surface of the third lens to the curvature radius of the second-side surface of the fourth lens to be close, a deflection angle allowing the light ray to exit from the third lens and enter the fourth lens is small, realizing a smooth transition of the light ray, thereby facilitating reduction of the sensitivity of the optical lens assembly. Preferably, 0.6≤R31/R42≤1.25.

In this embodiment, the sum d67 of the center thickness of the sixth lens and the center thickness of the seventh lens and the entire set focal length value F of the optical lens assembly meet: 0.25≤d67/F≤0.62. By controlling the sum of the center thicknesses of the sixth lens and the seventh lens to be relatively small, miniaturization is realized while ensuring the long-focus application of the optical lens assembly. Preferably, 0.28≤d67/F≤0.6.

In this embodiment, the curvature radius R61 of the first-side surface of the sixth lens and the curvature radius R72 of the second-side surface of the seventh lens meet: 0.25≤|R61/R72|≤1.4. By controlling a ratio of the curvature radius of the first-side surface of the sixth lens to the curvature radius of the second-side surface of the seventh lens to be close, a deflection angle allowing the light ray to exit from the sixth lens and enter the seventh lens is small, realizing the smooth transition of the light ray, facilitating effective correction of an aberration, thereby realizing high resolution. Preferably, 0.3≤|R61/R72|≤1.2.

In this embodiment, the curvature radius R1 of the first-side surface of the first lens and the entire set focal length value F of the optical lens assembly meet: 0.5≤R1/F≤1.85. When the entire set focal length value of the optical lens assembly is fixed, the curvature radius of the first-side surface of the first lens is controlled, such that the height of the light ray may be effectively decreased, so as to reduce a front end aperture of the optical lens assembly while eliminating peripheral aberration light rays, thereby realizing high resolution. Preferably, 0.6≤R1/F≤1.75.

In this embodiment, a curvature radius R21 of a first-side surface of a second lens, a curvature radius R22 of a second-side surface of the second lens, and a center thickness d2 of the second lens meet: 0.35≤|R21|/((R22)+d2)≤1.4. By controlling the curvature radii and center thicknesses of the two side surfaces of the second lens, the overall shape of the second lens with a shape of a crescent moon is uniform, such that the light rays of all field of views in the second lens are smoothly and effectively diverged, thereby causing the field of views to have uniform and high imaging quality. Preferably, 0.45≤|R21|/((R22)+d2)≤1.2.

In this embodiment, the center thickness d2 of the second lens and an edge thickness ET2 of the second lens meet: 0.95≤d2/ET2≤1.5. By controlling a ratio of the edge thickness to the center thickness of the second lens to be close, an optical path difference of the light rays of the field of views is regulated and controlled, and the light rays are smoothly diverged to a rear system, thereby realizing high resolution. Preferably, 1≤d2/ET2≤1.35.

In this embodiment, a combined focal length F34 of the third lens and the fourth lens, and the entire set focal length value F of the optical lens assembly meet: 0<|F34/F|≤0.75. By controlling a ratio of the focal length of the third lens and the fourth lens to the entire set focal length value of the optical lens assembly, the light rays may be effectively diverged when passing through the third lens and the fourth lens, thereby realizing an imaging height of a large image surface. Preferably, 0.005≤|F34/F|≤0.65.

In this embodiment, the focal length F5 of the fifth lens and the entire set focal length value F of the optical lens assembly meet: 0.7≤F5/F≤2. A ratio of the focal length of the fifth lens to the entire set focal length value of the optical lens assembly is relatively small, the light rays may be effectively converged at this point, thereby realizing the miniaturization of the optical lens assembly. Preferably, 0.8≤F5/F≤1.85.

In this embodiment, a combined focal length F67 of the sixth lens and the seventh lens, and the entire set focal length value F of the optical lens assembly meet: 0.55≤|F67/F|≤4.5. By controlling a ratio of the focal lengths of the sixth lens and the seventh lens to the entire set focal length value of the optical lens assembly, the light rays may be smoothly converged when passing through the sixth lens and the seventh lens, such that an angle of a principal light ray for imaging may be controlled, and the sensitivity is reduced. Preferably, 0.65≤|F67/F|≤4.

In this embodiment, the focal length F3 of the third lens and the entire set focal length value F of the optical lens assembly meet: 0.35≤F3/F≤1.8. The ratio of the focal length of the third lens to the entire set focal length value of the optical lens assembly is relatively small, the excessive divergence of the light rays collected in the front is prevented from affecting the aperture of the subsequent lenses. Preferably, 0.4≤F3/F≤1.65.

In this embodiment, the focal length F4 of the fourth lens and the entire set focal length value F of the optical lens assembly meet: −2.4≤F4/F≤−0.2. By controlling the focal length of the fourth lens with a negative refractive power, an aberration caused by the front lenses with a positive refractive power may be corrected, thereby realizing high resolution. Preferably, −2≤F4/F≤−0.25.

In this embodiment, the focal length F8 of the eighth lens and the entire set focal length value F of the optical lens assembly meet: −3.2≤F8/F≤−0.5. The eighth lens has a negative refractive power. By controlling a ratio of the focal length of the eighth lens to the entire set focal length value of the optical lens assembly, the convergence of the light rays in the front is smoothed, such that the light rays may smoothly enter the imaging surface, and the aberration is balanced, thereby realizing high resolution and obtaining a required principal light ray angle. Preferably, −3≤F8/F≤−0.6.

In this embodiment, the focal length F1 of the first lens and the entire set focal length value F of the optical lens assembly meet: 1.05≤F1/F≤2.8. By controlling the ratio of the focal length of the first lens to the entire set focal length value of the optical lens assembly, the first lens may effectively collect the light rays with a small aperture and allow the light rays to enter the optical lens assembly, thereby avoiding the introduction of an aberration of a large field of view angle. Preferably, 1.2≤F1/F≤2.5.

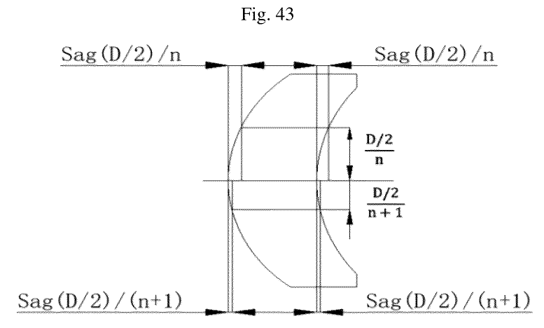

In this embodiment, as shown in FIG. 43, each of lenses of the optical lens assembly meets the followings: when the first-side surface of one of the lenses is a convex surface or a second-side surface of the one of the lenses is a concave surface, a sagittal height Sag(D/2)/n of the lens at one-nth of an optical axis and a sagittal height Sag(D/2)/(n+1) of the one of the lenses at one-(n+1)th of the optical axis meet: Sag(D/2)/n>Sag(D/2)/(n+1), where n≥1; and when the first-side surface of the one of the lenses is the concave surface or the second-side surface is the convex surface, a sagittal height Sag(D/2)/n of the one of the lenses at one-nth of an optical axis and a sagittal height Sag(D/2)/(n+1) of the one of the lenses at one-(n+1)th of the optical axis meet: Sag(D/2)/n>Sag(D/2)/(n+1), where n≥1. By controlling the sagittal height of each of lenses of the optical lens assembly to vary monotonically with the increasing of the apertures on both sides of the lens, a surface type of the lens changes subtly when the optical lens assembly is subject to high and low temperature changes, such that the change in focal length is stable, thereby realizing stable imaging under high and low temperature changes.

### Embodiment IV

As shown in FIG. 13 to FIG. 24, an optical lens assembly includes a first lens, a second lens, a third lens, a fourth lens, a fifth lens, a sixth lens, a seventh lens, and an eighth lens. The first lens has a positive refractive power; the second lens has a refractive power; the third lens has a positive refractive power; the fourth lens has a negative refractive power; the fifth lens has a positive refractive power; the sixth lens has a refractive power; the seventh lens has a refractive power; and the eighth lens has a negative refractive power. A curvature radius R15 of the second-side surface of the eighth lens and an entire set focal length value F of the optical lens assembly meet: R15/F≥0.3. When the focal length value F of the entire set of optical lens assembly assemblies is fixed, it ensures that the curvature radius of the second-side surface of the eighth lens is positive, such that rear lights may be effectively adjusted, an aberration is balanced, and the resolution of the optical lens assembly is improved. Preferably, R15/F≥0.5.

In an embodiment, the first lens has the positive refractive power, and has a convergence effect on lights. Meanwhile, by designing the first-side surface of the first lens as the convex surface, the lights are collected over a large range, such that a large number of the lights enter the optical lens assembly, thereby increasing light flux and illuminance of the optical lens assembly. By designing the second-side surface of the first lens as the concave surface, a size of the first lens is decreased to meet a processing requirement, and at the same time, costs are reduced. Furthermore, the control of the lights by the concave surface causes the lights transitioning to a rear part to not be too sensitive, thereby facilitating improvement of resolution. The first lens uses a high refractive index material, which facilitates the gathering of front end lights, so as to decrease a front end diameter.

In an embodiment, the first lens has the positive refractive power, and the first-side surface and the second-side surface of the first lens both are convex surfaces, such that the lights passing through the first lens are more convergent when being emitted from the second-side surface of the first lens, to limit heights of the lights, so as to compress a diameter of the optical lens assembly, thereby realizing small-diameter and miniaturization design. Moreover, the first lens uses spherical glass, such that processing costs are reduced while a waterproofing membrane may be additionally plated.

In an embodiment, the second lens has the negative refractive power; and the first-side surface of the second lens is the convex surface, and the second-side surface of the second lens is the concave surface. By setting the second lens to the negative refractive power and designing the first-side surface of the second lens as the convex surface, the front end lights are stably transitioned. The second-side surface of the second lens uses the design of the concave surface, such that the lights are filled in the pupil as much as possible after the lights converged on the first-side surface are released, thereby improving target surface illuminance.

In an embodiment, the second lens has the negative refractive power; and the first-side surface of the second lens is the concave surface, and the second-side surface of the second lens is the convex surface. By setting the second lens to the negative refractive power and designing the first-side surface of the second lens as the concave surface to match the second-side surface of the convex first lens, a light trend is stabilized, and at the same time, by designing the second-side surface of the second lens as the convex surface to receive the lights perfectly, the sensibility of the optical lens assembly is reduced.

In an embodiment, the second lens has the positive refractive power; and the first-side surface of the second lens is the convex surface, and the second-side surface of the second lens is the concave surface. The second lens has the positive refractive power and is a curved moon shaped convex to the first side, such that the lights are compressed by the second lens to decrease a rear end diameter, thereby realizing miniaturization.

In an embodiment, the third lens has the positive refractive power; and the first-side surface of the third lens is the concave surface, and the second-side surface of the third lens is the convex surface. The third lens is designed as the positive refractive power. The concave surface design of the first-side surface of the third lens is to better receive the lights passing through a diaphragm, so as to reserve an enough space for aberration adjustment of the lights of a rear optical system. By designing the second-side surface of the third lens as the convex surface, it ensures that the third lens and the fourth lens may have a close light trend, such that an optical energy loss caused by reflection between the lenses is reduced, relative illuminance is improved, and field curvature may be reduced to correct an off-axis aberration.

In an embodiment, the fourth lens has the negative refractive power, the first-side surface of the fourth lens is the concave surface, and the second-side surface of the fourth lens is the convex surface. The fourth lens uses the negative refractive power. The first-side surface of the fourth lens being the concave surface is to better receive the lights incident through the third lens. The second-side surface of the fourth lens is designed as the convex surface to change the light trend. Moreover, the fourth lens is used as a cemented negative film, such that its material attributes also play a crucial role in correcting aberrations such as chromatic aberrations.

In an embodiment, the fifth lens has the positive refractive power; and the first-side surface of the fifth lens is the convex surface, and the second-side surface of the fifth lens is the convex surface. The fifth lens uses the positive refractive power, and the first-side surface uses the convex surface, such that the lights of a front optical system may be gathered, and the rear end diameter is limited. The fifth lens serves as an important lens that bears a front lens group and a rear lens group, and the decreasing of the diameter may reduce a large aberration impact caused by edge FOV lights, such that the sensitivity and optical performance of the optical lens assembly are improved. By designing the second-side surface of the fifth lens as the convex surface, a size of the rear end diameter is optimized, and the convex surface design also maintains the sensitivity of the lights transmitted from the first-side surface, thereby facilitating reduction in the sensitivity.

In an embodiment, the fifth lens has the positive refractive power; and the first-side surface of the fifth lens is the concave surface, and the second-side surface of the fifth lens is the convex surface. The fifth lens uses the positive refractive power, and by designing the first-side surface of the fifth lens as the concave surface to receive upward lights emitted, changes in a light trend of the fifth lens are not significant, such that the sensitivity of the fifth lens is optimized. The second-side surface of the fifth lens being the convex surface changes the light trend, causing the lights to be smoothly transitioned to the rear part.

In an embodiment, the sixth lens has the negative refractive power; and the first-side surface of the sixth lens is the convex surface, and the second-side surface of the sixth lens is the concave surface. By setting the sixth lens to the negative refractive power, the first-side surface of the sixth lens being the convex surface is to converge the front end lights, the second-side surface of the sixth lens is designed as the concave surface, and the lights are diverged, such that light flux is increased, thereby an imaging effect in a dark environment is improved.

In an embodiment, the sixth lens has the positive refractive power; and the first-side surface of the sixth lens is the convex surface, and the second-side surface of the sixth lens is the convex surface. The sixth lens is set to the positive refractive power. The first-side surface of the sixth lens is designed as the convex surface to be symmetrical with the convex surface of the second-side surface of the fourth lens, such that an effect of balancing an aberration is achieved. By designing the second-side surface of the sixth lens as the convex surface, the lights may be further converged to the center to decrease the rear end diameter.

In an embodiment, the sixth lens has the positive refractive power; and the first-side surface of the sixth lens is the convex surface, and the second-side surface of the sixth lens is the concave surface. The sixth lens is set to the positive refractive power to converge the lights. The first-side surface of the sixth lens is designed as the convex surface to receive the front end lights. The second-side surface of the sixth lens is designed as the concave surface to achieve a transition effect, such that the trend of the lights entering the seventh lens is smooth, thereby improving the resolution of the optical lens assembly.

In an embodiment, the seventh lens has the positive refractive power; and the first-side surface of the seventh lens is the convex surface, and the second-side surface of the seventh lens is the convex surface. By designing the seventh lens as the positive refractive power, and by simultaneously using double convex structure design, the front end lights are further converged, such that the lights smoothly enter the rear optical system, thereby realizing a small diameter.

In an embodiment, the seventh lens has the negative refractive power; and the first-side surface of the seventh lens is the concave surface, and the second-side surface of the seventh lens is the convex surface. By designing the seventh lens as the negative refractive power, and designing the seventh lens as a curved moon shaped structure convex to the second side, the seventh lens may receive the lights emitted from the sixth lens, and the lights are diffused outwards, so as to expand an imaging range.

In an embodiment, the seventh lens has the negative refractive power; and the first-side surface of the seventh lens is the concave surface, and the second-side surface of the seventh lens is the concave surface. By designing the seventh lens as the negative refractive power, and designing the seventh lens as a double concave structure to match the double concave sixth lens, the lights are transitioned without a loss, and through the cooperation of the positive and negative refractive powers, an aberration between an edge light and a center light is corrected, thereby realizing high resolution.

In an embodiment, the seventh lens has the negative refractive power; and the first-side surface of the seventh lens is the convex surface, and the second-side surface of the seventh lens is the concave surface. By designing the seventh lens as the negative refractive power, designing the first-side surface of the seventh lens as the convex surface to gather the lights, and designing the second-side surface of the seventh lens as the concave surface to diverge the lights, the heights of the lights are rapidly accumulated subsequently on an image surface, thereby expanding the imaging range.

In an embodiment, the eighth lens has the negative refractive power; and the first-side surface of the eighth lens is the concave surface, and the second-side surface of the eighth lens is the concave surface. By designing the eighth lens as the negative refractive power, and designing the first-side surface as the concave surface, the lights entering through the seventh lens are collected, and by designing the second-side surface as the concave surface, a peripheral light aberration may be controlled and regulated to a certain extent, thereby improving the resolution of the optical lens assembly.

In an embodiment, the eighth lens has the negative refractive power; and the first-side surface of the eighth lens is the convex surface, and the second-side surface of the eighth lens is the concave surface. By designing the eighth lens as the negative refractive power, the lights may be further diverged. The designing of the first-side surface as the convex surface facilitates the receiving of the incident lights of the seventh lens. The designing of the second-side surface as the concave surface facilitates the increasing of the light flux, thereby improving the imaging quality of the optical lens assembly in a dark environment.

In this embodiment, the optical lens assembly further includes a diaphragm, and the diaphragm is located between the second lens and the third lens. By arranging the diaphragm between the second lens and the third lens, alight entering the optical lens assembly is collected to decrease a diameter of a rear optical system of the optical lens assembly, so as to reducing the assembly sensitivity of the optical lens assembly.

In this embodiment, the third lens and the fourth lens are cemented lenses, and the sixth lens and the seventh lens are cemented lenses. By designing the third lens and the fourth lens, which have opposite refractive powers, as the cemented lenses, the stable transition of the light to the rear optical system is facilitated. The sixth lens and the seventh lens are cemented lenses, such that the light passing through the front lens may be gently transitioned to the rear optical system, a total optical length of the optical lens assembly is shortened to cause various aberrations of the optical lens assembly to be fully corrected, and with a compact structure, a resolution ratio of the optical lens assembly is increased, and optical performance such as distortions, CRAs, and the like is optimized.

By designing the third lens and the fourth lens, as well as the sixth lens and the seventh lens, as the cemented lenses, an air gap between the two lenses may be reduced, and the total length of the optical lens assembly is shortened, such that the miniaturization of the optical lens assembly is facilitated, assembly components of the two lens members may also be reduced, processes are reduced, costs are reduced, and chromatic dispersion complementarity of the two lenses facilitates reduction in chromatic aberration, and may further reduce field curvature and correct an off-axis point aberration of the optical lens assembly, thereby improving imaging quality. By rationally distributing the focal length, thermal compensation is realized, thereby achieving good temperature performance.

In this embodiment, a sum d67 of a center thickness of the sixth lens and a center thickness of the seventh lens and a total optical length TTL of the optical lens assembly meet: d67/TTL≤0.3. When the TTL is similar, if the sum of the center thicknesses of the sixth lens and the seventh lens is smaller, limitation to the diameter of the rear optical system is larger, such that the diameter of the rear optical system is decreased, a small diameter effect is achieved, and at the same time, limitation to the center thickness of the cemented lens also plays an important role in controlling low cost. Preferably, d67/TTL≤0.26.

In this embodiment, an entire set focal length value F of the optical lens assembly, a radian value θ of a maximum field of view of the optical lens assembly, and a maximum clear diameter D of the first-side surface of the first lens corresponding to the optical lens assembly at the maximum field of view meet: (F*θ)/D≥0.3. When the FOV is constant, if the maximum clear diameter of the first-side surface of the first lens is smaller, it is more conductive to reducing a front end diameter of the optical lens assembly, thereby decreasing the size of the optical lens assembly. Preferably, (F*θ)/D≥0.5.

In this embodiment, an entire set focal length value F of the optical lens assembly, a maximum field of view FOV of the optical lens assembly, and an image height H corresponding to the maximum field of view of the optical lens assembly meet: (FOV×F)/H≥45. Through such arrangement, when the image height is the same, long focal length and large angle resolution are realized. Preferably, (FOV×F)/H≥50.

In this embodiment, a total optical length TTL of the optical lens assembly and an entire set focal length value F of the optical lens assembly meet: TTL/F≤3. When the focal length is close, a smaller TTL means that the optical lens assembly has a smaller size, such that the miniaturization of the optical lens assembly is realized. Preferably, TTL/F≤2.5.

In this embodiment, an entire set focal length value F of the optical lens assembly, a maximum field of view FOV of the optical lens assembly, and an image height H corresponding to the maximum field of view of the optical lens assembly meet: TTL/H/FOV≤0.5. With the same imaging surface and same image height, the length of the optical lens assembly may be effectively limited, and the miniaturization of the optical lens assembly is realized. TTL/H/FOV≤0.3.

In this embodiment, an entire set focal length value F of the optical lens assembly and an image height H corresponding to a maximum field of view of the optical lens assembly meet: 0.5≤F/H≤3. By controlling a ratio of the focal length value F of the entire set of optical lens assembly assemblies to the image height within a rational range, the resolution capability of the optical lens assembly is improved. Preferably, 1≤F/H≤2.5.

In this embodiment, a curvature radius R1 of the first-side surface of the first lens, a curvature radius R2 of the second-side surface of the first lens, a maximum effective clear diameter D of the first-side surface of the first lens corresponding to a maximum field of view FOV, and a maximum effective clear diameter D2 of the second-side surface of the first lens corresponding to the maximum field of view FOV meet: −1≤(R1/D)/(R2/D2)≤1. By limiting the curvature and maximum effective clear diameter of the first lens, and ensuring the above relationship within a certain range, a height of an edge light entering the optical lens assembly may be effectively limited, thereby further achieving a small diameter. Preferably, −0.5≤(R1/D)/(R2/D2)≤0.7.

In this embodiment, a curvature radius R9 of the first-side surface of the fifth lens and a curvature radius R10 of the second-side surface of the fifth lens meet: −6.5≤R9/R10≤7. By controlling the curvature radius of the fifth lens within a rational range, the deviation of incident angles of lights from different FOVs may be reduced, such that the smooth transition of the lights is facilitated, thereby reducing the sensitivity of the optical lens assembly. Preferably, −4≤R9/R10≤6.5.

In this embodiment, an image height H corresponding to a maximum field of view FOV of the optical lens assembly, an entire set focal length value F of the optical lens assembly, and a radian value θ of the maximum field of view of the optical lens assembly meet: |(H−F*θ)/(F*θ)|≤0.05. When it ensures that the focal length of the optical lens assembly is increased while the FOV and imaging surface of the optical lens assembly remain unchanged, such that an imaging effect at a center region of the imaging surface of the optical lens assembly is highlighted, thereby reducing an impact of target surface distortion. Preferably, |(H−F*θ)/(F*θ)|≤0.04.

In this embodiment, the focal length value F of the entire set of optical lens assembly assemblies and an ENPD of the optical lens assembly meet: F/ENPD≤2. When the focal length value of the entire set of optical lens assembly assemblies is fixed, the optical lens assembly has the characteristics of a large target surface and a small diameter. Preferably, D/H/F≤0.15.

In this embodiment, a maximum clear diameter D of the first-side surface of the first lens corresponding to the optical lens assembly at a maximum field of view, an entire set focal length value F of the optical lens assembly, and an image height H corresponding to a maximum field of view of the optical lens assembly meet: D/H/F≤0.2. When the focal length value of the entire set of optical lens assembly assemblies is fixed, the optical lens assembly has the characteristics of a large target surface and a small diameter. Preferably, D/H/F≤0.15.

In this embodiment, a curvature radius R10 of the second-side surface of the fifth lens and a maximum effective clear diameter D9 of the first-side surface of the fifth lens corresponding to a maximum field of view meet: R10/D9≥−7. By rationally setting a ratio of the curvature radius of the fifth lens to the maximum effective clear diameter, the height of the light entering the fifth lens is decreased, such that a small diameter is realized while the process ability of the lens is taken into consideration at the same time. Preferably, R10/D9≥−4.

In this embodiment, a curvature radius R10 of the second-side surface of the fifth lens and an entire set focal length value F of the optical lens assembly meet: R10/F≥−3.5. When the focal length is fixed, the curvature radius of the second-side surface of the fifth lens is controlled, such that the height of the light is able to be effectively decreased, so as to reduce the diameter of the rear optical system. Preferably, R10/F≥−2.5.

In this embodiment, a curvature radius R15 of the second-side surface of the eighth lens and a TTL of the optical lens assembly meet: R15/TTL≥0.001. With the total optical length unchanged, the curvature radius of the second-side surface of the eighth lens is controlled, such that a reflection ghost image generated among the eighth lens, a optical filter, and protective glass may be reduced, thereby improving imaging quality. Preferably, R15/TTL≥0.2.

In this embodiment, an optical BFL of the optical lens assembly and an entire set focal length value F of the optical lens assembly meet: BFL/F≤0.54. By limiting a ratio of the BFL to the F, on the basis of realizing miniaturization, an optical path difference between the edge light and a center light is reduced by limiting the BFL, such that an aberration is reduced, thereby improving resolution. Preferably, BFL/F≤0.41.

In this embodiment, a curvature radius R15 of the second-side surface of the eighth lens and an optical BFL of the optical lens assembly meet: R15/BFL≥0.5. The reflection ghost image easily generated among the second-side surface of the eighth lens, the optical filter, and the protective glass. The ghost image may be weakened or even avoided by controlling the second-side surface of the eighth lens to be the concave surface, and by controlling the optical BFL, the resolution capability of the optical lens assembly may be improved significantly. Preferably, R15/BFL≥2.

In this embodiment, the curvature radius R1 of the first-side surface of the first lens, the center thickness d1 of the first lens, and the curvature radius R2 of the second-side surface of the first lens meet: 0.175≤(R1+d1)/|R2|≤0.8. By controlling the curvature radii and center thicknesses of the two side surfaces of the first lens, the first lens has a smooth shape, facilitating collection of front light rays, thereby improving illuminance. Preferably, 0.2≤(R1+d1)/|R2|≤0.7.

In this embodiment, the curvature radius R31 of the first-side surface of the third lens and the curvature radius R42 of the second-side surface of the fourth lens meet: 0.5≤R31/R42≤1.5. By controlling a ratio of the curvature radius of the first-side surface of the third lens to the curvature radius of the second-side surface of the fourth lens to be close, a deflection angle allowing the light ray to exit from the third lens and enter the fourth lens is small, realizing a smooth transition of the light ray, thereby facilitating reduction of the sensitivity of the optical lens assembly. Preferably, 0.6≤R31/R42≤1.25.

In this embodiment, the sum d67 of the center thickness of the sixth lens and the center thickness of the seventh lens and the entire set focal length value F of the optical lens assembly meet: 0.25≤d67/F≤0.62. By controlling the sum of the center thicknesses of the sixth lens and the seventh lens to be relatively small, miniaturization is realized while ensuring the long-focus application of the optical lens assembly. Preferably, 0.28≤d67/F≤0.6.

In this embodiment, the curvature radius R61 of the first-side surface of the sixth lens and the curvature radius R72 of the second-side surface of the seventh lens meet: 0.25≤|R61/R72|≤1.4. By controlling a ratio of the curvature radius of the first-side surface of the sixth lens to the curvature radius of the second-side surface of the seventh lens to be close, a deflection angle allowing the light ray to exit from the sixth lens and enter the seventh lens is small, realizing the smooth transition of the light ray, facilitating effective correction of an aberration, thereby realizing high resolution. Preferably, 0.3≤|R61/R72|≤1.2.

In this embodiment, the curvature radius R1 of the first-side surface of the first lens and the entire set focal length value F of the optical lens assembly meet: 0.5≤R1/F≤1.85. When the entire set focal length value of the optical lens assembly is fixed, the curvature radius of the first-side surface of the first lens is controlled, such that the height of the light ray may be effectively decreased, so as to reduce a front end aperture of the optical lens assembly while eliminating peripheral aberration light rays, thereby realizing high resolution. Preferably, 0.6≤R1/F≤1.75.

In this embodiment, a curvature radius R21 of a first-side surface of a second lens, a curvature radius R22 of a second-side surface of the second lens, and a center thickness d2 of the second lens meet: 0.35≤|R21|/((R22)+d2)≤1.4. By controlling the curvature radii and center thicknesses of the two side surfaces of the second lens, the overall shape of the second lens with a shape of a crescent moon is uniform, such that the light rays of all field of views in the second lens are smoothly and effectively diverged, thereby causing the field of views to have uniform and high imaging quality. Preferably, 0.45≤|R21|/((R22)+d2)≤1.2.

In this embodiment, the center thickness d2 of the second lens and an edge thickness ET2 of the second lens meet: 0.95≤d2/ET2≤1.5. By controlling a ratio of the edge thickness to the center thickness of the second lens to be close, an optical path difference of the light rays of the field of views is regulated and controlled, and the light rays are smoothly diverged to a rear system, thereby realizing high resolution. Preferably, 1≤d2/ET2≤1.35.

In this embodiment, a combined focal length F34 of the third lens and the fourth lens, and the entire set focal length value F of the optical lens assembly meet: 0<|F34/F|≤0.75. By controlling a ratio of the focal length of the third lens and the fourth lens to the entire set focal length value of the optical lens assembly, the light rays may be effectively diverged when passing through the third lens and the fourth lens, thereby realizing an imaging height of a large image surface. Preferably, 0.005≤|F34/F|≤0.65.

In this embodiment, the focal length F5 of the fifth lens and the entire set focal length value F of the optical lens assembly meet: 0.7≤F5/F≤2. A ratio of the focal length of the fifth lens to the entire set focal length value of the optical lens assembly is relatively small, the light rays may be effectively converged at this point, thereby realizing the miniaturization of the optical lens assembly. Preferably, 0.8≤F5/F≤1.85.

In this embodiment, a combined focal length F67 of the sixth lens and the seventh lens, and the entire set focal length value F of the optical lens assembly meet: 0.5≤|F67/F|≤4.5. By controlling a ratio of the focal lengths of the sixth lens and the seventh lens to the entire set focal length value of the optical lens assembly, the light rays may be smoothly converged when passing through the sixth lens and the seventh lens, such that an angle of a principal light ray for imaging may be controlled, and the sensitivity is reduced. Preferably, 0.65≤|F67/F|≤4.

In this embodiment, the focal length F3 of the third lens and the entire set focal length value F of the optical lens assembly meet: 0.35≤F3/F≤1.8. The ratio of the focal length of the third lens to the entire set focal length value of the optical lens assembly is relatively small, the excessive divergence of the light rays collected in the front is prevented from affecting the aperture of the subsequent lenses. Preferably, 0.4≤F3/F≤1.65.

In this embodiment, the focal length F4 of the fourth lens and the entire set focal length value F of the optical lens assembly meet: −2.4≤F4/F≤−0.2. By controlling the focal length of the fourth lens with a negative refractive power, an aberration caused by the front lenses with a positive refractive power may be corrected, thereby realizing high resolution. Preferably, −2≤F4/F≤−0.25.

In this embodiment, the focal length F8 of the eighth lens and the entire set focal length value F of the optical lens assembly meet: −3.2≤F8/F≤−0.5. The eighth lens has a negative refractive power. By controlling a ratio of the focal length of the eighth lens to the entire set focal length value of the optical lens assembly, the convergence of the light rays in the front is smoothed, such that the light rays may smoothly enter the imaging surface, and the aberration is balanced, thereby realizing high resolution and obtaining a required principal light ray angle. Preferably, −3≤F8/F≤−0.6.

In this embodiment, the focal length F1 of the first lens and the entire set focal length value F of the optical lens assembly meet: 1.05≤F1/F≤2.8. By controlling the ratio of the focal length of the first lens to the entire set focal length value of the optical lens assembly, the first lens may effectively collect the light rays with a small aperture and allow the light rays to enter the optical lens assembly, thereby avoiding the introduction of an aberration of a large field of view angle. Preferably, 1.2≤F1/F≤2.5.

In this embodiment, as shown in FIG. 43, each of lenses of the optical lens assembly meets the followings: when the first-side surface of one of the lenses is a convex surface or a second-side surface of the one of the lenses is a concave surface, a sagittal height Sag(D/2)/n of the lens at one-nth of an optical axis and a sagittal height Sag(D/2)/(n+1) of the one of the lenses at one-(n+1)th of the optical axis meet: Sag(D/2)/n>Sag(D/2)/(n+1), where n≥1; and when the first-side surface of the one of the lenses is the concave surface or the second-side surface is the convex surface, a sagittal height Sag(D/2)/n of the one of the lenses at one-nth of an optical axis and a sagittal height Sag(D/2)/(n+1) of the one of the lenses at one-(n+1)th of the optical axis meet: Sag(D/2)/n>Sag(D/2)/(n+1), where n≥1. By controlling the sagittal height of each of lenses of the optical lens assembly to vary monotonically with the increasing of the apertures on both sides of the lens, a surface type of the lens changes subtly when the optical lens assembly is subject to high and low temperature changes, such that the change in focal length is stable, thereby realizing stable imaging under high and low temperature changes.

In an embodiment, the optical lens assembly may further include an optical filter for correcting color deviation and protective glass for protecting a photosensitive element on an imaging surface.

In the optical lens assembly, the maximum field of view FOV and H of the optical lens assembly are associated, and a FOV corresponding to an image height is used. The total optical length of the optical lens assembly refers to a distance from the first-side surface of the first lens to the imaging surface of the optical lens assembly on the optical axis.

The optical lens assembly in the disclosure may use a plurality of lenses, for example, the above eight lenses. The disclosure does not specifically limit the specific number of spherical lenses and aspheric lenses, and the number of the aspheric lenses may be increased when the focus is on imaging quality. An aspheric lens has a characteristic that a curvature keeps changing from the center of the lens to the periphery of the lens. Unlike a spherical lens with a constant curvature from the center of the lens to the periphery of the lens, the aspheric lens has the characteristic of a better curvature radius and the advantages of improving distortions and improving astigmatic aberrations. By using the aspheric lens, aberrations during imaging may be eliminated as much as possible, thereby improving the imaging quality.

In an exemplary implementation, in this solution, whether the lens is made of plastic or glass is not limited, and if the focus is on temperature performance, the first lens, the second lens, the third lens, the fourth lens, the fifth lens, the sixth lens, the seventh lens and the eighth lens may all be glass lenses. The optical lens assembly made of glass may inhibit a back focal length of the optical lens assembly from shifting with temperature changes, thereby improving the stability of the system. Meanwhile, the use of a glass material may avoid the image blurring of the lens caused by high and low temperature changes in an environment used, affecting the normal use of the optical lens assembly. For example, the all-glass design of the optical lens assembly has a wide temperature range and may maintain stable optical performance within a range of −40° C.-105° C. Specifically, when the focus is on resolution quality and reliability, the first lens to the eighth lens may all be glass aspheric lenses. Definitely, in an application scenario with a low requirement for temperature stability, the first lens to the eighth lens in the optical lens assembly may also be made of plastic. Manufacturing costs may be effectively reduced by using plastic to manufacture the optical lens assembly. Definitely, the first lens to the eighth lens in the optical lens assembly may also be made by a combination of plastic and glass.

The disclosure further provides an electronic device, including the optical lens assembly and an imaging element for converting an optical image formed by the optical lens assembly into an electrical signal. The imaging element may be a Charge-Coupled Device (CCD) or a Complementary Metal Oxide Semiconductor (CMOS). The electronic device may be an independent imaging device such as a digital camera, and may also be an imaging module which is integrated on a mobile electronic device such as a mobile phone. The electronic device is provided with the optical lens assembly described above.

However, a person skilled in the art should know that the number of the lenses forming the optical lens assembly may be changed without departing from the technical solutions claimed in the disclosure to achieve each result and advantage described in the specification. For example, although descriptions are made in the implementation with eight lenses as an example, the optical lens assembly is not limited to eight lenses. If necessary, the optical lens assembly may further include another number of lenses.

Examples of specific surface types and parameters of the optical lens assembly applicable to the above-mentioned implementation mode will further be described below with reference to the drawings.

### Example 13

As shown in FIG. 13, an optical lens assembly sequentially includes from a first side to a second side: a first lens L1, a second lens L2, a diaphragm STO, a third lens L3, a fourth lens L4, a fifth lens L5, a sixth lens L6, a seventh lens L7, an eighth lens L8, an optical filter, protective glass, and an imaging surface IMA.

The first lens L1 has a positive refractive power; and a first-side surface S1 of the first lens is a convex surface, and a second-side surface S2 of the first lens is a concave surface. The second lens L2 has a negative refractive power; and a first-side surface S3 of the second lens is a convex surface, and a second-side surface S4 of the second lens is a concave surface. The third lens L3 has a positive refractive power; and a first-side surface S6 of the third lens is a concave surface, and a second-side surface S7 of the third lens is a convex surface. The fourth lens L4 has a negative refractive power; and a first-side surface S7 of the fourth lens is a concave surface, and a second-side surface S8 of the fourth lens is a convex surface. The fifth lens L5 has a positive refractive power; and a first-side surface S9 of the fifth lens is a convex surface, and a second-side surface S10 of the fifth lens is a convex surface. The sixth lens L6 has a positive refractive power; and a first-side surface S11 of the sixth lens is a convex surface, and a second-side surface S12 of the sixth lens is a convex surface. The seventh lens L7 has a negative refractive power; and a first-side surface S12 of the seventh lens is a concave surface, and a second-side surface S13 of the seventh lens is a convex surface. The eighth lens L8 has a negative refractive power; and a first-side surface S14 of the eighth lens is a concave surface, and a second-side surface S15 of the eighth lens is a concave surface. The optical filter has a first-side surface S16 of the optical filter and a second-side surface S17 of the optical filter; and the protective glass has a first-side surface S18 of the protective glass and a second-side surface S19 of the protective glass. Light from an object passes through various surfaces S1 to S19 in sequence, and is finally imaged on the imaging surface IMA.

In this example, an entire set focal length value F of the optical lens assembly is 15.3688 mm, a total optical length TTL of the optical lens assembly is 32.5552 mm, and a maximum field of view FOV of the optical lens assembly is 34.3857°.

In this example, the third lens and the fourth lens are cemented lenses, such that the second-side surface of the third lens and the first-side surface of the fourth lens both are S7; and the sixth lens and the seventh lens are cemented lenses, such that the second-side surface of the sixth lens and the first-side surface of the seventh lens both are S12. However, for the first-side surface and the second-side surface, when curvature radii are the same, the surface shapes of the two side surfaces are different, such that the second-side surface S7 of the third lens is a convex surface, and the first-side surface S7 of the fourth lens is a concave surface; and the second-side surface S12 of the sixth lens is a convex surface, and the first-side surface S12 of the seventh lens is a concave surface.

It is to be noted that, i in the curvature radius Ri of each lens refers to a surface number of the surface of the lens.

Table 15 shows a basic structure parameter table of the optical lens assembly in Example 13, where curvature radius, and thickness/distance are all in millimeters (mm). Surf is a surface number of a lens, Nd is a refractive index, Vd is an abbe number, and Infinity means infinite.

TABLE 15

| Surface | Curvature | Thickness/ | Refractive | Abbe |
|---|---|---|---|---|
| S1 | 15.1000 | 1.9000 | 1.80 | 46.57 |
| S2 | 30.0000 | 0.1000 | | |
| S3 | 7.5000 | 1.5000 | 1.85 | 23.78 |
| S4 | 5.9000 | 1.5000 | | |
| STO | Infinity | 2.2000 | | |
| S6 | −13.3000 | 2.2000 | 1.69 | 54.82 |
| S7 | −6.3000 | 3.4000 | 1.91 | 35.25 |
| S8 | −14.2170 | 0.1000 | | |
| S9 | 14.0000 | 6.0000 | 1.57 | 71.30 |
| S10 | −20.0000 | 0.6000 | | |
| S11 | 30.0000 | 3.0000 | 1.70 | 55.53 |
| S12 | −10.2000 | 4.0000 | 1.69 | 31.16 |
| S13 | −44.0000 | 1.3000 | | |
| S14 | −8.6000 | 0.8000 | 1.49 | 70.44 |
| S15 | 24.0000 | 0.9000 | | |
| S16 | Infinity | 0.5000 | 1.52 | 64.20 |
| S17 | Infinity | 1.9302 | | |
| S18 | Infinity | 0.5000 | 1.52 | 64.20 |
| S19 | Infinity | 0.1250 | | |
| IMA | / | / | | |

### Example 14

As shown in FIG. 14, an optical lens assembly sequentially includes from a first side to a second side: a first lens L1, a second lens L2, a diaphragm STO, a third lens L3, a fourth lens L4, a fifth lens L5, a sixth lens L6, a seventh lens L7, an eighth lens L8, an optical filter, protective glass, and an imaging surface IMA.

The first lens L1 has a positive refractive power; and a first-side surface S1 of the first lens is a convex surface, and a second-side surface S2 of the first lens is a concave surface. The second lens L2 has a negative refractive power; and a first-side surface S3 of the second lens is a convex surface, and a second-side surface S4 of the second lens is a concave surface. The third lens L3 has a positive refractive power; and a first-side surface S6 of the third lens is a concave surface, and a second-side surface S7 of the third lens is a convex surface. The fourth lens L4 has a negative refractive power; and a first-side surface S7 of the fourth lens is a concave surface, and a second-side surface S8 of the fourth lens is a convex surface. The fifth lens L5 has a positive refractive power; and a first-side surface S9 of the fifth lens is a convex surface, and a second-side surface S10 of the fifth lens is a convex surface. The sixth lens L6 has a positive refractive power; and a first-side surface S11 of the sixth lens is a convex surface, and a second-side surface S12 of the sixth lens is a convex surface. The seventh lens L7 has a negative refractive power; and a first-side surface S12 of the seventh lens is a concave surface, and a second-side surface S13 of the seventh lens is a convex surface. The eighth lens L8 has a negative refractive power; and a first-side surface S14 of the eighth lens is a concave surface, and a second-side surface S15 of the eighth lens is a concave surface. The optical filter has a first-side surface S16 of the optical filter and a second-side surface S17 of the optical filter; and the protective glass has a first-side surface S18 of the protective glass and a second-side surface S19 of the protective glass. Light from an object passes through various surfaces S1 to S19 in sequence, and is finally imaged on the imaging surface IMA.

In this example, an entire set focal length value F of the optical lens assembly is 15.6134 mm, a total optical length TTL of the optical lens assembly is 32.9843 mm, and a maximum field of view FOV of the optical lens assembly is 34.2065°.

In this example, the third lens and the fourth lens are cemented lenses, and the sixth lens and the seventh lens are cemented lenses.

It is to be noted that, i in the curvature radius Ri of each lens refers to a surface number of the surface of the lens.

Table 16 shows a basic structure parameter table of the optical lens assembly in Example 14, where curvature radius, and thickness/distance are all in millimeters (mm). Surf is a surface number of a lens, Nd is a refractive index, Vd is an abbe number, and Infinity means infinite.

TABLE 16

| Surface | Curvature | Thickness/ | Refractive | Abbe |
|---|---|---|---|---|
| number | radius R | distance | index N | number Vd |
| S1 | 13.6800 | 2.5000 | 1.80 | 46.57 |
| S2 | 26.0000 | 0.1000 | | |
| S3 | 7.6000 | 1.4000 | 1.85 | 23.78 |
| S4 | 5.9000 | 1.6000 | | |
| STO | Infinity | 1.5000 | | |
| S6 | −12.3000 | 4.6000 | 1.69 | 54.82 |
| S7 | −6.4000 | 2.1000 | 1.91 | 35.25 |
| S8 | −14.2000 | 0.1000 | | |
| S9 | 14.2200 | 4.3000 | 1.57 | 71.30 |
| S10 | −20.6000 | 1.5900 | | |
| S11 | 29.5100 | 2.9000 | 1.70 | 55.53 |
| S12 | −11.5000 | 4.0500 | 1.69 | 31.16 |
| S13 | −31.3000 | 1.2000 | | |
| S14 | −9.1000 | 0.9000 | 1.49 | 70.44 |
| S15 | 20.3000 | 0.9000 | | |
| S16 | Infinity | 0.5000 | 1.52 | 64.20 |
| S17 | Infinity | 2.1193 | | |
| S18 | Infinity | 0.5000 | 1.52 | 64.20 |
| S19 | Infinity | 0.1250 | | |
| IMA | / | / | | |

### Example 15

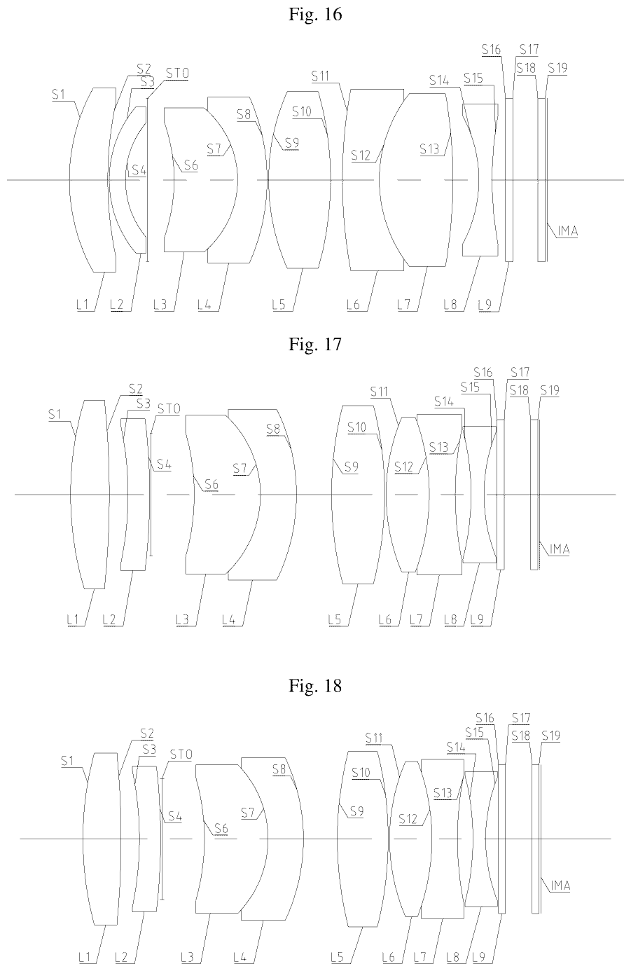

As shown in FIG. 15, an optical lens assembly sequentially includes from a first side to a second side: a first lens L1, a second lens L2, a diaphragm STO, a third lens L3, a fourth lens L4, a fifth lens L5, a sixth lens L6, a seventh lens L7, an eighth lens L8, an optical filter, protective glass, and an imaging surface IMA.

The first lens L1 has a positive refractive power; and a first-side surface S1 of the first lens is a convex surface, and a second-side surface S2 of the first lens is a concave surface. The second lens L2 has a negative refractive power; and a first-side surface S3 of the second lens is a convex surface, and a second-side surface S4 of the second lens is a concave surface. The third lens L3 has a positive refractive power; and a first-side surface S6 of the third lens is a concave surface, and a second-side surface S7 of the third lens is a convex surface. The fourth lens L4 has a negative refractive power; and a first-side surface S7 of the fourth lens is a concave surface, and a second-side surface S8 of the fourth lens is a convex surface. The fifth lens L5 has a positive refractive power; and a first-side surface S9 of the fifth lens is a convex surface, and a second-side surface S10 of the fifth lens is a convex surface. The sixth lens L6 has a negative refractive power; and a first-side surface S11 of the sixth lens is a convex surface, and a second-side surface S12 of the sixth lens is a concave surface. The seventh lens L7 has a positive refractive power; and a first-side surface S12 of the seventh lens is a convex surface, and a second-side surface S13 of the seventh lens is a convex surface. The eighth lens L8 has a negative refractive power; and a first-side surface S14 of the eighth lens is a concave surface, and a second-side surface S15 of the eighth lens is a concave surface. The optical filter has a first-side surface S16 of the optical filter and a second-side surface S17 of the optical filter; and the protective glass has a first-side surface S18 of the protective glass and a second-side surface S19 of the protective glass. Light from an object passes through various surfaces S1 to S19 in sequence, and is finally imaged on the imaging surface IMA.

In this example, an entire set focal length value F of the optical lens assembly is 15.4469 mm, a total optical length TTL of the optical lens assembly is 32.4494 mm, and a maximum field of view FOV of the optical lens assembly is 34.4283°.

In this example, the third lens and the fourth lens are cemented lenses, and the sixth lens and the seventh lens are cemented lenses.

It is to be noted that, i in the curvature radius Ri of each lens refers to a surface number of the surface of the lens.

Table 17 shows a basic structure parameter table of the optical lens assembly in Example 15, where curvature radius, and thickness/distance are all in millimeters (mm). Surf is a surface number of a lens, Nd is a refractive index, Vd is an abbe number, and Infinity means infinite.

TABLE 17

| Surface | Curvature | Thickness/ | Refractive | Abbe |
|---|---|---|---|---|
| number | radius R | distance | index N | number Vd |
| S1 | 12.5000 | 2.6000 | 1.80 | 46.57 |
| S2 | 25.7000 | 0.1000 | | |
| S3 | 7.6000 | 1.2000 | 1.85 | 23.78 |
| S4 | 5.9000 | 1.5000 | | |
| STO | Infinity | 2.0000 | | |
| S6 | −10.9000 | 4.3000 | 1.69 | 54.82 |
| S7 | −6.1000 | 1.6000 | 1.91 | 35.25 |
| S8 | −13.0550 | 0.1000 | | |
| S9 | 16.0000 | 4.3000 | 1.57 | 71.30 |
| S10 | −18.0000 | 0.8000 | | |
| S11 | 30.0000 | 3.2500 | 1.69 | 31.16 |
| S12 | 9.1000 | 4.9000 | 1.70 | 55.53 |
| S13 | −30.0000 | 1.2000 | | |
| S14 | −9.5000 | 0.9000 | 1.49 | 70.44 |
| S15 | 18.6000 | 0.9000 | | |
| S16 | Infinity | 0.5000 | 1.52 | 64.20 |
| S17 | Infinity | 1.6744 | | |
| S18 | Infinity | 0.5000 | 1.52 | 64.20 |
| S19 | Infinity | 0.1250 | | |
| IMA | / | / | | |

### Example 16

As shown in FIG. 16, an optical lens assembly sequentially includes from a first side to a second side: a first lens L1, a second lens L2, a diaphragm STO, a third lens L3, a fourth lens L4, a fifth lens L5, a sixth lens L6, a seventh lens L7, an eighth lens L8, an optical filter, protective glass, and an imaging surface IMA.

The first lens L1 has a positive refractive power; and a first-side surface S1 of the first lens is a convex surface, and a second-side surface S2 of the first lens is a concave surface. The second lens L2 has a negative refractive power; and a first-side surface S3 of the second lens is a convex surface, and a second-side surface S4 of the second lens is a concave surface. The third lens L3 has a positive refractive power; and a first-side surface S6 of the third lens is a concave surface, and a second-side surface S7 of the third lens is a convex surface. The fourth lens L4 has a negative refractive power; and a first-side surface S7 of the fourth lens is a concave surface, and a second-side surface S8 of the fourth lens is a convex surface. The fifth lens L5 has a positive refractive power; and a first-side surface S9 of the fifth lens is a convex surface, and a second-side surface S10 of the fifth lens is a convex surface. The sixth lens L6 has a negative refractive power; and a first-side surface S11 of the sixth lens is a convex surface, and a second-side surface S12 of the sixth lens is a concave surface. The seventh lens L7 has a positive refractive power; and a first-side surface S12 of the seventh lens is a convex surface, and a second-side surface S13 of the seventh lens is a convex surface. The eighth lens L8 has a negative refractive power; and a first-side surface S14 of the eighth lens is a concave surface, and a second-side surface S15 of the eighth lens is a concave surface. The optical filter has a first-side surface S16 of the optical filter and a second-side surface S17 of the optical filter; and the protective glass has a first-side surface S18 of the protective glass and a second-side surface S19 of the protective glass. Light from an object passes through various surfaces S1 to S19 in sequence, and is finally imaged on the imaging surface IMA.

In this example, an entire set focal length value F of the optical lens assembly is 15.4545 mm, a total optical length TTL of the optical lens assembly is 32.3781 mm, and a maximum field of view FOV of the optical lens assembly is 34.4446°.

In this example, the third lens and the fourth lens are cemented lenses, and the sixth lens and the seventh lens are cemented lenses.

It is to be noted that, i in the curvature radius Ri of each lens refers to a surface number of the surface of the lens.

Table 18 shows a basic structure parameter table of the optical lens assembly in Example 16, where curvature radius, and thickness/distance are all in millimeters (mm). Surf is a surface number of a lens, Nd is a refractive index, Vd is an abbe number, and Infinity means infinite.

TABLE 18

| Surface | Curvature | Thickness/ | Refractive | Abbe |
|---|---|---|---|---|
| number | radius R | distance | index N | number Vd |
| S1 | 12.6000 | 2.6000 | 1.80 | 46.57 |
| S2 | 24.7000 | 0.1000 | | |
| S3 | 7.6000 | 1.1000 | 1.85 | 23.78 |
| S4 | 6.0000 | 1.5000 | | |
| STO | Infinity | 1.8000 | | |
| S6 | −11.6000 | 4.3000 | 1.69 | 54.82 |
| S7 | −6.3000 | 2.0000 | 1.91 | 35.25 |
| S8 | −13.6560 | 0.1000 | | |
| S9 | 14.6000 | 4.2000 | 1.57 | 71.30 |
| S10 | −21.7000 | 0.8000 | | |
| S11 | 32.9000 | 2.5000 | 1.69 | 31.16 |
| S12 | 9.3000 | 5.0000 | 1.70 | 55.53 |
| S13 | −33.2000 | 1.7500 | | |
| S14 | −9.0000 | 0.9000 | 1.49 | 70.44 |
| S15 | 23.9000 | 0.9000 | | |
| S16 | Infinity | 0.5000 | 1.52 | 64.20 |
| S17 | Infinity | 1.7031 | | |
| S18 | Infinity | 0.5000 | 1.52 | 64.20 |
| S19 | Infinity | 0.1250 | | |
| IMA | / | / | | |

### Example 17

As shown in Fig. XVII, an optical lens assembly sequentially includes from a first side to a second side: a first lens L1, a second lens L2, a diaphragm STO, a third lens L3, a fourth lens L4, a fifth lens L5, a sixth lens L6, a seventh lens L7, an eighth lens L8, an optical filter, protective glass, and an imaging surface IMA.

The first lens L1 has a positive refractive power; and a first-side surface S1 of the first lens is a convex surface, and a second-side surface S2 of the first lens is a convex surface. The second lens L2 has a negative refractive power; and a first-side surface S3 of the second lens is a concave surface, and a second-side surface S4 of the second lens is a convex surface. The third lens L3 has a positive refractive power; and a first-side surface S6 of the third lens is a concave surface, and a second-side surface S7 of the third lens is a convex surface. The fourth lens L4 has a negative refractive power; and a first-side surface S7 of the fourth lens is a concave surface, and a second-side surface S8 of the fourth lens is a convex surface. The fifth lens L5 has a positive refractive power; and a first-side surface S9 of the fifth lens is a convex surface, and a second-side surface S10 of the fifth lens is a convex surface. The sixth lens L6 has a positive refractive power; and a first-side surface S11 of the sixth lens is a convex surface, and a second-side surface S12 of the sixth lens is a concave surface. The seventh lens L7 has a negative refractive power; and a first-side surface S12 of the seventh lens is a concave surface, and a second-side surface S13 of the seventh lens is a concave surface. The eighth lens L8 has a negative refractive power; and a first-side surface S14 of the eighth lens is a concave surface, and a second-side surface S15 of the eighth lens is a concave surface. The optical filter has a first-side surface S16 of the optical filter and a second-side surface S17 of the optical filter; and the protective glass has a first-side surface S18 of the protective glass and a second-side surface S19 of the protective glass. Light from an object passes through various surfaces S1 to S19 in sequence, and is finally imaged on the imaging surface IMA.

In this example, an entire set focal length value F of the optical lens assembly is 15.3972 mm, a total optical length TTL of the optical lens assembly is 32.5937 mm, and a maximum field of view FOV of the optical lens assembly is 34.3828°.

In this example, the third lens and the fourth lens are cemented lenses, and the sixth lens and the seventh lens are cemented lenses.

It is to be noted that, i in the curvature radius Ri of each lens refers to a surface number of the surface of the lens.

Table 19 shows a basic structure parameter table of the optical lens assembly in Example 17, where curvature radius, and thickness/distance are all in millimeters (mm). Surf is a surface number of a lens, Nd is a refractive index, Vd is an abbe number, and Infinity means infinite.

TABLE 19

| Surface | Curvature | Thickness/ | Refractive | Abbe |
|---|---|---|---|---|
| number | radius R | distance | index N | number Vd |
| S1 | 23.0000 | 2.7000 | 1.80 | 46.57 |
| S2 | −63.0000 | 1.3000 | | |
| S3 | −23.0000 | 1.5000 | 1.85 | 23.78 |
| S4 | −43.0000 | 0.1000 | | |
| STO | Infinity | 3.0000 | | |
| S6 | −15.7000 | 4.6000 | 1.69 | 54.82 |
| S7 | −7.5000 | 2.5000 | 1.91 | 35.25 |
| S8 | −13.5220 | 2.4300 | | |
| S9 | 25.0000 | 3.7000 | 1.57 | 71.30 |
| S10 | −25.0000 | 0.1000 | | |
| S11 | 13.8000 | 3.0000 | 1.70 | 55.53 |
| S12 | −15.4000 | 1.8000 | 1.69 | 31.16 |
| S13 | 23.0000 | 1.1000 | | |
| S14 | −18.0000 | 0.9000 | 1.49 | 70.44 |
| S15 | 11.7000 | 0.9000 | | |
| S16 | Infinity | 0.5000 | 1.52 | 64.20 |
| S17 | Infinity | 1.8387 | | |
| S18 | Infinity | 0.5000 | 1.52 | 64.20 |
| S19 | Infinity | 0.1250 | | |
| IMA | / | / | | |

### Example 18

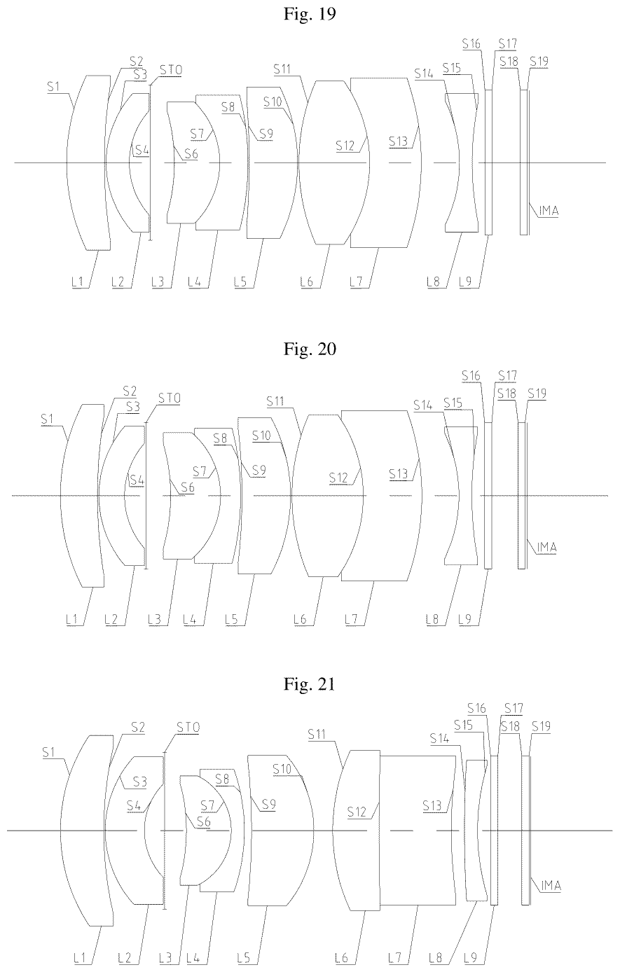

As shown in FIG. 18, an optical lens assembly sequentially includes from a first side to a second side: a first lens L1, a second lens L2, a diaphragm STO, a third lens L3, a fourth lens L4, a fifth lens L5, a sixth lens L6, a seventh lens L7, an eighth lens L8, an optical filter, protective glass, and an imaging surface IMA.

The first lens L1 has a positive refractive power; and a first-side surface S1 of the first lens is a convex surface, and a second-side surface S2 of the first lens is a convex surface. The second lens L2 has a negative refractive power; and a first-side surface S3 of the second lens is a concave surface, and a second-side surface S4 of the second lens is a convex surface. The third lens L3 has a positive refractive power; and a first-side surface S6 of the third lens is a concave surface, and a second-side surface S7 of the third lens is a convex surface. The fourth lens L4 has a negative refractive power; and a first-side surface S7 of the fourth lens is a concave surface, and a second-side surface S8 of the fourth lens is a convex surface. The fifth lens L5 has a positive refractive power; and a first-side surface S9 of the fifth lens is a convex surface, and a second-side surface S10 of the fifth lens is a convex surface. The sixth lens L6 has a positive refractive power; and a first-side surface S11 of the sixth lens is a convex surface, and a second-side surface S12 of the sixth lens is a convex surface. The seventh lens L7 has a negative refractive power; and a first-side surface S12 of the seventh lens is a concave surface, and a second-side surface S13 of the seventh lens is a concave surface. The eighth lens L8 has a negative refractive power; and a first-side surface S14 of the eighth lens is a concave surface, and a second-side surface S15 of the eighth lens is a concave surface. The optical filter has a first-side surface S16 of the optical filter and a second-side surface S17 of the optical filter; and the protective glass has a first-side surface S18 of the protective glass and a second-side surface S19 of the protective glass. Light from an object passes through various surfaces S1 to S19 in sequence, and is finally imaged on the imaging surface IMA.

In this example, an entire set focal length value F of the optical lens assembly is 15.3928 mm, a total optical length TTL of the optical lens assembly is 32.4082 mm, and a maximum field of view FOV of the optical lens assembly is 34.3825°.

In this example, the third lens and the fourth lens are cemented lenses, and the sixth lens and the seventh lens are cemented lenses.

It is to be noted that, i in the curvature radius Ri of each lens refers to a surface number of the surface of the lens.

Table 20 shows a basic structure parameter table of the optical lens assembly in Example 18, where curvature radius, and thickness/distance are all in millimeters (mm). Surf is a surface number of a lens, Nd is a refractive index, Vd is an abbe number, and Infinity means infinite.

TABLE 20

| Surface | Curvature | Thickness/ | Refractive | Abbe |
|---|---|---|---|---|
| number | radius R | distance | index N | number Vd |
| S1 | 23.0000 | 2.7000 | 1.80 | 46.57 |
| S2 | −63.0000 | 1.3000 | | |
| S3 | −23.0000 | 1.5000 | 1.85 | 23.78 |
| S4 | −43.0000 | 0.1000 | | |
| STO | Infinity | 3.0000 | | |
| S6 | −15.6000 | 4.5000 | 1.69 | 54.82 |
| S7 | −7.5000 | 2.5000 | 1.91 | 35.25 |
| S8 | −13.4550 | 2.4000 | | |
| S9 | 25.0000 | 3.6000 | 1.57 | 71.30 |
| S10 | −25.3000 | 0.1000 | | |
| S11 | 13.8000 | 3.0000 | 1.70 | 55.53 |
| S12 | −15.2000 | 1.8000 | 1.69 | 31.16 |
| S13 | 23.0000 | 1.1000 | | |
| S14 | −18.0000 | 0.9000 | 1.49 | 70.44 |
| S15 | 11.8000 | 0.9000 | | |
| S16 | Infinity | 0.5000 | 1.52 | 64.20 |
| S17 | Infinity | 1.8832 | | |
| S18 | Infinity | 0.5000 | 1.52 | 64.20 |
| S19 | Infinity | 0.1250 | | |
| IMA | / | / | | |

### Example 19

As shown in FIG. 19, an optical lens assembly sequentially includes from a first side to a second side: a first lens L1, a second lens L2, a diaphragm STO, a third lens L3, a fourth lens L4, a fifth lens L5, a sixth lens L6, a seventh lens L7, an eighth lens L8, an optical filter, protective glass, and an imaging surface IMA.

The first lens L1 has a positive refractive power; and a first-side surface S1 of the first lens is a convex surface, and a second-side surface S2 of the first lens is a concave surface. The second lens L2 has a negative refractive power; and a first-side surface S3 of the second lens is a convex surface, and a second-side surface S4 of the second lens is a concave surface. The third lens L3 has a positive refractive power; and a first-side surface S6 of the third lens is a concave surface, and a second-side surface S7 of the third lens is a convex surface. The fourth lens L4 has a negative refractive power; and a first-side surface S7 of the fourth lens is a concave surface, and a second-side surface S8 of the fourth lens is a convex surface. The fifth lens L5 has a positive refractive power; and a first-side surface S9 of the fifth lens is a concave surface, and a second-side surface S10 of the fifth lens is a convex surface. The sixth lens L6 has a positive refractive power; and a first-side surface S11 of the sixth lens is a convex surface, and a second-side surface S12 of the sixth lens is a convex surface. The seventh lens L7 has a negative refractive power; and a first-side surface S12 of the seventh lens is a concave surface, and a second-side surface S13 of the seventh lens is a convex surface. The eighth lens L8 has a negative refractive power; and a first-side surface S14 of the eighth lens is a concave surface, and a second-side surface S15 of the eighth lens is a concave surface. The optical filter has a first-side surface S16 of the optical filter and a second-side surface S17 of the optical filter; and the protective glass has a first-side surface S18 of the protective glass and a second-side surface S19 of the protective glass. Light from an object passes through various surfaces S1 to S19 in sequence, and is finally imaged on the imaging surface IMA.

In this example, an entire set focal length value F of the optical lens assembly is 15.6091 mm, a total optical length TTL of the optical lens assembly is 32.6947 mm, and a maximum field of view FOV of the optical lens assembly is 34.504°.

In this example, the third lens and the fourth lens are cemented lenses, and the sixth lens and the seventh lens are cemented lenses.

It is to be noted that, i in the curvature radius Ri of each lens refers to a surface number of the surface of the lens.

Table 21 shows a basic structure parameter table of the optical lens assembly in Example 19, where curvature radius, and thickness/distance are all in millimeters (mm). Surf is a surface number of a lens, Nd is a refractive index, Vd is an abbe number, and Infinity means infinite.

TABLE 21

| Surface | Curvature | Thickness/ | Refractive | Abbe |
|---|---|---|---|---|
| number | radius R | distance | index N | number Vd |
| S1 | 14.1750 | 2.6700 | 1.80 | 46.57 |
| S2 | 36.0000 | 0.1250 | | |
| S3 | 7.3000 | 1.6300 | 1.85 | 23.78 |
| S4 | 5.5000 | 1.5000 | | |
| STO | Infinity | 1.7000 | | |
| S6 | −13.0000 | 3.2000 | 1.69 | 54.82 |
| S7 | −6.0000 | 2.0000 | 1.91 | 35.25 |
| S8 | −19.3740 | 0.1000 | | |
| S9 | −50.0000 | 3.4000 | 1.57 | 71.30 |
| S10 | −12.0000 | 0.1000 | | |
| S11 | 14.5000 | 5.0000 | 1.70 | 55.53 |
| S12 | −10.0000 | 3.6500 | 1.69 | 31.16 |
| S13 | −18.0000 | 2.7000 | | |
| S14 | −10.0000 | 0.9000 | 1.49 | 70.44 |
| S15 | 22.0000 | 0.9000 | | |
| S16 | Infinity | 0.5000 | 1.52 | 64.20 |
| S17 | Infinity | 1.9947 | | |
| S18 | Infinity | 0.5000 | 1.52 | 64.20 |
| S19 | Infinity | 0.1250 | | |
| IMA | / | / | | |

### Example 20

As shown in FIG. 20, an optical lens assembly sequentially includes from a first side to a second side: a first lens L1, a second lens L2, a diaphragm STO, a third lens L3, a fourth lens L4, a fifth lens L5, a sixth lens L6, a seventh lens L7, an eighth lens L8, an optical filter, protective glass, and an imaging surface IMA.

The first lens L1 has a positive refractive power; and a first-side surface S1 of the first lens is a convex surface, and a second-side surface S2 of the first lens is a concave surface. The second lens L2 has a negative refractive power; and a first-side surface S3 of the second lens is a convex surface, and a second-side surface S4 of the second lens is a concave surface. The third lens L3 has a positive refractive power; and a first-side surface S6 of the third lens is a concave surface, and a second-side surface S7 of the third lens is a convex surface. The fourth lens L4 has a negative refractive power; and a first-side surface S7 of the fourth lens is a concave surface, and a second-side surface S8 of the fourth lens is a convex surface. The fifth lens L5 has a positive refractive power; and a first-side surface S9 of the fifth lens is a concave surface, and a second-side surface S10 of the fifth lens is a convex surface. The sixth lens L6 has a positive refractive power; and a first-side surface S11 of the sixth lens is a convex surface, and a second-side surface S12 of the sixth lens is a convex surface. The seventh lens L7 has a negative refractive power; and a first-side surface S12 of the seventh lens is a concave surface, and a second-side surface S13 of the seventh lens is a convex surface. The eighth lens L8 has a negative refractive power; and a first-side surface S14 of the eighth lens is a concave surface, and a second-side surface S15 of the eighth lens is a concave surface. The optical filter has a first-side surface S16 of the optical filter and a second-side surface S17 of the optical filter; and the protective glass has a first-side surface S18 of the protective glass and a second-side surface S19 of the protective glass. Light from an object passes through various surfaces S1 to S19 in sequence, and is finally imaged on the imaging surface IMA.

In this example, an entire set focal length value F of the optical lens assembly is 15.5795 mm, a total optical length TTL of the optical lens assembly is 32.6957 mm, and a maximum field of view FOV of the optical lens assembly is 34.5281°.

In this example, the third lens and the fourth lens are cemented lenses, and the sixth lens and the seventh lens are cemented lenses.

It is to be noted that, i in the curvature radius Ri of each lens refers to a surface number of the surface of the lens.

Table 22 shows a basic structure parameter table of the optical lens assembly in Example 20, where curvature radius, and thickness/distance are all in millimeters (mm). Surf is a surface number of a lens, Nd is a refractive index, Vd is an abbe number, and Infinity means infinite.

TABLE 22

| Surface | Curvature | Thickness/ | Refractive | Abbe |
|---|---|---|---|---|
| number | radius R | distance | index N | number Vd |
| S1 | 14.0000 | 2.6000 | 1.80 | 46.57 |
| S2 | 34.0000 | 0.1000 | | |
| S3 | 7.4000 | 1.8000 | 1.85 | 23.78 |
| S4 | 5.5000 | 1.5000 | | |
| STO | Infinity | 1.7300 | | |
| S6 | −13.0000 | 3.5000 | 1.69 | 54.82 |
| S7 | −5.8000 | 1.4000 | 1.91 | 35.25 |
| S8 | −18.8600 | 0.1000 | | |
| S9 | −40.0000 | 3.4000 | 1.57 | 71.30 |
| S10 | −11.5000 | 0.1000 | | |
| S11 | 14.1020 | 5.0000 | 1.70 | 55.53 |
| S12 | −9.8000 | 4.1000 | 1.69 | 31.16 |
| S13 | −17.3000 | 2.6000 | | |
| S14 | −10.0000 | 0.9000 | 1.49 | 70.44 |
| S15 | 24.0000 | 0.9000 | | |
| S16 | Infinity | 0.5000 | 1.52 | 64.20 |
| S17 | Infinity | 1.8407 | | |
| S18 | Infinity | 0.5000 | 1.52 | 64.20 |
| S19 | Infinity | 0.1250 | | |
| IMA | / | / | | |

### Example 21

As shown in FIG. 21, an optical lens assembly sequentially includes from a first side to a second side: a first lens L1, a second lens L2, a diaphragm STO, a third lens L3, a fourth lens L4, a fifth lens L5, a sixth lens L6, a seventh lens L7, an eighth lens L8, an optical filter, protective glass, and an imaging surface IMA.

The first lens L1 has a positive refractive power; and a first-side surface S1 of the first lens is a convex surface, and a second-side surface S2 of the first lens is a concave surface. The second lens L2 has a negative refractive power; and a first-side surface S3 of the second lens is a convex surface, and a second-side surface S4 of the second lens is a concave surface. The third lens L3 has a positive refractive power; and a first-side surface S6 of the third lens is a concave surface, and a second-side surface S7 of the third lens is a convex surface. The fourth lens L4 has a negative refractive power; and a first-side surface S7 of the fourth lens is a concave surface, and a second-side surface S8 of the fourth lens is a convex surface. The fifth lens L5 has a positive refractive power; and a first-side surface S9 of the fifth lens is a concave surface, and a second-side surface S10 of the fifth lens is a convex surface. The sixth lens L6 has a positive refractive power; and a first-side surface S11 of the sixth lens is a convex surface, and a second-side surface S12 of the sixth lens is a concave surface. The seventh lens L7 has a negative refractive power; and a first-side surface S12 of the seventh lens is a convex surface, and a second-side surface S13 of the seventh lens is a concave surface. The eighth lens L8 has a negative refractive power; and a first-side surface S14 of the eighth lens is a convex surface, and a second-side surface S15 of the eighth lens is a concave surface. The optical filter has a first-side surface S16 of the optical filter and a second-side surface S17 of the optical filter; and the protective glass has a first-side surface S18 of the protective glass and a second-side surface S19 of the protective glass. Light from an object passes through various surfaces S1 to S19 in sequence, and is finally imaged on the imaging surface IMA.

In this example, an entire set focal length value F of the optical lens assembly is 15.8227 mm, a total optical length TTL of the optical lens assembly is 32.4859 mm, and a maximum field of view FOV of the optical lens assembly is 34.7606°.

In this example, the third lens and the fourth lens are cemented lenses, and the sixth lens and the seventh lens are cemented lenses.

It is to be noted that, i in the curvature radius Ri of each lens refers to a surface number of the surface of the lens.

Table 23 shows a basic structure parameter table of the optical lens assembly in Example 21, where curvature radius, and thickness/distance are all in millimeters (mm). Surf is a surface number of a lens, Nd is a refractive index, Vd is an abbe number, and Infinity means infinite.

TABLE 23

| Surface | Curvature | Thickness/ | Refractive | Abbe |
|---|---|---|---|---|
| number | radius R | distance | index N | number Vd |
| S1 | 11.7000 | 3.0000 | 1.80 | 46.57 |
| S2 | 25.5000 | 0.1000 | | |
| S3 | 7.5000 | 2.7000 | 1.85 | 23.78 |
| S4 | 4.6000 | 1.4000 | | |
| STO | Infinity | 1.5000 | | |
| S6 | −12.4000 | 3.1000 | 1.69 | 54.82 |
| S7 | −4.2000 | 0.9000 | 1.91 | 35.25 |
| S8 | −12.7500 | 0.5000 | | |
| S9 | −45.0000 | 4.3000 | 1.57 | 71.30 |
| S10 | −8.0000 | 1.3000 | | |
| S11 | 13.0000 | 3.2000 | 1.70 | 55.53 |
| S12 | 170.0000 | 5.0000 | 1.69 | 31.16 |
| S13 | 34.0000 | 0.9000 | | |
| S14 | 80.0000 | 0.9000 | 1.49 | 70.44 |
| S15 | 15.2000 | 0.9000 | | |
| S16 | Infinity | 0.5000 | 1.52 | 64.20 |
| S17 | Infinity | 1.6609 | | |
| S18 | Infinity | 0.5000 | 1.52 | 64.20 |
| S19 | Infinity | 0.1250 | | |
| IMA | / | / | | |

### Example 22

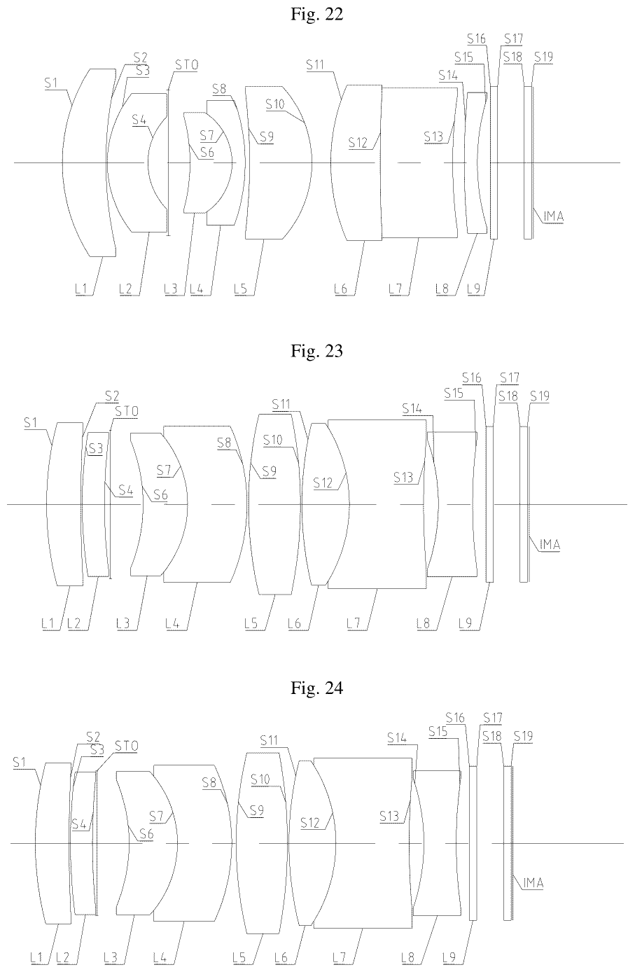

As shown in FIG. 22, an optical lens assembly sequentially includes from a first side to a second side: a first lens L1, a second lens L2, a diaphragm STO, a third lens L3, a fourth lens L4, a fifth lens L5, a sixth lens L6, a seventh lens L7, an eighth lens L8, an optical filter, protective glass, and an imaging surface IMA.

The first lens L1 has a positive refractive power; and a first-side surface S1 of the first lens is a convex surface, and a second-side surface S2 of the first lens is a concave surface. The second lens L2 has a negative refractive power; and a first-side surface S3 of the second lens is a convex surface, and a second-side surface S4 of the second lens is a concave surface. The third lens L3 has a positive refractive power; and a first-side surface S6 of the third lens is a concave surface, and a second-side surface S7 of the third lens is a convex surface. The fourth lens L4 has a negative refractive power; and a first-side surface S7 of the fourth lens is a concave surface, and a second-side surface S8 of the fourth lens is a convex surface. The fifth lens L5 has a positive refractive power; and a first-side surface S9 of the fifth lens is a concave surface, and a second-side surface S10 of the fifth lens is a convex surface. The sixth lens L6 has a positive refractive power; and a first-side surface S11 of the sixth lens is a convex surface, and a second-side surface S12 of the sixth lens is a concave surface. The seventh lens L7 has a negative refractive power; and a first-side surface S12 of the seventh lens is a convex surface, and a second-side surface S13 of the seventh lens is a concave surface. The eighth lens L8 has a negative refractive power; and a first-side surface S14 of the eighth lens is a convex surface, and a second-side surface S15 of the eighth lens is a concave surface. The optical filter has a first-side surface S16 of the optical filter and a second-side surface S17 of the optical filter; and the protective glass has a first-side surface S18 of the protective glass and a second-side surface S19 of the protective glass. Light from an object passes through various surfaces S1 to S19 in sequence, and is finally imaged on the imaging surface IMA.

In this example, an entire set focal length value F of the optical lens assembly is 15.7761 mm, a total optical length TTL of the optical lens assembly is 32.4613 mm, and a maximum field of view FOV of the optical lens assembly is 34.7494°.

In this example, the third lens and the fourth lens are cemented lenses, and the sixth lens and the seventh lens are cemented lenses.

It is to be noted that, i in the curvature radius Ri of each lens refers to a surface number of the surface of the lens.

Table 24 shows a basic structure parameter table of the optical lens assembly in Example 22, where curvature radius, and thickness/distance are all in millimeters (mm). Surf is a surface number of a lens, Nd is a refractive index, Vd is an abbe number, and Infinity means infinite.

TABLE 24

| Surface | Curvature | Thickness/ | Refractive | Abbe |
|---|---|---|---|---|
| number | radius R | distance | index N | number Vd |
| S1 | 11.8000 | 3.0000 | 1.80 | 46.57 |
| S2 | 25.6000 | 0.1000 | | |
| S3 | 7.5000 | 2.8000 | 1.85 | 23.78 |
| S4 | 4.5000 | 1.4000 | | |
| STO | Infinity | 1.5000 | | |
| S6 | −12.2000 | 2.9000 | 1.69 | 54.82 |
| S7 | −4.1000 | 0.9000 | 1.91 | 35.25 |
| S8 | −12.5370 | 0.3000 | | |
| S9 | −41.5000 | 4.3000 | 1.57 | 71.30 |
| S10 | −7.7000 | 1.3000 | | |
| S11 | 13.2000 | 3.4000 | 1.70 | 55.53 |
| S12 | 95.0000 | 5.0000 | 1.69 | 31.16 |
| S13 | 33.0000 | 0.8000 | | |
| S14 | 50.0000 | 0.9000 | 1.49 | 70.44 |
| S15 | 15.2000 | 0.9000 | | |
| S16 | Infinity | 0.5000 | 1.52 | 64.20 |
| S17 | Infinity | 1.8363 | | |
| S18 | Infinity | 0.5000 | 1.52 | 64.20 |
| S19 | Infinity | 0.1250 | | |
| IMA | / | / | | |

### Example 23

As shown in FIG. 23, an optical lens assembly sequentially includes from a first side to a second side: a first lens L1, a second lens L2, a diaphragm STO, a third lens L3, a fourth lens L4, a fifth lens L5, a sixth lens L6, a seventh lens L7, an eighth lens L8, an optical filter, protective glass, and an imaging surface IMA.

The first lens L1 has a positive refractive power; and a first-side surface S1 of the first lens is a convex surface, and a second-side surface S2 of the first lens is a concave surface. The second lens L2 has a negative refractive power; and a first-side surface S3 of the second lens is a convex surface, and a second-side surface S4 of the second lens is a concave surface. The third lens L3 has a positive refractive power; and a first-side surface S6 of the third lens is a concave surface, and a second-side surface S7 of the third lens is a convex surface. The fourth lens L4 has a negative refractive power; and a first-side surface S7 of the fourth lens is a concave surface, and a second-side surface S8 of the fourth lens is a convex surface. The fifth lens L5 has a positive refractive power; and a first-side surface S9 of the fifth lens is a convex surface, and a second-side surface S10 of the fifth lens is a convex surface. The sixth lens L6 has a positive refractive power; and a first-side surface S11 of the sixth lens is a convex surface, and a second-side surface S12 of the sixth lens is a convex surface. The seventh lens L7 has a negative refractive power; and a first-side surface S12 of the seventh lens is a concave surface, and a second-side surface S13 of the seventh lens is a concave surface. The eighth lens L8 has a negative refractive power; and a first-side surface S14 of the eighth lens is a convex surface, and a second-side surface S15 of the eighth lens is a concave surface. The optical filter has a first-side surface S16 of the optical filter and a second-side surface S17 of the optical filter; and the protective glass has a first-side surface S18 of the protective glass and a second-side surface S19 of the protective glass. Light from an object passes through various surfaces S1 to S19 in sequence, and is finally imaged on the imaging surface IMA.

In this example, an entire set focal length value F of the optical lens assembly is 15.4241 mm, a total optical length TTL of the optical lens assembly is 32.5177 mm, and a maximum field of view FOV of the optical lens assembly is 34.4236°.

In this example, the third lens and the fourth lens are cemented lenses, and the sixth lens and the seventh lens are cemented lenses.

It is to be noted that, i in the curvature radius Ri of each lens refers to a surface number of the surface of the lens.

Table 25 shows a basic structure parameter table of the optical lens assembly in Example 23, where curvature radius, and thickness/distance are all in millimeters (mm). Surf is a surface number of a lens, Nd is a refractive index, Vd is an abbe number, and Infinity means infinite.

TABLE 25

| Surface | Curvature | Thickness/ | Refractive | Abbe |
|---|---|---|---|---|
| number | radius R | distance | index N | number Vd |
| S1 | 21.6000 | 2.3000 | 1.80 | 46.57 |
| S2 | 87.0000 | 0.1000 | | |
| S3 | 30.7000 | 1.5000 | 1.85 | 23.78 |
| S4 | 36.0000 | 0.4000 | | |
| STO | Infinity | 2.2000 | | |
| S6 | −11.3000 | 3.0000 | 1.69 | 54.82 |
| S7 | −7.2000 | 4.0000 | 1.91 | 35.25 |
| S8 | −12.8270 | 0.1000 | | |
| S9 | 26.0000 | 3.5000 | 1.57 | 71.30 |
| S10 | −30.0000 | 0.1000 | | |
| S11 | 23.0000 | 3.2000 | 1.70 | 55.53 |
| S12 | −10.0000 | 5.0000 | 1.69 | 31.16 |
| S13 | 54.0000 | 1.0000 | | |
| S14 | −13.0000 | 2.3000 | 1.49 | 70.44 |
| S15 | 33.0000 | 0.9000 | | |
| S16 | Infinity | 0.5000 | 1.52 | 64.20 |
| S17 | Infinity | 1.7927 | | |
| S18 | Infinity | 0.5000 | 1.52 | 64.20 |
| S19 | Infinity | 0.1250 | | |
| IMA | / | / | | |

### Example 24

As shown in FIG. 24, an optical lens assembly sequentially includes from a first side to a second side: a first lens L1, a second lens L2, a diaphragm STO, a third lens L3, a fourth lens L4, a fifth lens L5, a sixth lens L6, a seventh lens L7, an eighth lens L8, an optical filter, protective glass, and an imaging surface IMA.

The first lens L1 has a positive refractive power; and a first-side surface S1 of the first lens is a convex surface, and a second-side surface S2 of the first lens is a concave surface. The second lens L2 has a negative refractive power; and a first-side surface S3 of the second lens is a convex surface, and a second-side surface S4 of the second lens is a concave surface. The third lens L3 has a positive refractive power; and a first-side surface S6 of the third lens is a concave surface, and a second-side surface S7 of the third lens is a convex surface. The fourth lens L4 has a negative refractive power; and a first-side surface S7 of the fourth lens is a concave surface, and a second-side surface S8 of the fourth lens is a convex surface. The fifth lens L5 has a positive refractive power; and a first-side surface S9 of the fifth lens is a convex surface, and a second-side surface S10 of the fifth lens is a convex surface. The sixth lens L6 has a positive refractive power; and a first-side surface S11 of the sixth lens is a convex surface, and a second-side surface S12 of the sixth lens is a convex surface. The seventh lens L7 has a negative refractive power; and a first-side surface S12 of the seventh lens is a concave surface, and a second-side surface S13 of the seventh lens is a concave surface. The eighth lens L8 has a negative refractive power; and a first-side surface S14 of the eighth lens is a convex surface, and a second-side surface S15 of the eighth lens is a concave surface. The optical filter has a first-side surface S16 of the optical filter and a second-side surface S17 of the optical filter; and the protective glass has a first-side surface S18 of the protective glass and a second-side surface S19 of the protective glass. Light from an object passes through various surfaces S1 to S19 in sequence, and is finally imaged on the imaging surface IMA.

In this example, an entire set focal length value F of the optical lens assembly is 15.4144 mm, a total optical length TTL of the optical lens assembly is 32.5676 mm, and a maximum field of view FOV of the optical lens assembly is 34.4262°.

In this example, the third lens and the fourth lens are cemented lenses, and the sixth lens and the seventh lens are cemented lenses.

It is to be noted that, i in the curvature radius Ri of each lens refers to a surface number of the surface of the lens.

Table 26 shows a basic structure parameter table of the optical lens assembly in Example 24, where curvature radius, and thickness/distance are all in millimeters (mm). Surf is a surface number of a lens, Nd is a refractive index, Vd is an abbe number, and Infinity means infinite.

TABLE 26

| Surface | Curvature | Thickness/ | Refractive | Abbe |
|---|---|---|---|---|
| number | radius R | distance | index N | number Vd |
| S1 | 21.2000 | 2.3000 | 1.80 | 46.57 |
| S2 | 91.0000 | 0.1000 | | |
| S3 | 37.0000 | 1.5000 | 1.85 | 23.78 |
| S4 | 44.0000 | 0.3000 | | |
| STO | Infinity | 2.2000 | | |
| S6 | −11.0000 | 3.3000 | 1.69 | 54.82 |
| S7 | −7.2000 | 3.7000 | 1.91 | 35.25 |
| S8 | −12.3720 | 0.3000 | | |
| S9 | 26.0000 | 3.5000 | 1.57 | 71.30 |
| S10 | −33.0000 | 0.1000 | | |
| S11 | 23.0000 | 3.2000 | 1.70 | 55.53 |
| S12 | −10.0000 | 5.0000 | 1.69 | 31.16 |
| S13 | 52.0000 | 1.0000 | | |
| S14 | −13.6000 | 2.2000 | 1.49 | 70.44 |
| S15 | 31.4000 | 0.9000 | | |
| S16 | Infinity | 0.5000 | 1.52 | 64.20 |
| S17 | Infinity | 1.8426 | | |
| S18 | Infinity | 0.5000 | 1.52 | 64.20 |
| S19 | Infinity | 0.1250 | | |
| IMA | / | / | | |

To sum up, Example 13 to Example 24 meet relationships shown in Table 27.

TABLE 27

| | Example | | | | | | | | | | | |
|---|---|---|---|---|---|---|---|---|---|---|---|---|
| Parameter | 13 | 14 | 15 | 16 | 17 | 18 | 19 | 20 | 21 | 22 | 23 | 24 |
| R15/F | 1.5616 | 1.3002 | 1.2041 | 1.5465 | 0.7599 | 0.7666 | 1.4094 | 1.5405 | 0.9606 | 0.9635 | 2.1395 | 2.0371 |
| d67/TTL | 0.1720 | 0.2031 | 0.1818 | 0.1946 | 0.2178 | 0.2160 | 0.1590 | 0.1499 | 0.1231 | 0.1171 | 0.2153 | 0.2149 |
| (F*θ)/D | 0.7964 | 0.7798 | 0.7920 | 0.7975 | 0.7631 | 0.7630 | 0.7645 | 0.7625 | 0.7330 | 0.7274 | 0.8323 | 0.8387 |
| (FOV × F)/H | 57.0779 | 57.7252 | 57.4663 | 57.5249 | 57.2100 | 57.2074 | 58.1798 | 58.1440 | 59.3031 | 59.2115 | 57.3606 | 57.3456 |
| TTL/F | 2.1183 | 2.1126 | 2.1007 | 2.0951 | 2.1169 | 2.1054 | 2.0946 | 2.0986 | 2.0531 | 2.0576 | 2.1082 | 2.1128 |
| TTL/H/FOV | 0.1023 | 0.1042 | 0.1018 | 0.1016 | 0.1024 | 0.1019 | 0.1024 | 0.1024 | 0.1008 | 0.1009 | 0.1021 | 0.1022 |
| F/H | 1.6599 | 1.6876 | 1.6692 | 1.6701 | 1.6639 | 1.6639 | 1.6862 | 1.6840 | 1.7060 | 1.7040 | 1.6663 | 1.6658 |
| (R1/D)/(R2/D2) | 0.4653 | 0.4692 | 0.4301 | 0.4498 | −0.3361 | −0.3361 | 0.3520 | 0.3694 | 0.4046 | 0.4068 | 0.2260 | 0.2119 |
| R9/R10 | −0.7000 | −0.6903 | −0.8889 | −0.6728 | −1.0000 | −0.9881 | 4.1667 | 3.4783 | 5.6250 | 5.3896 | −0.8667 | −0.7879 |
| \|(H − F*θ)/(F*θ)\| | 0.0039 | 0.0074 | 0.0030 | 0.0040 | 0.0015 | 0.0015 | 0.0152 | 0.0145 | 0.0339 | 0.0324 | 0.0011 | 0.0008 |
| F/ENPD | 1.6000 | 1.6000 | 1.6000 | 1.6000 | 1.6000 | 1.6000 | 1.6000 | 1.6000 | 1.6000 | 1.6000 | 1.6000 | 1.6000 |
| D/H/F | 0.0814 | 0.0827 | 0.0820 | 0.0815 | 0.0850 | 0.0850 | 0.0851 | 0.0854 | 0.0892 | 0.0901 | 0.0780 | 0.0774 |
| R10/D9 | −1.7473 | −1.8289 | −1.6229 | −1.9338 | −2.2226 | −2.2499 | −1.2569 | −1.2231 | −0.8461 | −0.8189 | −2.6485 | −2.9026 |
| R10/F | −1.3013 | −1.3194 | −1.1653 | −1.4041 | −1.6237 | −1.6436 | −0.7688 | −0.7381 | −0.5056 | −0.4881 | −1.9450 | −2.1409 |
| R15/TTL | 0.7372 | 0.6154 | 0.5732 | 0.7382 | 0.3590 | 0.3641 | 0.6729 | 0.7340 | 0.4679 | 0.4682 | 1.0148 | 0.9641 |
| R15/BFL | 6.0680 | 4.8983 | 5.0278 | 6.4108 | 3.0282 | 3.0193 | 5.4730 | 6.2084 | 4.1238 | 3.9365 | 8.6439 | 8.1187 |
| BFL/F | 0.2574 | 0.2654 | 0.2395 | 0.2412 | 0.2509 | 0.2539 | 0.2575 | 0.2481 | 0.2330 | 0.2448 | 0.2475 | 0.2509 |
| (R1 + d1)/\|R2\| | 0.5667 | 0.6223 | 0.5875 | 0.6154 | 0.4079 | 0.4079 | 0.4679 | 0.4882 | 0.5765 | 0.5781 | 0.2747 | 0.2582 |
| R31/R42 | 0.9355 | 0.8662 | 0.8349 | 0.8494 | 1.1611 | 1.1594 | 0.6710 | 0.6893 | 0.9725 | 0.9731 | 0.8810 | 0.8891 |
| d67/F | 0.4562 | 0.4458 | 0.5284 | 0.4861 | 0.3121 | 0.3122 | 0.5549 | 0.5848 | 0.5190 | 0.5332 | 0.5323 | 0.5326 |
| \|R61/R72\| | 0.6818 | 0.9428 | 1.0000 | 0.9910 | 0.6000 | 0.6000 | 0.8056 | 0.8151 | 0.3824 | 0.4000 | 0.4259 | 0.4423 |
| R1/F | 0.9840 | 0.8775 | 0.8105 | 0.8166 | 1.4954 | 1.4959 | 0.9093 | 0.8997 | 0.7405 | 0.7490 | 1.4021 | 1.3770 |
| \|R21\|/((R22) + d2) | 1.0135 | 1.0411 | 1.0704 | 1.0704 | 0.5169 | 0.5169 | 1.0238 | 1.0137 | 1.0274 | 1.0274 | 0.8187 | 0.8132 |
| d2/ET2 | 1.1634 | 1.1333 | 1.0989 | 1.0858 | 1.2278 | 1.2276 | 1.1914 | 1.2038 | 1.2382 | 1.2386 | 1.0862 | 1.0715 |
| \|F34/F\| | 0.1657 | 0.2383 | 0.2823 | 0.2498 | 0.0819 | 0.0831 | 0.5851 | 0.6018 | 0.4950 | 0.5086 | 0.0338 | 0.0096 |
| F5/F | 1.0032 | 0.9885 | 1.0071 | 1.0330 | 1.4611 | 1.4689 | 1.7160 | 1.7392 | 1.0335 | 1.0034 | 1.6185 | 1.6888 |
| \|F67/F\| | 1.7097 | 1.4511 | 1.4586 | 1.5889 | 2.5788 | 2.5790 | 0.8242 | 0.8078 | 1.6344 | 1.6940 | 3.2421 | 3.3138 |
| F3/F | 0.9950 | 0.9339 | 0.9459 | 0.9656 | 1.0930 | 1.1018 | 0.8668 | 0.8080 | 0.5011 | 0.4922 | 1.4268 | 1.4375 |
| F4/F | −1.0114 | −0.9351 | −0.9093 | −0.9497 | −1.4894 | −1.5033 | −0.6546 | −0.6185 | −0.4550 | −0.4442 | −1.7598 | −1.8540 |
| F8/F | −0.8359 | −0.8150 | −0.8240 | −0.8577 | −0.9323 | −0.9375 | −0.8924 | −0.9185 | −2.4367 | −2.8555 | −1.2164 | −1.2390 |
| F1/F | 2.3160 | 2.0979 | 1.7919 | 1.8790 | 1.3734 | 1.3738 | 1.7575 | 1.7866 | 1.5411 | 1.5650 | 2.2696 | 2.1866 |

Table 28 provides an entire set focal length value F of the optical lens assembly in Example 13 to Example 24 (in millimeter).

TABLE 28

| | Example | | | | | |
|---|---|---|---|---|---|---|
| Parameter | 13 | 14 | 15 | 16 | 17 | 18 |
| F | 15.3688 | 15.6134 | 15.4469 | 15.4545 | 15.3972 | 15.3928 |
| FOV | 34.3857 | 34.2065 | 34.4283 | 34.4446 | 34.3828 | 34.3825 |
| TTL | 32.5552 | 32.9843 | 32.4494 | 32.3781 | 32.5937 | 32.4082 |
| F1 | 35.5935 | 32.7549 | 27.6794 | 29.0394 | 21.1464 | 21.1464 |
| F2 | −56.9575 | −49.7222 | −45.7256 | −48.7941 | −59.9045 | −59.9045 |
| F3 | 15.2803 | 14.5710 | 14.6010 | 14.9118 | 16.8245 | 16.9543 |
| F4 | −15.5278 | −14.5849 | −14.0313 | −14.6618 | −22.9170 | −23.1245 |
| F5 | 15.4117 | 15.4264 | 15.5501 | 15.9569 | 22.4975 | 22.6111 |
| F6 | 11.2222 | 12.1798 | −20.0980 | −19.5246 | 10.8597 | 10.7959 |
| F7 | −20.1033 | −28.5849 | 10.5202 | 10.9100 | −13.0377 | −12.9345 |
| F8 | −12.8401 | −12.7177 | −12.7218 | −13.2472 | −14.3537 | −14.4283 |
| R15 | 24.0000 | 20.3000 | 18.6000 | 23.9000 | 11.7000 | 11.8000 |
| d67 | 5.6000 | 6.7000 | 5.9000 | 6.3000 | 7.1000 | 7.0000 |
| θ | 0.6001 | 0.5970 | 0.6009 | 0.6012 | 0.6001 | 0.6001 |
| H | 9.2587 | 9.2521 | 9.2543 | 9.2538 | 9.2536 | 9.2513 |
| R1 | 15.1000 | 13.6800 | 12.5000 | 12.6000 | 23.0000 | 23.0000 |
| D | 11.5811 | 11.9529 | 11.7196 | 11.6502 | 12.1086 | 12.1060 |
| R2 | 30.0000 | 26.0000 | 25.7000 | 24.7000 | −63.0000 | −63.0000 |
| D2 | 10.7063 | 10.6585 | 10.3642 | 10.2727 | 11.1473 | 11.1445 |
| R9 | 14.0000 | 14.2200 | 16.0000 | 14.6000 | 25.0000 | 25.0000 |
| R10 | −20.0000 | −20.6000 | −18.0000 | −21.7000 | −25.0000 | −25.3000 |
| ENPD | 9.6055 | 9.7583 | 9.6543 | 9.6591 | 9.6233 | 9.6205 |
| D9 | 11.4465 | 11.2636 | 11.0910 | 11.2213 | 11.2481 | 11.2451 |
| d9 | 6.0000 | 4.3000 | 4.3000 | 4.2000 | 3.7000 | 3.6000 |
| BFL | 3.9552 | 4.1443 | 3.6994 | 3.7281 | 3.8637 | 3.9082 |
| d1 | 1.9000 | 2.5000 | 2.6000 | 2.6000 | 2.7000 | 2.7000 |
| d2 | 1.5000 | 1.4000 | 1.2000 | 1.1000 | 1.5000 | 1.5000 |
| ET2 | 1.2893 | 1.2353 | 1.0920 | 1.0131 | 1.2217 | 1.2219 |
| F34 | −92.6187 | −65.4248 | −54.627 | −61.7646 | 187.7727 | 185.0672 |
| F67 | 26.2361 | 22.6204 | 22.4969 | 24.5182 | 39.6612 | 39.6542 |

| | Example | | | | | |
|---|---|---|---|---|---|---|
| Parameter | 19 | 20 | 21 | 22 | 23 | 24 |
| F | 15.6091 | 15.5795 | 15.8227 | 15.7761 | 15.4241 | 15.4144 |
| FOV | 34.5040 | 34.5281 | 34.7606 | 34.7494 | 34.4236 | 34.4262 |
| TTL | 32.6947 | 32.6957 | 32.4859 | 32.4613 | 32.5177 | 32.5676 |
| F1 | 27.4336 | 27.8343 | 24.3841 | 24.6890 | 35.0068 | 33.7057 |
| F2 | −44.7769 | −44.4724 | −24.3728 | −23.0911 | 215.7385 | 247.5505 |
| F3 | 13.5232 | 12.5835 | 7.9242 | 7.7599 | 21.9988 | 22.1509 |
| F4 | −10.2094 | −9.6282 | −7.1926 | −7.0015 | −27.1215 | −28.5546 |
| F5 | 26.7826 | 27.0933 | 16.3500 | 15.8261 | 24.9614 | 26.0306 |
| F6 | 9.2331 | 9.0410 | 19.9478 | 21.5381 | 10.3738 | 10.3738 |
| F7 | −39.8663 | −41.9650 | −62.1621 | −75.3327 | −11.7781 | −11.6960 |
| F8 | −13.9265 | −14.3066 | −38.5397 | −45.0302 | −18.7581 | −19.0942 |
| R15 | 22.0000 | 24.0000 | 15.2000 | 15.2000 | 33.0000 | 31.4000 |
| d67 | 5.2000 | 4.9000 | 4.0000 | 3.8000 | 7.0000 | 7.0000 |
| θ | 0.6022 | 0.6026 | 0.6067 | 0.6065 | 0.6008 | 0.6008 |
| H | 9.2571 | 9.2517 | 9.2745 | 9.2585 | 9.2564 | 9.2537 |
| R1 | 14.1750 | 14.0000 | 11.7000 | 11.8000 | 21.6000 | 21.2000 |
| D | 12.2946 | 12.3116 | 13.0971 | 13.1537 | 11.1344 | 11.0421 |
| R2 | 36.0000 | 34.0000 | 25.5000 | 25.6000 | 87.0000 | 91.0000 |
| D2 | 10.9917 | 11.0462 | 11.5503 | 11.6074 | 10.1369 | 10.0454 |
| R9 | −50.0000 | −40.0000 | −45.0000 | −41.5000 | 26.0000 | 26.0000 |
| R10 | −12.0000 | −11.5000 | −8.0000 | −7.7000 | −30.0000 | −33.0000 |
| ENPD | 9.7557 | 9.7372 | 9.8892 | 9.8601 | 9.6401 | 9.634 |
| D9 | 9.5472 | 9.4020 | 9.4550 | 9.4032 | 11.3270 | 11.3692 |
| d9 | 3.4000 | 3.4000 | 4.3000 | 4.3000 | 3.5000 | 3.5000 |
| BFL | 4.0197 | 3.8657 | 3.6859 | 3.8613 | 3.8177 | 3.8676 |
| d1 | 2.6700 | 2.6000 | 3.0000 | 3.0000 | 2.3000 | 2.3000 |
| d2 | 1.6300 | 1.8000 | 2.7000 | 2.8000 | 1.5000 | 1.5000 |
| ET2 | 1.8919 | 2.1047 | 3.2195 | 3.3393 | 1.6191 | 1.6001 |
| F34 | −26.6423 | −25.8578 | −31.9229 | −30.9781 | −456.2375 | −1603.4051 |
| F67 | 12.8485 | 12.5688 | 25.8256 | 26.6873 | 49.946 | 51.0193 |

### Technical Solution III

### Embodiment V

In this embodiment, an optical lens assembly includes, for example, eight lenses having refractive powers, which are a first lens, a second lens, a third lens, a fourth lens, a fifth lens, a sixth lens, a seventh lens, and an eighth lens. These eight lenses are sequentially arranged from a first side to a second side along an optical axis.

In this embodiment, the optical lens assembly may further include a photosensitive element provided on an imaging surface. In an embodiment, the photosensitive element provided on the imaging surface may be a Charge-Coupled Device (CCD) or a Complementary Metal Oxide Semiconductor (CMOS).

In this embodiment, the optical lens assembly may further include an optical filter disposed between the eighth lens and the imaging surface. The optical filter may filter lights having specific wavelengths.

In this embodiment, the first lens has a positive refractive power. The first lens has a convex-concave surface shape. The first lens is the positive refractive power, a first-side surface (object side surface) of the first lens is a convex surface, which plays a role in converging the lights, and the first lens may be a high refractive index material, facilitating the decreasing of a front end diameter, thereby realizing miniaturization. The first-side surface (object side surface) of the first lens is the convex surface, such that the lights are conveniently collected to enter an optical system, thereby improving the overall light flux and illuminance of the lens. A second-side surface (image side surface) of the first lens is a concave surface, which causes the lights entering through the first-side surface (object side surface) of the first lens to be properly diverged, such that a trend of the lights emitted from the image side surface of the first lens is further gently transitioned to the rear lens, thereby reducing the lens sensitivity of the first lens.

In this embodiment, the first lens has the positive refractive power. The first lens has the convex-convex surface shape. The first lens is the positive refractive power, the first-side surface (object-side surface) is the convex surface, which plays a role in converging the lights, and the first lens may be the high refractive index material, facilitating the decreasing of the front end diameter, thereby realizing miniaturization. The first lens is a double convex structure, the convex surface of the second-side surface (image-side surface) may further converge the lights, and by lowering the lights, the diameter of the second lens may be decreased to reduce a front group diameter of the system, thereby realizing miniaturization.

In this embodiment, the second lens has a negative refractive power. The second lens has a concave-concave surface shape. The second lens is the negative refractive power, and has a double concave structure, which plays a role in diverging the lights, such that center lights and edge lights of all FOVs may be dispersed, causing the lights to have a certain height when entering the third lens. By matching the first lens having the positive refractive power, light flux is improved, and the front end diameter is decreased while system illuminance is increased. Moreover, the increasing of an edge FOV optical path facilitates formation of a clear image by the edge light and center light, and aberrations such as field curvature are corrected, thereby realizing high resolution.

In this embodiment, the third lens has a positive refractive power. The third lens has the convex-convex surface shape. The third lens is the positive refractive power, and a first-side surface (object side surface) is designed as a convex surface, such that the height of the lights entering through the second lens may be compressed. A second-side surface (image side surface) is designed as a convex surface, such that the lights emitted by the third lens are further converged and smoothly enter the rear optical system, further causing the light trend to be gently transitioned, thereby decreasing the front end diameter of the lens. Moreover, through the cooperative use with the negative refractive power of the second lens, an optical path difference between different FOV lights is adjusted, thereby realizing high resolution. The second-side surface (image side surface) of the third lens is convex, and the lights are converged after passing through the third lens, such that the lights of periphery FOVs enter the rear system as much as possible, thereby improving overall light flux and illuminance.

In this embodiment, the third lens has a negative refractive power. The third lens has the convex-concave surface shape. The third lens is the negative refractive power, and the first-side surface (object side surface) is designed as the convex surface, such that a convergent degree of the lights is properly compressed, and by matching the concave second-side surface, the lights are smoothly emitted and transitioned with little or no deflection, thereby improving image quality.

In this embodiment, the fourth lens has a positive refractive power. The fourth lens has the convex-convex surface shape. The fourth lens is the positive refractive power and designed in a double convex manner, and by cooperating with the convex surface of the second-side surface (image side surface) of the third lens, the lights are smoothly transitioned to the rear lens, and deflection in the lights is relatively small, thereby reducing sensitivity. In this embodiment, the fourth lens and the fifth lens are cemented, such that field curvature may further be reduced to correct an off-axis aberration of the system.

In this embodiment, the fourth lens has a negative refractive power. The fourth lens has the concave-concave surface shape. The fourth lens is a negative double concave lens, which facilitates the diverging of the lights, such that the center lights and edge lights of the FOVs may be dispersed, causing the lights of different FOVs to image clearly. In this embodiment, the fourth lens serves as a negative film of a cemented member, such that correction of the chromatic aberration is realized by matching the positive third lens.

In this embodiment, the fourth lens has a negative refractive power. The fourth lens has the convex-concave surface shape. The fourth lens is the negative refractive power to diverge the lights. The first-side surface (object side surface) is the convex surface, such that the lights emitted by the third lens are further converged. The second-side surface (image side surface) is the concave surface, which certainly releases the lights, causing the lights to be smoothly transitioned to the rear lens, thereby reducing sensitivity. In this embodiment, the fourth lens serves as the negative film of the cemented member, and is cemented with the fifth lens as a positive film, which has an important effect of correcting the chromatic aberration.

In this embodiment, the fifth lens has a positive refractive power. The fifth lens has the convex-convex surface shape. The fifth lens is the positive refractive power, and a second-side surface (image side surface) is a convex surface, which converges the lights. In an aspect, the diverged lights may smoothly enter the rear optical system, and in another aspect, the lights may be lowered to enter a position of the subsequent optical system, thereby decreasing a rear end diameter.

In this embodiment, the fifth lens has a negative refractive power. The fifth lens has a concave-convex surface shape. The fifth lens is the negative refractive power, and the first-side surface (object side surface) is a concave surface, such that the incident lights passing through the fourth lens may be better received. The second-side surface (image side surface) is a convex surface, such that a divergent trend of the lights may be slowed down to smoothly transition the lights, the sensitivity of the system is reduced, resolution capability is improved, and the diameter of the rear end lens is decreased, thereby realizing miniaturization. In this embodiment, the fifth lens having the negative refractive power and the fourth lens having the positive refractive power are cemented, such that the chromatic aberration of the optical system may be effectively corrected, thereby improving image quality.

In this embodiment, the sixth lens has a negative refractive power. The sixth lens has the convex-concave surface shape. The sixth lens is the negative refractive power, and has a divergent effect on the lights. By controlling a focal length of the sixth lens, the chromatic aberration caused by the front positive lens may be effectively corrected, thereby improving image quality. A first-side surface (object side surface) of the sixth lens is a convex surface, such that the lights converged in the front may be further converged to smooth an overall light trend. A second-side surface (image side surface) is a concave surface, and the lights are in a divergent trend by matching a high refractive index material, such that the periphery lights may reach a higher imaging position, facilitating cooperative use of large chip sizes.

In this embodiment, the sixth lens has a positive refractive power. The sixth lens has the convex-convex surface shape. The sixth lens is the positive refractive power, and the first-side surface (object side surface) is the convex surface, such that front group lights are gathered, and the rear end diameter is limited to reduce a large aberration impact caused by edge FOV lights, thereby reducing system sensitivity and improving optical performance. The design of the second-side surface (image side surface) as the convex surface may optimize the size of the rear end diameter.

In this embodiment, the seventh lens has a positive refractive power. The seventh lens has the convex-convex surface shape. The seventh lens is the positive refractive power, and may converge the lights. By controlling an angle of the edge light entering the eighth lens, a size of a CRA of the system is effectively controlled. The double concave structure design of the seventh lens may converge the front end lights, such that a small rear end diameter is realized, and the total length of the optical system is shortened by causing the lights to reach the imaging surface as fast as possible. The seventh lens having the positive refractive power and the sixth lens having the negative refractive power are cemented, such that an effect of correcting the aberration may be achieved, thereby realizing high resolution.

In this embodiment, the seventh lens has a negative refractive power. The seventh lens has the concave-concave surface shape. The seventh lens is the negative refractive power, and has a divergent effect on the lights. By properly diverging the lights converged in the front end, the lights are gently transitioned, and a small aberration is generated. Moreover, the seventh lens having the negative refractive power and the sixth lens having the positive refractive power are cemented, such that an effect of correcting the aberration may be achieved, thereby realizing high resolution.

In this embodiment, the seventh lens has the negative refractive power. The seventh lens has the concave-convex surface shape. The seventh lens is the negative refractive power, and the first-side surface (object side surface) is the concave surface, such that the seventh lens may better receive the lights emitted by the sixth lens. The second-side surface (image side surface) is the convex surface, such that the lights may be effectively converged and collected, thereby realizing the miniaturization of the rear end diameter. The seventh lens having the negative refractive power and the sixth lens having the positive refractive power are cemented, such that an effect of correcting the aberration may be achieved, thereby realizing high resolution.

In this embodiment, the eighth lens has a negative refractive power. The eighth lens has the concave-concave surface shape. The eighth lens is the negative refractive power, such that an aberration generated by the front lens with the positive refractive power may be balanced, thereby realizing high resolution. Meanwhile, the center and periphery FOV lights are diverged, and a BFL is prolonged. Through the double concave design of the eighth lens, the lights are in an upward divergent trend after passing through the second-side surface (image side surface) of the eighth lens, such that the heights of the lights may be rapidly accumulated on an image surface, thereby expanding an imaging range.

In this embodiment, the eighth lens has the negative refractive power. The eighth lens has the concave-convex surface shape. The eighth lens is the negative refractive power, such that an aberration generated by the front lens with the positive refractive power may be balanced, thereby realizing high resolution. Meanwhile, the negative refractive power facilitates the diverging of the lights, and the imaging range is expanded. The first-side surface (object side surface) of the eighth lens is the concave surface, such that more lights entering through the seventh lens may be collected. The second-side surface (image side surface) is the convex surface, such that the lights may be smoothly converged to the rear optical system, light energy losses may also be reduced, and system illuminance is increased.

In this embodiment, the sixth lens and the seventh lens may be cemented to form a double cemented lens. The sixth lens and the seventh lens form a cemented member, such that the lights passing through the front lens may be gently transitioned to the rear optical system, thereby decreasing the total length of the lens. Various aberrations of the optical system may be fully corrected, such that a resolution ratio may be increased with a compact structure, and optical performance such as distortions, CRAs, and the like is optimized.

In this embodiment, the third lens and the fourth lens may be cemented to form a double cemented lens. The third lens and the fourth lens have opposite refractive powers, and form a cemented member, such that the light may be gently transitioned to the rear lens.

In this embodiment, the fourth lens and the fifth lens may be cemented to form a double cemented lens. The fourth lens and the fifth lens have opposite refractive powers, and form a cemented member, such that the light may be gently transitioned to the rear lens.

The above double cemented lens also has the following advantages: the air gap between the two lenses may be reduced to decrease the total length of the system; the chromatic dispersion of the two lenses are complementary, facilitating reduction in an chromatic aberration, thereby improving imaging quality; assembly components between the two lenses may be reduced, processes are reduced, and costs are reduced; field curvature may be further reduced to correct an off-axis point aberration of the system; and by rationally distributing the focal length, thermal compensation is realized, thereby achieving good temperature performance.

In this embodiment, the optical lens assembly further includes a diaphragm disposed between the second lens and the third lens. By arranging the diaphragm between the second lens and the third lens, light entering the optical system is effectively collected, a lens diameter on a rear end of the optical system is reduced, and the assembling sensitivity of the system is reduced. However, it is to be noted that, the position of the diaphragm disclosed herein is only exemplary and not limiting; in alternative implementations, the diaphragm may also be provided in other positions according to actual requirements.

In this embodiment, the optical lens assembly of the disclosure meets: TTL/F≤3.5, where TTL refers to a distance from the center of the first-side surface of the first lens to the imaging surface of the optical lens assembly on the optical axis, and F refers to a total effective focal length of the optical lens assembly. By controlling a ratio of the distance from the center of the first-side surface of the first lens to the imaging surface of the optical lens assembly on the optical axis to the total effective focal length of the optical lens assembly within the range, the miniaturization of the lens is realized, and when the optical system is at the same focal length, if the TTL is smaller, it is more conductive to realizing miniaturization. More specifically, the TTL and the F meets: TTL/F≤3. By controlling a ratio of the TTL to the F within the range, miniaturization may be better realized. The TTL and the F meets: TTL/F≤2.5 in an implementation.

In this embodiment, the optical lens assembly of the disclosure meets: F/ENPD≤2, where F refers to the total effective focal length of the optical lens assembly, and ENPD refers to an entrance pupil diameter of the optical lens assembly. By controlling a ratio of the total effective focal length of the optical lens assembly to the ENPD of the optical lens assembly within the range, a small FNO is realized, the light flux is increased, and a large entrance pupil diameter facilitates improvement of relative illuminance. More specifically, the F and the ENPD meets: 1.4≤F/ENPD≤1.8. By controlling a ratio of the F to the ENPD within the range, the light flux may further be increased, thereby more facilitating improvement of relative illuminance. The F and the ENPD meets: 1.5≤F/ENPD≤1.7 in an implementation.

In this embodiment, the optical lens assembly of the disclosure meets: 0≤R31/F≤20, where R31 refers to a curvature radius of the first-side surface of the third lens, and F refers to the total effective focal length of the optical lens assembly. By controlling a ratio of the curvature radius of the first-side surface of the third lens to the total effective focal length of the optical lens assembly within the range, heights of the lights entering through the second lens is able to be compressed, thereby decreasing the front end diameter of the lens.

More specifically, the R31 and the F meets: 0.4≤R31/F≤10. By controlling a ratio of the R31 to the F within the range, the front lights may be properly converged to further compress the lights, thereby further realizing a small diameter. The R31 and the F meets: 0.7≤R31/F≤3.5 in an implementation.

In this embodiment, the optical lens assembly of the disclosure meets: −20≤R52/F≤0, where R52 refers to a curvature radius of the second-side surface of the fifth lens, and F refers to the total effective focal length of the optical lens assembly. By controlling a ratio of the curvature radius of the second-side surface of the fifth lens to the total effective focal length of the optical lens assembly within the range, the design of the second-side surface (image side surface) of the fifth lens as the convex surface facilitates the collection of the front group lights of the system and limitations to the rear end diameter, thereby realizing the miniaturization of the rear end diameter. More specifically, the R52 and the F meets: −10≤R52/F≤−0.4. By controlling a ratio of the R52 to the F within the range, the rear end diameter may be better limited, thereby realizing the miniaturization of the rear end diameter. The R52 and the F meets: −5≤R52/F≤−0.8 in an implementation.

In this embodiment, the optical lens assembly of the disclosure meets: 0≤R61/F≤20, where R61 refers to a curvature radius of the first-side surface of the sixth lens, and F refers to the total effective focal length of the optical lens assembly. By controlling a ratio of the curvature radius of the first-side surface of the sixth lens to the total effective focal length of the optical lens assembly within the range, the design of the first-side surface (object side surface) of the sixth lens as the convex surface facilitates the collection of the front group lights of the system and limitations to the rear end diameter, thereby realizing the miniaturization of the rear end diameter. More specifically, the R61 and the F meets: 0.3≤R61/F≤15. By controlling a ratio of the R61 to the F within the range, the rear end diameter may be better limited, thereby realizing the miniaturization of the rear end diameter. The R61 and the F meets: 0.5≤R61/F≤8 in an implementation, and meets: 0.7≤R61/F≤3.5 in an implementation.

In this embodiment, the optical lens assembly of the disclosure meets: −12≤R21/R22<0, where R21 refers to a curvature radius of the first-side surface of the second lens, and R22 refers to a curvature radius of the second-side surface of the second lens. The second lens is in a double concave surface shape. By controlling a ratio of the curvature radius of the first-side surface of the second lens to the curvature radius of the second-side surface of the second lens within the range, the diverging of the lights is facilitated, such that the lights entering the third lens have a certain height, thereby increasing the light flux. Furthermore, the lights of all FOVs are dispersed, the imaging quality of all FOVs on the imaging surface is improved, and the long focal length of the entire system is taken into consideration at the same time. More specifically, the R21 and the R22 meets: −8≤R21/R22≤−0.5. By controlling a ratio of the R21 to the R22 within the range, the light flux may further be increased, the imaging quality of all FOVs on the imaging surface is further improved, and the long focal length of the entire system is better taken into consideration at the same time. The R21 and the R22 meets: −5≤R21/R22≤−0.8 in an implementation.

In this embodiment, the optical lens assembly of the disclosure meets: −12≤R21/F≤0, where R21 refers to the curvature radius of the first-side surface of the second lens, and F refers to the total effective focal length of the optical lens assembly. By controlling a ratio of the curvature radius of the first-side surface of the second lens to the total effective focal length of the optical lens assembly within the range, the lights are properly diverged when entering the first-side surface (object-side surface) of the second lens, and then gently enter the subsequent optical system.

More specifically, the R21 and the F meets: −8≤R21/F≤−0.35. By controlling a ratio of the R21 to the F within the range, the long focal length of the entire system may also be realized. The R21 and the F meets: −3.5≤R21/F≤−0.6 in an implementation.

In this embodiment, the optical lens assembly of the disclosure meets: 0.02≤d23/TTL≤0.4, where d23 refers to an air gap between the second lens and the third lens on the optical axis, that is, a distance from the center of the second-side surface of the second lens to the center of the first-side surface of the third lens; and the TTL refers to the distance from the center of the first side of the first lens to the imaging surface of the optical lens assembly on the optical axis. By controlling a ratio of the air gap between the second lens and the third lens on the optical axis to the distance from the center of the first side of the first lens to the imaging surface of the optical lens assembly on the optical axis within the range, and by controlling the air gap between the second lens and the third lens to be relatively large, the lights emitted by the second lens are smoothly diverged and then enter the third lens, such that the light flux of the system may be increased by expanding a width of a light beam.

More specifically, the d23 and the TTL meet: 0.035≤d23/TTL≤0.25. By controlling a ratio of the d23 to the TTL within the range, the advantage of miniaturization may also be realized. The d23 and the TTL meets: 0.045≤d23/TTL≤0.18 in an implementation.

In this embodiment, the optical lens assembly of the disclosure meets: −4≤F2/F. F2 is an effective focal length of the second lens; and F refers to the total effective focal length of the optical lens assembly. By controlling a ratio of the effective focal length of the second lens to the total effective focal length of the optical lens assembly within the range, an optical path of the edge light is increased, and is divergent with the center light, so as to form a clear image, and the long focal length and small distortion are taken into consideration at the same time.

More specifically, the F2 and the F meets: −2.5≤F2/F≤−0.3. By controlling the ratio of the F2 to the F within the range, and by matching the first lens having the positive refractive power, the light flux of the entire system is increased. The F2 and the F meets: −1.5≤F2/F≤−0.45 in an implementation.

In this embodiment, the optical lens assembly of the disclosure meets: 0<R22/F≤5, where R22 refers to the curvature radius of the second-side surface of the second lens, and F refers to the total effective focal length of the optical lens assembly. By controlling a ratio of the curvature radius of the second-side surface of the second lens to the total effective focal length of the optical lens assembly within the range, the front lights are properly diverged. More specifically, the R22 and the F meets: 0.2≤R22/F≤3. By controlling the ratio of the R22 to the F within the range, the second-side surface (image-side surface) of the second lens is designed as the concave surface, and has an effect of diverging the lights, such that the lights passing through the second lens are released certainly, more edge lights are allowed to enter the diaphragm, the light flux is increased, and system illuminance is increased. The R22 and the F meets: 0.4≤R22/F≤1.5 in an implementation.

In this embodiment, the optical lens assembly of the disclosure meets: −8≤F8/F, where F8 refers to an effective focal length of the eighth lens, and F refers to the total effective focal length of the optical lens assembly. By controlling a ratio of the effective focal length of the eighth lens to the total effective focal length of the optical lens assembly within the range, the eighth lens has a negative refractive power, and the lights passing through the eighth lens are in a divergent trend, such that more lights enter the image surface, thereby effectively increasing the light flux.

More specifically, the F8 and the F meets: −5≤F8/F≤−0.25. By controlling the F8 to the F within the range, a large image surface and small distortion may also be realized while the light flux is effectively increased. The F8 and the F meets: −2.5≤F8/F≤−0.4 in an implementation.

In this embodiment, the optical lens assembly of the disclosure meets: F1/F≤8, where F1 refers to an effective focal length of the first lens, and F refers to the total effective focal length of the optical lens assembly. By controlling a ratio of the effective focal length of the first lens to the total effective focal length of the optical lens assembly within the range, a focal length of the first one among the lenses is rationally distributed, such that the entering of the a large FOV light into the optical system is facilitated. More specifically, the F1 and the F meets: 0.3≤F1/F≤5. By controlling a ratio of the F1 to the F within the range, the entering of the large FOV light into the optical system may be more facilitated. The F1 and the F meets: 1.2≤F1/F≤3.5 in an implementation.

In this embodiment, the optical lens assembly of the disclosure meets: 0.7≤R62/R71≤1.3, where R62 refers to a curvature radius of the second-side surface of the sixth lens, and R71 refers to a curvature radius of the first-side surface of the seventh lens. By controlling the curvature radius of the second-side surface of the sixth lens to close to the curvature radius of the first-side surface of the seventh lens, the sixth lens and the seventh lens may be cemented and have positively and negatively opposite refractive power, and the lenses having the positive refractive power and the negative refractive power are cemented, such that a chromatic aberration is corrected, thereby improving resolution. Furthermore, tolerance sensitivity such as tilting/core shifting and the like generated during the assembly of an independent lens may be reduced by using the cemented member, thereby further improving system performance; and the cemented member also facilitates the smooth transition of the lights, thereby reducing the sensitivity of the system. More specifically, the R62 and the R71 meets: 0.8≤R62/R71≤1.2. By controlling the ratio of the R62 to the R71 within the range, the chromatic aberration may be better corrected, resolution is improved, and system performance may further be improved, thereby reducing the sensitivity of the system. The R62 and the R71 meets: 0.9≤R62/R71≤1.1 in an implementation, and meets: 0.95≤R62/R71≤1.05 in an implementation.

In this embodiment, the optical lens assembly of the disclosure meets: d67/TTL≤0.05, where d67 refers to an air gap between the sixth lens and the seventh lens on the optical axis, and the TTL refers to the distance from the center of the first-side surface of the first lens to the imaging surface of the optical lens assembly on the optical axis. By controlling a ratio of the air gap between the sixth lens and the seventh lens on the optical axis to the distance from the center of the first-side surface of the first lens to the imaging surface of the optical lens assembly on the optical axis within the range, the air gap between the centers of the sixth lens and the seventh lens is very small, and the sixth lens and the seventh lens may be cemented. The lenses having the positive refractive power and the negative refractive power are cemented, such that a chromatic aberration is corrected, thereby improving resolution. Furthermore, tolerance sensitivity such as tilting/core shifting and the like generated during the assembly of an independent lens may be reduced by using the cemented member, thereby further improving system performance. More specifically, the d67 and the TTL meets: d67/TTL≤0.03. By controlling the ratio of the d67 to the TTL within the range, the chromatic aberration may be better corrected, resolution is improved, and system performance may further be improved. The d67 and the TTL meets: d67/TTL≤0.02 in an implementation, and meets: d67/TTL≤0.01 in an implementation.

In this embodiment, the optical lens assembly of the disclosure meets: 0.6≤|F67/F|, where F67 refers to a combined focal length of the sixth lens and the seventh lens, and F refers to the total effective focal length of the optical lens assembly. By controlling an absolute value of a ratio of the combined focal length of the sixth lens and the seventh lens to the total effective focal length of the optical lens assembly within the range, a trend of the lights entering the cemented member may be effectively controlled, an aberration caused by large angle light entering the front end is reduced, such that the lights smoothly enter the image surface, and a lens structure is compact at the same time, thereby realizing miniaturization. In this embodiment, |F67/F| may be, for example, equal to values such as 80, 70, 50, 30, 15, 7, 3.5, 1.0, or the like. More specifically, the F67 and the F meets: 0.8≤|F67/F|≤80. By controlling the absolute value of the ratio of the F67 to the F, the light trend may be better controlled, the aberration is reduced, and miniaturization is further realized. The F67 and the F meets: 1≤|F67/F|≤55 in an implementation.

In this embodiment, the optical lens assembly of the disclosure meets: 0<F45/F≤3, where F45 refers to a combined focal length of the fourth lens and the fifth lens, and F refers to the total effective focal length of the optical lens assembly. By controlling a ratio of the combined focal length of the fourth lens and the fifth lens to the total effective focal length of the optical lens assembly within the range, a focal length of the cemented member of the fourth lens and the fifth lens is controlled to be positive, such that the lights are smoothly collected and converged to the imaging surface, thereby improving resolution. More specifically, the F45 and the F meets: 0.25≤F45/F≤2.5. By controlling the ratio of the F45 and the F within the range, the lights may be better smoothly collected and converged to the imaging surface, thereby further improving resolution.

In this embodiment, the optical lens assembly of the disclosure meets: −10≤R42/R51≤4, where R42 refers to a curvature radius of the second-side surface of the fourth lens, and R51 refers to a curvature radius of the first-side surface of the fifth lens. By controlling a ratio of the curvature radius of the second-side surface of the fourth lens to the curvature radius of the first-side surface of the fifth lens within the range, a trend of the lights on an image side of the fourth lens and an object side of the fifth lens may be smoothed, thereby improving resolution. More specifically, the R42 and the R51 meets: −7≤R42/R51≤3. By controlling the ratio of the R42 to the R51 within the range, the trend of the lights between the fourth lens and the fifth lens may be smoother, thereby further improving resolution. The R42 and the R51 meets: 0.8≤R42/R51≤1.2 in an implementation, and meets: 0.9≤R42/R51≤1.1 in an implementation.

In this embodiment, the optical lens assembly of the disclosure meets: d45/TTL≤0.04, where d45 refers to an air gap between the fourth lens and the fifth lens on the optical axis, and the TTL refers to the distance from the center of the first-side surface of the first lens to the imaging surface of the optical lens assembly on the optical axis. By controlling a ratio of the air gap between the fourth lens and the fifth lens on the optical axis to the distance from the center of the first-side surface of the first lens to the imaging surface of the optical lens assembly on the optical axis within the range, the air gap between the centers of the fourth lens and the fifth lens is very small, such that the total optical length may be decreased, the trend of the lights between the fourth lens and the fifth lens may be smoothed, thereby improving resolution. More specifically, the d45 and the TTL meets: d45/TTL≤0.03. By controlling the ratio of the d45 to the TTL within the range, the total optical length may be further decreased, such that the trend of the lights between the fourth lens and the fifth lens may be smoother, thereby further improving resolution. The d45 and the TTL meets: d45/TTL≤0.025 in an implementation, and meets: d45/TTL≤0.015 in an implementation.

In this embodiment, the optical lens assembly of the disclosure meets: |F34/F|≤8.5, where F34 refers to a combined focal length of the third lens and the fourth lens, and F refers to the total effective focal length of the optical lens assembly. By controlling an absolute value of a ratio of the combined focal length of the third lens and the fourth lens to the total effective focal length of the optical lens assembly within the range, the focal length of the cemented member of the third lens and the fourth lens is controlled to be small, a trend of the lights expanded by the diaphragm is maintained, such that the lights are smoothly transitioned to the rear optical system, thereby reducing sensitivity and improving resolution. More specifically, the F34 and the F meets: |F34/F|≤6. By controlling the ratio of the F34 and the F within the range, the lights may be transitioned to the rear optical system more smoothly, thereby reducing sensitivity and improving resolution.

In this embodiment, the optical lens assembly of the disclosure meets: −6≤R32/R41≤2, where R32 refers to a curvature radius of the second-side surface of the third lens, and R41 refers to a curvature radius of the first-side surface of the fourth lens. By controlling a ratio of the curvature radius of the second-side surface of the third lens to the curvature radius of the first-side surface of the fourth lens within the range, a trend of the lights on an image side of the third lens and an object side of the fourth lens may be smoothed, thereby improving resolution. More specifically, the R32 and the R41 meets: −5≤R32/R41≤1.5. By controlling the ratio of the R32 to the R41 within the range, the trend of the lights between the third lens and the fourth lens is smoother, thereby further improving resolution. The R32 and the R41 meets: 0.9≤R32/R41≤1.1 in an implementation.

In this embodiment, the optical lens assembly of the disclosure meets: d34/TTL≤0.04, where d34 refers to an air gap between the third lens and the fourth lens on the optical axis, and the TTL refers to the distance from the center of the first-side surface of the first lens to the imaging surface of the optical lens assembly on the optical axis. By controlling a ratio of the air gap between the third lens and the fourth lens on the optical axis to the distance from the center of the first-side surface of the first lens to the imaging surface of the optical lens assembly on the optical axis within the range, the air gap between the centers of the third lens and the fourth lens is very small, such that the total optical length may be decreased, the trend of the lights between the third lens and the fourth lens may be smoothed, thereby improving resolution. More specifically, the d34 and the TTL meets: d34/TTL≤0.035. By controlling the ratio of the d34 to the TTL within the range, the total optical length may be further decreased, such that the trend of the lights between the third lens and the fourth lens is smoother, thereby further improving resolution. d34/TTL≤0.02 may be met in an implementation.

In this embodiment, the optical lens assembly of the disclosure meets: 45°≤(FOV×F)/H, FOV refers to a maximum field of view of the optical lens assembly, F refers to the total effective focal length of the optical lens assembly, and H refers to an image height corresponding to the maximum field of view of the optical lens assembly. By controlling the maximum field of view FOV of the optical lens assembly, the total effective focal length of the optical lens assembly, and the image height H corresponding to the maximum field of view of the optical lens assembly to meet a conditional expression 45°≤(FOV×F)/H, a long focal length and a large angle resolution ratio of the lens may be met at the same time.

More specifically, the FOV, the F, and the H meets: 50°≤(FOV×F)/H≤90°. By controlling the FOV, the F, and the H to meet 50°≤(FOV×F)/H≤90°, the long focal length and a large angle resolution ratio of the lens may be better met at the same time. The FOV, the F, and the H meets: 55°≤(FOV×F)/H≤70° in an implementation, and meets: 55°≤(FOV×F)/H≤60° in an implementation.

In this embodiment, the optical lens assembly of the disclosure meets: 1.0≤F/H≤2.5, where F refers to the total effective focal length of the optical lens assembly, and H refers to the image height corresponding to the maximum field of view FOV of the optical lens assembly. By controlling a ratio of the total effective focal length of the optical lens assembly to the image height H corresponding to the maximum field of view FOV of the optical lens assembly within the range, proportions of the focal length and the image height are rationally designed, thereby improving resolution. More specifically, the F and the H meets: 1.2≤F/H≤2. By controlling a ratio of the F to the H within the range, the improvement of resolution may be further facilitated. The F and the H meets: 1.5≤F/H≤1.8 in an implementation.

In this embodiment, the optical lens assembly of the disclosure meets: |(R11/D1)/(R12/D2)|≤1, where R11 refers to a curvature radius of the first-side surface of the first lens, D1 refers to a maximum clear diameter of the first-side surface of the first lens corresponding to the maximum field of view of the optical lens assembly, R12 refers to a curvature radius of the second-side surface of the first lens, and D2 refers to a maximum effective clear diameter of the second-side surface of the first lens corresponding to the maximum field of view of the optical lens assembly. By controlling the curvature radius of the first-side surface of the first lens, the maximum clear diameter of the first-side surface of the first lens corresponding to the maximum field of view of the optical lens assembly, the curvature radius of the second-side surface of the first lens, and the maximum effective clear diameter of the second-side surface of the first lens corresponding to the maximum field of view of the optical lens assembly to meet a conditional expression |(R11/D1)/(R12/D2)|≤1, a height of an edge light entering the optical lens assembly may be effectively limited, facilitating the lowering of the light, thereby further achieving a small front end diameter. More specifically, the R11, the D1, the R12, and the D2 meets: |(R11/D1)/(R12/D2)|≤0.8. By controlling the R11, the D1, the R12, and the D2 to meet |(R11/D1)/(R12/D2)|≤0.8, the lights may be further lowered, thereby better realizing the small front end diameter. The R11, the D1, the R12, and the D2 meets: 0.1≤|(R11/D1)/(R12/D2)|≤0.6 in an implementation, and meets: 0.2≤|(R11/D1)/(R12/D2)|≤0.55 in an implementation.

In this embodiment, the optical lens assembly of the disclosure meets: D1/H/FOV≤0.1, FOV refers to the maximum field of view of the optical lens assembly, D1 refers to the maximum effective clear diameter of the first-side surface of the first lens corresponding to a maximum field of view of the optical lens assembly, and H refers to the image height corresponding to the maximum field of view of the optical lens assembly. By controlling the maximum field of view FOV of the optical lens assembly, the maximum effective clear diameter of the first-side surface of the first lens corresponding to a maximum field of view of the optical lens assembly, and the image height corresponding to the maximum field of view of the optical lens assembly to meet a conditional expression D1/H/FOV≤0.1, and with the image height corresponding to the maximum field of view of the optical system of the lens and the maximum field of view FOV unchanged, the maximum clear diameter of the lens is smaller, such that miniaturization may be realized. More specifically, the D1, the H, and the FOV meets: D1/H/FOV≤0.075. By controlling the D1, the H, and the FOV to meet D1/H/FOV≤0.075, miniaturization may further be realized. The D1, the H, and the FOV meets: D1/H/FOV≤0.05 in an implementation.

In this embodiment, the optical lens assembly of the disclosure meets: TTL/H/FOV≤0.2, where FOV refers to the maximum field of view of the optical lens assembly, H refers to the image height corresponding to the maximum field of view of the optical lens assembly, and TTL refers to the distance from the center of the first-side surface of the first lens to the imaging surface of the optical lens assembly on the optical axis. By controlling the maximum field of view FOV of the optical lens assembly, the image height corresponding to the maximum field of view of the optical lens assembly, and the distance from the center of the first-side surface of the first lens to the imaging surface of the optical lens assembly on the optical axis to meet a conditional expression TTL/H/FOV≤0.2, and with the image height corresponding to the maximum field of view of the optical system of the lens and the maximum field of view FOV unchanged, the total length of the optical system is decreased, such that miniaturization may be realized. More specifically, the TTL, the H, and the FOV meets: TTL/H/FOV≤0.15. By controlling the TTL, the H, and the FOV to meet TTL/H/FOV≤0.15, in an implementation, the total length of the optical system may be decreased, thereby further realizing miniaturization. The TTL, the H, and the FOV meets: TTL/H/FOV≤0.12 in an implementation.

In this embodiment, the optical lens assembly of the disclosure meets: 0.5≤(H/2)/(F×tan(θ/2))≤1.5, H refers to the image height corresponding to the maximum field of view of the optical lens assembly, F refers to the total effective focal length of the optical lens assembly, and θ refers to a radian value corresponding to the maximum field of view FOV of the optical lens assembly. By controlling the image height corresponding to the maximum field of view FOV of the optical lens assembly, the total effective focal length of the optical lens assembly, and radian value corresponding to the maximum field of view FOV of the optical lens assembly to meet a conditional expression 0.5≤(H/2)/(F×tan(θ/2))≤1.5, and with an ideal image height unchanged, if an actual image height is closer to the ideal image height, it indicates that lens distortion is smaller. More specifically, the H, the F, and the θ meets: 0.65≤(H/2)/(F×tan(θ/2))≤1.4. By controlling the H, the F, and the θ to meet 0.65≤(H/2)/(F×tan(θ/2))≤1.4, small distortion may further be realized. The H, the F, and the θ meets 0.8≤(H/2)/(F×tan(θ/2))≤1.2 in an implementation, and meets: 0.9≤(H/2)/(F×tan(θ/2))≤1.05 in an implementation.

In this embodiment, the optical lens assembly of the disclosure meets: −0.75≤R21/(R22+d2)≤−0.1, where R21 refers to the curvature radius of the first-side surface of the second lens, R22 refers to the curvature radius of the second-side surface of the second lens, and d2 refers to a center thickness of the second lens. By controlling the curvature radii and center thicknesses of the two side surfaces of the second lens, the second lens with both side surfaces being concave surfaces may effectively diverge the light rays in the front, thereby achieving high illuminance and large image surface required for imaging. Preferably, −0.85≤R21/(R22+d2)≤−0.085.

In this embodiment, the optical lens assembly of the disclosure meets: 0.28≤d2/ET2≤0.65, where d2 refers to the center thickness of the second lens, and ET2 refers to an edge thickness of the second lens. By controlling the edge thickness of the second lens to be thick and the center thickness to be thin, an optical path difference between a center field of view and an edge field of view may be regulated and controlled, such that the light rays of all field of views are effectively diverged with a small aperture, matching a large aperture application, thereby realizing high illuminance. Preferably, 0.32≤d2/ET2≤0.75.

In this embodiment, the optical lens assembly of the disclosure meets: 0.5≤R11/F≤2.8, where R11 refers to the curvature radius of the first-side surface of the first lens, and the F refers to the total effective focal length of the optical lens assembly. When the total effective focal length of the optical lens assembly is fixed, the curvature radius of the first-side surface of the first lens is controlled, such that the height of the light ray may be effectively decreased, so as to reduce a front end aperture of the optical lens while eliminating peripheral aberration light rays, thereby realizing high resolution. Preferably, 0.65≤R11/F≤2.5.

In this embodiment, the optical lens assembly of the disclosure meets: 0.35≤R31/F≤1.5, where R31 refers to the curvature radius of the first-side surface of the third lens, and the F refers to the total effective focal length of the optical lens assembly. By controlling the first-side surface of the third lens to be a convex surface with a small curvature radius, the convergence compression of the light rays is realized, and light ray losses due to excessive divergence are avoided, thereby facilitating high illuminance and miniaturization. Preferably, 0.45≤R31/F≤1.25.

In this embodiment, the optical lens assembly of the disclosure meets: −3.5≤R52/R61≤−0.35, where R52 refers to the curvature radius of the second-side surface of the fifth lens, and R61 refers to the curvature radius of the first-side surface of the sixth lens. By controlling the second-side surface of the fifth lens and the first-side surface of the sixth lens to be two continuous convex surfaces, the light rays may be effectively converged at this point for two times, and the aberration caused by the front concave surface is corrected, thereby realizing high resolution. Preferably, −3≤R52/R61≤−0.45.

In this embodiment, the optical lens assembly of the disclosure meets: −2≤(R52*F)/(R61*TTL)≤−0.16, where the R52 refers to the curvature radius of the second-side surface of the fifth lens, the F refers to the total effective focal length of the optical lens assembly, the R61 refers to the curvature radius of the first-side surface of the sixth lens, and the TTL refers to the distance from the center of the first-side surface of the first lens to the imaging surface of the optical lens assembly on the optical axis. By controlling the second-side surface of the fifth lens and the first-side surface of the sixth lens to be two continuous convex surfaces, the light rays may be effectively converged at this point for two times without affecting the overall trend of the light rays, thereby achieving the overall low sensitivity and miniaturization of the optical lens assembly. Preferably, −1.75≤(R52*F)/(R61*TTL)≤−0.2.

In this embodiment, the optical lens assembly of the disclosure meets: −1.25≤R81/F≤−0.2, where R81 refers to the curvature radius of the first-side surface of the eighth lens, the F refers to the total effective focal length of the optical lens assembly. By controlling the first-side surface of the eighth lens to be a concave surface and relatively curved, excessive convergence of the light rays may be avoided, thereby facilitating the control of a principal light ray angle. Preferably, −1≤R81/F≤−0.3.

In this embodiment, the optical lens assembly of the disclosure meets: −4.5≤F1/F8≤−1, where the F1 refers to the effective focal length of the first lens, and F8 refers to an effective focal length of the eighth lens. By controlling the focal lengths of the first lens and the eighth lens to be positive and negative, respectively, the collection and imaging of the light rays are affected, such that the overall high imaging quality of the optical lens assembly is improved, and the imaging quality of at least eight million pixels may be realized. Preferably, −3.75≤F1/F8≤−1.2.

In this embodiment, the optical lens assembly of the disclosure meets: 0.35≤(d6+d7)/F≤0.68, where d6 refers to the center thickness of the sixth lens, d7 refers to the center thickness of the seventh lens, and the F refers to the total effective focal length of the optical lens assembly. By controlling the sum of the center thicknesses of the sixth lens and the seventh lens to be relatively small, miniaturization is realized while ensuring the long-focus application of the optical lens assembly. Preferably, 0.38≤(d6+d7)/F≤0.65.

In this embodiment, the optical lens assembly of the disclosure meets: −3.8≤F6/F7≤−0.4, where F6 refers to an effective focal length of the sixth lens, and F7 refers to an effective focal length of the seventh lens. An aberration is balanced by controlling the focal lengths of the sixth lens and seventh lens to be positive and negative respectively and have close numerical values. In some embodiments, the sixth lens and the seventh lens are glass spherical lenses. By controlling a ratio of the focal lengths of the sixth lens and seventh lens, the stability of imaging is maintained when an ambient temperature fluctuates. Preferably, −3.5≤F6/F7≤−0.5.

In this embodiment, as shown in FIG. 43, each of lenses of the optical lens assembly meets the followings: when a first-side surface of one of the lenses is a convex surface or a second-side surface of the one of the lenses is a concave surface, the optical lens assembly of the disclosure meets: Sag(D/2)/n>Sag(D/2)/(n+1), where Sag(D/2)/n refers to a sagittal height of the lens at one-nth of an optical axis, and Sag(D/2)/(n+1) refers to a sagittal height of the one of the lenses at one-(n+1)th of the optical axis, where n≥1; and when the first-side surface of the one of the lenses is the concave surface or the second-side surface is the convex surface, the optical lens assembly of the disclosure meets: Sag(D/2)/n>Sag(D/2)/(n+1), where the Sag(D/2)/n refers to a sagittal height of the lens at one-nth of an optical axis, and the Sag(D/2)/(n+1) refers to a sagittal height of the one of the lenses at one-(n+1)th of the optical axis, where n≥1. By controlling the sagittal height of each of lenses of the optical lens assembly to vary monotonically with the increasing of the apertures on both sides of the lens, a surface type of the lens changes subtly when the optical lens assembly is subject to high and low temperature changes, such that the change in focal length is stable, thereby realizing stable imaging under high and low temperature changes.

In this embodiment, according to requirements, the optical lens assembly of the disclosure may further include an optical filter and/or protective glass disposed between the eighth lens and the imaging surface. The optical filter may filter lights having specific wavelengths. The protective glass may prevent a second side element (e.g., a chip) of the optical lens assembly from being damaged.

In this embodiment, the first lens to the eighth lens may include an aspheric lens. The disclosure does not specifically limit the specific number of spherical lenses and aspheric lenses, and the number of the aspheric lenses may be increased when the focus is on resolution quality. In particular, in order to improve the resolution quality of the optical system, the first lens, the second lens, the third lens, the fourth lens, the fifth lens, the sixth lens, the seventh lens, and the eighth lens may all be aspheric lenses. The aspheric lens has a characteristic that a curvature keeps changing from the center of the lens to the periphery. Unlike a spherical lens with a constant curvature from the center of the lens to the periphery, the aspheric lens has the characteristic of a better curvature radius and the advantages of improving distortions and improving astigmatic aberrations. By using the aspheric lens, aberrations during imaging may be eliminated as much as possible, thereby improving the imaging quality of the lens. The arrangement of the aspheric lens facilitates correction of a system aberration, thereby improving resolution.

In this embodiment, the first lens, the second lens, the third lens, the fourth lens, the fifth lens, the sixth lens, the seventh lens, and the eighth lens may all be glass lenses. The optical lens assembly made of glass may inhibit a back focal length of the optical lens assembly from shifting with temperature changes, thereby improving the stability of the system. Meanwhile, the use of a glass material may avoid the problems of the image blurring of the lens caused by high and low temperature changes in an environment used, affecting the normal use of the lens. Specifically, when focusing on temperature performance and resolution quality, the first lens to the eighth lens may all be glass aspheric lenses. In an application scenario with a low requirement for temperature stability, the first lens to the eighth lens in the optical lens assembly may also be made of plastic. Manufacturing costs may be effectively reduced by using plastic to manufacture the optical lens assembly. Definitely, the first lens to the eighth lens in the optical lens assembly may also be made by a combination of plastic and glass.

According to the optical lens assembly of the above implementations of the disclosure, by rationally setting the parameters such as the shapes, refractive powers, and the lie of the lenses, the optical lens assembly has at least one beneficial effects of high resolution, miniaturization, a small diameter, low sensitivity, high light flux, a long focal length, small distortion, or high performance, such that the optical lens assembly may better meet requirements of continuous development and application of vehicle front-view lenses.

However, those skilled in the art should know that the number of the lenses forming the lens may be changed without departing from the technical solutions claimed in the disclosure to achieve each result and advantage described in the specification. For example, although descriptions are made in the embodiments with eight lenses as an example, the optical lens assembly includes, but is not limited to, eight lenses. If necessary, the optical lens assembly may further include another number of lenses. Specific examples for the optical lens assembly applicable to the above embodiments are further described below with reference to the drawings.

### Example 25

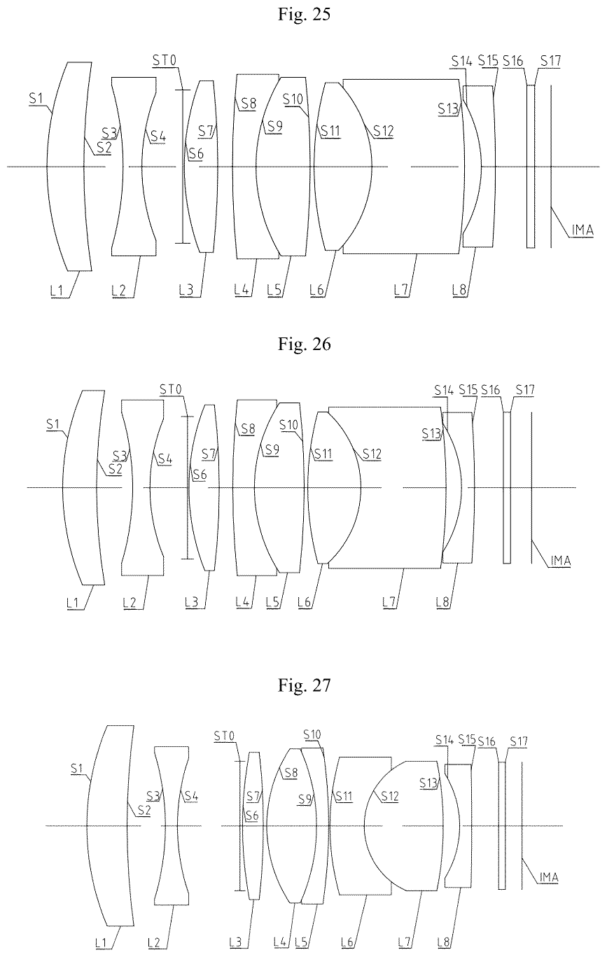

An optical lens assembly of Example 25 of the disclosure is described below with reference to FIG. 25. FIG. 25 is a schematic structural diagram of an optical lens assembly according to Example 25 of the disclosure.

As shown in FIG. 25, the optical lens assembly sequentially includes from a first side to a second side along an optical axis: a first lens L1, a second lens L2, a third lens L3, a fourth lens L4, a fifth lens L5, a sixth lens L6, a seventh lens L7, and an eighth lens L8.

The first lens L1 is a convex-concave lens having a positive refractive power, with a first-side surface of the first lens S1 being a convex surface and a second-side surface of the first lens S2 being a concave surface. The second lens L2 is a concave-concave lens having a negative refractive power, with a first-side surface of the second lens S3 being a concave surface and a second-side surface of the second lens S4 being a concave surface. The third lens L3 is a convex-convex lens having a positive refractive power, with a first-side surface of the third lens S6 being a convex surface and a second-side surface of the third lens S7 being a convex surface. The fourth lens L4 is a convex-concave lens having a negative refractive power, with a first-side surface of the fourth lens S8 being a convex surface and a second-side surface of the fourth lens S9 being a concave surface. The fifth lens L5 is a convex-convex lens having a positive refractive power, with a first-side surface of the fifth lens S9 being a convex surface and a second-side surface of the fifth lens S10 being a convex surface. The sixth lens L6 is a convex-convex lens having a positive refractive power, with a first-side surface of the sixth lens S11 being a convex surface and a second-side surface of the sixth lens S12 being a convex surface. The seventh lens L7 is a concave-convex lens having a negative refractive power, with a first-side surface of the seventh lens S12 being a concave surface and a second-side surface of the seventh lens S13 being a convex surface. The eighth lens L8 is a concave-convex lens having a negative refractive power, with a first-side surface of the eighth lens S14 being a concave surface and a second-side surface of the eighth lens S15 being a convex surface. The fourth lens L4 and the fifth lens L5 are cemented to form a double cemented lens; and the sixth lens L6 and the seventh lens L7 are cemented to form a double cemented lens.

The optical lens assembly further includes a diaphragm STO disposed between the second lens L2 and the third lens L3, the lights entering the optical system are effectively collected, a lens diameter on a rear end of the optical system is reduced, and the assembly sensitivity of the system is reduced. For example, the diaphragm STO may be arranged in a position close to the first-side surface S6 of the third lens L3 between the second lens L2 and the third lens L3.

In this embodiment, the optical lens assembly may further include an optical filter or protective glass disposed between the eighth lens L8 and the imaging surface (IMA). The optical filter or protective glass, for example, has a first-side surface S16 and a second-side surface S17.

When the optical lens assembly is used for photographing, light from an object sequentially passes through the surfaces S1 to S17 and finally images on the imaging surface. When the optical lens assembly is used for projection, light from an image source surface sequentially passes through the surfaces S17 to S1 and finally projects to a target object (not shown).

Table 29 shows a curvature radius R, thickness/distance, refractive index N, and Abbe number Vd of each lens of the optical lens assembly of Example 25. “The thickness/distance” should be understood that, a thickness/distance of a row at which the S1 is located is a center thickness of the first lens L1, a thickness/distance of a row at which the S2 is located is a distance of an air gap between the first lens L1 and the second lens L2, a thickness/distance of a row at which the S3 is located is a center thickness of the second lens L2, and so on.

TABLE 29

| Surface | Curvature | Thickness/ | Refractive | Abbe |
|---|---|---|---|---|
| number | radius R (mm) | distance (mm) | index N | number Vd |
| S1 | 17.2133 | 2.3523 | 1.91 | 35.26 |
| S2 | 44.0423 | 2.5000 | | |
| S3 | −18.6538 | 1.2000 | 1.69 | 31.16 |
| S4 | 12.6337 | 2.6034 | | |
| STO | Infinite | 0.1000 | | |
| S6 | 15.5337 | 2.1300 | 1.91 | 35.26 |
| S7 | −52.8000 | 0.9387 | | |
| S8 | 59.5806 | 1.5000 | 1.74 | 28.30 |
| S9 | 10.8402 | 3.4508 | 1.81 | 40.95 |
| S10 | −54.4500 | 0.2500 | | |
| S11 | 20.0000 | 3.6860 | 1.59 | 68.53 |
| S12 | −7.6966 | 5.9057 | 1.69 | 31.16 |
| S13 | −41.0333 | 1.0705 | | |
| S14 | −8.3300 | 0.9000 | 1.53 | 60.46 |
| S15 | −72.0300 | 2.0000 | | |
| S16 | Infinite | 0.5000 | 1.52 | 64.20 |
| S17 | Infinite | 1.0444 | | |
| IMA | / | / | | |

### Example 26

An optical lens assembly of Example 26 of the disclosure is described below with reference to FIG. 26. FIG. 26 is a schematic structural diagram of an optical lens assembly according to Example 26 of the disclosure.

As shown in FIG. 26, the optical lens assembly sequentially includes from a first side to a second side along an optical axis: a first lens L1, a second lens L2, a third lens L3, a fourth lens L4, a fifth lens L5, a sixth lens L6, a seventh lens L7, and an eighth lens L8.

The first lens L1 is a convex-concave lens having a positive refractive power, with a first-side surface of the first lens S1 being a convex surface and a second-side surface of the first lens S2 being a concave surface. The second lens L2 is a concave-concave lens having a negative refractive power, with a first-side surface of the second lens S3 being a concave surface and a second-side surface of the second lens S4 being a concave surface. The third lens L3 is a convex-convex lens having a positive refractive power, with a first-side surface of the third lens S6 being a convex surface and a second-side surface of the third lens S7 being a convex surface. The fourth lens L4 is a convex-concave lens having a negative refractive power, with a first-side surface of the fourth lens S8 being a convex surface and a second-side surface of the fourth lens S9 being a concave surface. The fifth lens L5 is a convex-convex lens having a positive refractive power, with a first-side surface of the fifth lens S9 being a convex surface and a second-side surface of the fifth lens S10 being a convex surface. The sixth lens L6 is a convex-convex lens having a positive refractive power, with a first-side surface of the sixth lens S11 being a convex surface and a second-side surface of the sixth lens S12 being a convex surface. The seventh lens L7 is a concave-convex lens having a negative refractive power, with a first-side surface of the seventh lens S12 being a concave surface and a second-side surface of the seventh lens S13 being a convex surface. The eighth lens L8 is a concave-convex lens having a negative refractive power, with a first-side surface of the eighth lens S14 being a concave surface and a second-side surface of the eighth lens S15 being a convex surface. The fourth lens L4 and the fifth lens L5 are cemented to form a double cemented lens; and the sixth lens L6 and the seventh lens L7 are cemented to form a double cemented lens.

The optical lens assembly further includes a diaphragm STO disposed between the second lens L2 and the third lens L3, the lights entering the optical system are effectively collected, a lens diameter on a rear end of the optical system is reduced, and the assembly sensitivity of the system is reduced. For example, the diaphragm STO may be arranged in a position close to the first-side surface S6 of the third lens L3 between the second lens L2 and the third lens L3.

In this embodiment, the optical lens assembly may further include an optical filter or protective glass disposed between the eighth lens L8 and the imaging surface (IMA). The optical filter or protective glass, for example, has a first-side surface S16 and a second-side surface S17.

When the optical lens assembly is used for photographing, light from an object sequentially passes through the surfaces S1 to S17 and finally images on the imaging surface. When the optical lens assembly is used for projection, light from an image source surface sequentially passes through the surfaces S17 to S1 and finally projects to a target object (not shown).

Table 30 shows a curvature radius R, thickness/distance, refractive index N, and Abbe number Vd of each lens of the optical lens assembly of Example 26.

TABLE 30

| Surface | Curvature | Thickness/ | Refractive | Abbe |
|---|---|---|---|---|
| number | radius R (mm) | distance (mm) | index N | number Vd |
| S1 | 17.2133 | 2.3523 | 1.91 | 35.26 |
| S2 | 40.5934 | 2.5000 | | |
| S3 | −18.2808 | 1.2000 | 1.69 | 31.16 |
| S4 | 12.6337 | 2.6034 | | |
| STO | infinity | 0.1000 | | |
| S6 | 15.5726 | 2.1000 | 1.91 | 35.26 |
| S7 | −49.5000 | 0.9387 | | |
| S8 | 59.2218 | 1.5000 | 1.74 | 28.30 |
| S9 | 10.8402 | 3.4508 | 1.81 | 40.95 |
| S10 | −54.7250 | 0.2500 | | |
| S11 | 20.0000 | 3.6860 | 1.59 | 68.53 |
| S12 | −7.1015 | 5.9057 | 1.69 | 31.16 |
| S13 | −41.0333 | 1.0705 | | |
| S14 | −8.3300 | 0.9000 | 1.53 | 60.46 |
| S15 | −75.0000 | 2.0000 | | |
| S16 | infinity | 0.5000 | 1.52 | 64.20 |
| S17 | infinity | 1.4594 | | |
| IMA | / | / | | |

### Example 27

An optical lens assembly of Example 27 of the disclosure is described below with reference to FIG. 27. FIG. 27 is a schematic structural diagram of an optical lens assembly according to Example 27 of the disclosure.

As shown in FIG. 27, the optical lens assembly sequentially includes from a first side to a second side along an optical axis: a first lens L1, a second lens L2, a third lens L3, a fourth lens L4, a fifth lens L5, a sixth lens L6, a seventh lens L7, and an eighth lens L8.

The first lens L1 is a convex-concave lens having a positive refractive power, with a first-side surface of the first lens S1 being a convex surface and a second-side surface of the first lens S2 being a concave surface. The second lens L2 is a concave-concave lens having a negative refractive power, with a first-side surface of the second lens S3 being a concave surface and a second-side surface of the second lens S4 being a concave surface. The third lens L3 is a convex-convex lens having a positive refractive power, with a first-side surface of the third lens S6 being a convex surface and a second-side surface of the third lens S7 being a convex surface. The fourth lens L4 is a convex-convex lens having a positive refractive power, with a first-side surface of the fourth lens S8 being a convex surface and a second-side surface of the fourth lens S9 being a convex surface. The fifth lens L5 is a concave-convex lens having a negative refractive power, with a first-side surface of the fifth lens S9 being a concave surface and a second-side surface of the fifth lens S10 being a convex surface. The sixth lens L6 is a convex-concave lens having a negative refractive power, with a first-side surface of the sixth lens S11 being a convex surface and a second-side surface of the sixth lens S12 being a concave surface. The seventh lens L7 is a convex-convex lens having a positive refractive power, with a first-side surface of the seventh lens S12 being a convex surface and a second-side surface of the seventh lens S13 being a convex surface. The eighth lens L8 is a concave-convex lens having a negative refractive power, with a first-side surface of the eighth lens S14 being a concave surface and a second-side surface of the eighth lens S15 being a convex surface. The fourth lens L4 and the fifth lens L5 are cemented to form a double cemented lens; and the sixth lens L6 and the seventh lens L7 are cemented to form a double cemented lens.

The optical lens assembly further includes a diaphragm STO disposed between the second lens L2 and the third lens L3, the lights entering the optical system are effectively collected, a lens diameter on a rear end of the optical system is reduced, and the assembly sensitivity of the system is reduced. For example, the diaphragm STO may be arranged in a position close to the first-side surface S6 of the third lens L3 between the second lens L2 and the third lens L3.

In this embodiment, the optical lens assembly may further include an optical filter or protective glass disposed between the eighth lens L8 and the imaging surface (IMA). The optical filter or protective glass, for example, has a first-side surface S16 and a second-side surface S17.

When the optical lens assembly is used for photographing, light from an object sequentially passes through the surfaces S1 to S17 and finally images on the imaging surface. When the optical lens assembly is used for projection, light from an image source surface sequentially passes through the surfaces S17 to S1 and finally projects to a target object (not shown).

Table 31 shows a curvature radius R, thickness/distance, refractive index N, and Abbe number Vd of each lens of the optical lens assembly of Example 27.

TABLE 31

| Surface | Curvature | Thickness/ | Refractive | Abbe |
|---|---|---|---|---|
| number | radius R (mm) | distance (mm) | index N | number Vd |
| S1 | 19.0372 | 2.9948 | 1.91 | 35.26 |
| S2 | 54.6840 | 2.8576 | | |
| S3 | −18.7294 | 0.9000 | 1.69 | 31.16 |
| S4 | 15.5827 | 4.6578 | | |
| STO | infinity | 0.2000 | | |
| S6 | 29.7174 | 1.5517 | 1.91 | 35.26 |
| S7 | −48.6734 | 0.2500 | | |
| S8 | 10.3822 | 3.7178 | 1.59 | 68.53 |
| S9 | −14.0302 | 0.9000 | 1.83 | 37.23 |
| S10 | −39.9653 | 0.1000 | | |
| S11 | 18.7541 | 2.5488 | 2.00 | 25.44 |
| S12 | 5.2553 | 5.9000 | 1.69 | 31.16 |
| S13 | −24.3445 | 1.2213 | | |
| S14 | −7.3611 | 0.9000 | 1.69 | 31.16 |
| S15 | −205.9212 | 2.0000 | | |
| S16 | infinity | 0.5000 | 1.52 | 64.20 |
| S17 | infinity | 1.2472 | | |
| IMA | / | / | | |

### Example 28

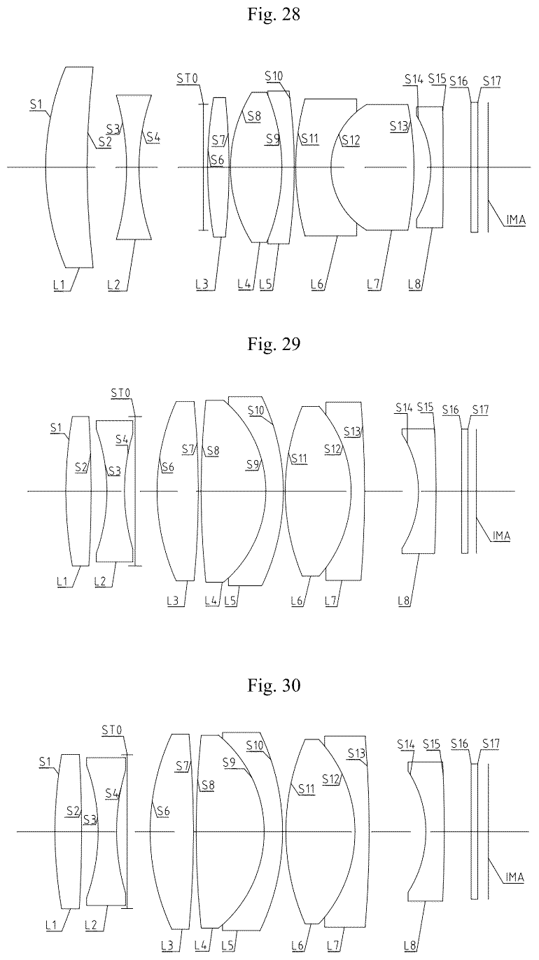

An optical lens assembly of Example 28 of the disclosure is described below with reference to FIG. 28. FIG. 28 is a schematic structural diagram of an optical lens assembly according to Example 28 of the disclosure.

As shown in FIG. 28, the optical lens assembly sequentially includes from a first side to a second side along an optical axis: a first lens L1, a second lens L2, a third lens L3, a fourth lens L4, a fifth lens L5, a sixth lens L6, a seventh lens L7, and an eighth lens L8.

The first lens L1 is a convex-concave lens having a positive refractive power, with a first-side surface of the first lens S1 being a convex surface and a second-side surface of the first lens S2 being a concave surface. The second lens L2 is a concave-concave lens having a negative refractive power, with a first-side surface of the second lens S3 being a concave surface and a second-side surface of the second lens S4 being a concave surface. The third lens L3 is a convex-convex lens having a positive refractive power, with a first-side surface of the third lens S6 being a convex surface and a second-side surface of the third lens S7 being a convex surface. The fourth lens L4 is a convex-convex lens having a positive refractive power, with a first-side surface of the fourth lens S8 being a convex surface and a second-side surface of the fourth lens S9 being a convex surface. The fifth lens L5 is a concave-convex lens having a negative refractive power, with a first-side surface of the fifth lens S9 being a concave surface and a second-side surface of the fifth lens S10 being a convex surface. The sixth lens L6 is a convex-concave lens having a negative refractive power, with a first-side surface of the sixth lens S11 being a convex surface and a second-side surface of the sixth lens S12 being a concave surface. The seventh lens L7 is a convex-convex lens having a positive refractive power, with a first-side surface of the seventh lens S12 being a convex surface and a second-side surface of the seventh lens S13 being a convex surface. The eighth lens L8 is a concave-convex lens having a negative refractive power, with a first-side surface of the eighth lens S14 being a concave surface and a second-side surface of the eighth lens S15 being a convex surface. The fourth lens L4 and the fifth lens L5 are cemented to form a double cemented lens; and the sixth lens L6 and the seventh lens L7 are cemented to form a double cemented lens.

The optical lens assembly further includes a diaphragm STO disposed between the second lens L2 and the third lens L3, the lights entering the optical system are effectively collected, a lens diameter on a rear end of the optical system is reduced, and the assembly sensitivity of the system is reduced. For example, the diaphragm STO may be arranged in a position close to the first-side surface S6 of the third lens L3 between the second lens L2 and the third lens L3.

In this embodiment, the optical lens assembly may further include an optical filter or protective glass disposed between the eighth lens L8 and the imaging surface (IMA). The optical filter or protective glass, for example, has a first-side surface S16 and a second-side surface S17.

When the optical lens assembly is used for photographing, light from an object sequentially passes through the surfaces S1 to S17 and finally images on the imaging surface. When the optical lens assembly is used for projection, light from an image source surface sequentially passes through the surfaces S17 to S1 and finally projects to a target object (not shown).

Table 32 shows a curvature radius R, thickness/distance, refractive index N, and Abbe number Vd of each lens of the optical lens assembly of Example 28.

TABLE 32

| Surface | Curvature | Thickness/ | Refractive | Abbe |
|---|---|---|---|---|
| number | radius R (mm) | distance (mm) | index N | number Vd |
| S1 | 19.0372 | 2.9948 | 1.91 | 35.26 |
| S2 | 60.0000 | 2.8576 | | |
| S3 | −18.7294 | 0.9000 | 1.69 | 31.16 |
| S4 | 15.5827 | 4.6578 | | |
| STO | infinity | 0.3000 | | |
| S6 | 29.7174 | 1.5517 | 1.91 | 35.26 |
| S7 | −48.6734 | 0.1000 | | |
| S8 | 10.3822 | 3.7178 | 1.59 | 68.53 |
| S9 | −14.0302 | 0.9000 | 1.83 | 37.23 |
| S10 | −39.9653 | 0.1000 | | |
| S11 | 18.7541 | 2.5488 | 2.00 | 25.44 |
| S12 | 5.3073 | 6.0000 | 1.69 | 31.16 |
| S13 | −24.3445 | 1.2213 | | |
| S14 | −7.3611 | 0.9000 | 1.69 | 31.16 |
| S15 | −205.9212 | 2.0000 | | |
| S16 | infinity | 0.5000 | 1.52 | 64.20 |
| S17 | infinity | 0.7433 | | |
| IMA | / | / | | |

### Example 29

An optical lens assembly of Example 29 of the disclosure is described below with reference to FIG. 29. FIG. 29 is a schematic structural diagram of an optical lens assembly according to Example 29 of the disclosure.

As shown in FIG. 29, the optical lens assembly sequentially includes from a first side to a second side along an optical axis: a first lens L1, a second lens L2, a third lens L3, a fourth lens L4, a fifth lens L5, a sixth lens L6, a seventh lens L7, and an eighth lens L8.

The first lens L1 is a convex-convex lens having a positive refractive power, with a first-side surface of the first lens S1 being a convex surface and a second-side surface of the first lens S2 being a convex surface. The second lens L2 is a concave-concave lens having a negative refractive power, with a first-side surface of the second lens S3 being a concave surface and a second-side surface of the second lens S4 being a concave surface. The third lens L3 is a convex-convex lens having a positive refractive power, with a first-side surface of the third lens S6 being a convex surface and a second-side surface of the third lens S7 being a convex surface. The fourth lens L4 is a convex-convex lens having a positive refractive power, with a first-side surface of the fourth lens S8 being a convex surface and a second-side surface of the fourth lens S9 being a convex surface. The fifth lens L5 is a concave-convex lens having a negative refractive power, with a first-side surface of the fifth lens S9 being a concave surface and a second-side surface of the fifth lens S10 being a convex surface. The sixth lens L6 is a convex-convex lens having a positive refractive power, with a first-side surface of the sixth lens S11 being a convex surface and a second-side surface of the sixth lens S12 being a convex surface. The seventh lens L7 is a concave-convex lens having a negative refractive power, with a first-side surface of the seventh lens S12 being a concave surface and a second-side surface of the seventh lens S13 being a convex surface. The eighth lens L8 is a concave-convex lens having a negative refractive power, with a first-side surface of the eighth lens S14 being a concave surface and a second-side surface of the eighth lens S15 being a convex surface. The fourth lens L4 and the fifth lens L5 are cemented to form a double cemented lens; and the sixth lens L6 and the seventh lens L7 are cemented to form a double cemented lens.

The optical lens assembly further includes a diaphragm STO disposed between the second lens L2 and the third lens L3, the lights entering the optical system are effectively collected, a lens diameter on a rear end of the optical system is reduced, and the assembly sensitivity of the system is reduced. For example, the diaphragm STO may be arranged in a position close to the first-side surface S6 of the third lens L3 between the second lens L2 and the third lens L3.

In this embodiment, the optical lens assembly may further include an optical filter or protective glass disposed between the eighth lens L8 and the imaging surface (IMA). The optical filter or protective glass, for example, has a first-side surface S16 and a second-side surface S17.

When the optical lens assembly is used for photographing, light from an object sequentially passes through the surfaces S1 to S17 and finally images on the imaging surface. When the optical lens assembly is used for projection, light from an image source surface sequentially passes through the surfaces S17 to S1 and finally projects to a target object (not shown).

Table 33 shows a curvature radius R, thickness/distance, refractive index N, and Abbe number Vd of each lens of the optical lens assembly of Example 29

TABLE 33

| Surface | Curvature | Thickness/ | Refractive | Abbe |
|---|---|---|---|---|
| number | radius R (mm) | distance (mm) | index N | number Vd |
| S1 | 34.1223 | 2.0302 | 1.91 | 35.26 |
| S2 | −96.0400 | 1.2614 | | |
| S3 | −14.7971 | 1.4000 | 1.69 | 31.16 |
| S4 | 16.1608 | 0.8600 | | |
| STO | infinity | 1.7460 | | |
| S6 | 17.4806 | 3.3045 | 1.91 | 35.26 |
| S7 | −76.8320 | 0.2200 | | |
| S8 | 70.0000 | 5.1826 | 1.59 | 68.53 |
| S9 | −9.4823 | 1.4000 | 1.83 | 37.23 |
| S10 | −17.3631 | 0.1500 | | |
| S11 | 17.5023 | 5.2689 | 1.59 | 68.53 |
| S12 | −10.2375 | 1.0784 | 1.69 | 31.16 |
| S13 | −89.1000 | 4.3170 | | |
| S14 | −8.5239 | 1.4000 | 1.49 | 70.42 |
| S15 | −110.0000 | 2.0500 | | |
| S16 | infinity | 0.5000 | 1.52 | 64.21 |
| S17 | infinity | 0.6798 | | |
| IMA | / | / | | |

### Example 30

An optical lens assembly of Example 30 of the disclosure is described below with reference to FIG. 30. FIG. 30 is a schematic structural diagram of an optical lens assembly according to Example 30 of the disclosure.

As shown in FIG. 30, the optical lens assembly sequentially includes from a first side to a second side along an optical axis: a first lens L1, a second lens L2, a third lens L3, a fourth lens L4, a fifth lens L5, a sixth lens L6, a seventh lens L7, and an eighth lens L8.

The first lens L1 is a convex-convex lens having a positive refractive power, with a first-side surface of the first lens S1 being a convex surface and a second-side surface of the first lens S2 being a convex surface. The second lens L2 is a concave-concave lens having a negative refractive power, with a first-side surface of the second lens S3 being a concave surface and a second-side surface of the second lens S4 being a concave surface. The third lens L3 is a convex-convex lens having a positive refractive power, with a first-side surface of the third lens S6 being a convex surface and a second-side surface of the third lens S7 being a convex surface. The fourth lens L4 is a convex-convex lens having a positive refractive power, with a first-side surface of the fourth lens S8 being a convex surface and a second-side surface of the fourth lens S9 being a convex surface. The fifth lens L5 is a concave-convex lens having a negative refractive power, with a first-side surface of the fifth lens S9 being a concave surface and a second-side surface of the fifth lens S10 being a convex surface. The sixth lens L6 is a convex-convex lens having a positive refractive power, with a first-side surface of the sixth lens S11 being a convex surface and a second-side surface of the sixth lens S12 being a convex surface. The seventh lens L7 is a concave-convex lens having a negative refractive power, with a first-side surface of the seventh lens S12 being a concave surface and a second-side surface of the seventh lens S13 being a convex surface. The eighth lens L8 is a concave-convex lens having a negative refractive power, with a first-side surface of the eighth lens S14 being a concave surface and a second-side surface of the eighth lens S15 being a convex surface. The fourth lens L4 and the fifth lens L5 are cemented to form a double cemented lens; and the sixth lens L6 and the seventh lens L7 are cemented to form a double cemented lens.

The optical lens assembly further includes a diaphragm STO disposed between the second lens L2 and the third lens L3, the lights entering the optical system are effectively collected, a lens diameter on a rear end of the optical system is reduced, and the assembly sensitivity of the system is reduced. For example, the diaphragm STO may be arranged in a position close to the first-side surface S6 of the third lens L3 between the second lens L2 and the third lens L3.

In this embodiment, the optical lens assembly may further include an optical filter or protective glass disposed between the eighth lens L8 and the imaging surface (IMA). The optical filter or protective glass, for example, has a first-side surface S16 and a second-side surface S17.

When the optical lens assembly is used for photographing, light from an object sequentially passes through the surfaces S1 to S17 and finally images on the imaging surface. When the optical lens assembly is used for projection, light from an image source surface sequentially passes through the surfaces S17 to S1 and finally projects to a target object (not shown).

Table 34 shows a curvature radius R, thickness/distance, refractive index N, and Abbe number Vd of each lens of the optical lens assembly of Example 30

TABLE 34

| Surface | Curvature | Thickness/ | Refractive | Abbe |
|---|---|---|---|---|
| number | radius R (mm) | distance (mm) | index N | number Vd |
| S1 | 34.1223 | 2.0302 | 1.91 | 35.26 |
| S2 | −100.0000 | 1.2614 | | |
| S3 | −14.7971 | 1.4000 | 1.69 | 31.16 |
| S4 | 16.1608 | 0.8110 | | |
| STO | infinity | 1.7460 | | |
| S6 | 17.4806 | 3.3045 | 1.91 | 35.26 |
| S7 | −79.2000 | 0.2000 | | |
| S8 | 70.0000 | 5.1826 | 1.59 | 68.53 |
| S9 | −9.4823 | 1.4000 | 1.83 | 37.23 |
| S10 | −17.3631 | 0.2500 | | |
| S11 | 17.5023 | 5.2689 | 1.59 | 68.53 |
| S12 | −10.2889 | 1.0784 | 1.69 | 31.16 |
| S13 | −87.3180 | 4.3170 | | |
| S14 | −8.5239 | 1.4000 | 1.49 | 70.42 |
| S15 | −120.0000 | 2.0500 | | |
| S16 | infinity | 0.5000 | 1.52 | 64.21 |
| S17 | infinity | 0.8079 | | |
| IMA | / | / | | |

### Example 31

An optical lens assembly of Example 31 of the disclosure is described below with reference to FIG. 31. FIG. 31 is a schematic structural diagram of an optical lens assembly according to Example 31 of the disclosure.

As shown in FIG. 31, the optical lens assembly sequentially includes from a first side to a second side along an optical axis: a first lens L1, a second lens L2, a third lens L3, a fourth lens L4, a fifth lens L5, a sixth lens L6, a seventh lens L7, and an eighth lens L8.

The first lens L1 is a convex-concave lens having a positive refractive power, with a first-side surface of the first lens S1 being a convex surface and a second-side surface of the first lens S2 being a concave surface. The second lens L2 is a concave-concave lens having a negative refractive power, with a first-side surface of the second lens S3 being a concave surface and a second-side surface of the second lens S4 being a concave surface. The third lens L3 is a convex-convex lens having a positive refractive power, with a first-side surface of the third lens S6 being a convex surface and a second-side surface of the third lens S7 being a convex surface. The fourth lens L4 is a convex-convex lens having a positive refractive power, with a first-side surface of the fourth lens S8 being a convex surface and a second-side surface of the fourth lens S9 being a convex surface. The fifth lens L5 is a concave-convex lens having a negative refractive power, with a first-side surface of the fifth lens S9 being a concave surface and a second-side surface of the fifth lens S10 being a convex surface. The sixth lens L6 is a convex-convex lens having a positive refractive power, with a first-side surface of the sixth lens S11 being a convex surface and a second-side surface of the sixth lens S12 being a convex surface. The seventh lens L7 is a concave-convex lens having a negative refractive power, with a first-side surface of the seventh lens S12 being a concave surface and a second-side surface of the seventh lens S13 being a convex surface. The eighth lens L8 is a concave-concave lens having a negative refractive power, with a first-side surface of the eighth lens S14 being a concave surface and a second-side surface of the eighth lens S15 being a concave surface. The fourth lens L4 and the fifth lens L5 are cemented to form a double cemented lens; and the sixth lens L6 and the seventh lens L7 are cemented to form a double cemented lens.

The optical lens assembly further includes a diaphragm STO disposed between the second lens L2 and the third lens L3, the lights entering the optical system are effectively collected, a lens diameter on a rear end of the optical system is reduced, and the assembly sensitivity of the system is reduced. For example, the diaphragm STO may be arranged in a position close to the first-side surface S6 of the third lens L3 between the second lens L2 and the third lens L3.

In this embodiment, the optical lens assembly may further include an optical filter or protective glass disposed between the eighth lens L8 and the imaging surface (IMA). The optical filter or protective glass, for example, has a first-side surface S16 and a second-side surface S17.

When the optical lens assembly is used for photographing, light from an object sequentially passes through the surfaces S1 to S17 and finally images on the imaging surface. When the optical lens assembly is used for projection, light from an image source surface sequentially passes through the surfaces S17 to S1 and finally projects to a target object (not shown).

Table 35 shows a curvature radius R, thickness/distance, refractive index N, and Abbe number Vd of each lens of the optical lens assembly of Example 31

TABLE 35

| Surface | Curvature | Thickness/ | Refractive | Abbe |
|---|---|---|---|---|
| number | radius R (mm) | distance (mm) | index N | number Vd |
| S1 | 20.4248 | 1.9619 | 1.91 | 35.26 |
| S2 | 44.9212 | 1.8546 | | |
| S3 | −14.7843 | 2.5268 | 1.69 | 31.16 |
| S4 | 15.9247 | 1.6010 | | |
| STO | infinity | 0.1000 | | |
| S6 | 16.4114 | 2.8069 | 1.91 | 35.26 |
| S7 | −29.8073 | 0.6000 | | |
| S8 | 20.8203 | 4.1700 | 1.59 | 68.53 |
| S9 | −10.4852 | 3.2035 | 1.83 | 37.23 |
| S10 | −25.4234 | 0.2000 | | |
| S11 | 25.6175 | 3.9406 | 1.59 | 68.53 |
| S12 | −7.2783 | 3.9313 | 1.69 | 31.16 |
| S13 | −40.3036 | 1.4035 | | |
| S14 | −9.0244 | 1.4000 | 1.49 | 70.42 |
| S15 | 36.6320 | 2.0500 | | |
| S16 | infinity | 0.5000 | 1.52 | 64.21 |
| S17 | infinity | 0.6667 | | |
| IMA | / | / | | |

### Example 32

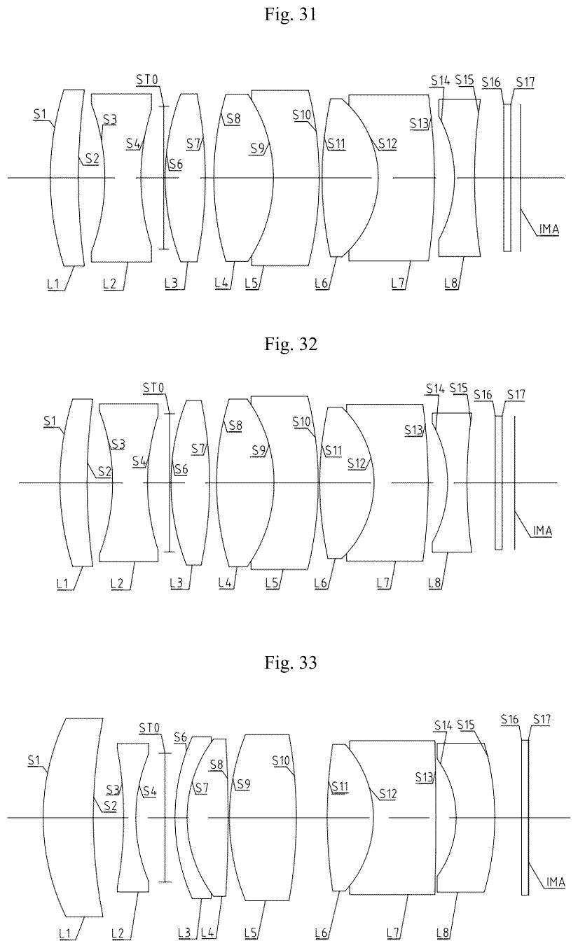

An optical lens assembly of Example 32 of the disclosure is described below with reference to FIG. 32. FIG. 32 is a schematic structural diagram of an optical lens assembly according to Example 32 of the disclosure.

As shown in FIG. 32, the optical lens assembly sequentially includes from a first side to a second side along an optical axis: a first lens L1, a second lens L2, a third lens L3, a fourth lens L4, a fifth lens L5, a sixth lens L6, a seventh lens L7, and an eighth lens L8.

The first lens L1 is a convex-concave lens having a positive refractive power, with a first-side surface of the first lens S1 being a convex surface and a second-side surface of the first lens S2 being a concave surface. The second lens L2 is a concave-concave lens having a negative refractive power, with a first-side surface of the second lens S3 being a concave surface and a second-side surface of the second lens S4 being a concave surface. The third lens L3 is a convex-convex lens having a positive refractive power, with a first-side surface of the third lens S6 being a convex surface and a second-side surface of the third lens S7 being a convex surface. The fourth lens L4 is a convex-convex lens having a positive refractive power, with a first-side surface of the fourth lens S8 being a convex surface and a second-side surface of the fourth lens S9 being a convex surface. The fifth lens L5 is a concave-convex lens having a negative refractive power, with a first-side surface of the fifth lens S9 being a concave surface and a second-side surface of the fifth lens S10 being a convex surface. The sixth lens L6 is a convex-convex lens having a positive refractive power, with a first-side surface of the sixth lens S11 being a convex surface and a second-side surface of the sixth lens S12 being a convex surface. The seventh lens L7 is a concave-convex lens having a negative refractive power, with a first-side surface of the seventh lens S12 being a concave surface and a second-side surface of the seventh lens S13 being a convex surface. The eighth lens L8 is a concave-concave lens having a negative refractive power, with a first-side surface of the eighth lens S14 being a concave surface and a second-side surface of the eighth lens S15 being a concave surface. The fourth lens L4 and the fifth lens L5 are cemented to form a double cemented lens; and the sixth lens L6 and the seventh lens L7 are cemented to form a double cemented lens.

The optical lens assembly further includes a diaphragm STO disposed between the second lens L2 and the third lens L3, the lights entering the optical system are effectively collected, a lens diameter on a rear end of the optical system is reduced, and the assembly sensitivity of the system is reduced. For example, the diaphragm STO may be arranged in a position close to the first-side surface S6 of the third lens L3 between the second lens L2 and the third lens L3.

In this embodiment, the optical lens assembly may further include an optical filter or protective glass disposed between the eighth lens L8 and the imaging surface (IMA). The optical filter or protective glass, for example, has a first-side surface S16 and a second-side surface S17.

When the optical lens assembly is used for photographing, light from an object sequentially passes through the surfaces S1 to S17 and finally images on the imaging surface. When the optical lens assembly is used for projection, light from an image source surface sequentially passes through the surfaces S17 to S1 and finally projects to a target object (not shown).

Table 36 shows a curvature radius R, thickness/distance, refractive index N, and Abbe number Vd of each lens of the optical lens assembly of Example 32.

TABLE 36

| Surface | Curvature | Thickness/ | Refractive | Abbe |
|---|---|---|---|---|
| number | radius R (mm) | distance (mm) | index N | number Vd |
| S1 | 20.4248 | 1.9619 | 1.91 | 35.26 |
| S2 | 44.9212 | 1.8546 | | |
| S3 | −14.7843 | 2.5268 | 1.69 | 31.16 |
| S4 | 15.9247 | 1.6010 | | |
| STO | infinity | 0.1000 | | |
| S6 | 16.4114 | 2.8069 | 1.91 | 35.26 |
| S7 | −29.8073 | 0.5000 | | |
| S8 | 20.8203 | 4.1700 | 1.59 | 68.53 |
| S9 | −10.4852 | 3.2035 | 1.83 | 37.23 |
| S10 | −26.2043 | 0.1000 | | |
| S11 | 25.6175 | 3.9406 | 1.59 | 68.53 |
| S12 | −7.6351 | 3.9313 | 1.69 | 31.16 |
| S13 | −41.1262 | 1.4035 | | |
| S14 | −9.0244 | 1.4000 | 1.49 | 70.42 |
| S15 | 37.3796 | 2.0500 | | |
| S16 | infinity | 0.5000 | 1.52 | 64.21 |
| S17 | infinity | 0.9125 | | |
| IMA | / | / | | |

### Example 33

An optical lens assembly of Example 33 of the disclosure is described below with reference to FIG. 33. FIG. 33 is a schematic structural diagram of an optical lens assembly according to Example 33 of the disclosure.

As shown in FIG. 33, the optical lens assembly sequentially includes from a first side to a second side along an optical axis: a first lens L1, a second lens L2, a third lens L3, a fourth lens L4, a fifth lens L5, a sixth lens L6, a seventh lens L7, and an eighth lens L8.

The first lens L1 is a convex-concave lens having a positive refractive power, with a first-side surface of the first lens S1 being a convex surface and a second-side surface of the first lens S2 being a concave surface. The second lens L2 is a concave-concave lens having a negative refractive power, with a first-side surface of the second lens S3 being a concave surface and a second-side surface of the second lens S4 being a concave surface. The third lens L3 is a convex-concave lens having a negative refractive power, with a first-side surface of the third lens S6 being a convex surface and a second-side surface of the third lens S7 being a convex surface. The fourth lens L4 is a convex-convex lens having a positive refractive power, with a first-side surface of the fourth lens S8 being a convex surface and a second-side surface of the fourth lens S9 being a convex surface. The fifth lens L5 is a convex-convex lens having a positive refractive power, with a first-side surface of the fifth lens S9 being a concave surface and a second-side surface of the fifth lens S10 being a convex surface. The sixth lens L6 is a convex-convex lens having a positive refractive power, with a first-side surface of the sixth lens S11 being a convex surface and a second-side surface of the sixth lens S12 being a convex surface. The seventh lens L7 is a concave-convex lens having a negative refractive power, with a first-side surface of the seventh lens S12 being a concave surface and a second-side surface of the seventh lens S13 being a convex surface. The eighth lens L8 is a concave-convex lens having a negative refractive power, with a first-side surface of the eighth lens S14 being a concave surface and a second-side surface of the eighth lens S15 being a convex surface. The fourth lens L3 and the fifth lens L4 are cemented to form a double cemented lens; and the sixth lens L6 and the seventh lens L7 are cemented to form a double cemented lens.

The optical lens assembly further includes a diaphragm STO disposed between the second lens L2 and the third lens L3, the lights entering the optical system are effectively collected, a lens diameter on a rear end of the optical system is reduced, and the assembly sensitivity of the system is reduced. For example, the diaphragm STO may be arranged in a position close to the first-side surface S6 of the third lens L3 between the second lens L2 and the third lens L3.

In this embodiment, the optical lens assembly may further include an optical filter or protective glass disposed between the eighth lens L8 and the imaging surface (IMA). The optical filter or protective glass, for example, has a first-side surface S16 and a second-side surface S17.

When the optical lens assembly is used for photographing, light from an object sequentially passes through the surfaces S1 to S17 and finally images on the imaging surface. When the optical lens assembly is used for projection, light from an image source surface sequentially passes through the surfaces S17 to S1 and finally projects to a target object (not shown).

Table 37 shows a curvature radius R, thickness/distance, refractive index N, and Abbe number Vd of each lens of the optical lens assembly of Example 33.

TABLE 37

| Surface | Curvature | Thickness/ | Refractive | Abbe |
|---|---|---|---|---|
| number | radius R (mm) | distance (mm) | index N | number Vd |
| S1 | 16.9303 | 3.7365 | 2.00 | 25.44 |
| S2 | 38.0081 | 2.2762 | | |
| S3 | −28.3612 | 0.9000 | 1.81 | 22.69 |
| S4 | 12.2048 | 2.1850 | | |
| STO | infinity | 0.7470 | | |
| S6 | 14.7717 | 0.9000 | 1.92 | 20.88 |
| S7 | 9.6727 | 3.0634 | 1.59 | 68.53 |
| S8 | −102.2036 | 0.1000 | | |
| S9 | 16.6034 | 5.0000 | 1.92 | 20.88 |
| S10 | −35.6132 | 2.3021 | | |
| S11 | 37.0103 | 3.4604 | 1.73 | 54.67 |
| S12 | −8.1542 | 4.6615 | 1.81 | 22.69 |
| S13 | −209.8975 | 1.5156 | | |
| S14 | −7.5121 | 2.8867 | 1.81 | 22.69 |
| S15 | −19.8883 | 2.0000 | | |
| S16 | infinity | 0.5000 | 1.52 | 64.21 |
| S17 | infinity | 0.0385 | | |
| IMA | / | / | | |

### Example 34

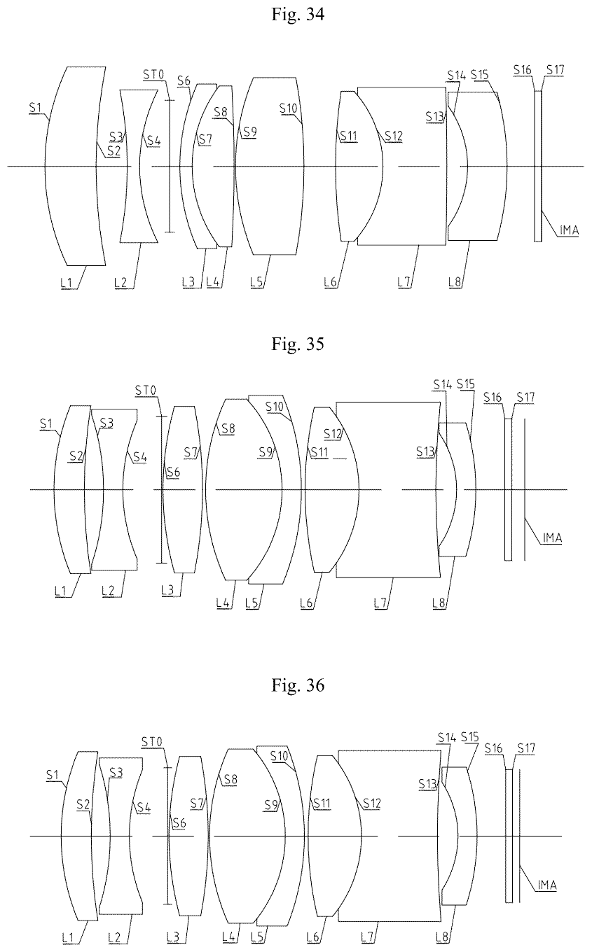

An optical lens assembly of Example 34 of the disclosure is described below with reference to FIG. 34. FIG. 34 is a schematic structural diagram of an optical lens assembly according to Example 34 of the disclosure.

As shown in FIG. 34, the optical lens assembly sequentially includes from a first side to a second side along an optical axis: a first lens L1, a second lens L2, a third lens L3, a fourth lens L4, a fifth lens L5, a sixth lens L6, a seventh lens L7, and an eighth lens L8.

The first lens L1 is a convex-concave lens having a positive refractive power, with a first-side surface of the first lens S1 being a convex surface and a second-side surface of the first lens S2 being a concave surface. The second lens L2 is a concave-concave lens having a negative refractive power, with a first-side surface of the second lens S3 being a concave surface and a second-side surface of the second lens S4 being a concave surface. The third lens L3 is a convex-concave lens having a negative refractive power, with a first-side surface of the third lens S6 being a convex surface and a second-side surface of the third lens S7 being a convex surface. The fourth lens L4 is a convex-convex lens having a positive refractive power, with a first-side surface of the fourth lens S8 being a convex surface and a second-side surface of the fourth lens S9 being a convex surface. The fifth lens L5 is a convex-convex lens having a positive refractive power, with a first-side surface of the fifth lens S9 being a concave surface and a second-side surface of the fifth lens S10 being a convex surface. The sixth lens L6 is a convex-convex lens having a positive refractive power, with a first-side surface of the sixth lens S11 being a convex surface and a second-side surface of the sixth lens S12 being a convex surface. The seventh lens L7 is a concave-convex lens having a negative refractive power, with a first-side surface of the seventh lens S12 being a concave surface and a second-side surface of the seventh lens S13 being a convex surface. The eighth lens L8 is a concave-convex lens having a negative refractive power, with a first-side surface of the eighth lens S14 being a concave surface and a second-side surface of the eighth lens S15 being a convex surface. The fourth lens L3 and the fifth lens L4 are cemented to form a double cemented lens; and the sixth lens L6 and the seventh lens L7 are cemented to form a double cemented lens.

The optical lens assembly further includes a diaphragm STO disposed between the second lens L2 and the third lens L3, the lights entering the optical system are effectively collected, a lens diameter on a rear end of the optical system is reduced, and the assembly sensitivity of the system is reduced. For example, the diaphragm STO may be arranged in a position close to the first-side surface S6 of the third lens L3 between the second lens L2 and the third lens L3.

In this embodiment, the optical lens assembly may further include an optical filter or protective glass disposed between the eighth lens L8 and the imaging surface (IMA). The optical filter or protective glass, for example, has a first-side surface S16 and a second-side surface S17.

When the optical lens assembly is used for photographing, light from an object sequentially passes through the surfaces S1 to S17 and finally images on the imaging surface. When the optical lens assembly is used for projection, light from an image source surface sequentially passes through the surfaces S17 to S1 and finally projects to a target object (not shown).

Table 38 shows a curvature radius R, thickness/distance, refractive index N, and Abbe number Vd of each lens of the optical lens assembly of Example 34.

TABLE 38

| Surface | Curvature | Thickness/ | Refractive | Abbe |
|---|---|---|---|---|
| number | radius R (mm) | distance (mm) | index N | number Vd |
| S1 | 16.9303 | 3.7365 | 2.00 | 25.44 |
| S2 | 38.0081 | 2.2762 | | |
| S3 | −28.6477 | 0.9000 | 1.81 | 22.69 |
| S4 | 12.2048 | 2.1850 | | |
| STO | infinity | 0.7470 | | |
| S6 | 14.7717 | 0.9000 | 1.92 | 20.88 |
| S7 | 9.6727 | 3.0634 | 1.59 | 68.53 |
| S8 | −103.2360 | 0.1000 | | |
| S9 | 16.6034 | 5.0000 | 1.92 | 20.88 |
| S10 | −35.6132 | 2.3021 | | |
| S11 | 37.3730 | 3.4604 | 1.73 | 54.67 |
| S12 | −8.1542 | 4.6615 | 1.81 | 22.69 |
| S13 | −209.8975 | 1.5156 | | |
| S14 | −7.5121 | 2.8867 | 1.81 | 22.69 |
| S15 | −19.8883 | 2.0000 | | |
| S16 | infinity | 0.5000 | 1.52 | 64.21 |
| S17 | infinity | 0.0227 | | |
| IMA | / | / | | |

### Example 35

An optical lens assembly of Example 35 of the disclosure is described below with reference to FIG. 35. FIG. 35 is a schematic structural diagram of an optical lens assembly according to Example 35 of the disclosure.

As shown in FIG. 35, the optical lens assembly sequentially includes from a first side to a second side along an optical axis: a first lens L1, a second lens L2, a third lens L3, a fourth lens L4, a fifth lens L5, a sixth lens L6, a seventh lens L7, and an eighth lens L8.

The first lens L1 is a convex-concave lens having a positive refractive power, with a first-side surface of the first lens S1 being a convex surface and a second-side surface of the first lens S2 being a concave surface. The second lens L2 is a concave-concave lens having a negative refractive power, with a first-side surface of the second lens S3 being a concave surface and a second-side surface of the second lens S4 being a concave surface. The third lens L3 is a convex-convex lens having a positive refractive power, with a first-side surface of the third lens S6 being a convex surface and a second-side surface of the third lens S7 being a convex surface. The fourth lens L4 is a convex-convex lens having a positive refractive power, with a first-side surface of the fourth lens S8 being a convex surface and a second-side surface of the fourth lens S9 being a convex surface. The fifth lens L5 is a concave-convex lens having a negative refractive power, with a first-side surface of the fifth lens S9 being a concave surface and a second-side surface of the fifth lens S10 being a convex surface. The sixth lens L6 is a convex-convex lens having a positive refractive power, with a first-side surface of the sixth lens S11 being a convex surface and a second-side surface of the sixth lens S12 being a convex surface. The seventh lens L7 is a concave-concave lens having a negative refractive power, with a first-side surface of the seventh lens S12 being a concave surface and a second-side surface of the seventh lens S13 being a concave surface. The eighth lens L8 is a concave-convex lens having a negative refractive power, with a first-side surface of the eighth lens S14 being a concave surface and a second-side surface of the eighth lens S15 being a convex surface. The fourth lens L4 and the fifth lens L5 are cemented to form a double cemented lens; and the sixth lens L6 and the seventh lens L7 are cemented to form a double cemented lens.

The optical lens assembly further includes a diaphragm STO disposed between the second lens L2 and the third lens L3, the lights entering the optical system are effectively collected, a lens diameter on a rear end of the optical system is reduced, and the assembly sensitivity of the system is reduced. For example, the diaphragm STO may be arranged in a position close to the first-side surface S6 of the third lens L3 between the second lens L2 and the third lens L3.

In this embodiment, the optical lens assembly may further include an optical filter or protective glass disposed between the eighth lens L8 and the imaging surface (IMA). The optical filter or protective glass, for example, has a first-side surface S16 and a second-side surface S17.

When the optical lens assembly is used for photographing, light from an object sequentially passes through the surfaces S1 to S17 and finally images on the imaging surface. When the optical lens assembly is used for projection, light from an image source surface sequentially passes through the surfaces S17 to S1 and finally projects to a target object (not shown).

Table 39 shows a curvature radius R, thickness/distance, refractive index N, and Abbe number Vd of each lens of the optical lens assembly of Example 35

TABLE 39

| Surface | Curvature | Thickness/ | Refractive | Abbe |
|---|---|---|---|---|
| number | radius R (mm) | distance (mm) | index N | number Vd |
| S1 | 15.8841 | 2.2087 | 1.74 | 44.90 |
| S2 | 39.6809 | 1.3923 | | |
| S3 | −17.3191 | 1.4000 | 1.70 | 41.14 |
| S4 | 12.6155 | 2.8159 | | |
| STO | infinity | 0.1000 | | |
| S6 | 22.1562 | 2.8685 | 1.74 | 44.90 |
| S7 | −31.1246 | 0.2200 | | |
| S8 | 15.4320 | 5.5510 | 1.62 | 53.20 |
| S9 | −9.6305 | 1.4000 | 1.76 | 40.11 |
| S10 | −17.7356 | 0.2724 | | |
| S11 | 26.9021 | 3.9140 | 1.62 | 58.15 |
| S12 | −9.3197 | 5.5749 | 1.76 | 27.55 |
| S13 | 61.7400 | 1.5022 | | |
| S14 | −7.2296 | 1.4000 | 1.75 | 37.50 |
| S15 | −16.3133 | 2.1000 | | |
| S16 | infinity | 0.5000 | 1.52 | 64.21 |
| S17 | infinity | 0.9450 | | |
| IMA | / | / | | |

### Example 36

An optical lens assembly of Example 36 of the disclosure is described below with reference to FIG. 36. FIG. 36 is a schematic structural diagram of an optical lens assembly according to Example 36 of the disclosure.

As shown in FIG. 36, the optical lens assembly sequentially includes from a first side to a second side along an optical axis: a first lens L1, a second lens L2, a third lens L3, a fourth lens L4, a fifth lens L5, a sixth lens L6, a seventh lens L7, and an eighth lens L8.

The first lens L1 is a convex-concave lens having a positive refractive power, with a first-side surface of the first lens S1 being a convex surface and a second-side surface of the first lens S2 being a concave surface. The second lens L2 is a concave-concave lens having a negative refractive power, with a first-side surface of the second lens S3 being a concave surface and a second-side surface of the second lens S4 being a concave surface. The third lens L3 is a convex-convex lens having a positive refractive power, with a first-side surface of the third lens S6 being a convex surface and a second-side surface of the third lens S7 being a convex surface. The fourth lens L4 is a convex-convex lens having a positive refractive power, with a first-side surface of the fourth lens S8 being a convex surface and a second-side surface of the fourth lens S9 being a convex surface. The fifth lens L5 is a concave-convex lens having a negative refractive power, with a first-side surface of the fifth lens S9 being a concave surface and a second-side surface of the fifth lens S10 being a convex surface. The sixth lens L6 is a convex-convex lens having a positive refractive power, with a first-side surface of the sixth lens S11 being a convex surface and a second-side surface of the sixth lens S12 being a convex surface. The seventh lens L7 is a concave-concave lens having a negative refractive power, with a first-side surface of the seventh lens S12 being a concave surface and a second-side surface of the seventh lens S13 being a concave surface. The eighth lens L8 is a concave-convex lens having a negative refractive power, with a first-side surface of the eighth lens S14 being a concave surface and a second-side surface of the eighth lens S15 being a convex surface. The fourth lens L4 and the fifth lens L5 are cemented to form a double cemented lens; and the sixth lens L6 and the seventh lens L7 are cemented to form a double cemented lens.

The optical lens assembly further includes a diaphragm STO disposed between the second lens L2 and the third lens L3, the lights entering the optical system are effectively collected, a lens diameter on a rear end of the optical system is reduced, and the assembly sensitivity of the system is reduced. For example, the diaphragm STO may be arranged in a position close to the first-side surface S6 of the third lens L3 between the second lens L2 and the third lens L3.

In this embodiment, the optical lens assembly may further include an optical filter or protective glass disposed between the eighth lens L8 and the imaging surface (IMA). The optical filter or protective glass, for example, has a first-side surface S16 and a second-side surface S17.

When the optical lens assembly is used for photographing, light from an object sequentially passes through the surfaces S1 to S17 and finally images on the imaging surface. When the optical lens assembly is used for projection, light from an image source surface sequentially passes through the surfaces S17 to S1 and finally projects to a target object (not shown).

Table 40 shows a curvature radius R, thickness/distance, refractive index N, and Abbe number Vd of each lens of the optical lens assembly of Example 36

TABLE 40

| Surface | Curvature | Thickness/ | Refractive | Abbe |
|---|---|---|---|---|
| number | radius R (mm) | distance (mm) | index N | number Vd |
| S1 | 15.8841 | 2.2087 | 1.74 | 44.90 |
| S2 | 39.6809 | 1.3923 | | |
| S3 | −17.3187 | 1.4000 | 1.70 | 41.14 |
| S4 | 12.6155 | 2.8159 | | |
| STO | infinity | 0.1000 | | |
| S6 | 22.1562 | 2.8685 | 1.74 | 44.90 |
| S7 | −30.9690 | 0.1000 | | |
| S8 | 15.4320 | 5.5510 | 1.62 | 53.20 |
| S9 | −9.7278 | 1.4000 | 1.76 | 40.11 |
| S10 | −17.6470 | 0.2724 | | |
| S11 | 25.3252 | 3.9140 | 1.62 | 58.15 |
| S12 | −9.1361 | 5.5749 | 1.76 | 27.55 |
| S13 | 75.0000 | 1.5022 | | |
| S14 | −7.1580 | 1.4000 | 1.75 | 37.50 |
| S15 | −16.3133 | 2.1000 | | |
| S16 | infinity | 0.5000 | 1.52 | 64.21 |
| S17 | infinity | 0.5266 | | |
| IMA | / | / | | |

### Example 37

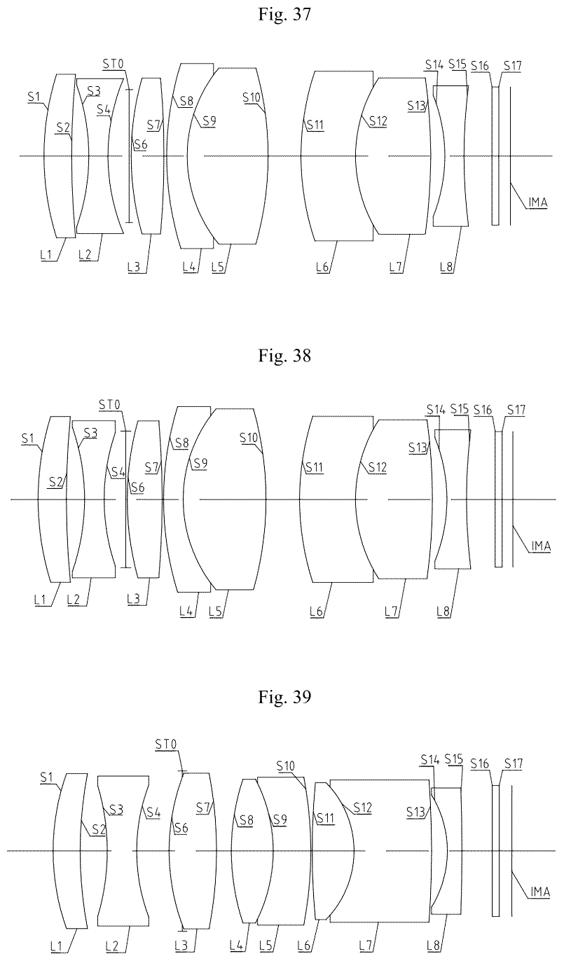

An optical lens assembly of Example 37 of the disclosure is described below with reference to FIG. 37. FIG. 37 is a schematic structural diagram of an optical lens assembly according to Example 37 of the disclosure.

As shown in FIG. 37, the optical lens assembly sequentially includes from a first side to a second side along an optical axis: a first lens L1, a second lens L2, a third lens L3, a fourth lens L4, a fifth lens L5, a sixth lens L6, a seventh lens L7, and an eighth lens L8.

The first lens L1 is a convex-concave lens having a positive refractive power, with a first-side surface of the first lens S1 being a convex surface and a second-side surface of the first lens S2 being a concave surface. The second lens L2 is a concave-concave lens having a negative refractive power, with a first-side surface of the second lens S3 being a concave surface and a second-side surface of the second lens S4 being a concave surface. The third lens L3 is a convex-convex lens having a positive refractive power, with a first-side surface of the third lens S6 being a convex surface and a second-side surface of the third lens S7 being a convex surface. The fourth lens L4 is a convex-concave lens having a negative refractive power, with a first-side surface of the fourth lens S8 being a convex surface and a second-side surface of the fourth lens S9 being a concave surface. The fifth lens L5 is a convex-convex lens having a positive refractive power, with a first-side surface of the fifth lens S9 being a convex surface and a second-side surface of the fifth lens S10 being a convex surface. The sixth lens L6 is a convex-concave lens having a negative refractive power, with a first-side surface of the sixth lens S11 being a convex surface and a second-side surface of the sixth lens S12 being a concave surface. The seventh lens L7 is a convex-convex lens having a positive refractive power, with a first-side surface of the seventh lens S12 being a convex surface and a second-side surface of the seventh lens S13 being a convex surface. The eighth lens L8 is a concave-concave lens having a negative refractive power, with a first-side surface of the eighth lens S14 being a concave surface and a second-side surface of the eighth lens S15 being a concave surface. The fourth lens L4 and the fifth lens L5 are cemented to form a double cemented lens; and the sixth lens L6 and the seventh lens L7 are cemented to form a double cemented lens.

The optical lens assembly further includes a diaphragm STO disposed between the second lens L2 and the third lens L3, the lights entering the optical system are effectively collected, a lens diameter on a rear end of the optical system is reduced, and the assembly sensitivity of the system is reduced. For example, the diaphragm STO may be arranged in a position close to the first-side surface S6 of the third lens L3 between the second lens L2 and the third lens L3.

In this embodiment, the optical lens assembly may further include an optical filter or protective glass disposed between the eighth lens L8 and the imaging surface (IMA). The optical filter or protective glass, for example, has a first-side surface S16 and a second-side surface S17.

When the optical lens assembly is used for photographing, light from an object sequentially passes through the surfaces S1 to S17 and finally images on the imaging surface. When the optical lens assembly is used for projection, light from an image source surface sequentially passes through the surfaces S17 to S1 and finally projects to a target object (not shown).

Table 41 shows a curvature radius R, thickness/distance, refractive index N, and Abbe number Vd of each lens of the optical lens assembly of Example 37

TABLE 41

| Surface | Curvature | Thickness/ | Refractive | Abbe |
|---|---|---|---|---|
| number | radius R (mm) | distance (mm) | index N | number Vd |
| S1 | 19.9710 | 2.0257 | 1.75 | 35.02 |
| S2 | 61.9496 | 1.2604 | | |
| S3 | −15.6730 | 1.4000 | 1.61 | 43.88 |
| S4 | 14.7011 | 1.5501 | | |
| STO | infinity | 0.1500 | | |
| S6 | 21.0183 | 2.3997 | 1.74 | 44.90 |
| S7 | −65.8786 | 0.2000 | | |
| S8 | 22.6816 | 1.5000 | 1.76 | 26.61 |
| S9 | 10.1505 | 5.9260 | 1.66 | 54.66 |
| S10 | −23.7618 | 2.4022 | | |
| S11 | 19.4785 | 4.0000 | 1.76 | 26.61 |
| S12 | 10.5565 | 5.5000 | 1.74 | 44.90 |
| S13 | −41.9864 | 1.0360 | | |
| S14 | −12.0500 | 1.4000 | 1.76 | 26.61 |
| S15 | 40.5799 | 2.0500 | | |
| S16 | infinity | 0.5000 | 1.52 | 64.21 |
| S17 | infinity | 0.8450 | | |
| IMA | / | / | | |

### Example 38

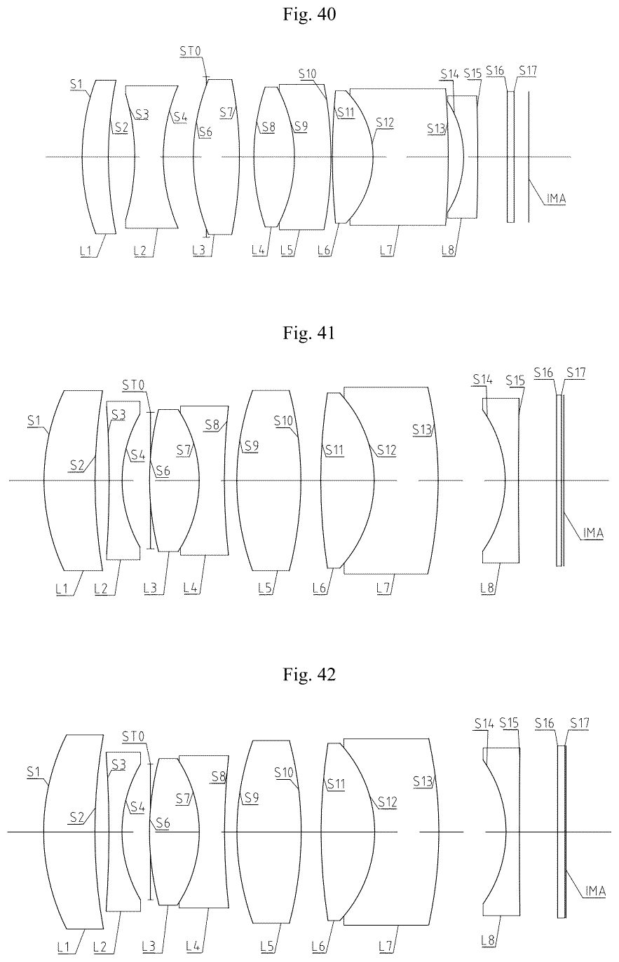

An optical lens assembly of Example 38 of the disclosure is described below with reference to FIG. 38. FIG. 38 is a schematic structural diagram of an optical lens assembly according to Example 38 of the disclosure.

As shown in FIG. 38, the optical lens assembly sequentially includes from a first side to a second side along an optical axis: a first lens L1, a second lens L2, a third lens L3, a fourth lens L4, a fifth lens L5, a sixth lens L6, a seventh lens L7, and an eighth lens L8.

The first lens L1 is a convex-concave lens having a positive refractive power, with a first-side surface of the first lens S1 being a convex surface and a second-side surface of the first lens S2 being a concave surface. The second lens L2 is a concave-concave lens having a negative refractive power, with a first-side surface of the second lens S3 being a concave surface and a second-side surface of the second lens S4 being a concave surface. The third lens L3 is a convex-convex lens having a positive refractive power, with a first-side surface of the third lens S6 being a convex surface and a second-side surface of the third lens S7 being a convex surface. The fourth lens L4 is a convex-concave lens having a negative refractive power, with a first-side surface of the fourth lens S8 being a convex surface and a second-side surface of the fourth lens S9 being a concave surface. The fifth lens L5 is a convex-convex lens having a positive refractive power, with a first-side surface of the fifth lens S9 being a convex surface and a second-side surface of the fifth lens S10 being a convex surface. The sixth lens L6 is a convex-concave lens having a negative refractive power, with a first-side surface of the sixth lens S11 being a convex surface and a second-side surface of the sixth lens S12 being a concave surface. The seventh lens L7 is a convex-convex lens having a positive refractive power, with a first-side surface of the seventh lens S12 being a convex surface and a second-side surface of the seventh lens S13 being a convex surface. The eighth lens L8 is a concave-concave lens having a negative refractive power, with a first-side surface of the eighth lens S14 being a concave surface and a second-side surface of the eighth lens S15 being a concave surface. The fourth lens L4 and the fifth lens L5 are cemented to form a double cemented lens; and the sixth lens L6 and the seventh lens L7 are cemented to form a double cemented lens.

The optical lens assembly further includes a diaphragm STO disposed between the second lens L2 and the third lens L3, the lights entering the optical system are effectively collected, a lens diameter on a rear end of the optical system is reduced, and the assembly sensitivity of the system is reduced. For example, the diaphragm STO may be arranged in a position close to the first-side surface S6 of the third lens L3 between the second lens L2 and the third lens L3.

In this embodiment, the optical lens assembly may further include an optical filter or protective glass disposed between the eighth lens L8 and the imaging surface (IMA). The optical filter or protective glass, for example, has a first-side surface S16 and a second-side surface S17.

When the optical lens assembly is used for photographing, light from an object sequentially passes through the surfaces S1 to S17 and finally images on the imaging surface. When the optical lens assembly is used for projection, light from an image source surface sequentially passes through the surfaces S17 to S1 and finally projects to a target object (not shown).

Table 42 shows a curvature radius R, thickness/distance, refractive index N, and Abbe number Vd of each lens of the optical lens assembly of Example 38

TABLE 42

| Surface | Curvature | Thickness/ | Refractive | Abbe |
|---|---|---|---|---|
| number | radius R (mm) | distance (mm) | index N | number Vd |
| S1 | 19.9710 | 2.0257 | 1.75 | 35.02 |
| S2 | 61.9496 | 1.3000 | | |
| S3 | −15.6730 | 1.4000 | 1.61 | 43.88 |
| S4 | 14.7011 | 1.5501 | | |
| STO | infinity | 0.1000 | | |
| S6 | 21.0183 | 2.5000 | 1.74 | 44.90 |
| S7 | −65.8786 | 0.1000 | | |
| S8 | 22.4548 | 1.4000 | 1.76 | 26.61 |
| S9 | 10.1000 | 5.9260 | 1.66 | 54.66 |
| S10 | −23.7618 | 2.4022 | | |
| S11 | 19.2837 | 4.0000 | 1.76 | 26.61 |
| S12 | 10.5565 | 5.5000 | 1.74 | 44.90 |
| S13 | −41.9864 | 1.0360 | | |
| S14 | −11.8126 | 1.4000 | 1.76 | 26.61 |
| S15 | 40.5799 | 2.0500 | | |
| S16 | infinity | 0.5000 | 1.52 | 64.21 |
| S17 | infinity | 0.7712 | | |
| IMA | / | / | | |

### Example 39

An optical lens assembly of Example 39 of the disclosure is described below with reference to FIG. 39. FIG. 39 is a schematic structural diagram of an optical lens assembly according to Example 39 of the disclosure.

As shown in FIG. 39, the optical lens assembly sequentially includes from a first side to a second side along an optical axis: a first lens L1, a second lens L2, a third lens L3, a fourth lens L4, a fifth lens L5, a sixth lens L6, a seventh lens L7, and an eighth lens L8.

The first lens L1 is a convex-concave lens having a positive refractive power, with a first-side surface of the first lens S1 being a convex surface and a second-side surface of the first lens S2 being a concave surface. The second lens L2 is a concave-concave lens having a negative refractive power, with a first-side surface of the second lens S3 being a concave surface and a second-side surface of the second lens S4 being a concave surface. The third lens L3 is a convex-convex lens having a positive refractive power, with a first-side surface of the third lens S6 being a convex surface and a second-side surface of the third lens S7 being a convex surface. The fourth lens L4 is a convex-convex lens having a positive refractive power, with a first-side surface of the fourth lens S8 being a convex surface and a second-side surface of the fourth lens S9 being a concave surface. The fifth lens L5 is a concave-convex lens having a negative refractive power, with a first-side surface of the fifth lens S9 being a concave surface and a second-side surface of the fifth lens S10 being a convex surface. The sixth lens L6 is a convex-convex lens having a positive refractive power, with a first-side surface of the sixth lens S11 being a convex surface and a second-side surface of the sixth lens S12 being a convex surface. The seventh lens L7 is a concave-convex lens having a negative refractive power, with a first-side surface of the seventh lens S12 being a concave surface and a second-side surface of the seventh lens S13 being a convex surface. The eighth lens L8 is a concave-convex lens having a negative refractive power, with a first-side surface of the eighth lens S14 being a concave surface and a second-side surface of the eighth lens S15 being a convex surface. The fourth lens L4 and the fifth lens L5 are cemented to form a double cemented lens; and the sixth lens L6 and the seventh lens L7 are cemented to form a double cemented lens.

The optical lens assembly further includes a diaphragm STO disposed between the second lens L2 and the third lens L3, the lights entering the optical system are effectively collected, a lens diameter on a rear end of the optical system is reduced, and the assembly sensitivity of the system is reduced. For example, the diaphragm STO may be arranged in a position close to the first-side surface S6 of the third lens L3 between the second lens L2 and the third lens L3.

In this embodiment, the optical lens assembly may further include an optical filter or protective glass disposed between the eighth lens L8 and the imaging surface (IMA). The optical filter or protective glass, for example, has a first-side surface S16 and a second-side surface S17.

When the optical lens assembly is used for photographing, light from an object sequentially passes through the surfaces S1 to S17 and finally images on the imaging surface. When the optical lens assembly is used for projection, light from an image source surface sequentially passes through the surfaces S17 to S1 and finally projects to a target object (not shown).

Table 43 shows a curvature radius R, thickness/distance, refractive index N, and Abbe number Vd of each lens of the optical lens assembly of Example 39

TABLE 43

| Surface | Curvature | Thickness/ | Refractive | Abbe |
|---|---|---|---|---|
| number | radius R (mm) | distance (mm) | index N | number Vd |
| S1 | 16.2748 | 1.9195 | 1.91 | 35.25 |
| S2 | 29.1139 | 1.9265 | | |
| S3 | −16.0945 | 2.0849 | 1.69 | 31.16 |
| S4 | 13.2196 | 3.2402 | | |
| STO | infinity | −0.9426 | | |
| S6 | 15.0624 | 3.3654 | 1.91 | 35.25 |
| S7 | −28.8984 | 1.0487 | | |
| S8 | 16.1105 | 2.9709 | 1.59 | 68.34 |
| S9 | −10.9600 | 2.6682 | 1.83 | 37.21 |
| S10 | −27.8181 | 0.1000 | | |
| S11 | 52.7819 | 2.9687 | 1.59 | 68.34 |
| S12 | −6.9044 | 5.5000 | 1.69 | 31.16 |
| S13 | −69.2853 | 1.1180 | | |
| S14 | −7.6243 | 1.0324 | 1.49 | 70.44 |
| S15 | −130.5242 | 2.1500 | | |
| S16 | infinity | 0.5000 | 1.52 | 64.20 |
| S17 | infinity | 0.8958 | | |
| IMA | / | / | | |

### Example 40

An optical lens assembly of Example 40 of the disclosure is described below with reference to FIG. 40. FIG. 40 is a schematic structural diagram of an optical lens assembly according to Example 40 of the disclosure.

As shown in FIG. 40, the optical lens assembly sequentially includes from a first side to a second side along an optical axis: a first lens L1, a second lens L2, a third lens L3, a fourth lens L4, a fifth lens L5, a sixth lens L6, a seventh lens L7, and an eighth lens L8.

The first lens L1 is a convex-concave lens having a positive refractive power, with a first-side surface of the first lens S1 being a convex surface and a second-side surface of the first lens S2 being a concave surface. The second lens L2 is a concave-concave lens having a negative refractive power, with a first-side surface of the second lens S3 being a concave surface and a second-side surface of the second lens S4 being a concave surface. The third lens L3 is a convex-convex lens having a positive refractive power, with a first-side surface of the third lens S6 being a convex surface and a second-side surface of the third lens S7 being a convex surface. The fourth lens L4 is a convex-convex lens having a positive refractive power, with a first-side surface of the fourth lens S8 being a convex surface and a second-side surface of the fourth lens S9 being a concave surface. The fifth lens L5 is a concave-convex lens having a negative refractive power, with a first-side surface of the fifth lens S9 being a concave surface and a second-side surface of the fifth lens S10 being a convex surface. The sixth lens L6 is a convex-convex lens having a positive refractive power, with a first-side surface of the sixth lens S11 being a convex surface and a second-side surface of the sixth lens S12 being a convex surface. The seventh lens L7 is a concave-convex lens having a negative refractive power, with a first-side surface of the seventh lens S12 being a concave surface and a second-side surface of the seventh lens S13 being a convex surface. The eighth lens L8 is a concave-convex lens having a negative refractive power, with a first-side surface of the eighth lens S14 being a concave surface and a second-side surface of the eighth lens S15 being a convex surface. The fourth lens L4 and the fifth lens L5 are cemented to form a double cemented lens; and the sixth lens L6 and the seventh lens L7 are cemented to form a double cemented lens.

The optical lens assembly further includes a diaphragm STO disposed between the second lens L2 and the third lens L3, the lights entering the optical system are effectively collected, a lens diameter on a rear end of the optical system is reduced, and the assembly sensitivity of the system is reduced. For example, the diaphragm STO may be arranged in a position close to the first-side surface S6 of the third lens L3 between the second lens L2 and the third lens L3.

In this embodiment, the optical lens assembly may further include an optical filter or protective glass disposed between the eighth lens L8 and the imaging surface (IMA). The optical filter or protective glass, for example, has a first-side surface S16 and a second-side surface S17.

When the optical lens assembly is used for photographing, light from an object sequentially passes through the surfaces S1 to S17 and finally images on the imaging surface. When the optical lens assembly is used for projection, light from an image source surface sequentially passes through the surfaces S17 to S1 and finally projects to a target object (not shown).

Table 44 shows a curvature radius R, thickness/distance, refractive index N, and Abbe number Vd of each lens of the optical lens assembly of Example 40

TABLE 44

| Surface | Curvature | Thickness/ | Refractive | Abbe |
|---|---|---|---|---|
| number | radius R (mm) | distance (mm) | index N | number Vd |
| S1 | 16.2748 | 1.9195 | 1.91 | 35.25 |
| S2 | 29.1139 | 1.9265 | | |
| S3 | −16.2570 | 2.0849 | 1.69 | 31.16 |
| S4 | 13.0874 | 3.1402 | | |
| STO | infinity | −0.9426 | | |
| S6 | 15.0624 | 3.3654 | 1.91 | 35.25 |
| S7 | −28.8984 | 1.0487 | | |
| S8 | 16.2241 | 2.9709 | 1.59 | 68.34 |
| S9 | −10.9271 | 2.6682 | 1.83 | 37.21 |
| S10 | −27.8181 | 0.1000 | | |
| S11 | 52.2541 | 2.9687 | 1.59 | 68.34 |
| S12 | −6.9044 | 5.5000 | 1.69 | 31.16 |
| S13 | −64.2853 | 1.1180 | | |
| S14 | −7.6243 | 1.0324 | 1.49 | 70.44 |
| S15 | −130.5242 | 2.1500 | | |
| S16 | infinity | 0.5000 | 1.52 | 64.20 |
| S17 | infinity | 1.0746 | | |
| IMA | / | / | | |

### Example 41

An optical lens assembly of Example 41 of the disclosure is described below with reference to FIG. 41. FIG. 41 is a schematic structural diagram of an optical lens assembly according to Example 41 of the disclosure.

As shown in FIG. 41, the optical lens assembly sequentially includes from a first side to a second side along an optical axis: a first lens L1, a second lens L2, a third lens L3, a fourth lens L4, a fifth lens L5, a sixth lens L6, a seventh lens L7, and an eighth lens L8.

The first lens L1 is a convex-concave lens having a positive refractive power, with a first-side surface of the first lens S1 being a convex surface and a second-side surface of the first lens S2 being a concave surface. The second lens L2 is a concave-concave lens having a negative refractive power, with a first-side surface of the second lens S3 being a concave surface and a second-side surface of the second lens S4 being a concave surface. The third lens L3 is a convex-convex lens having a positive refractive power, with a first-side surface of the third lens S6 being a convex surface and a second-side surface of the third lens S7 being a convex surface. The fourth lens L4 is a concave-concave lens having a negative refractive power, with a first-side surface of the fourth lens S8 being a concave surface and a second-side surface of the fourth lens S9 being a concave surface. The fifth lens L5 is a convex-convex lens having a positive refractive power, with a first-side surface of the fifth lens S9 being a concave surface and a second-side surface of the fifth lens S10 being a convex surface. The sixth lens L6 is a convex-convex lens having a positive refractive power, with a first-side surface of the sixth lens S11 being a convex surface and a second-side surface of the sixth lens S12 being a convex surface. The seventh lens L7 is a concave-convex lens having a negative refractive power, with a first-side surface of the seventh lens S12 being a concave surface and a second-side surface of the seventh lens S13 being a convex surface. The eighth lens L8 is a concave-concave lens having a negative refractive power, with a first-side surface of the eighth lens S14 being a concave surface and a second-side surface of the eighth lens S15 being a concave surface. The fourth lens L3 and the fifth lens L4 are cemented to form a double cemented lens; and the sixth lens L6 and the seventh lens L7 are cemented to form a double cemented lens.

The optical lens assembly further includes a diaphragm STO disposed between the second lens L2 and the third lens L3, the lights entering the optical system are effectively collected, a lens diameter on a rear end of the optical system is reduced, and the assembly sensitivity of the system is reduced. For example, the diaphragm STO may be arranged in a position close to the first-side surface S6 of the third lens L3 between the second lens L2 and the third lens L3.

In this embodiment, the optical lens assembly may further include an optical filter or protective glass disposed between the eighth lens L8 and the imaging surface (IMA). The optical filter or protective glass, for example, has a first-side surface S16 and a second-side surface S17.

When the optical lens assembly is used for photographing, light from an object sequentially passes through the surfaces S1 to S17 and finally images on the imaging surface. When the optical lens assembly is used for projection, light from an image source surface sequentially passes through the surfaces S17 to S1 and finally projects to a target object (not shown).

Table 45 shows a curvature radius R, thickness/distance, refractive index N, and Abbe number Vd of each lens of the optical lens assembly of Example 41

TABLE 45

| Surface | Curvature | Thickness/ | Refractive | Abbe |
|---|---|---|---|---|
| number | radius R (mm) | distance (mm) | index N | number Vd |
| S1 | 14.7223 | 3.4865 | 1.91 | 35.28 |
| S2 | 37.8739 | 0.9652 | | |
| S3 | −74.0166 | 0.8844 | 1.54 | 47.23 |
| S4 | 9.2578 | 1.9377 | | |
| STO | infinity | −0.0657 | | |
| S6 | 19.6744 | 3.3930 | 1.57 | 71.30 |
| S7 | −9.0617 | 1.7181 | 1.81 | 25.46 |
| S8 | 47.8737 | 0.8459 | | |
| S9 | 18.4090 | 4.3779 | 1.92 | 20.88 |
| S10 | −24.7743 | 1.3568 | | |
| S11 | 39.8255 | 3.6514 | 1.77 | 49.60 |
| S12 | −8.9137 | 4.3695 | 1.92 | 18.90 |
| S13 | −29.6411 | 4.5767 | | |
| S14 | −8.4905 | 0.9063 | 1.52 | 64.20 |
| S15 | 392.4646 | 2.6000 | | |
| S16 | infinity | 0.5000 | 1.52 | 64.20 |
| S17 | infinity | −0.1723 | | |
| IMA | / | / | | |

### Example 42

An optical lens assembly of Example 42 of the disclosure is described below with reference to FIG. 42. FIG. 42 is a schematic structural diagram of an optical lens assembly according to Example 42 of the disclosure.

As shown in FIG. 42, the optical lens assembly sequentially includes from a first side to a second side along an optical axis: a first lens L1, a second lens L2, a third lens L3, a fourth lens L4, a fifth lens L5, a sixth lens L6, a seventh lens L7, and an eighth lens L8.

The first lens L1 is a convex-concave lens having a positive refractive power, with a first-side surface of the first lens S1 being a convex surface and a second-side surface of the first lens S2 being a concave surface. The second lens L2 is a concave-concave lens having a negative refractive power, with a first-side surface of the second lens S3 being a concave surface and a second-side surface of the second lens S4 being a concave surface. The third lens L3 is a convex-convex lens having a positive refractive power, with a first-side surface of the third lens S6 being a convex surface and a second-side surface of the third lens S7 being a convex surface. The fourth lens L4 is a concave-concave lens having a negative refractive power, with a first-side surface of the fourth lens S8 being a concave surface and a second-side surface of the fourth lens S9 being a concave surface. The fifth lens L5 is a convex-convex lens having a positive refractive power, with a first-side surface of the fifth lens S9 being a concave surface and a second-side surface of the fifth lens S10 being a convex surface. The sixth lens L6 is a convex-convex lens having a positive refractive power, with a first-side surface of the sixth lens S11 being a convex surface and a second-side surface of the sixth lens S12 being a convex surface. The seventh lens L7 is a concave-convex lens having a negative refractive power, with a first-side surface of the seventh lens S12 being a concave surface and a second-side surface of the seventh lens S13 being a convex surface. The eighth lens L8 is a concave-concave lens having a negative refractive power, with a first-side surface of the eighth lens S14 being a concave surface and a second-side surface of the eighth lens S15 being a concave surface. The fourth lens L3 and the fifth lens L4 are cemented to form a double cemented lens; and the sixth lens L6 and the seventh lens L7 are cemented to form a double cemented lens.

The optical lens assembly further includes a diaphragm STO disposed between the second lens L2 and the third lens L3, the lights entering the optical system are effectively collected, a lens diameter on a rear end of the optical system is reduced, and the assembly sensitivity of the system is reduced. For example, the diaphragm STO may be arranged in a position close to the first-side surface S6 of the third lens L3 between the second lens L2 and the third lens L3.

In this embodiment, the optical lens assembly may further include an optical filter or protective glass disposed between the eighth lens L8 and the imaging surface (IMA). The optical filter or protective glass, for example, has a first-side surface S16 and a second-side surface S17.

When the optical lens assembly is used for photographing, light from an object sequentially passes through the surfaces S1 to S17 and finally images on the imaging surface. When the optical lens assembly is used for projection, light from an image source surface sequentially passes through the surfaces S17 to S1 and finally projects to a target object (not shown).

Table 46 shows a curvature radius R, thickness/distance, refractive index N, and Abbe number Vd of each lens of the optical lens assembly of Example 42

TABLE 46

| Surface | Curvature | Thickness/ | Refractive | Abbe |
|---|---|---|---|---|
| number | radius R (mm) | distance (mm) | index N | number Vd |
| S1 | 14.8710 | 3.4865 | 1.91 | 35.28 |
| S2 | 37.8739 | 0.9652 | | |
| S3 | −73.4244 | 0.8844 | 1.54 | 47.23 |
| S4 | 9.1652 | 1.9377 | | |
| STO | infinity | −0.0657 | | |
| S6 | 19.4776 | 3.3930 | 1.57 | 71.30 |
| S7 | −9.1255 | 1.7181 | 1.81 | 25.46 |
| S8 | 47.8737 | 0.8459 | | |
| S9 | 18.4090 | 4.3779 | 1.92 | 20.88 |
| S10 | −24.7743 | 1.3568 | | |
| S11 | 39.8255 | 3.6514 | 1.77 | 49.60 |
| S12 | −8.9137 | 4.3695 | 1.92 | 18.90 |
| S13 | −29.6411 | 4.5767 | | |
| S14 | −8.4905 | 0.9063 | 1.52 | 64.20 |
| S15 | 392.4646 | 2.6000 | | |
| S16 | infinity | 0.5000 | 1.52 | 64.20 |
| S17 | infinity | 0.0788 | | |
| IMA | / | / | | |

To sum up, parameter values in Example 25 to Example 42 are respectively shown in Table 47 and Table 48 below, where F, TTL, ENPD, H, F1-F8, d23, d45, d67, R11, R12, R21, R22, R31, R32, R41, R42, R51, R52, R61, R62, R71, R72, R81, R82, D1, D2, F45, F67, and F34 all are in millimeter (mm), FOV is in degree (°), and θ is in radian.

TABLE 47

| | Example | | | | | | | | |
|---|---|---|---|---|---|---|---|---|---|
| Parameter | 25 | 26 | 27 | 28 | 29 | 30 | 31 | 32 | 33 |
| F | 15.4054 | 15.7255 | 15.4538 | 14.9003 | 15.1423 | 15.3537 | 15.1488 | 15.3533 | 17.6033 |
| TTL | 32.1316 | 32.5167 | 32.4472 | 31.9933 | 32.8488 | 33.0079 | 32.9167 | 32.9625 | 36.2727 |
| FOV | 34.3676 | 34.3676 | 34.3676 | 34.3676 | 34.3676 | 34.3676 | 34.3676 | 34.3676 | 35.5348 |
| θ | 0.5998 | 0.5998 | 0.5998 | 0.5998 | 0.5998 | 0.5998 | 0.5998 | 0.5998 | 0.6202 |
| ENPD | 9.6284 | 9.8284 | 9.6586 | 9.3127 | 9.4639 | 9.5961 | 9.4680 | 9.5958 | 10.7337 |
| H | 9.2014 | 9.4178 | 9.4092 | 9.0021 | 9.0468 | 9.1775 | 9.0374 | 9.1774 | 10.9694 |
| F1 | 29.5761 | 31.0967 | 30.6188 | 29.3827 | 27.6638 | 27.9478 | 39.3400 | 39.3400 | 27.7557 |
| F2 | −10.6831 | −10.5939 | −12.1233 | −12.1233 | −10.9254 | −10.9254 | −10.6844 | −10.6844 | −10.3476 |
| F3 | 13.2878 | 13.1214 | 20.3153 | 20.3153 | 15.7952 | 15.8766 | 11.8880 | 11.8880 | −32.8230 |
| F4 | −17.9954 | −18.0214 | 10.6345 | 10.6345 | 14.3883 | 14.3883 | 12.3354 | 12.3354 | 15.0076 |
| F5 | 11.4206 | 11.4290 | −26.1740 | −26.1740 | −27.0868 | −27.0868 | −23.5674 | −22.9608 | 12.7222 |
| F6 | 9.8308 | 9.2805 | −7.9870 | −8.1006 | 11.6863 | 11.7216 | 9.9737 | 10.3451 | 9.4296 |
| F7 | −14.7157 | −13.3215 | 6.7804 | 6.8447 | −16.7566 | −16.8990 | −13.4520 | −14.1890 | −10.4997 |
| F8 | −17.7802 | −17.6847 | −11.0180 | −11.0180 | −18.9759 | −18.8363 | −14.6551 | −14.7156 | −16.5168 |
| d23 | 2.7034 | 2.7034 | 4.8578 | 4.9578 | 2.6060 | 2.5570 | 1.7010 | 1.7010 | 2.9320 |
| d45 | 0.0000 | 0.0000 | 0.0000 | 0.0000 | 0.0000 | 0.0000 | 0.0000 | 0.0000 | 0.1000 |
| d67 | 0.0000 | 0.0000 | 0.0000 | 0.0000 | 0.0000 | 0.0000 | 0.0000 | 0.0000 | 0.0000 |
| R11 | 17.2133 | 17.2133 | 19.0372 | 19.0372 | 34.1223 | 34.1223 | 20.4248 | 20.4248 | 16.9303 |
| R12 | 44.0423 | 40.5934 | 54.6840 | 60.0000 | −96.0400 | −100.0000 | 44.9212 | 44.9212 | 38.0081 |
| R21 | −18.6538 | −18.2808 | −18.7294 | −18.7294 | −14.7971 | −14.7971 | −14.7843 | −14.7843 | −28.3612 |
| R22 | 12.6337 | 12.6337 | 15.5827 | 15.5827 | 16.1608 | 16.1608 | 15.9247 | 15.9247 | 12.2048 |
| R31 | 15.5337 | 15.5726 | 29.7174 | 29.7174 | 17.4806 | 17.4806 | 16.4114 | 16.4114 | 14.7717 |
| R32 | −52.8000 | −49.5000 | −48.6734 | −48.6734 | −76.8320 | −79.2000 | −29.8073 | −29.8073 | 9.6727 |
| R41 | 59.5806 | 59.2218 | 10.3822 | 10.3822 | 70.0000 | 70.0000 | 20.8203 | 20.8203 | 9.6727 |
| R42 | 10.8402 | 10.8402 | −14.0302 | −14.0302 | −9.4823 | −9.4823 | −10.4852 | −10.4852 | −102.2036 |
| R51 | 10.8402 | 10.8402 | −14.0302 | −14.0302 | −9.4823 | −9.4823 | −10.4852 | −10.4852 | 16.6034 |
| R52 | −54.4500 | −54.7250 | −39.9653 | −39.9653 | −17.3631 | −17.3631 | −25.4234 | −26.2043 | −35.6132 |
| R61 | 20.0000 | 20.0000 | 18.7541 | 18.7541 | 17.5023 | 17.5023 | 25.6175 | 25.6175 | 37.0103 |
| R62 | −7.6966 | −7.1015 | 5.2553 | 5.3073 | −10.2375 | −10.2889 | −7.2783 | −7.6351 | −8.1542 |
| R71 | −7.6966 | −7.1015 | 5.2553 | 5.3073 | −10.2375 | −10.2889 | −7.2783 | −7.6351 | −8.1542 |
| R72 | −41.0333 | −41.0333 | −24.3445 | −24.3445 | −89.1 | −87.3180 | −40.3036 | −41.1262 | −209.8975 |
| R81 | −8.3300 | −8.3300 | −7.3611 | −7.3611 | −8.5239 | −8.5239 | −9.0244 | −9.0244 | −7.5121 |
| R82 | −72.0300 | −75.0000 | −205.9212 | −205.9212 | −110 | −120.0000 | 36.6320 | 37.3796 | −19.8883 |
| D1 | 12.9732 | 13.0564 | 14.3280 | 13.2864 | 11.2677 | 11.3475 | 11.8072 | 11.8956 | 14.0000 |
| D2 | 11.9171 | 11.9800 | 12.9250 | 11.8682 | 10.5863 | 10.6659 | 10.9363 | 11.0262 | 12.0391 |
| F45 | 30.6503 | 30.6493 | 16.6766 | 16.6766 | 32.2115 | 32.2115 | 26.9216 | 27.5888 | / |
| F67 | 30.8273 | 31.7546 | 40.5810 | 39.7786 | 31.0859 | 30.9115 | 38.1919 | 37.8152 | 73.9947 |
| F34 | / | / | / | / | / | / | / | / | 28.9460 |
| d2 | 1.2000 | 1.2000 | 0.9000 | 0.9000 | 1.4000 | 1.4000 | 2.5268 | 2.5268 | 0.9000 |
| ET2 | 2.8200 | 2.9113 | 2.5339 | 2.1368 | 2.9330 | 2.9692 | 4.2041 | 4.2453 | 2.3538 |
| d6 | 3.6860 | 3.6860 | 2.5488 | 2.5488 | 5.2689 | 5.2689 | 3.9406 | 3.9406 | 3.4604 |
| d7 | 5.9057 | 5.9057 | 5.9000 | 6.0000 | 1.0784 | 1.0784 | 3.9313 | 3.9313 | 4.6615 |

TABLE 48

| | Example | | | | | | | | |
|---|---|---|---|---|---|---|---|---|---|
| Parameter | 34 | 35 | 36 | 37 | 38 | 39 | 40 | 41 | 42 |
| F | 17.6173 | 15.4939 | 14.8118 | 15.2608 | 15.1988 | 15.2967 | 15.5335 | 17.6177 | 17.8035 |
| TTL | 36.2569 | 34.1650 | 33.6266 | 34.1450 | 33.9612 | 32.5463 | 32.6251 | 35.5036 | 35.5824 |
| FOV | 35.5348 | 34.3676 | 34.3676 | 34.3676 | 34.3676 | 34.3676 | 34.3676 | 35.4502 | 35.4502 |
| θ | 0.6202 | 0.5998 | 0.5998 | 0.5998 | 0.5998 | 0.5998 | 0.5998 | 0.6187 | 0.6187 |
| ENPD | 10.7423 | 9.6837 | 9.2574 | 9.5380 | 9.4992 | 9.5605 | 9.7084 | 10.8084 | 10.9224 |
| H | 10.9805 | 9.2784 | 8.8482 | 9.0961 | 9.0664 | 9.1313 | 9.3179 | 11.0312 | 11.1664 |
| F1 | 27.7557 | 34.0599 | 34.0599 | 38.2639 | 38.2639 | 37.5616 | 37.5616 | 24.5411 | 24.9384 |
| F2 | −10.3795 | −10.1480 | −10.1479 | −12.2445 | −12.2445 | −10.1599 | −10.1497 | −15.1030 | −14.9549 |
| F3 | −32.8230 | 17.7126 | 17.6769 | 21.5593 | 21.5700 | 11.2089 | 11.2089 | 11.3617 | 11.3824 |
| F4 | 15.0192 | 10.3701 | 10.4306 | −25.2165 | −25.1211 | 11.4328 | 11.4433 | −9.2714 | −9.3264 |
| F5 | 12.7222 | −29.7199 | −30.6297 | 11.4564 | 11.4177 | −23.2252 | −23.1070 | 11.9300 | 11.9300 |
| F6 | 9.4436 | 11.5452 | 11.2235 | −37.2431 | −37.8983 | 10.4580 | 10.4475 | 9.7117 | 9.7117 |
| F7 | −10.4997 | −10.2822 | −10.3944 | 11.8073 | 11.8073 | −11.4615 | −11.5989 | −15.2320 | −15.2320 |
| F8 | −16.5168 | −18.3378 | −18.0043 | −11.9506 | −11.7676 | −16.5998 | −16.5998 | −16.0230 | −16.0230 |
| d23 | 2.9320 | 2.9159 | 2.9159 | 1.7001 | 1.6501 | 2.2976 | 2.1976 | 1.8720 | 1.8720 |
| d45 | 0.1000 | 0.0000 | 0.0000 | 0.0000 | 0.0000 | 0.0000 | 0.0000 | 0.8459 | 0.8459 |
| d67 | 0.0000 | 0.0000 | 0.0000 | 0.0000 | 0.0000 | 0.0000 | 0.0000 | 0.0000 | 0.0000 |
| R11 | 16.9303 | 15.8841 | 15.8841 | 19.9710 | 19.9710 | 16.2748 | 16.2748 | 14.7223 | 14.8710 |
| R12 | 38.0081 | 39.6809 | 39.6809 | 61.9496 | 61.9496 | 29.1139 | 29.1139 | 37.8739 | 37.8739 |
| R21 | −28.6477 | −17.3191 | −17.3187 | −15.6730 | −15.6730 | −16.0945 | −16.2570 | −74.0166 | −73.4244 |
| R22 | 12.2048 | 12.6155 | 12.6155 | 14.7011 | 14.7011 | 13.2196 | 13.0874 | 9.2578 | 9.1652 |
| R31 | 14.7717 | 22.1562 | 22.1562 | 21.0183 | 21.0183 | 15.0624 | 15.0624 | 19.6744 | 19.4776 |
| R32 | 9.6727 | −31.1246 | −30.9690 | −65.8786 | −65.8786 | −28.8984 | −28.8984 | −9.0617 | −9.1255 |
| R41 | 9.6727 | 15.4320 | 15.4320 | 22.6816 | 22.4548 | 16.1105 | 16.2241 | −9.0617 | −9.1255 |
| R42 | −103.2360 | −9.6305 | −9.7278 | 10.1505 | 10.1000 | −10.9600 | −10.9271 | 47.8737 | 47.8737 |
| R51 | 16.6034 | −9.6305 | −9.7278 | 10.1505 | 10.1000 | −10.9600 | −10.9271 | 18.4090 | 18.4090 |
| R52 | −35.6132 | −17.7356 | −17.6470 | −23.7618 | −23.7618 | −27.8181 | −27.8181 | −24.7743 | −24.7743 |
| R61 | 37.3730 | 26.9021 | 25.3252 | 19.4785 | 19.2837 | 52.7819 | 52.2541 | 39.8255 | 39.8255 |
| R62 | −8.1542 | −9.3197 | −9.1361 | 10.5565 | 10.5565 | −6.9044 | −6.9044 | −8.9137 | −8.9137 |
| R71 | −8.1542 | −9.3197 | −9.1361 | 10.5565 | 10.5565 | −6.9044 | −6.9044 | −8.9137 | −8.9137 |
| R72 | −209.8975 | 61.7400 | 75.0000 | −41.9864 | −41.9864 | −69.2853 | −64.2853 | −29.6411 | −29.6411 |
| R81 | −7.5121 | −7.2296 | −7.1580 | −12.0500 | −11.8126 | −7.6243 | −7.6243 | −8.4905 | −8.4905 |
| R82 | −19.8883 | −16.3133 | −16.3133 | 40.5799 | 40.5799 | −130.5242 | −130.5242 | 392.4646 | 392.4646 |
| D1 | 14.0000 | 11.9703 | 11.6758 | 11.3864 | 11.3874 | 10.9667 | 10.9726 | 12.0000 | 12.0000 |
| D2 | 12.0396 | 10.9768 | 10.6697 | 10.5220 | 10.5230 | 10.0344 | 10.0403 | 10.5242 | 10.5820 |
| F45 | / | 15.5918 | 15.5181 | 20.3743 | 20.2521 | 22.9653 | 23.1260 | / | / |
| F67 | 75.0641 | −551.5351 | 676.6159 | 19.3089 | 19.1749 | 141.0003 | 125.4283 | 30.6507 | 30.6507 |
| F34 | 28.9910 | / | / | / | / | / | / | −85.6756 | −89.5268 |
| d2 | 0.9000 | 1.4000 | 1.4000 | 1.4000 | 1.4000 | 2.0849 | 2.0849 | 0.8844 | 0.8844 |
| ET2 | 2.3479 | 3.3046 | 3.1591 | 3.0877 | 3.0717 | 3.6050 | 3.6069 | 2.2771 | 2.3275 |
| d6 | 3.4604 | 3.9140 | 3.9140 | 4.0000 | 4.0000 | 2.9687 | 2.9687 | 3.6514 | 3.6514 |
| d7 | 4.6615 | 5.5749 | 5.5749 | 5.5000 | 5.5000 | 5.5000 | 5.5000 | 4.3695 | 4.3695 |

Furthermore, Example 25 to Example 42 respectively meet relationships shown in Table 49 and Table 50 below.

TABLE 49

| Conditional | Example | | | | | | | | |
|---|---|---|---|---|---|---|---|---|---|
| expression | 25 | 26 | 27 | 28 | 29 | 30 | 31 | 32 | 33 |
| TTL/F | 2.0857 | 2.0678 | 2.0996 | 2.1472 | 2.1693 | 2.1498 | 2.1729 | 2.1469 | 2.0606 |
| F/ENPD | 1.6000 | 1.6000 | 1.6000 | 1.6000 | 1.6000 | 1.6000 | 1.6000 | 1.6000 | 1.6400 |
| R31/F | 1.0083 | 0.9903 | 1.9230 | 1.9944 | 1.1544 | 1.1385 | 1.0833 | 1.0689 | 0.8391 |
| R52/F | −3.5345 | −3.4800 | −2.5861 | −2.6822 | −1.1467 | −1.1309 | −1.6782 | −1.7068 | −2.0231 |
| R61/F | 1.2982 | 1.2718 | 1.2136 | 1.2586 | 1.1559 | 1.1399 | 1.6911 | 1.6685 | 2.1025 |
| R21/R22 | −1.4765 | −1.4470 | −1.2019 | −1.2019 | −0.9156 | −0.9156 | −0.9284 | −0.9284 | −2.3238 |
| R21/F | −1.2109 | −1.1625 | −1.2120 | −1.2570 | −0.9772 | −0.9637 | −0.9759 | −0.9629 | −1.6111 |
| d23/TTL | 0.0841 | 0.0831 | 0.1497 | 0.1550 | 0.0793 | 0.0775 | 0.0517 | 0.0516 | 0.0808 |
| F2/F | −0.6935 | −0.6737 | −0.7845 | −0.8136 | −0.7215 | −0.7116 | −0.7053 | −0.6959 | −0.5878 |
| R22/F | 0.8201 | 0.8034 | 1.0083 | 1.0458 | 1.0673 | 1.0526 | 1.0512 | 1.0372 | 0.6933 |
| F8/F | −1.1542 | −1.1246 | −0.7130 | −0.7394 | −1.2532 | −1.2268 | −0.9674 | −0.9585 | −0.9383 |
| F1/F | 1.9199 | 1.9775 | 1.9813 | 1.9720 | 1.8269 | 1.8203 | 2.5969 | 2.5623 | 1.5767 |
| R62/R71 | 1.0000 | 1.0000 | 1.0000 | 1.0000 | 1.0000 | 1.0000 | 1.0000 | 1.0000 | 1.0000 |
| d67/TTL | 0.0000 | 0.0000 | 0.0000 | 0.0000 | 0.0000 | 0.0000 | 0.0000 | 0.0000 | 0.0000 |
| \|F67/F\| | 2.0011 | 2.0193 | 2.6260 | 2.6697 | 2.0529 | 2.0133 | 2.5211 | 2.4630 | 4.2035 |
| (FOV × F)/H | 57.5398 | 57.3858 | 56.4458 | 56.8853 | 57.5236 | 57.4960 | 57.6082 | 57.4952 | 57.0250 |
| F/H | 1.6742 | 1.6698 | 1.6424 | 1.6552 | 1.6738 | 1.6730 | 1.6762 | 1.6729 | 1.6048 |
| \|(R11/D1)/(R12/D2)\| | 0.3590 | 0.3891 | 0.3140 | 0.2834 | 0.3338 | 0.3207 | 0.4211 | 0.4214 | 0.3830 |
| D1/H/FOV | 0.0410 | 0.0403 | 0.0443 | 0.0429 | 0.0362 | 0.0360 | 0.0380 | 0.0377 | 0.0359 |
| TTL/H/FOV | 0.1016 | 0.1005 | 0.1003 | 0.1034 | 0.1057 | 0.1047 | 0.1060 | 0.1045 | 0.0931 |
| (H/2)/(F × tan(θ/2)) | 0.9658 | 0.9684 | 0.9845 | 0.9769 | 0.9660 | 0.9665 | 0.9646 | 0.9665 | 0.9723 |
| F45/F | 1.9896 | 1.9490 | 1.0791 | 1.1192 | 2.1273 | 2.0980 | 1.7771 | 1.7969 | / |
| R42/R51 | 1.0000 | 1.0000 | 1.0000 | 1.0000 | 1.0000 | 1.0000 | 1.0000 | 1.0000 | −6.1556 |
| d45/TTL | 0 | 0 | 0 | 0 | 0 | 0 | 0 | 0 | 0.0028 |
| \|F34/F\| | / | / | / | / | / | / | / | / | 1.6444 |
| R32/R41 | −0.8862 | −0.8358 | −4.6882 | −4.6882 | −1.0976 | −1.1314 | −1.4316 | −1.4316 | 1 |
| d34/TTL | 0.0292 | 0.0289 | 0.0077 | 0.0031 | 0.0067 | 0.0061 | 0.0182 | 0.0152 | 0 |
| R21/(R22 + d2) | −0.1724 | −0.1690 | −0.1736 | −0.1736 | −0.1365 | −0.1365 | −0.1350 | −0.1350 | −0.2628 |
| d2/ET2 | 0.4255 | 0.4122 | 0.3552 | 0.4212 | 0.4773 | 0.4715 | 0.6010 | 0.5952 | 0.3824 |
| R11/F | 1.1174 | 1.0946 | 1.2319 | 1.2776 | 2.2534 | 2.2224 | 1.3483 | 1.3303 | 0.9618 |
| R31/F | 0.8201 | 0.8034 | 1.0083 | 1.0458 | 1.0673 | 1.0526 | 1.0512 | 1.0372 | 0.6933 |
| R52/R61 | −2.7225 | −2.7363 | −2.1310 | −2.1310 | −0.9920 | −0.9920 | −0.9924 | −1.0229 | −0.9623 |
| (R52*F)/(R61*TTL) | −1.3053 | −1.3233 | −1.0150 | −0.9925 | −0.4573 | −0.4615 | −0.4567 | −0.4765 | −0.4670 |
| R81/F | −0.5407 | −0.5297 | −0.4763 | −0.4940 | −0.5629 | −0.5552 | −0.5957 | −0.5878 | −0.4267 |
| F1/F | 1.9199 | 1.9775 | 1.9813 | 1.9720 | 1.8269 | 1.8203 | 2.5969 | 2.5623 | 1.5767 |
| F8/F | −1.1542 | −1.1246 | −0.7130 | −0.7394 | −1.2532 | −1.2268 | −0.9674 | −0.9585 | −0.9383 |
| F1/F8 | −1.6634 | −1.7584 | −2.7790 | −2.6668 | −1.4578 | −1.4837 | −2.6844 | −2.6734 | −1.6805 |
| (d6 + d7)/F | 0.6226 | 0.6099 | 0.5467 | 0.5737 | 0.4192 | 0.4134 | 0.5196 | 0.5127 | 0.4614 |
| F6/F7 | −0.6680 | −0.6967 | −1.1780 | −1.1835 | −0.6974 | −0.6936 | −0.7414 | −0.7291 | −0.8981 |

TABLE 50

| Conditional | Example | | | | | | | | |
|---|---|---|---|---|---|---|---|---|---|
| expression | 34 | 35 | 36 | 37 | 38 | 39 | 40 | 41 | 42 |
| TTL/F | 2.0580 | 2.2051 | 2.2703 | 2.2374 | 2.2345 | 2.1277 | 2.1003 | 2.0152 | 1.9986 |
| F/ENPD | 1.6400 | 1.6000 | 1.6000 | 1.6000 | 1.6000 | 1.6000 | 1.6000 | 1.6300 | 1.6300 |
| R31/F | 0.8385 | 1.4300 | 1.4958 | 1.3773 | 1.3829 | 0.9847 | 0.9697 | 1.1167 | 1.0940 |
| R52/F | −2.0215 | −1.1447 | −1.1914 | −1.5570 | −1.5634 | −1.8186 | −1.7908 | −1.4062 | −1.3915 |
| R61/F | 2.1214 | 1.7363 | 1.7098 | 1.2764 | 1.2688 | 3.4505 | 3.3640 | 2.2605 | 2.2369 |
| R21/R22 | −2.3472 | −1.3728 | −1.3728 | −1.0661 | −1.0661 | −1.2175 | −1.2422 | −7.9951 | −8.0112 |
| R21/F | −1.6261 | −1.1178 | −1.1693 | −1.0270 | −1.0312 | −1.0522 | −1.0466 | −4.2013 | −4.1242 |
| d23/TTL | 0.0809 | 0.0853 | 0.0867 | 0.0498 | 0.0486 | 0.0706 | 0.0674 | 0.0527 | 0.0526 |
| F2/F | −0.5892 | −0.6550 | −0.6851 | −0.8023 | −0.8056 | −0.6642 | −0.6534 | −0.8573 | −0.8400 |
| R22/F | 0.6928 | 0.8142 | 0.8517 | 0.9633 | 0.9673 | 0.8642 | 0.8425 | 0.5255 | 0.5148 |
| F8/F | −0.9375 | −1.1835 | −1.2155 | −0.7831 | −0.7742 | −1.0852 | −1.0686 | −0.9095 | −0.9000 |
| F1/F | 1.5755 | 2.1983 | 2.2995 | 2.5073 | 2.5176 | 2.4555 | 2.4181 | 1.3930 | 1.4008 |
| R62/R71 | 1.0000 | 1.0000 | 1.0000 | 1.0000 | 1.0000 | 1.0000 | 1.0000 | 1.0000 | 1.0000 |
| d67/TTL | 0.0000 | 0.0000 | 0.0000 | 0.0000 | 0.0000 | 0.0000 | 0.0000 | 0.0000 | 0.0000 |
| \|F67/F\| | 4.2608 | 35.5969 | 45.6809 | 1.2653 | 1.2616 | 9.2177 | 8.0747 | 1.7398 | 1.7216 |
| (FOV × F)/H | 57.0126 | 57.3901 | 57.5310 | 57.6596 | 57.6134 | 57.5724 | 57.2929 | 56.6168 | 56.5211 |
| F/H | 1.6044 | 1.6699 | 1.6740 | 1.6777 | 1.6764 | 1.6752 | 1.6671 | 1.5971 | 1.5944 |
| \|(R11/D1)/(R12/D2)\| | 0.3831 | 0.3671 | 0.3658 | 0.2979 | 0.2979 | 0.5115 | 0.5115 | 0.3409 | 0.3462 |
| D1/H/FOV | 0.0359 | 0.0375 | 0.0384 | 0.0364 | 0.0365 | 0.0349 | 0.0343 | 0.0307 | 0.0303 |
| TTL/H/FOV | 0.0929 | 0.1071 | 0.1106 | 0.1092 | 0.1090 | 0.1037 | 0.1019 | 0.0908 | 0.0899 |
| (H/2)/(F × tan(θ/2)) | 0.9725 | 0.9683 | 0.9659 | 0.9638 | 0.9645 | 0.9652 | 0.9699 | 0.9795 | 0.9812 |
| F45/F | / | 1.0063 | 1.0477 | 1.3351 | 1.3325 | 1.5013 | 1.4888 | / | / |
| R42/R51 | −6.2178 | 1.0000 | 1.0000 | 1.0000 | 1.0000 | 1.0000 | 1.0000 | 2.6006 | 2.6006 |
| d45/TTL | 0.0028 | 0 | 0 | 0 | 0 | 0 | 0 | 0.0238 | 0.0238 |
| \|F34/F\| | 1.6456 | / | / | / | / | / | / | 4.8630 | 5.0286 |
| R32/R41 | 1 | −2.0169 | −2.0068 | −2.9045 | −2.9338 | −1.7938 | −1.7812 | 1 | 1 |
| d34/TTL | 0 | 0.0064 | 0.0030 | 0.0059 | 0.0029 | 0.0322 | 0.0321 | 0 | 0 |
| R21/(R22 + d2) | −0.2655 | −0.1598 | −0.1598 | −0.1446 | −0.1446 | −0.1475 | −0.1490 | −0.6861 | −0.6806 |
| d2/ET2 | 0.3833 | 0.4237 | 0.4432 | 0.4534 | 0.4558 | 0.5783 | 0.5780 | 0.3884 | 0.3800 |
| R11/F | 0.9610 | 1.0252 | 1.0724 | 1.3086 | 1.3140 | 1.0639 | 1.0477 | 0.8357 | 0.8353 |
| R31/F | 0.6928 | 0.8142 | 0.8517 | 0.9633 | 0.9673 | 0.8642 | 0.8425 | 0.5255 | 0.5148 |
| R52/R61 | −0.9529 | −0.6593 | −0.6968 | −1.2199 | −1.2322 | −0.5270 | −0.5324 | −0.6221 | −0.6221 |
| (R52*F)/(R61*TTL) | −0.4630 | −0.2990 | −0.3069 | −0.5452 | −0.5515 | −0.2477 | −0.2535 | −0.3087 | −0.3113 |
| R81/F | −0.4264 | −0.4666 | −0.4833 | −0.7896 | −0.7772 | −0.4984 | −0.4908 | −0.4819 | −0.4769 |
| F1/F | 1.5755 | 2.1983 | 2.2995 | 2.5073 | 2.5176 | 2.4555 | 2.4181 | 1.3930 | 1.4008 |
| F8/F | −0.9375 | −1.1835 | −1.2155 | −0.7831 | −0.7742 | −1.0852 | −1.0686 | −0.9095 | −0.9000 |
| F1/F8 | −1.6805 | −1.8574 | −1.8918 | −3.2018 | −3.2516 | −2.2628 | −2.2628 | −1.5316 | −1.5564 |
| (d6 + d7)/F | 0.4610 | 0.6124 | 0.6406 | 0.6225 | 0.6250 | 0.5536 | 0.5452 | 0.4553 | 0.4505 |
| F6/F7 | −0.8994 | −1.1228 | −1.0798 | −3.1542 | −3.2097 | −0.9124 | −0.9007 | −0.6376 | −0.6376 |

The disclosure further provides an electronic device. The electronic device includes the optical lens assembly according to the above implementations of the disclosure and an imaging element for converting an optical image formed by the optical lens assembly into an electrical signal. The electronic device may be an independent imaging device such as a distance-detecting camera, or may also be an imaging module which is integrated on the distance-detecting camera. Furthermore, the electronic device may also be an independent imaging device such as a vehicle camera, or may also be an imaging module which is integrated on a driver assistance system.

The above descriptions are merely the preferred embodiments and the used technical principles of the disclosure. It should be understood by those skilled in the art that the disclosed application scope involved in the disclosure is not limited to the technical solution formed by a particular combination of the above technical features, but should also cover other technical solutions formed by any combination of the above technical features or their equivalent features without departing from the concept of the disclosure, for example, the technical solutions formed by interchanging the above features with (but not limited to) technical features having similar functions disclosed in the disclosure.

What is claimed is:

1. An optical lens assembly, sequentially comprising from a first side to a second side:
a first lens having a positive refractive power, wherein a first-side surface of the first lens is a convex surface;
a second lens having a negative refractive power, wherein a first-side surface of the second lens is a concave surface, and a second-side surface of the second lens is a concave surface;
a third lens having a positive refractive power, wherein a second-side surface of the third lens is a convex surface;
a fourth lens having a refractive power, wherein a first-side surface of the fourth lens is a convex surface;
a fifth lens having a refractive power;
and a sixth lens having a negative refractive power;
wherein an image height H corresponding to a maximum field of view of the optical lens assembly, an entire set focal length value F of the optical lens assembly, and a radian value θ of the maximum field of view of the optical lens assembly meet: |(H−F*θ)/(F*θ)|≤0.06.

2. The optical lens assembly according to claim 1, wherein
a second-side surface of the first lens is a concave surface or a convex surface; and/or
a first-side surface of the third lens is a convex surface or a concave surface; and/or
the fourth lens and the fifth lens are cemented to form a double cemented lens, the fourth lens has a positive refractive power, and a first-side surface of the fourth lens is a convex surface, and a second-side surface of the fourth lens is a convex surface, the fifth lens has a negative refractive power, a first-side surface of the fifth lens is a concave surface, a second-side surface of the fifth lens is a convex surface or a concave surface; and/or
the fourth lens and the fifth lens are cemented to form a double cemented lens, the fourth lens has a negative refractive power, and a first-side surface of the fourth lens is a convex surface, and a second-side surface of the fourth lens is a concave surface, the fifth lens has a positive refractive power; and a first-side surface of the fifth lens is a convex surface, and a second-side surface of the fifth lens is a concave surface; and/or
a first-side surface of the sixth lens is a concave surface, a second-side surface of the sixth lens is a convex surface; or a first-side surface of the sixth lens is a concave surface, and a second-side surface of the sixth lens is a concave surface; or a first-side surface of the sixth lens is a convex surface, and a second-side surface of the sixth lens is a concave surface.

3. The optical lens assembly according to claim 1, wherein a curvature radius R10 of a second-side surface of the fifth lens and a curvature radius R11 of a first-side surface of the sixth lens meet: |R10/R11|≥4.3.

4. The optical lens assembly according to claim 1, wherein a curvature radius R10 of a second-side surface of the fifth lens and an entire set focal length value F of the optical lens assembly meet: |R10/F|≥1.2; and/or
a curvature radius R10 of a second-side surface of the fifth lens and a curvature radius R11 of a first-side surface of the sixth lens meet: 11.383≥|R10/R11|≥4.3.

5. The optical lens assembly according to claim 1, wherein a curvature radius R10 of a second-side surface of the fifth lens and a total optical length of the optical lens assembly, which is a distance TTL from a center of a first side of the first lens to a center of an imaging surface of the optical lens assembly, meet: |R10/TTL|≥0.8.

6. The optical lens assembly according to claim 1, wherein a total optical length of the optical lens assembly, which is a distance TTL from a center of a first side of the first lens to a center of an imaging surface of the optical lens assembly, and a center thickness d11 of the sixth lens meet: TTL/d11≥6.

7. The optical lens assembly according to claim 1, wherein a center thickness d3 of the second lens and a center thickness d6 of the third lens meet: 0.2≤d3/d6.

8. The optical lens assembly according to claim 1, wherein
a curvature radius R10 of a second-side surface of the fifth lens, a center thickness d8 of the fourth lens, and a center thickness d9 of the fifth lens meet: |R10/(d8+d9)|≥2.5; and/or
a curvature radius R10 of a second-side surface of the fifth lens and a center thickness d9 of the fifth lens meet: |R10/d9|≥5.2.

9. The optical lens assembly according to claim 1, wherein
a curvature radius R10 of a second-side surface of the fifth lens, a center thickness d8 of the fourth lens, and a center thickness d9 of the fifth lens meet: 16.266≥|R10/(d8+d9)|≥2.5; and/or
a curvature radius R10 of a second-side surface of the fifth lens and a center thickness d9 of the fifth lens meet: 37.004≥|R10/d9|≥5.2.

10. The optical lens assembly according to claim 1, wherein
a curvature radius R10 of a second-side surface of the fifth lens and an entire set focal length value F of the optical lens assembly meet: 6.884≥|R10/F|≥1.5; and/or
a curvature radius R10 of a second-side surface of the fifth lens and a total optical length of the optical lens assembly, which is a distance TTL from a center of a first side of the first lens to a center of an imaging surface of the optical lens assembly, meet:
3.9≥|R10/TTL≥0.85.

11. The optical lens assembly according to claim 1, wherein a total optical length of the optical lens assembly, which is a distance TTL from a center of a first side of the first lens to a center of an imaging surface of the optical lens assembly, and a center thickness d11 of the sixth lens meet: 32.208≥TTL/d11≥9.

12. The optical lens assembly according to claim 1, wherein a center thickness d3 of the second lens and a center thickness d6 of the third lens meet: 0.3≥d3/d6≥1.8.

13. The optical lens assembly according to claim 1, wherein
an entire set focal length value F of the optical lens assembly and a radian value θ of a maximum field of view of the optical lens assembly meet: F/θ≤30; and/or
an entire set focal length value F of the optical lens assembly, a radian value θ of a maximum field of view of the optical lens assembly, and a maximum clear diameter D of a first-side surface of the first lens meet: 0.978≥(F*θ)/D≥0.2; and/or
a maximum clear diameter D of a first-side surface of the first lens, an image height H corresponding to a maximum field of view of the optical lens assembly, and the maximum field of view FOV of the optical lens assembly meet: D/H/FOV≤0.08; and/or
a maximum clear diameter D of a first-side surface of the first lens, an image height H corresponding to a maximum field of view of the optical lens assembly, and an entire set focal length value F of the optical lens assembly meet: D/H/F≤0.2; and/or
a maximum clear diameter D of a first-side surface of the first lens and a curvature radius R1 of the first-side surface of the first lens meet: 0.883≥D/R1≥0.05; and/or
an image height H corresponding to a maximum field of view of the optical lens assembly, an entire set focal length value F of the optical lens assembly, and a radian value θ of the maximum field of view of the optical lens assembly meet: |(H−F*θ)/(F*θ)|≤0.04; and/or
an image height H corresponding to a maximum field of view of the optical lens assembly, an entire set focal length value F of the optical lens assembly, and a radian value θ of the maximum field of view of the optical lens assembly meet: 0.4≤(H/2)/(F*tan(θ/2))≤2; and/or
a total optical length of the optical lens assembly, which is a distance TTL from a center of a first side of the first lens to a center of an imaging surface of the optical lens assembly, and an entire set focal length value F of the optical lens assembly meet: TTL/F≤4; and/or
an entire set focal length value F of the optical lens assembly and an Entrance Pupil Diameter ENPD of the optical lens assembly meet: F/ENPD≤3; and/or a curvature radius R12 of a second-side surface of the sixth lens and a center thickness d11 of the sixth lens meet: 6.459≤|R12/d11|≥55; and/or
a curvature radius R11 of a first-side surface of the sixth lens and a curvature radius R12 of a second-side surface of the sixth lens meet: 1.528≥|R11/R12|≥0.1; and/or
a maximum effective clear diameter D7 of a first-side surface of the fourth lens corresponding to a maximum field of view of the optical lens assembly, a curvature radius R7 of the first-side surface of the fourth lens, and a sagittal height SAG7 of the first-side surface of the fourth lens meet: 1.055≥arctan(D7/(R7−SAG7))≥0.2.

14. The optical lens assembly according to claim 1, wherein
a distance d26 between the first lens and the third lens, a center thickness d6 of the third lens, and a curvature radius R5 of a first-side surface of the third lens meet: |(d26−d6)/R5|≤0.4; and/or
a distance d26 between the first lens and the third lens, a center thickness d6 of the third lens and a total optical length of the optical lens assembly, which is a distance TTL from a center of a first side of the first lens to the center of an imaging surface of the optical lens assembly, meet: |(d26−d6)/TTL|≤0.15.

15. The optical lens assembly according to claim 1, wherein
an entire set focal length value F of the optical lens assembly, a curvature radius R3 of a first-side surface of the second lens, and a curvature radius R4 of a second-side surface of the second lens meet: |F/R3|+|F/R4|≤8; and/or
a focal length F2 of the second lens and a focal length F3 of the third lens meet: −5≤F2/F3≤−0.02.

16. The optical lens assembly according to claim 1, wherein
a curvature radius R12 of a second-side surface of the sixth lens and a center thickness d11 of the sixth lens meet: |R12/d11|≤55; and/or
a curvature radius R11 of a first-side surface of the sixth lens and a curvature radius R12 of a second-side surface of the sixth lens meet: |R11/R12|≥0.1.

17. The optical lens assembly according to claim 1, wherein
a center thickness d6 of the third lens and a total optical length of the optical lens assembly, which is a distance TTL from a center of a first side of the first lens to a center of an imaging surface of the optical lens assembly, meet: 0.204≥d6/TTL≥0.02; and/or
a center thickness d8 of the fourth lens, a center thickness d9 of the fifth lens, and a total optical length of the optical lens assembly, which is a distance TTL from a center of a first side of the first lens to a center of an imaging surface of the optical lens assembly, meet: 0.318≥(d8+d9)/TTL≥0.05.

18. The optical lens assembly according to claim 1, wherein
a curvature radius R4 of a second-side surface of the second lens and a curvature radius R5 of a first-side surface of the third lens meet: |R4/R5|≤20; and/or
a curvature radius R6 of a second-side surface of the third lens and an entire set focal length value F of the optical lens assembly meet: |R6/F|≤10; and/or
a curvature radius R7 of a first-side surface of the fourth lens and an entire set focal length value F of the optical lens assembly meet: R7/F≤7; and/or
an air gap d7 between the third lens and the fourth lens and an optical back focal length of the optical lens assembly, which is a distance BFL from a center of a second side of the last lens of the optical lens assembly to a center of an imaging surface, meet: (d7*BFL)/(d7+BFL)≤1; and/or
a maximum effective clear diameter D7 of a first-side surface of the fourth lens corresponding to a maximum field of view of the optical lens assembly, a curvature radius R7 of the first-side surface of the fourth lens, and a sagittal height SAG7 of the first-side surface of the fourth lens meet: arctan(D7/(R7−SAG7))≥0.2.

19. The optical lens assembly according to claim 1, wherein
a curvature radius R11 of a first-side surface of the sixth lens and an entire set focal length value F of the optical lens assembly meet: |R11/F|≤5; and/or
a focal length F6 of the sixth lens and an entire set focal length value F of the optical lens assembly meet: −7≤F6/F≤−0.1.

20. An electronic device, comprising the optical lens assembly according to claim 1 and an imaging element for converting an optical image formed by the optical lens assembly into an electrical signal.
